(19) United States
(12) Patent Application Publication
(10) Pub. No.: US 2021/0042830 A1
(43) Pub. Date: Feb. 11, 2021

(54) USER MEDIA PLATFORM SERVER SYSTEM

(71) Applicant: RUON GLOBAL LTD, London (GB)

(72) Inventor: Timothy E. Burke, Exeter (GB)

(21) Appl. No.: 16/989,588

(22) Filed: Aug. 10, 2020

Related U.S. Application Data
(60) Provisional application No. 62/885,183, filed on Aug. 9, 2019.

(51) Int. Cl. G06Q 40/04; G06F 16/23; G06Q 30/00; G06Q 50/26; G06Q 50/00; G06Q 20/38; G06Q 20/32; G06Q 20/34; G06Q 20/12

(52) U.S. Cl. CPC G06Q 40/04; G06F 16/2379; G06Q 30/0185; G06Q 50/265; G06Q 50/01; G06Q 20/0655; G06Q 20/322; G06Q 20/341; G06Q 20/381; G06Q 20/123; G06Q 20/384

(57) ABSTRACT

In some embodiments, the disclosure is directed to a digital media system that uses a decentralized communication system to transfer digital data. In some embodiments, the digital data includes digital property, currency, and instructions for executing financial transactions. In some embodiments, the digital media system controls the storage and flow of digital data through specified nodes located in specified jurisdictions. In some embodiments, by controlling the location of stored digital data and the node route through which digital data flows, the digital media system enables an improved social media network that can be used in the battle to end world poverty.

### CROSS REFERENCE TO RELATED APPLICATIONS

This application claims the benefit of U.S. Provisional Patent Application No. 62/885,183, filed Aug. 9, 2019, the entire contents of which are incorporated herein.

### BACKGROUND

Uncertainty related to rules and regulations for the transfer of private digital property and performing financial transactions between users within different jurisdictional borders has made certainty of rule compliance almost impossible. Further complicating the matter are the possibilities of fees and taxes in certain jurisdictions for storing digital assets on servers within certain jurisdictions as well. As more and more private and government jurisdictions continue to add new rules and/or laws the problem continues to grow exponentially. What is needed is a digital media system that can limit the transfer of digital data including the execution of financial transactions to specified jurisdictions.

In addition, conventional online social networking and messaging platforms enable users to view content and create and distribute communications viewable by one or more other users or vendors of the platforms. However, the underlying platform algorithms generally do not include activity monitoring of users to enable platform systems to rank users by popularity or influence within the platform ecosystem. Furthermore, the platforms are usually devoid of artificial intelligence functions that enable users to more fully engage with products or services. Accordingly, the ability of current platforms to offer engaging and incentivizing interaction with platform content is limited, and improved platforms are required.

### SUMMARY

In some embodiments, the disclosure described herein is directed a digital media system that comprises a plurality of systems. In some embodiments, computers from one or more systems cooperated to enable a decentralized communication system. In some embodiments, one or more systems cooperate to implement a social media system. In some embodiments, one or more systems cooperate to implement a digital currency exchange system. In some embodiments, one or more systems cooperate to implement a connectivity system. In some embodiments, the digital media system described herein is a system that enables the safe, secure, and traceable transfer of any conventional and/or proprietary digital data described herein. In some embodiments, the digital media system described herein is a system that aims to bring peace through the elimination of global poverty.

In some embodiments, computers from one or more systems cooperated to enable a decentralized communication system. In some embodiments, the decentralized communication system includes one or more computers that include one or more processors and one or more non-transitory computer readable media with instructions stored thereon that implement one or more of any system described herein. In some embodiments, the instructions implement a decentralized communication network that includes a plurality of nodes. As used herein, the term “node” and “nodes” broadly includes any portion of the digital media system that is configured transmit digital data according to some embodiments. In some embodiments, at least a portion of any computer described herein can be used to implement a node that enables at least a portion of the novel digital media system. In some embodiments, the digital media system includes at least a portion of one or more conventional financial (e.g., blockchain technology) and/or social media systems (i.e., Facebook®, Amazon®). In some embodiments, the digital media system is configured to prevent the processing of digital data by one or more conventional systems.

In some embodiments, one or more portions of the decentralized communication network are located inside one or more jurisdictions. In some embodiments, jurisdictions are a reference to any physical and or digital domain controlled by an entity (e.g. government, individual, and/or business).

In some embodiments, one or more jurisdictions include one or more areas and/or assets are controlled and/or regulated by a government. In some embodiments, government jurisdictions exert domain over physical property, assets, and/or financial transactions within its borders. For example, one or more government jurisdictions may associate costs, taxes, fees, fines imprisonment, reward and/or punishment with transactions that include digital data according to some embodiments.

In some embodiments, one or more jurisdictions included one or more areas and/or assets are controlled and/or regulated by an individual and/or business asserting personal rights to the use of private property. In some embodiments, the private property is one or more of physical property (e.g., hardware, servers, computers, land, buildings, and/or any physical structure), intellectual property (i.e., trade secrets, patents, trademarks, and/or any system or method whose use is restricted by law), and/or digital property (software, computer code and/or instructions, computer execution methods, and/or any type of digital data that can be stored on and/or transmitted to one or more non-transitory computer readable media). In some embodiments, the private property is located within one or more government jurisdictions. In some embodiments, the provide property is configured to receive, store, process, transmit, and/or display digital data. For example, in some embodiments, a conventional social media company is private property that is configured to control the flow of digital data through its network and regulate what digital content is allowed and/or accepted.

In some embodiments, one or more portions of the decentralized communication system are located inside one or more jurisdictions. In some embodiments, one or more portions of the decentralized communication system are located outside of one or more jurisdictions. In some embodiments, one or more portions of the decentralized communication system are located outside of every jurisdiction other than a jurisdiction defined by the digital media system described herein (i.e., the private property of the digital media system). In some embodiments, the decentralized communication system can direct the flow of data to pass through and/or not pass through one or more jurisdictions. In some embodiments, directing the flow of data through jurisdictions solves the problem of which rules and/or regulations apply to the digital data and/or transactions (e.g., financial transactions) involving the digital data. In some embodiments, directing the flow of data through jurisdictions solves the problem of how to efficiently provide funds to those in need in impoverished and/or remote locations lacking in telecommunications infrastructure. In some embodiments, directing the flow of data through jurisdictions using the novel system and methods described herein helps solve the problem of poverty across the entire globe by making it possible for anyone to safely and securely generate, receive and/or store currency and/or digital data.

In some embodiments, each of the plurality of nodes includes one or more classifications that includes of one or more of a terrestrial node, a space node, a stationary node, and/or a mobile node. In some embodiments, a terrestrial node is a node that is located greater than or equal to 100 km above and/or below Earth's sea level (e.g, a server on the top floor of a building). In some embodiments, a space node is a node that is located greater than 100 km above Earth's sea level (e.g., a satellite, space station, and/or moon base). In some embodiments, a stationary node is a node that is configured to remain stationary at a fixed radial distance from a fixed point on the Earth's surface as data passes therethrough (e.g., a cellular tower, a geosynchronous orbiting satellite). In some embodiments, a mobile node is a node that is configured to move at a variable velocity that includes any direction relative to a fixed point on the Earth's surface as data passes therethrough (e.g., a low orbit satellite, a ship, and airplane). In some embodiments, the digital media system uses a combination of one or more of the plurality of nodes to transmit, transform, and/or store digital data.

In some embodiments, one or more mobile and/or space nodes are configured to directly transmit and/or receive a data signal comprising the digital data from a terrestrial node when the space node and/or mobile node is inside and/or outside a specified jurisdiction. For example, an airplane (i.e., mobile node) passing over United States receives a transmission from a fixed terrestrial node and stores the digital data in computer that includes a non-transitory computer readable medium onboard the airplane according to some embodiments. In some embodiments, the digital data is then transmitted by the computer on the airplane to a fixed terrestrial node in Mexico only after the airplane has crossed Mexico's borders. In this example the flow of digital data is controlled and only passed through specific nodes to insure the digital data is only subject to desired jurisdictional rules. In some embodiments, any one of the plurality of nodes can include one or more classifications. For example, in some embodiments a node comprises a computer located in building within a government jurisdiction which is classified both as a terrestrial node and a stationary node. In some embodiments, for example, the mobile node may be a satellite comprising a computer orbiting the Earth that includes a classification as both a space node and a mobile node. In some embodiments, a node including a computer on a vehicle (e.g., one or more airplanes, spaceships, boats, submarines, drones, cars, and/or anything configured to be moved and/or movable by a motive force) has one or more classifications including a mobile node, a stationary node, a terrestrial node, and a space node depending on its position at any given time. In some embodiments, any node described herein includes conventional and/or proprietary hardware and/or software that enables the transmission, transformation and/or storage of digital data. In some embodiments, one or more nodes used by the system may be a part of one or more jurisdictions.

In some embodiments, one or more of the plurality of nodes are configured to perform a digital transaction inside and/or outside one or specified jurisdictions. In some embodiments, a digital transaction is any manipulation of data in exchange for compensation and/or any conversion of data from one form to another.

In some embodiments, a digital transaction may include a financial transaction. In some embodiments, the financial transaction is one or more of a conventional financial transaction and a proprietary financial transaction. In some embodiments, the financial transaction includes one or more of receiving, storing, transmitting, a backed currency, a fiat currency and/or a digital currency. In some embodiments, a backed currency is currency supported by a commodity (e.g., gold, silver, etc.) In some embodiments, a fiat currency is a government issued currency that is not backed by a commodity. In some embodiments, a digital currency included currency that only exist in digital form (e.g., cryptocurrency, virtual currency, and/or any currency associated with blockchain technology). In some embodiments, fiat currency can take both a physical and digital form and is able to be transmitted and/or transferred using one or more of the plurality of nodes described herein. A reference to currency as used herein includes any currency that can be transferred and/or exchanged digitally using the digital media system.

In some embodiments, a digital transaction may take the form of the association of a digital opinion (e.g., a conventional “comment,” “like,” and/or “thumbs-up” as used conventional social media) to a primary user's digital data by one or more secondary users. For example, a primary user's digital data may be a photograph, and one or more secondary users may provide a digital opinion showing approval. This digital transaction of rewarding a primary user with digital opinions can be described as an emotional compensation to the primary user but may carry with it an intrinsic value that can be converted into a currency (i.e., backed, fiat, and/or digital) and/or other type of compensation by the system. For example, in some embodiments, the system is configured to use one or more proprietary and/or conventional algorithms to measure the number of digital opinions associated with one or more portions of a user's digital data and provide that user with currency (e.g., virtual currency that can be used to purchase services within the digital media system) in exchange for use of the primary user's digital data in conjunction with other portions of the digital media system.

In some embodiments, the system is configured to enable secondary users to transmit currency from a primary user to a secondary user. In some embodiments, the exchange of currency is a financial transaction. In some embodiments, a financial transaction that takes place on a node located in a jurisdiction are subject to the rules and regulations in that jurisdiction. One problem solved by the digital media system is the control over which jurisdictions a digital transaction takes place according to some embodiments. For example, in conventional social media and financial systems, a user may purchase a swimsuit located in Seoul using a mobile phone (i.e., a node) located in Texas. The problem plaguing the digital commerce industry of the prior art is uncertainty as to which jurisdiction's rules (Texas or Seoul) govern the collection of taxes and fees according to some embodiments. In some embodiments, this problem is compounded by the location of the server (i.e., a node) that includes the non-transitory computer readable media storing the image of the swimsuit and/or performing the financial exchange of currency. If this server is located in England, for example, the financial transaction and/or cost associated with storing the digital data may be subject to additional taxes, fees, and/or privacy regulations according to some embodiments. In some embodiments, other complications arise when at least a portion of the data from digital transaction passes through networks (i.e., nodes) located in different jurisdictions (e.g., states), that have their own rules and regulations. The digital media system describes herein solves the problems associated with those uncertainties.

In some embodiments, the system is configured to route digital data (e.g., currency, digital transactions, digital property, etc.) through a node route that includes a specified number of nodes in specified locations within specified jurisdictions. For instance, in the example above, a space node subject to no other jurisdiction than that created within the digital media system may store the primary and or one or more secondary user's digital data (e.g., the swimsuit picture), financial data (e.g., currency), and/or perform the financial transaction. In some embodiments, the system is configured to directly transmit a request for the digital transaction from a terrestrial node in Texas to a space node orbiting a one or more planets (e.g., Earth). The financial exchange of currency between the primary and one or more secondary users takes place on the space nodes where it is not subject to the rules and regulations of one or more jurisdictions. In some embodiments, the system is configured to send the primary and/or the secondary user's currency to another node of each respective user's choice, where the receipt and/or storage of the primary and/or secondary users currency may be subject to the least amount of tax, for instance.

In some embodiments, the ability of a user to choose to which nodes digital data (e.g., currency) is sent improves upon prior art financial systems in that a user can choose to transmit and or store the currency in any location on and/or off the planet which allows a user to bypass jurisdictions that would otherwise take a portion of the currency to settle a fee, tax, or debt. This results in more money kept by all users whose digital data resides within the digital media system's jurisdiction which is an improved system over the prior art according to some embodiments. In some embodiments, it is the strategic placing of nodes that enables a system to redistribute wealth to those around the world in an effort to improve the quality of life of all people by eliminating constraints imposed by extreme poverty.

In some embodiments, the goal of eliminating extreme poverty is enabled by a connectivity system. In some embodiments, the connectivity system comprises one or more connectivity boxes comprising one or more connectivity nodes (i.e., nodes) that are distributed to one or more terrestrial locations lacking a telecommunications structure capable of enabling one or more portions of the digital media system. In some embodiments, these connectivity nodes enable anyone to engage in digital commerce anywhere the world. In some embodiments, the connectivity system includes one or more computers (e.g., laptop, cellular phone, satellite phone, tablets, smart watches, etc.), connectivity network components (e.g., antennas, transmitters, receivers, and/or any conventional hardware and/or software that enables data transfer), and payment devices that include a non-transitory computer readable medium with user identification data stored thereon (e.g., Visa® credit cards, debit cards, digital wallets, scannable codes).

In some embodiments, one or more portions of the connectivity system is used at least as part of the decentralized communication system. In some embodiments, one or more portions of the connectivity system acts as one or more nodes. For example, in some embodiments, a primary user's cellular phone connected to at least a portion of the connectivity system can be used as a node to transfer one or more secondary user's digital data. In some embodiments, the computer, phone, and/or any other data transfer configurable device acts as a communications link between the decentralized system network components. In some embodiments, in this respect, one or more computers are also one or more connectivity network components. In some embodiments, the advantage to this system is that a first computer (e.g., satellite phone) in a remote or impoverished area that can receive from and/or transmit digital data to a node (e.g., a low orbit satellite) can then transmit that signal to one or more secondary computers (e.g., cellular phones) within range to receive a transmitted signal (e.g., an electromagnet wave). In some embodiments, the secondary computers then retransmit the digital data to third computers (e.g., tablets) that are within range to receive the second computer's signal but not necessarily the first computers signal. In some embodiments, this number of computers (i.e., nodes) involved in this information relay has no limit.

In some embodiments, some non-limiting examples of digital data that the digital media system described herein is configured to process, transmit, transfer, receive, store, execute, implement, using a defined path of nodes specified by a user and/or the system are described in the following drawings and detailed description:

### DESCRIPTION OF THE DRAWINGS

FIG. 1 illustrates coins earn in total number of content (images & videos), rollover content to preview number of coins earnt, and ability to send coins to charity or other users according to some embodiments.

FIG. 2 illustrates a virtual AI assistance that can read hashtags and your friends posts and choose flowers and presents to send them automatically according to some embodiments.

FIG. 3 illustrates the ability to earn coins via streaming according to some embodiments.

FIGS. 3A-3E illustrate Total Token Balance (in RUON's own digital currency) and the amount of RUON or other crypto currency their post has made in the top right of app page according to some embodiments.

FIG. 4 illustrates products sold for dollar via credit card transactions or RUON cryptocurrency or other currencies according to some embodiments.

FIG. 4A illustrates how users can sell their own products in exchange for RUON digital currency according to some embodiments.

FIGS. 4B & 4C illustrate the ability to select a store from many different shopping categories according to some embodiments.

FIG. 5 illustrates multiple chat rooms according to some embodiments.

FIG. 6 illustrates a RUON crypto balance according to some embodiments.

FIGS. 7 & 8 illustrate a system to show how many RUONs content posts have generated and is available for spending according to some embodiments.

FIG. 9 illustrates a RUON crypto balance according to some embodiments.

FIG. 10 illustrates a search engine for RUON App searches included all blockchain websites, DApps and other blockchain related companies and content according to some embodiments.

FIG. 11 illustrates a RUON page for users to raise money from other users according to some embodiments.

FIG. 12 illustrates live television and liver user chat according to some embodiments.

FIGS. 13-13D illustrate a RUON page for users to raise money from other users according to some embodiments.

FIG. 13E illustrates a RUON signup according to some embodiments.

FIG. 13F illustrates banking and business mobile services for people in the 3rd world according to some embodiments.

FIG. 14 illustrates a fully encrypted blockchain banking app with finger print encryption to banking and financial services according to some embodiments.

FIGS. 15, 16, and 17 illustrate photo, video, product review, posting, and communication pages of the system according to some embodiments.

FIGS. 18-23 illustrate an activity page of the system according to some embodiments.

FIG. 24 illustrates a social media linking page of the system according to some embodiments.

FIGS. 25-29 illustrate user and vendor review pages of the system according to some embodiments.

FIG. 30 illustrates a user profile page according to some embodiments.

FIG. 31 illustrates system AI suggesting purchases according to some embodiments.

FIG. 32 illustrates a computer system of the system according to some embodiments.

FIG. 33 illustrates a system provider page according to some embodiments.

FIG. 34 illustrates a user interest group page according to some embodiments.

FIG. 35-37 illustrate a media view and comment display page and shows a mySTORY page with the ability to sell user videos to other users according to some embodiments.

FIG. 38 illustrates a user follow display page according to some embodiments.

FIG. 39 illustrates a profile edit display page according to some embodiments.

FIG. 40 illustrates a messaging display page according to some embodiments.

FIG. 41 illustrates a media selection page according to some embodiments.

FIG. 42 illustrates a comment display page according to some embodiments.

FIG. 43 illustrates a media or user posting history page according to some embodiments.

FIG. 44 illustrates a system usage display page according to some embodiments.

FIG. 45 illustrates a page that allows sending money in various currencies according to some embodiments.

FIG. 46 illustrates how users can choose a group of friends to send money to all at once according to some embodiments.

FIG. 47 illustrates a send money page according to some embodiments.

FIG. 48 illustrates transaction history according to some embodiments.

FIGS. 49-49D illustrate selecting a bank account to send money from according to some embodiments.

FIGS. 50-50B illustrate an expert services page according to some embodiments.

FIG. 51 illustrates a GoViral feature page that allows users to BOOST their post to 25, 50 and 100% of the RUOn audience to instantly get more followers according to some embodiments.

FIG. 52 illustrates a user phone directory according to some embodiments.

FIG. 53 illustrates a blockchain listing search directory according to some embodiments.

FIG. 54 illustrates a system utilities selection page according to some embodiments.

FIG. 55 illustrates a secure access facial recognition display illustrating how facial recognition enables access to many aspects of the system according to some embodiments.

FIG. 56 illustrates a marketplace for people to buy companies or sell companies or luxury items in exchange for BTC and crypto or fiat according to some embodiments.

FIG. 57 illustrates feature descriptions for user interest groups (“UIG”) according to some embodiments.

FIG. 58 illustrates an “earn” display page according to some embodiments.

FIGS. 59 and 60 illustrate a page for selecting AI that help with one or more of being a personal assistant, shopping, birthday presents, organizing celebrations, matchmaking, entertainment and events, travel, cooking, booking and also money making ideas according to some embodiments.

FIG. 61 illustrates shows “post”, “stream, “earn”, “spend” and “give back” display pages according to some embodiments.

FIG. 62 illustrates a user wallet display according to some embodiments.

FIG. 63 illustrates a financial transaction page according to some embodiments.

FIG. 64-65 illustrates miscellaneous system-generated display pages according to some embodiments.

FIG. 66 illustrates a friend categorization display page according to some embodiments.

FIG. 67 illustrates how users can pinch in and out to view more of less users and content, user discovery according to some embodiments.

FIG. 68 illustrates a friend category page according to some embodiments.

FIG. 69 illustrates how much a user's mystery video or post has made, today this month and this week according to some embodiments.

FIG. 70 illustrates a page with details for a person in need according to some embodiments.

FIG. 71 illustrates user display and discovery how much users have 1) earnt or 2) donated on the App according to some embodiments.

FIG. 72 illustrates how users can choose to sell the individual Clips they make inside their RUON MySTORY and long edited video posts for other users to buy and use in their own clips according to some embodiments.

FIG. 73 illustrates attaching music clips to videos according to some embodiments.

FIG. 74 illustrates how users can search stock videos and images and other user videos and content posts that they have made available for other users videos according to some embodiments.

FIGS. 75-80 illustrate “comments on content” display page and shows a “button” for users to select a video or a piece of content to use that is uploaded by another user in accordance with some embodiments of the invention according to some embodiments.

FIGS. 81-84 illustrate displays including content scrolling, currently viewed, myStory, and add comments according to some embodiments.

FIGS. 85-86 illustrate scrolling profile display pages according to some embodiments.

FIGS. 87-91 illustrate cryptocurrency banking and exchange displays according to some embodiments.

FIG. 92 illustrates a new post page including the ability to record an audio tag according to some embodiments.

FIG. 93 illustrates more posts, users, videos, contacts, followers and profile pages in a quickly easy searchable manner according to some embodiments.

FIG. 94 illustrates a unique way to display all the RUON attached to a user's posts according to some embodiments.

FIG. 95 illustrates friends, dating searches and profiles, followers and matches displays according to some embodiments.

FIG. 96 illustrates friends, dating searches and profiles, followers and matches display according to some embodiments.

FIG. 97 illustrates a button you click to see which posts today have gained the most coins, likes and also popularity from likes vs. views according to some embodiments.

FIG. 98 illustrates an advanced way to show caller IDs according to some embodiments.

FIG. 99 illustrates a screen allowing you to easily categorize your contacts according to some embodiments.

FIG. 100 illustrates a screen to choose a type of coin according to some embodiments.

FIG. 101 illustrates linking to the app and social platform's digital currency so a user will be able to take photos, post and pay their bills simply from taking selfie according to some embodiments.

FIG. 102 illustrates dropping coins in specific locations using a Google maps API according to some embodiments.

FIG. 103 illustrates balloon coin tethering to receive rewards for completing tasks according to some embodiments.

FIG. 104-108 illustrates playing games using the RUON app according to some embodiments.

FIG. 109 illustrates tethering and or dropping coins at a certain location according to some embodiments.

FIG. 110 illustrates how to expand and change display views according to some embodiments.

FIG. 111 illustrates a products feedback page according to some embodiments.

FIG. 111 A illustrates chats and comments translated into other languages by the system according to some embodiments.

FIG. 112 illustrates an in-app RUON exchange that links all the RUON features into all the other cryptos and even the fiat $, EURO and Sterling according to some embodiments.

FIG. 113 illustrates blockchain crowdfunded project pages powered on RUON according to some embodiments.

FIGS. 114-120 illustrate RUON data points discovery and editing and sharing of revenue data points according to some embodiments.

FIG. 121 illustrates the ability to backup your data and populate RUON with all your content from other social platforms and then have it monetized instantly on RUON according to some embodiments.

FIG. 122-126 illustrates a blockchain powered social media network built on a satellite constellation according to some embodiments.

FIG. 127 illustrates a computer system showing various interactions between the digital media system components including one or more nodes.

FIG. 128 illustrates the display of digital data including copyrighted music that has been transferred through one or more nodes.

FIG. 129 illustrates the display of digital data including privately owned copyrighted images according to some embodiments.

FIG. 130 illustrates a system display that allows a user to manipulate digital data in multiple ways according to some embodiments.

FIG. 131 illustrates a system user contacts display according to some embodiments.

FIG. 132 illustrates a system display that allows a user to manipulate digital data in multiple ways according to some embodiments according to some embodiments.

FIG. 133 illustrates an interaction with an A assistant implemented by the system according to some embodiments.

FIG. 134 illustrates a user being able to select a specific store residing in one or more jurisdictions according to some embodiments.

FIG. 135 illustrates at least a portion of the decentralized communication system including one or more connectivity boxes (e.g., “Soverignsky Boxes”) according to some embodiments.

FIG. 136 illustrates a jurisdiction configured to process one or more digital transactions comprising space nodes outside of any jurisdiction other than specified by the digital media system according to some embodiments.

FIG. 137 illustrates space node to terrestrial node communication occurring only when the space node is above and/or within a specified jurisdiction according to some embodiments.

FIG. 138 illustrates a portion of the system displaying available virtual currency stored within one or more nodes according to some embodiments.

FIG. 139 illustrates a system interface configured to allow a user to access a specified financial jurisdiction according to some embodiments.

FIG. 140 illustrates a system display page showing different types of currency stored digitally at one or more nodes in one or more jurisdictions according to some embodiments.

FIG. 141 illustrates a system display showing two secondary user's digital data stored on one or more nodes in one or more jurisdictions according to some embodiments.

FIG. 142 illustrates a feature of the digital media system that tracks the node path and financial transactions associated with a currency transfer such as charitable donations according to some embodiments.

FIG. 143 illustrates a user's private property in the form of a digital image the controlled access to the private property through a user “my story video page” according to some embodiments.

FIG. 144 illustrates the system's ability to reroute information through specific nodes in the event of losing one or more other nodes according to some embodiments.

### DETAILED DESCRIPTION

Some embodiments include system application software and/or algorithms configured to generate a user interface such as a graphic user interface (GUI) on a user's device. In some embodiments, the system comprises at least a front-end mobile application. In some embodiments, the system can generate a combination of a color scheme, branding elements and spatial arrangement of functional or aesthetic elements on a display of the user's device, such as the said mobile device.

Some embodiments of the system include hashtag technology enabling incentivizing interaction with content. Some embodiments of the system include a process where digital assets are distributed to users of an online (social media) platform in return for interacting with content posted on that platform, where such remuneration is proportional to the influence of the user as determined by a popularity algorithm of the system application software. In some embodiments, the popularity algorithm can comprise an artificial intelligence (AI) algorithm that analyses the activity of one or more users on an online (social media) platform to calculate an index of users being ranked by popularity or influence within the ecosystem for the platform.

Some embodiments of the system include automatic sign-up of followers. Some embodiments of the system include a process via which users of an online (social media) platform can distribute content to a collection of users that have subscribed to that group, where such groups are defined by particular activities, interests, relationships, dating preferences or searches, and/or categorization.

Some embodiments of the system include parental and child protection technology. Some embodiments of the system include a process whereby a “Parent” user account can be used to control the content viewing and interaction capabilities of a “Child” user account, enabling parents to prevent their child from accessing inappropriate material.

Some embodiments of the system include a cryptocurrency/blockchain directory. In some embodiments, the system can comprise and/or couple to a database of company information and contact details for a range of businesses that operate in the blockchain, cryptocurrency, or wider financial technology industries.

Some embodiments of the system include self-forming quantum mesh networks. Some embodiments include a wireless network that is maintained by one or more network participants on an ad hoc basis, whereby each participant is remunerated for acting as an intermediary node to facilitate the transfer of data between parties that are too far apart to complete the transfer otherwise.

Some embodiments of the system include a “SovereignSky” platform blockchain system that is hosted in space. Some embodiments of the system include smart contracts for system payments of system currency, assets, or coins. Some embodiments of the system include a family of self-executing programs that can be integrated into block data of the system blockchain. In some embodiments, when certain pre-determined conditions such as date and time are met, the blockchain can facilitate the transfer of digital assets, thus enabling autonomous payments either on an independent or repeating basis (i.e. tantamount to a direct debit or standing order being paid in system).

Some embodiments of the system include an autonomous program (“mining bot”) that can accept digital assets from users of an online (social media) platform, use those assets to maintain proof-of-work mining nodes on the bitcoin network, and subsequently distribute the digital assets that have been released as block rewards back to the users in a proportion relative to their original contribution (i.e. tantamount to a “Collective Investment Scheme” (CIS) being paid in the system). Some further embodiments of the system include an autonomous program that can accept digital assets from users of an online (social media) platform, exchange those assets at profit via analysis of chart data including moving averages, and subsequently distribute the profit back to the users in a proportion relative to their original contribution.

Some embodiments of the system include a database of or streaming access to a collection of marketing videos that explain or discuss one or more aspects of the system.

Some embodiments of the system can enable connecting friends. Some embodiments of the system can enable categorization of a user's friends on import or entry into the system.

Some embodiments of the system can enable user interest groups. Some embodiments of the system can enable users to join other niche user groups (e.g., swimwear shopping and gaming technology) and share with other users of similar interests.

Some embodiments of the system can enable editing friend categories where a user can add or delete friends from a user's contact's categories.

Some embodiments include a system where no sim card is needed for a user to log in. In some embodiments, the system application is not connected to a user's phone number, and the system can be used on devices such as tablets without needing a SM card.

In some embodiments, the system application uses “two-way opt-in” where a user is required to add or accept contacts before being able to message using the system application.

In some further embodiments, the system application includes a Facebook® sign-in option, where signing in with a Facebook® account can be faster and easier if the user doesn't want to spend time filling in a registration page.

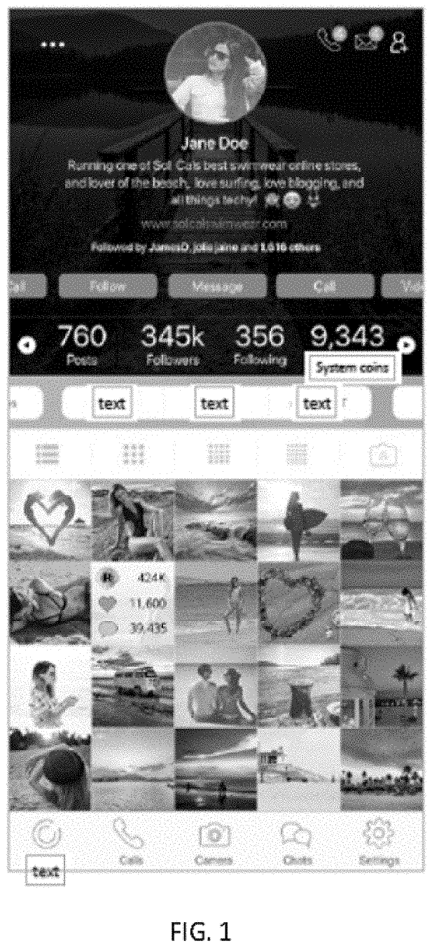

Referring to FIG. 1 and FIG. 11, in some embodiments, the system application further includes Instagram® sign-in option. In some other embodiments, the system application includes LinkedIn® sign-in option. LinkedIn®, the LinkedIn® logo, the IN® logo are registered trademarks or trademarks of LinkedIn Corporation and its affiliates in the United States and/or other countries. Facebook® is a trademark of Facebook, Inc. Instagram® is a trademark of Instagram, LLC.

In some embodiments, the system application includes a “message seen” notification function, where a user can see when someone has opened a user's message, so that a user knows whether or not the message has been read. In some embodiments, a user can switch off notifications. For example, in some embodiments, a user can set specific notifications to a snooze mode if the user doesn't want to be disturbed during a specific time frame.

In some embodiments, a user can set a status. In some embodiments, the system can enable a user to set a specific status that can be used to share a user's mood, what users are doing, or to share important information with all a user's contacts at once.

In some embodiments, the system can show when a user was last active, and a user can see activity history, e.g., the system application can set a “user last active yesterday at 9:30.” message. In some embodiments, a user can specify a user's availability. In some embodiments, a user can stay invisible so that a user doesn't need to logout to appear offline.

In some embodiments, the system can show that someone is typing, and a user can see when someone is typing a reply, which can prevent confusion. In some embodiments, the system can enable a user to send files over 100 MB in size. In some embodiments, a user can send documents to other users using the system application. In some embodiments, a user can be enabled to send music files, and a user can share music files with a user's friends. In some further embodiments, a user can send picture or video messages, such as photos or drawings, or videos with the system application. In some other embodiments, a user can send audio voice clips, and a user can send a pre-recorded voice message. In some embodiments, the system can enable unlimited sending of files.

In some embodiments, the system can enable a user to send a user's location, and a user can send a stamp to someone showing a user's current location. In some embodiments, a user can send a contact stamp, and a user can quickly and conveniently forward a person's contact details on, which is more efficient than finding their number and typing it into a message.

In some embodiments, the system can enable a two-way video chat, and a user can have a one-on-one conversation with video. In some embodiments, the system can enable a two-way voice chat, where the user can communicate quickly and easily, similar to a traditional phone call. In some embodiments, the system can enable a group voice chat and/or a two-way voice chat that is like a phone conversation with several people at once.

In some embodiments, the system can enable an image preview, and a user can see a small thumbnail of images before opening them. In some embodiments, the system can enable an option to delete message history, and a user can delete past messages, (i.e., if they contain confidential or private information).

In some embodiments, the system can enable an existing contacts integration, where a user can easily access and communicate with contacts from a user's existing phonebook. In some further embodiments, the system can enable a contact of any system application, and a user can browse and contact any of a user's fellow system application users.

In some embodiments, the system can enable a “meeting new people” function tailored towards finding new contacts. In some embodiments, the system can enable a “has favorite contacts” function, where a user can have quick access to the people with whom a user communicates with most often.

In some embodiments, the system includes an “all chat history list” function. In some embodiments, the system includes a “chat view individual” function. In some further embodiments, the system includes a “chat view group” function. In some embodiments, the system includes a starting chat with someone function. In some other embodiments, the system can include a premium chat function.

In some embodiments, the system can enable one or more concurrent chat rooms, posting pages, and/or communication pages. In some embodiments, the system can issue one or more system generated or provided rewards, assets, currency, coins, or tokens to one or more users. In some embodiments, tokens can be exchanged or sent via chat rooms, and/or via posting pages (e.g., as a reward for posting content), and/or communication pages. As used herein, the terms rewards, assets, currency, coins, and tokens are used interchangeably. As used herein, a token holder can be a user in possession of one or more rewards, assets, currency, coins, and/or tokens. In some embodiments, the system can enable token holders to use the system to pay to host “invite-only” chat rooms. In some embodiments, the system can enable token holders to use the system to pay for premium services created for chat rooms by open source developers. In some embodiments, the system can enable token holders to use the system to use a “myWallet” “Payment” link posted in chat rooms by users. In some other embodiments, the system can enable token holders to use the system to use “myWallet” “Investment” link posted in chat rooms. In some embodiments, the system can enable token holders to invite all the members of user-interest groups (“UIGs”) (where the system includes a monthly fee until disconnected).

In some embodiments, the system can enable content posting. For example, in some embodiments, other users can reward users with the system for posts. In some embodiments, trend video and posts can be posted to larger audiences on moments. In some embodiments, the system can enable users to promote video and posts across the system application.

In some embodiments of the invention, system tokens can be rewarded for the most viewed video of the week. In some further embodiments, system tokens can be rewarded for users who earned the most system tokens that week. In other embodiments, system tokens can be rewarded for users who made the most friends that week. In some further embodiments, system tokens can be rewarded for users who were the most popular that week. In other embodiments, system tokens can be rewarded for users who shared the most. In some further embodiments, system tokens can be rewarded for users who invited the most. In some embodiments, as the number of users grows, and system total supply gets less, the system can provide less system tokens for rewards.

In some embodiments, the system can enable voice input supports including, but not limited to, English, Mandarin and Cantonese Chinese. In some embodiments, the system includes content reading, where a user can use a “Scan” function to translate between English and Chinese. In some embodiments, the video live streaming (e.g., including translations) can attach the system to a user's favorite mystery videos. Some embodiments include calling and encrypted video calling Skype®-style international landline calling and mobile (non-system application user charge). In some embodiments, the system includes end-to-end encryption of a user's messages and calls, and thus protects data between communicating parties and ensures that only the intended receiver can access the unencrypted information. Further, in some embodiments, the system can enable encrypted Dropbox® and synchronization.

Some embodiments utilize a StealthCrypto® operating system that is designed with state of the art, multi-layered military-grade protection and end-to-end encryption to make data breaches practically impossible. In some embodiments, when a user connects and transmits data through mesh networks established via StealthCrypto® technology, the contributor of the node through which the data passes through will be rewarded with a proportionate amount of “QMN” (StealthCrypto® token). In some embodiments, the system enables end-to-end-encryption including, but not limited to, enablement of StealthCrytpo® phone functions that encrypts a user's communication with cryptographic protocols to send and receive emails, chat, and make calls without concern to a user's privacy.

In some embodiments, the system enables mobile solutions having an “IMSI-Catcher Detector” that detects suspicious cellular activity and Stingray devices, and immediately alerts users to ensure no wiretapping attempt could succeed. In some embodiments, the system includes an untraceable device function. Further, in some embodiments, the system is wiretap secured. In some embodiments, the system includes a StealthCrypto® operating system for mobile solutions with a location tracking feature removed or disabled to prevent localization of a coupled user's device.

In some embodiments, the system includes split encrypted storage. For example, some embodiments include full disk split encryption, securing a user's data, files, operating system, and software programs. In some embodiments, system ensures that if a StealthCrypto® Phone is used by an unauthorized user, no information can be extracted from it.

In some embodiments, token holders can use the system to pay a small transfer fee when exchanging currency and/or tokens using “myWallet”. In some embodiments, the token holders can use the system to order an online or physical the system debit smartcard. In some embodiments, the token holders can use system coins to convert flat currency to electronic currency or vice versa. In some further embodiments, the token holders use the system to convert between currencies. In some embodiments, system wallets can store the system currency (e.g., such as system rewards). Some embodiments include in-system application purchases, and a user can unlock additional content and features by making small purchases within the system application.

Some embodiments include a “myNewschannel” or blog where users can reward other users with system provided tokens for posts. In some embodiments, token holders can use the system to pay for advertising banners. Some other embodiments include a “myTVchannel” Instagram®-style TV streaming and blog channel. In some embodiments, other users can reward users with the system tokens for posts. Some embodiments include token holders who can be enabled to ‘turn on’ their TV channel.

As discussed earlier, some embodiments include a system with functions built on sovereign blockchain and/or a scalable blockchain. Some embodiments include systems utilizing a hybrid blockchain. In some embodiments, the system can include a payment service such as Alipay® or Paypal® for processing in-application purchases. PayPal® is a registered trademark of PayPal Inc. Alipay® is a trademark of Alibaba Group Holding Limited.

Some embodiments include the use of a spaced-based “SovereignSky” blockchain satellite network provider enable to provide jurisdiction-free transactions for all and every blockchain transaction. In this embodiment, the spaced-based “SovereignSky” blockchain satellite network portion of the system can comprise a “One World, One Network” system. In some embodiments, in addition to or in place of satellite Internet nodes, nodes can be coupled or mounted to ships positioned in any portion of any ocean or lake on Earth.

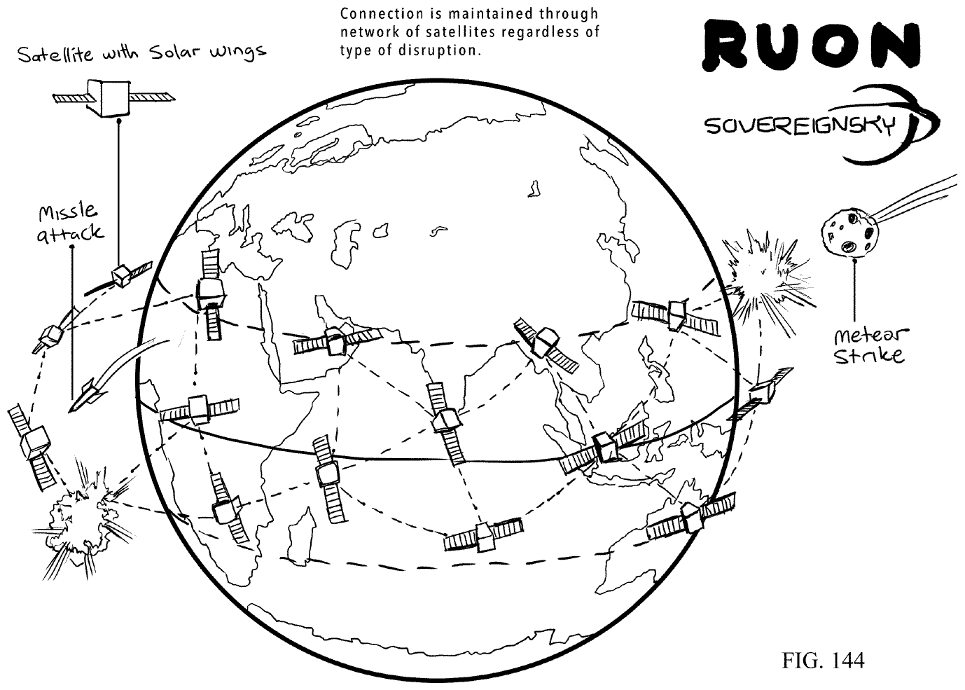

As shown in FIG. 144, in some embodiments, the SovereignSky space-based satellite blockhain network comprises a resilient mesh banking and financial system set in space and self-powered by solar panels. In some embodiments, the system-enabled space-based blockchain includes nodes housed and built on between 1,000 to 2,500 small micro-cubes satellites that are launched into space. In some embodiments, once these cubes are orbiting, they can connect together via our mesh technology forming a military-grade encryption and near indestructible global WiFi connectivity to help eradicate extreme poverty everywhere and a future proof global digital currency built on SovereignSky, which is one of the fastest, most secure and scalable blockchains on and off planet. In some embodiments, the cube satellites are self-powered by solar panels, creating an indestructible banking and financial system, an off-world digital currency that could still work during destruction on-world like a 3rd world war, solar flares, meteorites, giant cyclones, banking system failures, hyper-inflation or global financial market collapse. The SovereignSky is a juristriction-free blockchain set in space and comprises a free blockchain built on a mesh network of cube micro-satellites. Nodes will be set on these and other satellites via USD connectivity allowing transactions to happen in the free jurisdiction of space.

In some embodiments, the system can create an indestructible banking and financial system, an off-world digital currency that could still work during destruction on-world due to a 3rd world war, solar flares, meteorite impacts, giant cyclones, banking system failures, hyper-inflation or global financial market collapse. In some embodiments, the system can use a “payload piggyback” method to create the indestructible, “imesh” banking and financial system which covers the world. In some embodiments, the nodes or blockchain code, transactional wallets and/or executing programs of the Sovereignsky and system blockchain can be attached via “hard drives or small USD clips” on a number of “payloads”, satellites or cube satellites that are launched into space. In some embodiments, the system or SovereignSky can upload code or have our blockchain code installed on a number of international cube satellites, and once in orbit, can connect to the “Network” of the system. In some embodiments, the system space network can consist of 1,000-2,000 cube satellites, or 5,000 small USD chips or hard drives on different payloads and satellites. In some embodiments, “payload piggyback” partners for SovereignSky could include Jeff Bezos and Amazon Project Kuiper, Elon Musk and his Starlink project and any other satellites going into orbit in the next 5 years.

Some embodiments include BEOS and the Sovereign Sky project. BEOS makes the location and applicable jurisdictions of each of its blockchain signing nodes explicitly known where smart contracts only execute on nodes in favorable jurisdictions. Most will execute on nodes anywhere, but some will want to wait until a special jurisdiction node gets its next signing turn. This could be a node on a server in Utah, the Amazon, New York City, a cruise ship in international waters or space, where BEOSnick 1 will offer its services. BEOS will offer representative nodes for users to choose from in many of these locations. BEOS will blaze the trail on this area by guaranteeing to organizations that their transactions are taking place in a jurisdiction where they know themselves to be compliant. All of this is made possible by ultra-low power nodes running EOS third generation graphene technology. Mining based block chains requiring a coal power plant to operate need not apply. Any business logic that can be implemented as a smart contract can now run in space.

SovereignCoin aims to become the first truly ‘stable’ digital currencies by having its corporate clients and companies back the currency and their transactions and trade with hard assets using “Proof of Asset” (PoA) protocols which are verified and integrated into Sovereign's blockchain. SovereignCoin also has a “Goldlabel” solution allowing these same clients their very own cryptocurrency which can be renamed as their standalone currency or connected to Sovereign's global digital network. In general, SovereignCoin will serve as a real-time payment and deposit solution for banks, financial companies, corporate businesses, and international companies specializing in large volume transactions from high value real-estate deals, aerospace and defense contracts for nations, tier-one mergers and acquisitions, national debt processing, large-scale business transactions and international energy, commodity, and oil trading.

Envision the future: Sovereign's global financial network connects and trickles funds down to individuals, including those from the poorest segments of society, via a smartphone mobile application which has a digital wallet and connected physical cryptocurrency smartcard. SovereignAid's ICO will enable any charitable organization to partner with “MissionEarthProject”, phone manufacturers, Chinese factories and major donors to purchase and budget smartphones or “upcycle” some of the 150 million cell phones thrown out each year in the United States. These smartphones will be reused and sent overseas with a mobile application, which accepts Sovereign network donations, pre-installed for distribution to millions in need. SovereignAid has partnered with the system, a highly advanced, crypto-powered social network described as the “WeChat of the West”. It features an Instagram-style layout and multiple cryptocurrency digital wallet with integrated smartcard which will be redesigned for the extensive SovereignAid project.

Buy anything from anywhere accepting MasterCard. First, this allows 98.5% of the donation to go directly to the person in need. Second, the donor can see how their donation is used via the system's video and photo sharing profile pages. For example, a village in the middle of Africa which has been sent $10,000 worth of SovereignCoin can now buy water and food in their local community. The $10,000 worth of SovereignCoin is automatically converted to $10,000 in United States dollars via the digital wallet smartcard. Yes, they may need to travel to buy supplies, but they now have the money to purchase travel and food for their village using the crypto smartcard. This smartcard will be entrusted to a designated village or Church head who will be in charge of the smartphone and card. They will also organize food and supplies to take care of the village, churches, hospitals, or local orphanages.

How much money will be needed to eradicate extreme global poverty? These are rough numbers, but there are still more than 1.3 billion living in extreme poverty today who have less than $1.25 a day, including hundreds of children living in fear of abuse every day. The World Bank estimates that $130 billion is needed per year to eradicate global extreme poverty, which is tiny in comparison to the fact that the world GNP is $75 trillion a year. The US as a whole is a very generous nation, in fact, an incredible $390 billion is donated to charities each year. So first, we must ask where all this money is going as only $130 billion is needed to fix the extreme poverty problem. It has been incredible to learn that under 0.75% is donated to charity from the majority of the top Fortune 500 and companies' combined in the USA.

In some embodiments, all revenue and money that is awarded to users for top and most popular posts can be collected in the system wallet. In some embodiments, system tokens or currency and/or any other cryptocurrency from the exchange tokens can be rewarded for most viewed video of the week. In some embodiments, system tokens can be rewarded for users who have earned the most system currency during any time (i.e., such as during a week). In some further embodiments, system tokens can be rewarded for users who made the most friends that week. In some other embodiments, system tokens can be rewarded to users who are most popular at any time (i.e., such as being most popular during any given week). In some embodiments, system tokens can be rewarded for users who shared the most. In some alternative embodiments, system tokens can be rewarded to a user who invited the most users and/or provided, encouraged, our influenced access to the system as members or users of the system.

In some embodiments, the system can include music licenses from major music labels and Blockchain reports on how many times a song or video is played to enable payment out of a share of the user's cryptocurrency money they have previously acquired. For example, if a user gets $25 in cryptocurrency for their clip, then the music label for the clip gets 3% of this $25. Similarly, users can be paid for allowing other users (content creators) to use any content they've created and sold on the system for users including any content such as images, video, and/or any other user content sold by one use to another user.

In some embodiments, all revenue and money that is awarded to users for top and most popular posts can be collected in the system wallet. In some embodiments, if a user uses another user's video, that user sets the price and gets paid in system tokens. Consequently, the system uses blockchain technology to enable a user to earn tokens collected in wallets. Thus, the system includes an additional ability to earn money from users using your own content, videos and pictures in their own videos. Further, in some embodiments, the system includes all the capabilities of “Coinbase” within the system's “multi-blockchain” wallet that allows users to buy, sell and trade any coins in a simple way similar to Coinbase.

In some embodiments, the system can enable users to watch millions of musical clips and enables users to shoot short video clips, and enable a user's smartphone as a mobile studio. In some embodiments, the system can allow application users to shoot relatively short video clips for fun. In some embodiments, the system enables users to upload (directly) short video clips, select sound from different categories, and allow users to directly record and edit their clips. In some embodiments, users can be enabled to upload recorded videos directly to the user's account. The user can then edit those and add type effects. This can save time and energy and allow users to engage followers in a situation where video recording is not convenient.

Therefore, in some embodiments, the system can enable users to interact with the music in a new way, allow users to create their own short music videos by selecting background music, and enables users to create whatever they want for 15 seconds. Further, in some embodiments, the system includes various music styles, including hip-hop and electronic. In some embodiments, users sell their own videos and content and make them available for other users trying to make their own little short video clips on the system A network (FIG. 75).

Some embodiments include special effects that enable users to easily create magical clips and select background music. Further, some embodiments include eye-catching and easy-to-use special effects so that users have fun and make entertaining videos more easily. In some embodiments, using the system's artificial intelligence engine and image capturing technology, the system enables a fully-featured music video application with special effects. In some embodiments, the special effects include shaking and shivering with hip-hop and electronic music, hair dying, 3D stickers and props. In addition, in some embodiments, users can take their talent to the next level and unlock a world of endless possibilities by tapping into a massive music library.

Some embodiments enable users to share in multiple social platforms. For example, in some embodiments, a lip-syncing application can enable application users to create short lip-synchronizing music videos and share those videos on multiple social platforms like Facebook®, WhatsApp®, Instagram®, and Facebook Messenger®. Further, in some embodiments, the system includes a personalized recommendation algorithm that enables users' preferences and increases engagement.

Some embodiments enable users to prepare, post, or share duet videos for those interested in collaborating with others, including those in other town, cities, regions, or countries. In some embodiments, the system enables one or more of any of the disclosed system-generated effects to be added to the videos. This feature can add variety to the user's feed which will further help you in acquiring more followers. Users can sell their own videos and content and make them available for other users trying to make their own video clips on the system A network (FIG. 75).

Some embodiments enable a slideshow maker feature, including slideshow video processing, posting and sharing capabilities. Accordingly, in some embodiments, the system can enable a user to create a unique collection by embedding several memories in the form of videos. Further, in some embodiments, the system enables the user to seamlessly share any slideshow video in a user's feed.

Some embodiments enable a timer for video recording, and can enable the creation of lip-sync videos using a timer feature. Thus, in some embodiments, the system includes a timer option to enable a user to make the recording initiate automatically.

In some embodiments of the invention, the system can include loyalty cards and rewards functions. Some embodiments include loyalty card wallet functions where a user can store all loyalty cards in one place. Some embodiments include loyalty points conversion from cards in the wallet to system “RED” rewards or tokens. In some embodiments, users can earn loyalty points from in-store spending using loyalty cards in the wallet using system RED rewards or other rewards or tokens. Some further embodiments include loyalty and/or dedicated store management (e.g., retailer settings including the system RED reward, messaging, parameters, etc.), that can enable the retailers to adjust their settings in a more agile manner.

In some embodiments, the system includes one or more adjustable application and chat settings. For example, some embodiments include a built-in translator that can enable users to communicate across different languages. Some embodiments include upgradeable or adjustable additions of languages that are supported, allowing a wider range of languages in the application. This function allows a user to utilize the system in a user's language of choice, and thus making the system more suitable for more users around the world.

Some embodiments include synchronization to the cloud, where data is synchronized to the cloud, making it easier to access across different devices and ensuring a constant data backup. Some embodiments include functions that can be personalized, where a user can personalize the appearance of the system application, for example, choosing a different themes and colors.

Some embodiments include tablet-optimized, mobile device optimized, and/or personal computer-optimized system applications. Some embodiments include operating system compatibility with Android® devices such as smartphones and tablets. Some further embodiments include is compatible with Windows® phones. Some further embodiments include compatible with “iOS” operating systems, including, but not limited to, a range of iOS devices such as iPhones® (including iPhone® X), iPads® and the iPod® Touch®. Some other feature support functions can comprise Face ID® for verifying transactions when using WeChat® pay and an improved design for system notifications when receiving messages. In some embodiments, the system can maintain a compatibility with retro devices.

Some embodiments include ad-free functionality where ads are not displayed to a user during use. Some embodiments include a free application (e.g., for Android® operating system devices). In some embodiments, a user can download the system application for free, from platforms such as Google® Play® or the Apple® App Store. Android® is a trademark of Google LLC.)

In some embodiments, the system application further includes Instagram® page displays that comprise a scrollable page with custom views and separate news feed section. Some further embodiments include a “Moments” page. In some embodiments, the system can support a user's micro-blog page. In some embodiments, a “Moments” page or function can allow a user to use a mini-blog and post thoughts and images and/or video to user's friends. In some embodiments, posts are automatically updated to a user's circle of friends. For example, in the latest version of WeChat, if a user needs more time to assemble a user's “Moments” post, and a user can tap “Cancel” in the Edit screen and select to save a draft. In some embodiments, this function can be integrated with the system application. WeChat® trademark of Tencent Holdings Limited.

In some embodiments, the system can enable connecting friends, where a user can categorize a user's friends on import. Some further embodiments support user interest groups that allow a user to join other niche user groups (e.g., swimwear shopping and gaming technology groups) and share with users of similar interests. Some embodiments include editing friend categories functions, and a user can add or delete friends from a user's contacts categories.

Some embodiments of the system include a login manager that removes the need to frequently switch between two different WeChat® accounts on the same device.

In some embodiments, the system application includes an email sign-in option. Some embodiments include SMS inbox message & contact displays. In some embodiments, the system can display hundreds of text contacts and conversations on one screen. In some embodiments, after sending a message with a typographical error, the system can recall the message, re-use the old content, edit the message and resend the corrected message.

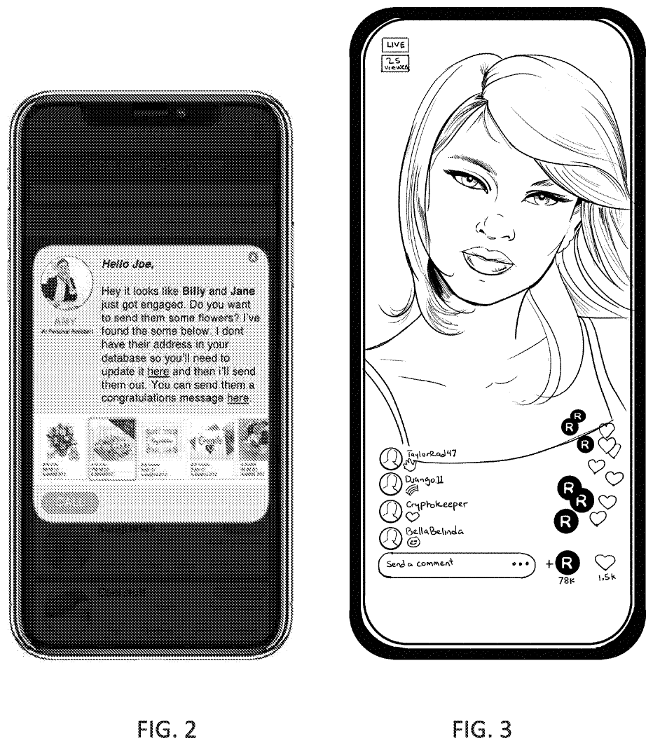

FIG. 2 illustrates a content posting page of the system in accordance with some embodiments of the invention. As discussed earlier, in some embodiments, a popularity algorithm can comprise an artificial intelligence algorithm that analyses the activity of one or more users on an online (social media) platform to calculate an index of users being ranked by popularity or influence within the ecosystem for the platform. In some embodiments, the artificial intelligence of the system can remember family and friend's birthdays. In some embodiments, the artificial intelligence of the system can read a user's posts and shop for the user. In some embodiments, the artificial intelligence of the system can read a friend's post and shop and/or suggest posts for a user (e.g., such as a wedding or engagement). In some embodiments, the artificial intelligence of the system can select cool presents and gifts for the user, and/or a user's family and friends. For example, in some embodiments, an artificial intelligence algorithm can run an analysis of when a user's friends and family members birthdays are coming up. In some embodiments, the artificial intelligence then reads what the user's friends and family have been posting, liking, searching, what UIGs they belong to, and which users and hashtags they've looking up. This data is then used to remind users of upcoming birthdays and suggest potential gifts or activities that it determines to be suitable to the birthday boy or girl.

Some embodiments include contact categorizing. For example, some embodiments include an artificial intelligence algorithm that analyzes the communication habits of a user, how much the user speaks to contacts, friends and followers. Further, the artificial intelligence algorithm can examine communication habits with user contacts, friends, and/or followers, and categorizes them into one or more categories, including, but not limited to, close, regular contact, business, social, business leads, and romantic. In some embodiments, the artificial intelligence algorithm can pop up and alert the user to a selected category choice which can be automatically assigned or be subject to approval, dependent on the user settings.

Some embodiments include a newsfeed function. For example, in some embodiments, an artificial intelligence algorithm can analyze user reading habits, blogs, hashtags and content views, searches and posts, and can subsequently create a dedicated news feed based on user topics and likes.

Some embodiments include a travel function. Some embodiments include an artificial intelligence algorithm that analyzes a user's direct messages and searches for meetings, conference calls and calendar dates. Further, the artificial intelligence algorithm can alert users on the day of meetings, analyze traffic, and advise on when to leave home, and/or provide potential routes or methods of transport.

Some embodiments include a background function. In some embodiments, an artificial intelligence algorithm can analyze a user's direct messages, and can search for meetings, conference calls and calendar dates. The artificial intelligence algorithm can then pop up and ask a user to select a person the user will be meeting. In some embodiments, if the user and/or the user's identifying information is not within the system application, the artificial intelligence algorithm can search third party websites and associated databases to find the person. In some embodiments, the artificial intelligence algorithm can be configured to search using their email, telephone number, and ask a user to insert their social profile. Resulting meetings can be a business, romantic or just a social meeting. In some embodiments, the artificial intelligence algorithm can search the internet and bring back a page of information on the person. In some embodiments, the artificial intelligence algorithm can select interests, hashtags, and other information about the person the user is meeting to allow the user to gather more information before meeting with the person.

Some embodiments include popular content functions. For example, in some embodiments, an artificial intelligence algorithm can analyze what is trending within the system application. In some embodiments, the artificial intelligence algorithm can read popular posts, content, and read popular user blogs. In some embodiments, the artificial intelligence algorithm can analyze what is cool, hot and trending, and provide users with a weekly roundup of what is going on within the system ecosystem.

Some embodiments include an emotional state function. In some embodiments, an artificial intelligence algorithm can look after the user. In some embodiments, the artificial intelligence algorithm can look out for sad face emojis and a list of sad, angry, aggressive, upset keywords and language. In some embodiments, if a user's artificial intelligence algorithm picks up on this, it will search for an online shopping present that best suits a user's online habits, and render a popup with a message and a shopping suggestion that will make the user feel better. Once a user presses or activates “accept”, the artificial intelligence algorithm will send it to the user in the post.

In some embodiments, the artificial intelligence algorithm can select a song from a user's list of favorite bands in a user's detailed profile page and play it. In some embodiments, the artificial intelligence algorithm can play an inspiring quote from YouTube® that can help brighten up a user's day. YouTube® is a trademark of Google LLC. In some embodiments, the artificial intelligence algorithm can suggest a dinner party. In some embodiments, the artificial intelligence algorithm popup can suggest a get together of a user's five closest friends and/or find a location based on a user's favorite places the user has visited.

Some embodiments include a shop function. In some embodiments, an artificial intelligence algorithm that can find data on people browsing, liking, and/or starring history and feed it into the system artificial intelligence algorithm engine to improve the sales conversion rate of the system application.

Some embodiments include function related to eating. In some embodiments, the artificial intelligence algorithm can understand when and what the user likes to eat. In some embodiments, the user can update their detailed profile with what and when they like to eat. In some embodiments, the artificial intelligence algorithm can pop up asking if a user is hungry and automatically connect to a local food service such as Uber Eats® or yummie.com and order the user a user's perfect meal. In some embodiments, the user is required to select “Yes” to the artificial intelligence algorithm food order suggestion before any purchase is made or other action is taken. In some embodiments, artificial intelligence-driven virtual assistants will anticipate a user's needs and fulfil them without the need for a user to provide instructions. Uber Eats® is a trademark of Uber Technologies, Inc.

Some embodiments include assistant functions. Some embodiments can include an artificial intelligence algorithm and voice machine and live support person hybrid. In some embodiments, the system can provide someone to talk to. In some embodiments, the system application can either provide a voice machine that the user can interact with, or a dedicated person that the user can talk to for any advice and help in everyday life in support of the artificial intelligence algorithm. In some embodiments, the support person can always be the same to build a rapport with the user. In some embodiments, the artificial intelligence algorithm or live personal assistance, which is a paid for service, can be available at any time as someone independent the user can talk to.

In some embodiments, jobs for the assistant include waking the user up with a phone call rather than an alarm, and/or researching information online, and/or being available to talk to when stressed or ill, or when the user requires independent advice. In some embodiments, the support center can have staff who have expertise in different areas so the user can be sent to if a more specialized person is required to handle the issue being asked by the user. In some embodiments, if the artificial intelligence algorithm is working and not the live agent, then the system software can allow chatbots and virtual personal assistants to research any question and provide an accurate response.

Some embodiments include television and film functions. In some embodiments, an artificial intelligence algorithm can offer suggestions based on a user's previous television and film viewing patterns. In some embodiments, the artificial intelligence algorithm can analyze user interests and draw upon them to create music and shows that use digital performers.

Some embodiments include natural disaster functions. In some embodiments, an artificial intelligence algorithm can be aware of natural disasters that occur or are anticipated, and can build a database of all the users in the affected area. In some embodiments, the artificial intelligence algorithm can then create a news feed of all those potentially affected people using the aid features of the system application (discussed earlier).

Some embodiments include friends in town functions. In some embodiments, an artificial intelligence algorithm can let a user know when a close friend is in town. In some embodiments, a user can select which other users can access knowledge of the user's location. In some embodiments, there are options to allow these users to be notified when they are close, but not actually allow for their location to be tracked or seen, just alerted when both users are in the same town or neighborhood. In some embodiments, the artificial intelligence algorithm can pop up and alert the user which of a user's friends are local without giving their exact location.

As discussed earlier, in some embodiments, the system can enable content posting. For example, in some embodiments, other users can reward users with the system for posts. In some embodiments, posts can comprise longer video length (premium) posts, and allow advanced sending video features (e.g., setting time for a post disappearing function). In some embodiments, the system can include posts and/or functions related to, using, or comprising pictures sent as postcards (partnership, in-application), a library of premium animated emoji features, premium filters and advanced and/or animated filters, video effects and SFX, special titles (in-application, and/or partnerships), trend video and posts to larger audiences on “Moments”, and/or promote video and posts across the system application. In some further embodiments, the system can include posts and/or functions related to, using, or comprising the activation of UIGs for individual content image posts and videos (premium), payments to promote video content, image posts, and status updates across the community and stores, and payments for a library of additional effects, titles, animations on daily status updates. Some further embodiments include “Discover” tab management, and unlimited sending of files.

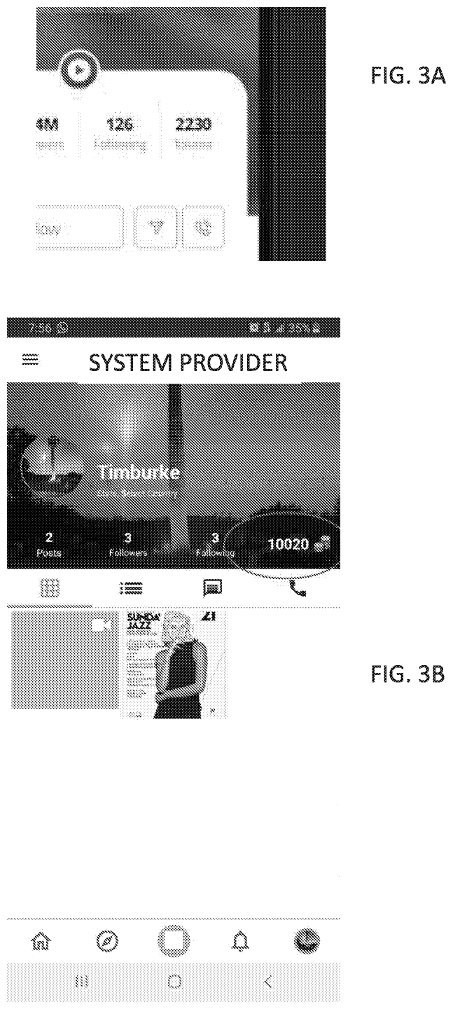

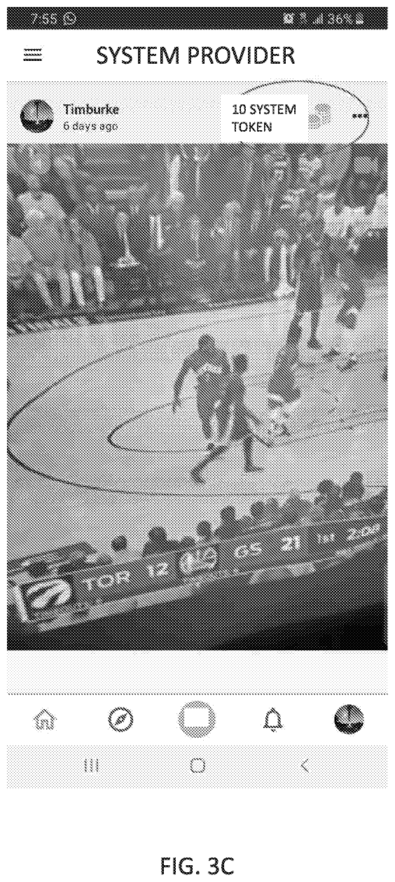

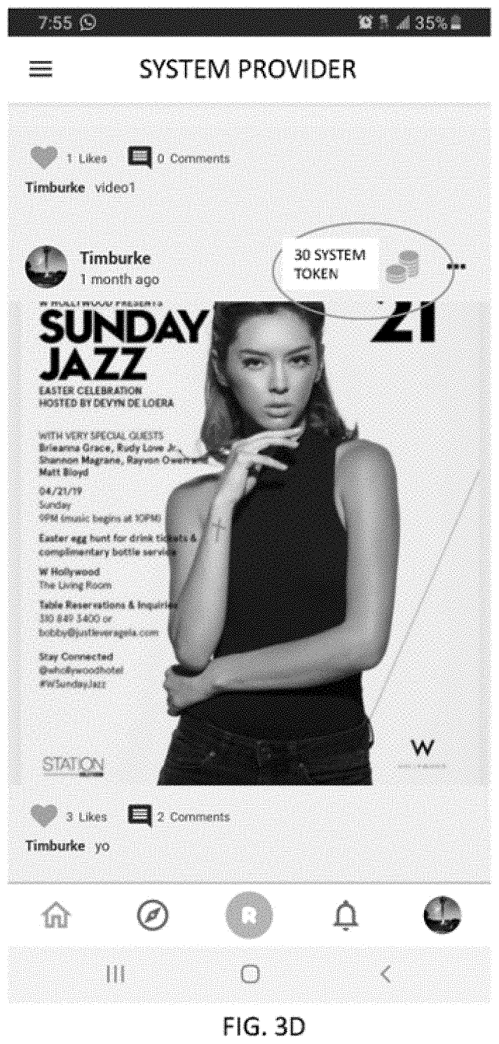

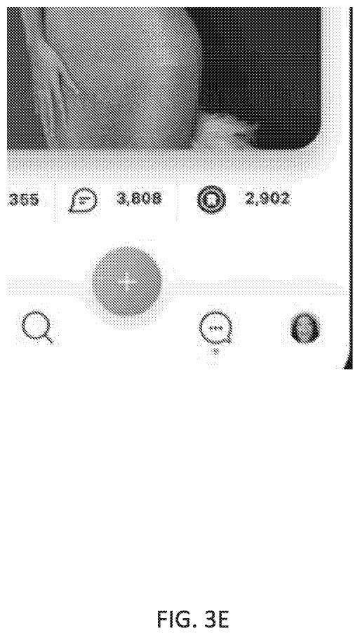

FIG. 3 illustrates a streaming and/or calling page of the system in accordance with some embodiments of the invention. Some embodiments enable video live streaming. In some embodiments, a user can attach system assets or rewards to a user's favorite mystery video.

FIG. 3A shows a partial portion of a display page showing a token balance in accordance with some embodiments of the invention. In some embodiments, a user's total balance of tokens such as system or user-provided currency can be shown in a information bar of a user's display. In some embodiments, the user's main page can show a user's token balance. For example, FIG. 3B shows a user display page showing a token balance in accordance with some embodiments of the invention.

FIG. 3C shows a user display page showing a token reward for content in accordance with some embodiments of the invention. In some embodiments, a user's display can include a display of tokens for content posted by the user. In some embodiments, the display includes one or more historical posts showing token rewards. For example, FIG. 3D shows a user display page showing a token reward for previously posted content in accordance with some embodiments of the invention.

FIG. 3E shows a partial portion of a display page showing a token balance with a user and comment box in accordance with some embodiments of the invention. In some embodiments, a commented and/or rewarding user image can be shown in the display page.

Some embodiments include “system-OUT” functions. In some embodiments, calls to numbers that don't use Viber can be made through the system using Viber Out, a service that connects a user anywhere in the world for a low fee (or any other caller service). Some further embodiments enable caller-id security.

Some embodiments of the system application can enable content reading, and/or a floating web page window. In some embodiments. when reading an account article or viewing a web page, a user can swipe and hold right, and a small “Float window” area can appear in a lower right corner. Some embodiments of the system application can enable drag and release to this corner and a user's web page can be minimized to a floating icon, and a user can continue to use other parts of WeChat® and return to reading a user's web page later.

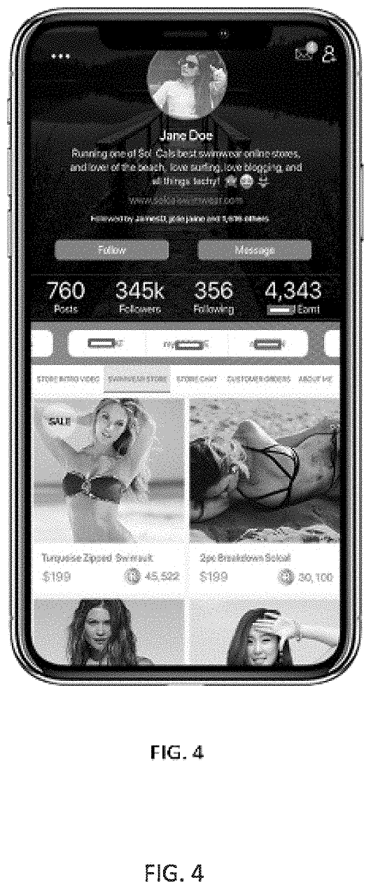

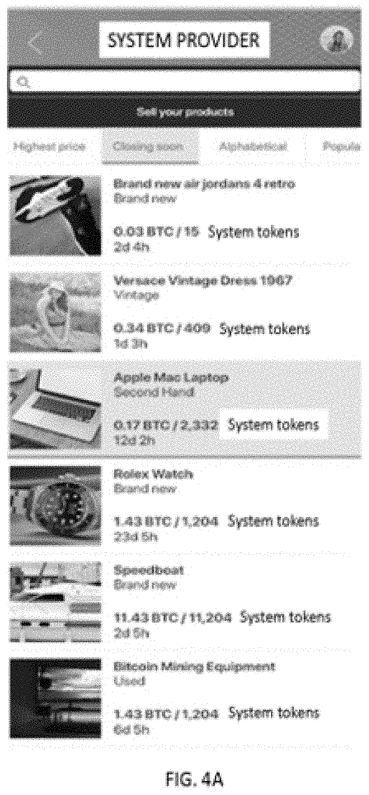

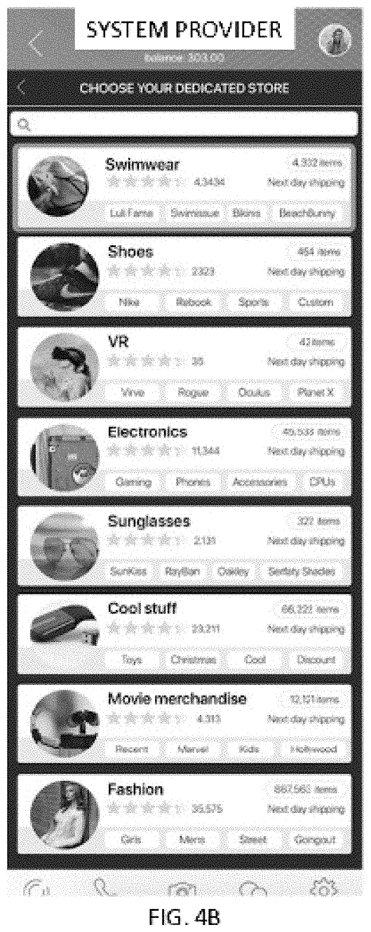

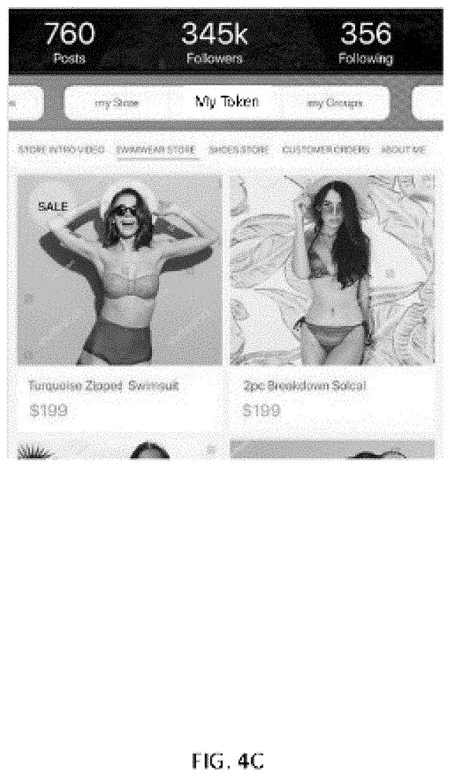

FIG. 4 illustrates a dedicated store page of the system in accordance with some embodiments of the invention. Some embodiments include dedicated store token holders where a user can use the system to pay, and pays to be active with each dedicated store, and where the cost is taken from their first sales (e.g., with a monthly fee). In some embodiments, token holders can use system rewards to pay to upgrade their stores. In some embodiments, token holders can use system rewards for add-on features for individual items. In some embodiments, token holders can use system rewards to pay to “feature” their new items on newsfeeds. Some embodiments include dedicated store token holders where a user can use with the system to pay, and pays to active with each dedicated store, and where the cost is taken from their first sales (e.g., with a monthly fee). In some embodiments, the token holders can use the system to pay users. In turn they pay to activate UIG and promote the store. In some embodiments, monthly fees do not apply (if they are connected to the UIG). For example, a store owner will pay a monthly fee to stay connected to a user group with a large user-base with similar interests to what he/she is selling in their store.

In some embodiments, the system can allow a user to list products for sale in exchange for bitcoin and cryptocurrency. For example, FIG. 4A shows a product for sale display page in accordance with some embodiments of the invention, and FIG. 4B shows a dedicated store page including white-label storefront access in accordance with some embodiments of the invention, and FIG. 4C shows a portion of a dedicated store page in accordance with some embodiments of the invention.

In some embodiments, the system can enable token holders to use system rewards to pay to “‘turn on’” their customer chat room connected to their store (where a minimum monthly fee applies). In some embodiments, the system can enable token holders to use system rewards to pay to advertise their stores within an Amazon®-style search directory (“PPC” and “PPM”). Amazon is a trademark of Amazon.com, Inc. and/or its affiliates.

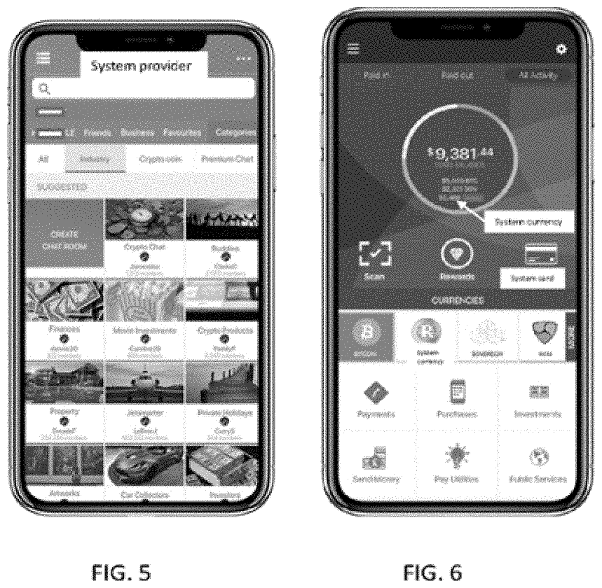

FIG. 5 illustrates a chat room page of the system in accordance with some embodiments of the invention. In some embodiments, the system can enable token holders to use system rewards to pay to host “invite-only” chat rooms. In some embodiments, the system can enable token holders to use system rewards to buy and use premium bots created by open source developers. In some further embodiments, the system can enable token holders to use system rewards to buy premium emojis created by open source developers. In some other embodiments, the system can enable token holders to use system rewards to pay for premium services created for chat rooms by open source developers. In some embodiments, the system can enable token holders to use system rewards to use “myWallet” “Payment” links posted in chat rooms by users. In some further embodiments, the system can enable token holders to use system rewards for using “myWallet” “Investment” links posted in chat rooms. In some embodiments, the system can enable token holders to use system rewards using “myWallet” “Purchase” links posted in chatrooms using “myWallet” “Purchase” links posted in chat rooms such as gofundme/crowdfunding pages. In some embodiments, the system can receive fees each time the system receives a user click.

In some embodiments, the system can enable token holders to invite all the members of UIGs (monthly fee until disconnected). In some embodiments, the system can enable token holders to use system rewards to pay to broadcast television channels within a group chat room. In some embodiments, the system can enable token holders to use system rewards to pay for advertisements within their chat rooms. In some embodiments, the system can enable token holders to pay to use premium privacy settings like troll and hater keyword blocking. In some embodiments, the system can enable token holders as chat room hosts using advanced “member joining” settings.

In some embodiments, the system application can create premium-type chat rooms (e.g., romance chat rooms, therapy chat rooms, and financial advice chat rooms, and other expert chat rooms). In some embodiments, the system application can generate reminders. In some embodiments, the system can generate a dual-column layout display page to a user.

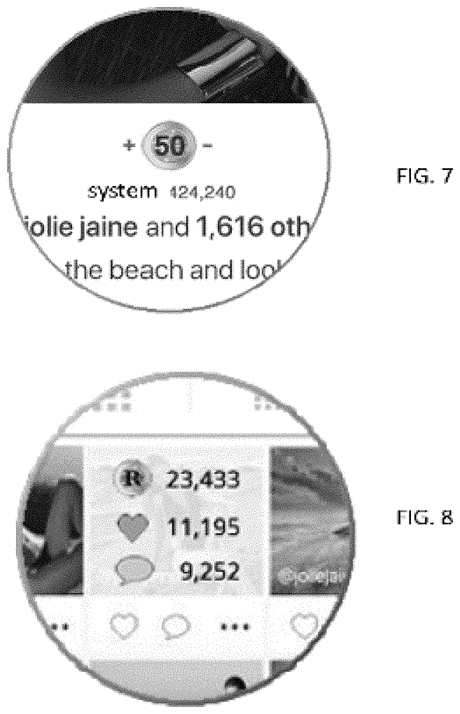

FIG. 6 illustrates a user function page of the system in accordance with some embodiments of the invention. Further, FIGS. 7-8 illustrate portions of payment or reward related function pages of the system in accordance with some embodiments of the invention. Some embodiments enable a “myTEXT AGENT”.

In some embodiments, the system application can enable token holders to use system rewards to “subscribe” to weekly “therapist” agent text messages within premium chat service area. In some embodiments, the system application can enable token holders to use system rewards to “subscribe” to weekly “romantic” agent text messages within premium chat service area. In some embodiments, the system application can enable token holders to use system rewards to “subscribe” to weekly “financial” agent text messages within premium chat service area. In some embodiments, the system application can enable token holders to use system rewards to “subscribe” to weekly “happy” agent text messages within premium chat service area.

In some embodiments, the system application can enable notes features enabling a user to create bulleted and numbered lists, as well as adding checkboxes for creating a shopping or to-do list. Additionally, some embodiments include a “Sticky on Top” option to allow a user to place a banner at the top of a user's chat list screen for easy and convenient access to important notes. In some embodiments, notes in ‘Favorites' can be saved as images.

In some embodiments, the system application can enable “myFUNDME” features. In some embodiments, token holders can use system rewards coins to pay to list projects. In some embodiments, token holders can use system rewards coins to pay to list ‘myFund me’ pages.

As discussed earlier, the system application can enable “myWallet” functions. In some embodiments, the system application can enable token holders to use system rewards to pay a small transfer fee when exchanging currency and/or tokens. In some embodiments, the system application can enable token holders to use system rewards to pay for transfer fees when users send money to each other. In some further embodiments, the system application can enable token holders to use system rewards to order an online or physical system rewards debit smartcard. In some other embodiments, the system application can enable token holders to use system rewards coins to convert flat currency to electronic currency or vice versa. In some other embodiments, the system application can enable token holders to use system rewards to convert between currencies. In some embodiments, the system application can enable token holders to use system rewards for large investments and transactions above $50,000. In some embodiments, the wallet feature stores the currency.

Some embodiments include enhanced chat history search for payment transactions. In some embodiments, the system can generate a user's own reward code. Some further embodiments include a “mySmartcard” function and the system application can include a connected debit card. In some embodiments, the token holders can receive the system generated or award points and cash back every time their smartcard is used to make purchases. Some embodiments can include functions where token holders get related smartcard rewards.

Some embodiments include a “myOriginals” function. In some embodiments, the system application can include a Netflix-style movie, television and entertainment streaming integrated platform. In some embodiments, users can vote and fund using system currency (e.g., for shows). In some embodiments, token holders can use system rewards coins to “vote” on movies, and/or television shows where shows are financed as “original” shows. In some further embodiments, token holders can use system rewards coins to access “exclusive content” from “MovieFund” projects and movies. In some other embodiments, token holders can use system reward coins to buy “Rewards and Perks” such as cameo roles, credits, merchandise and/or premiere tickets (similar to Kickstarter).

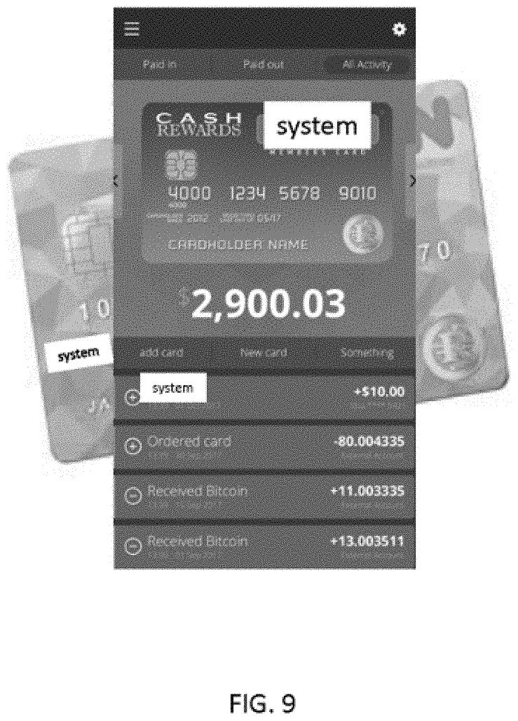

FIG. 9 illustrates a user function page of the system in accordance with some embodiments of the invention. Some embodiments include “myMovies” functions utilizing an Internet-based video on demand and subscription streaming entertainment service such as FlixFling. In some embodiments, token holders can use system rewards to buy movies on a ‘pay per download’ function. In some embodiments, token holders can use system rewards to buy movies on a “subscription” basis. Some embodiments can enable users to watch movies via in-application partnerships.

Some embodiments include “myConcierge” functions. In some embodiments, a user can use electronic currency to book hotels and make restaurant reservations. Some embodiments can enable token holders use system rewards to sign up to the concierge service. In some embodiments, token holders can use system rewards to make bookings and purchases through a system concierge company.

Some embodiments include a one-stop platform for tourists to obtain detailed information about cities, including tourist attractions, culinary delights, and shopping. In some embodiments, features can be enabled with WeChat® and the Netherlands Royal Communications Group (KPN) launched WeChat® Go “Europe Experience”.

Some embodiments include “mySearch” functions. Some embodiments include a Google®-search page for all blockchain applications of the system. Some embodiments include search option. In some embodiments, if a user needs to find something specific, a user can search a user's data for certain keywords. In some embodiments, token holders can use system rewards to pay to be placed at the top of a directory listing page (similar to Google® functions). In some embodiments, token holders can use system rewards for advertisers using “PPC” to list within the system directory listing results.

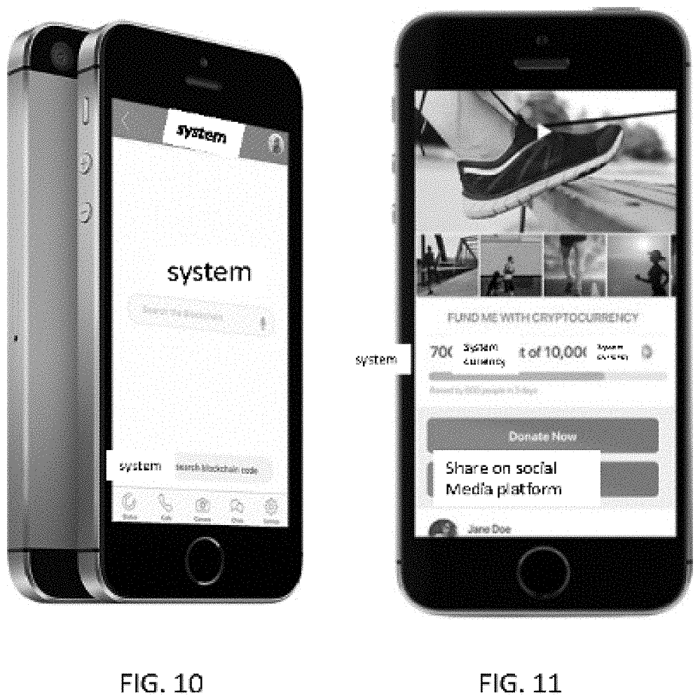

FIG. 10 illustrates a user function page of the system in accordance with some embodiments of the invention. In some embodiments, the system can use a “myBAY” function. In some embodiments of the invention, the system application can enable token holders to use system rewards to list items. In some embodiments of the invention, the system can enable token holders to use system rewards to “feature” items. In some embodiments of the invention, the system can enable token holders to use system rewards to “promote” items. In some further embodiments of the invention, the system can enable token holders to use various amounts of system rewards to list different items. In some other embodiments of the invention, the system can enable token holders to use system rewards for sponsored links. In some embodiments of the invention, the system can enable token holders to use system rewards for promoted directories. In some embodiments of the invention, the system can enable token holders to use system rewards to appear at the top of search results.

In some embodiments, the system application can support in-application promotions, including, but not limited to, PPC advertising, advertising banners, sponsored links, sponsored listings, and promoted directories.

Page, a user's micro-blog page, and “Moments” page or function can allow a user to use a mini-blog and post thoughts and images to user's friends. As discussed earlier, in some embodiments, the system can allow users to reward other users with system rewards for posts, enable token holders to use system rewards coins for advertising, and/or enable token holders to use system rewards for PPC advertising, and/or enable token holders to use system rewards to pay for sponsored link, and/or buy banner adverts, and pay to promote their accounts in the system search directory.

Some embodiments include a “myInvestments” functionality accessible by token holders in the system. In some embodiments, token holders can use system rewards to list projects. In some embodiments, token holders can use system rewards to message other investors. In some further embodiments, token holders can use system rewards coins to pay monthly membership fees.

Some embodiments include a “myNewschannel OR BLOG”. In some embodiments, users can reward other users with system rewards for posts, enable token holder banner adverts, enable token holders PPC advertising. Some embodiments enable token holders sponsoring of news channels, and/or enable token holders to buy trending news, and/or enable token holders to use system rewards to pay for advertising banners, and/or enable token holders sponsored links, and enable token holders sponsored channels.

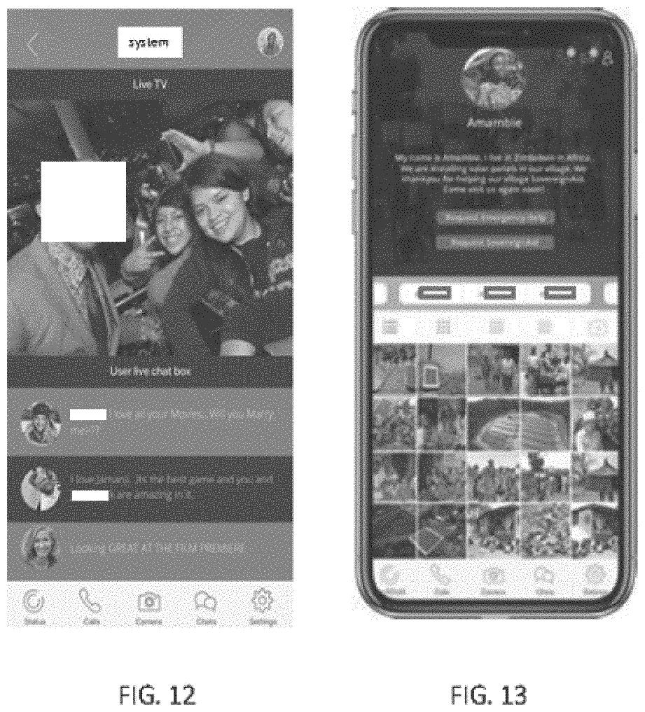

FIG. 12 illustrates a channel page of the system in accordance with some embodiments of the invention. Some embodiments include a “myTVChannel” functionality enabling Instagram-style television and streaming, and blog channel, and where other users can reward users with system rewards for posts. In some embodiments, token holders are allowed to ‘turn on’ their TV channel, and/or token holders are allowed to ‘turn on’ video advertisers. Further, in some embodiments, token holders can be enabled to turn off TV streaming adverts from other channels. Further, in some embodiments, token holders can be enabled to buy banner adverts to show on other channels or newsfeeds. Further, in some embodiments, token holders can be enabled to use system rewards coins to pay for PPC advertising on profile pages and newsfeeds and other pages of the site. Further, in some embodiments, token holders can sponsor other news channels. Further, in some embodiments, token holders can be enabled to pay to their video or TV News broadcasts. Further, in some embodiments, token holders can be enabled to pay for advertising banners using system rewards coins. Further, in some embodiments, token holders can be enabled to buy sponsored links.

Some embodiments include “myTRADER” functions. In some embodiments, token holders are allowed to enter trading chat rooms and/or can access trading bots. In some embodiments, token holders (for a weekly fee) can receive access to text experts and bots.

Some embodiments include “myMINE” functions. In some embodiments, token holders are enabled to enable crypto cloud-mining services. In some embodiments “CloudToken” holders can earn more tokens by providing data storage on the network. In some embodiments, token holders are automatically paid an amount of ETH each week, based on their “cloudmining” results.

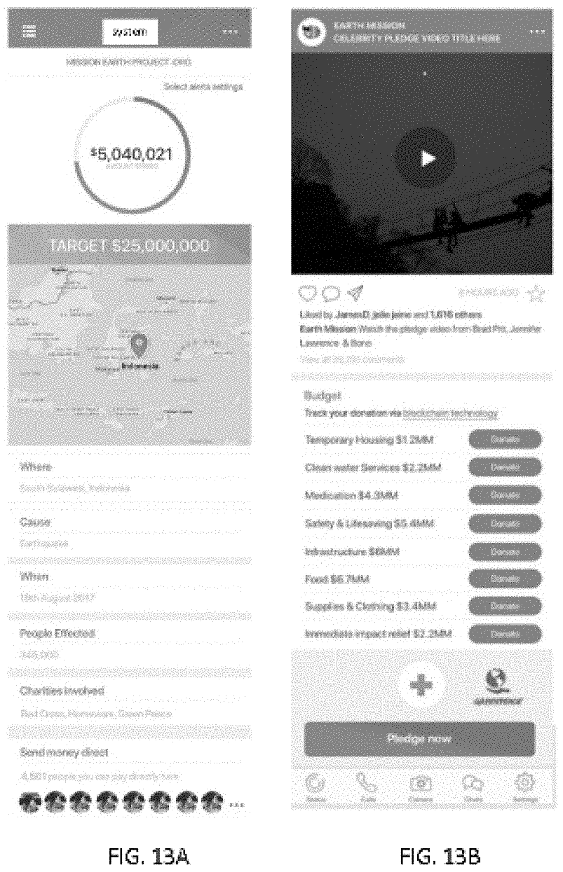

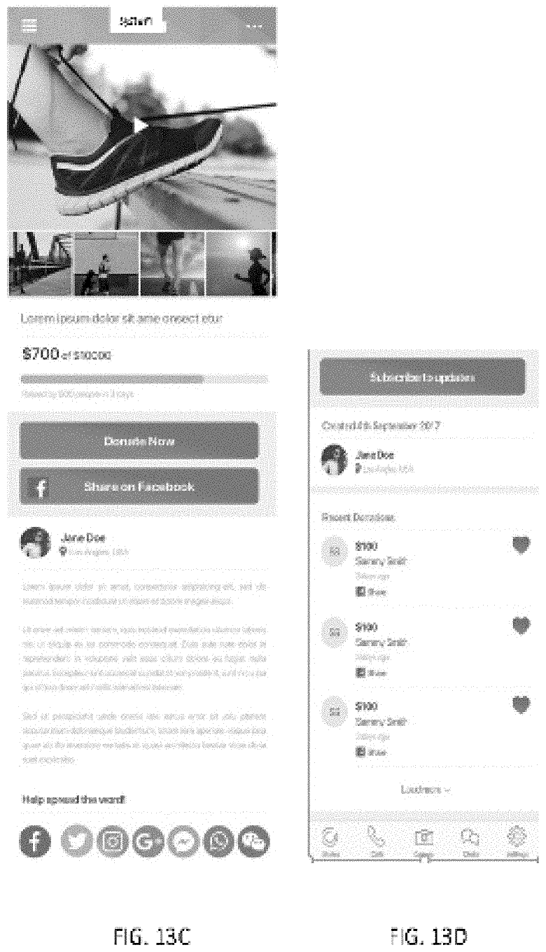

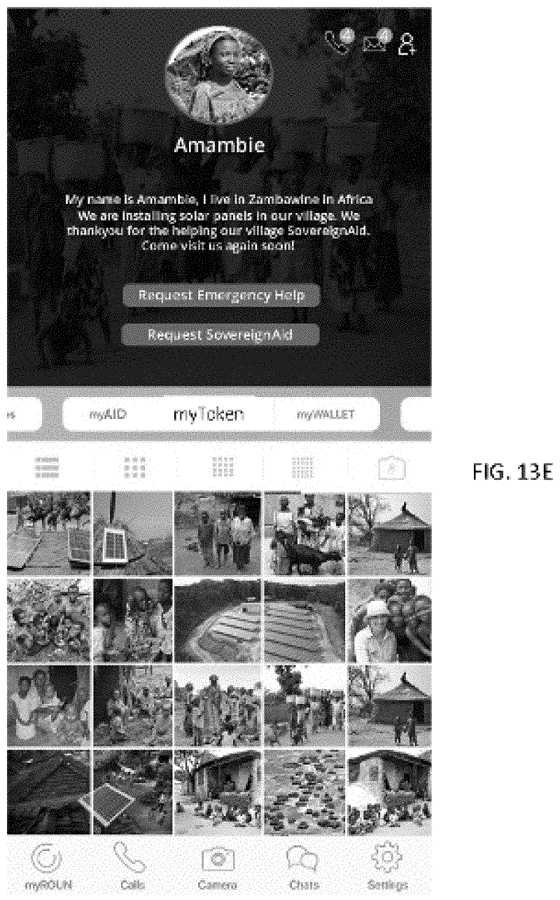

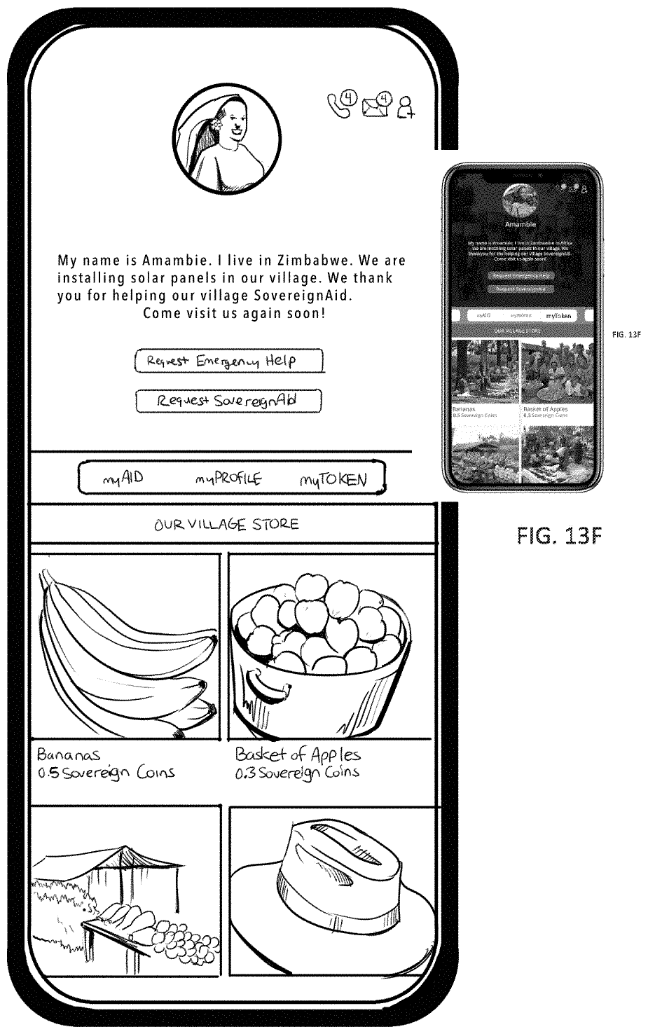

FIG. 13 illustrates a user function page of the system in accordance with some embodiments of the invention. In some embodiments, the system can enable a double verification global charity via use of an electronic currency and use of the connected smart card. In some embodiments, the system can enable trusted donors to see how their donations are spent from photographs and videos using a ‘People in Need’ function of the system application. In this instance, donors can be enabled to track how donations are spent via the system blockchain accounting. In some further embodiments, the system can enable people in emergency or in natural disasters to “apply” for immediate donations through the system application. For example, some embodiments include computer-implemented methods for the provision of humanitarian aid that enables communication and a range of transactional functions between a donor (i.e., a user looking to make a charitable donation), and a donee (i.e., a user that who requesting aid).

In some embodiments, donors can be enabled to view user profiles for donee projects which have been created, approved by the system, and then listed on the system application. People in need will fit pre-defined categories such as religious or environmental groups as well as victims of natural disasters, thus preventing fraudulent actors from abusing the system. In some embodiments, the donee can have the ability to alert donors for emergency cash. Further, a person in need can be enabled by the system to upload a profile, upload photos of their current living situation, and alert a list of donors that they need immediate donation and help. In some embodiments, the donor and donee can communicate directly with each other before a donation is made, including questions to safeguard their donation before making it. In some embodiments, once a donation is made, up to 97.5% of that donation is directly made available to the person in need via system blockchain wallet to wallet transfer of electronic currency. In some embodiments, turnkey solutions for custom smart contracts are integrated so that donations can be released incrementally as pre-set conditions are met by the donee, including the receipt of delivered goods, sharing of photographic evidence (as to the use of prior donated increments), or external criteria such as time and date.

FIG. 13A shows disaster relief summary display page in accordance with some embodiments of the invention. In some embodiments, the display can include a display of an amount raised, a target amount, a location map showing the disaster area, and/or details including a location, cause, when the disaster occurred, the number of people affected, charities involved, and one or more links to individuals enabling a user to send money directly.

FIG. 13B shows a disaster relief details display page in accordance with some embodiments of the invention. In some embodiments, the display page can include an image or video of related to the disaster, such as a pledge video. In some embodiments, the display page can include a budget analysis including one or more donation categories where a user can donate via blockchain technology.

Referring to FIG. 13C, showing a donation display page in accordance with some embodiments of the invention, and FIG. 13D, showing a donations summary display page in accordance with some embodiments of the invention, in some embodiments, the user can build pages for blockchain and crypto-currency donations.

FIGS. 13E-13F show emergency help from people in need display pages in accordance with some embodiments of the invention. In some embodiments, the display can include links to payments options and displays of donation choices. In some embodiments, villages can be enabled to set up a store to sell their local produce and receive bitcoin or crypto-currency. This electronic money can be spent on the connected card.

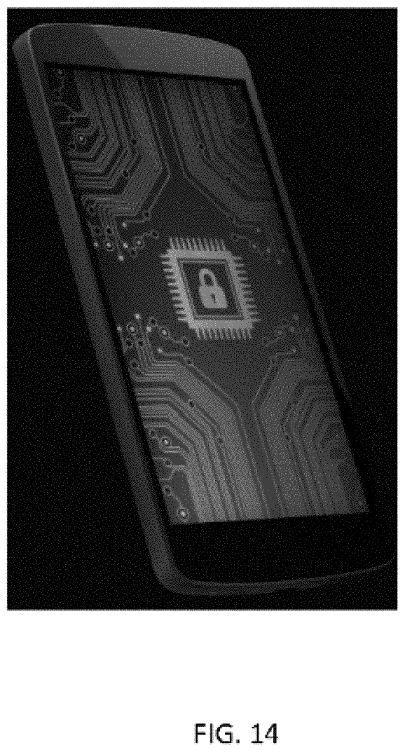

FIG. 14 illustrates a system function page of the system in accordance with some embodiments of the invention. As discussed earlier, in some embodiments, the system can comprise blockchain enabled applications including blockchain-enabled user devices such as mobile phones that can include pre-installed system applications, wallet applications, etc.

Some functions of the system can comprise mesh networking functions. Some embodiments include a quantum mesh network, where each node acts as a router and/or repeater for other nodes in the network. Some embodiments include connecting to WiFi, Bluetooth® or optional connections. Some functions of the system can comprise decentralized communications. Some functions of the system can comprise a locked bootloader that makes any attempt to adjust a user device (e.g., a phone) an automatic deletion of all information, ensuring an additional security level protecting users from any attempts to manually extract information.

Some functions of the system can comprise an ad-hoc wireless mesh networks with multi-hop functionality, bridging the gap between nodes that are just out of range (e.g., where node B acts as an incentivized ‘bridging channel’ for nodes A and C to communicate and transfer data with each other). Some further embodiments include compatible StealthCrypto® phones that include phone EMF protections for safety and security.

Some functions of the system can comprise a modified Kernel where the secure operating system kernel has been modified to allow users to disable hardware (e.g., such as USB, Bluetooth®, camera, etc.) by removing its drivers from the device. Some functions of the system can comprise blockchain features such as a built-in cold storage Qubit wallet which supports major cryptocurrencies, tokens, Qubit Exchange, P2P and decentralized. Some further functions of the system can comprise a Locked Bootloader, where accessing data when the device is in recovery mode is one way to bypass its encryption, and where it has been sealed off in a secure operating system.

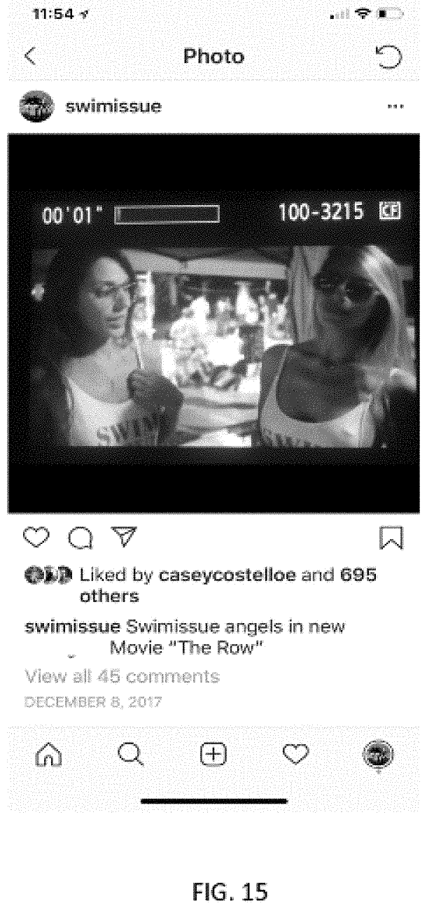

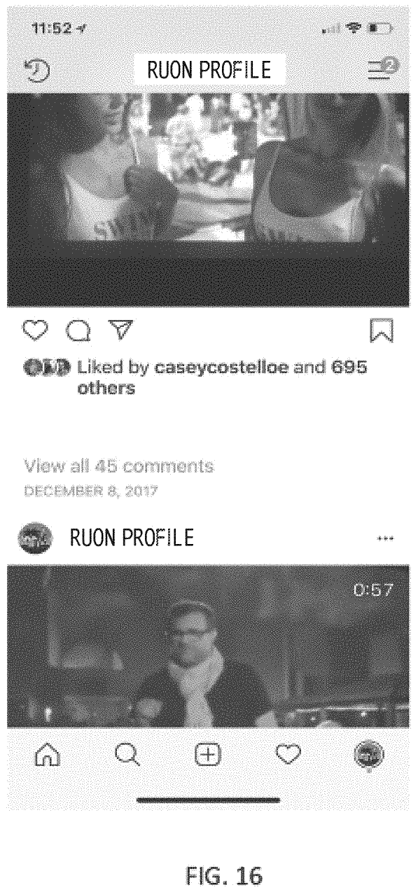

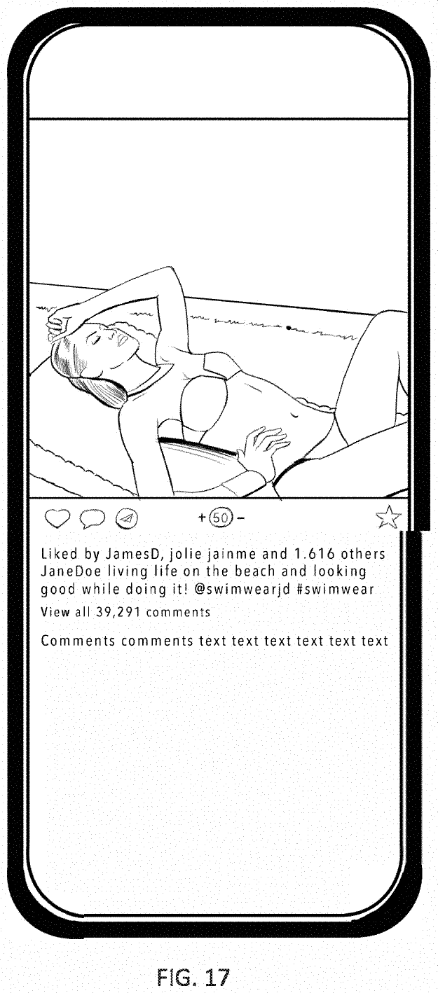

FIGS. 15 and 17A-17B illustrate photo, video, product review, posting, and communication pages of the system in accordance with some embodiments of the invention. As discussed in the example embodiments herein, the system can enable one or more system generated or provided rewards, assets, currency, coins, or tokens to one or more users, and actively encourage and reward the posting of user content. In reference to FIGS. 17A and 17B, the system can include a small icon at the bottom of content posts and at the bottom right of “mySTORY” videos enabling followers and friends of the user to click and attach their system coins (including any cryptocurrency) to the content. In some embodiments, these system coins can be subtracted from the user's overall balance and added to that of the user who posted the content. As shown, in some embodiments, the system icon can be a “(+)” icon and/or a “(−)” icon positioned adjacent a coin icon, enabling users the ability to get “rewarded” by system coins from content posts. In some embodiments, these coins can appear in the wallet of users, and can be spent on an integrated smart card on a VISA network or otherwise exchanged on alternative third-party platforms.

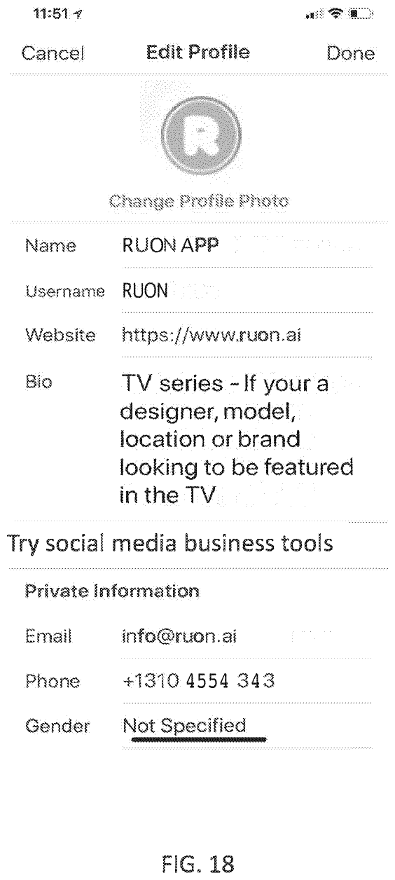

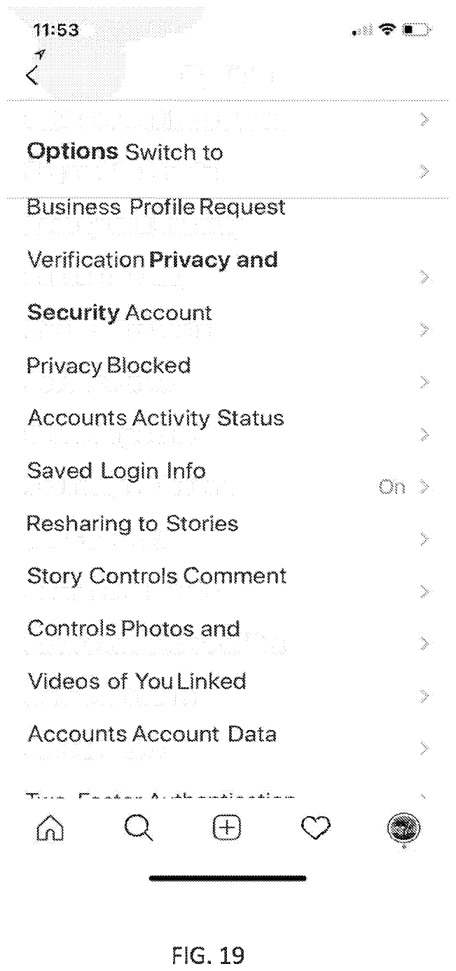

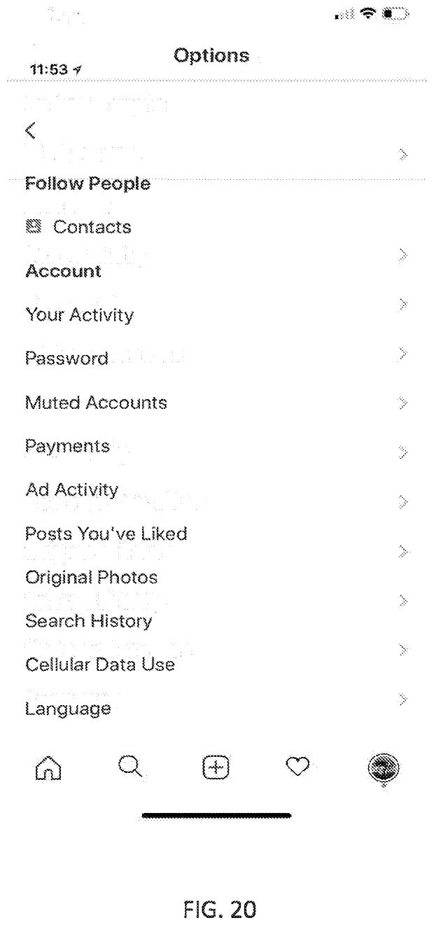

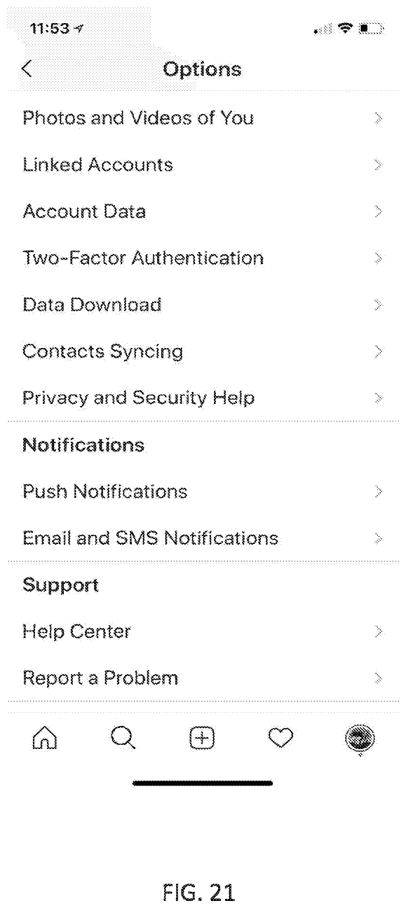

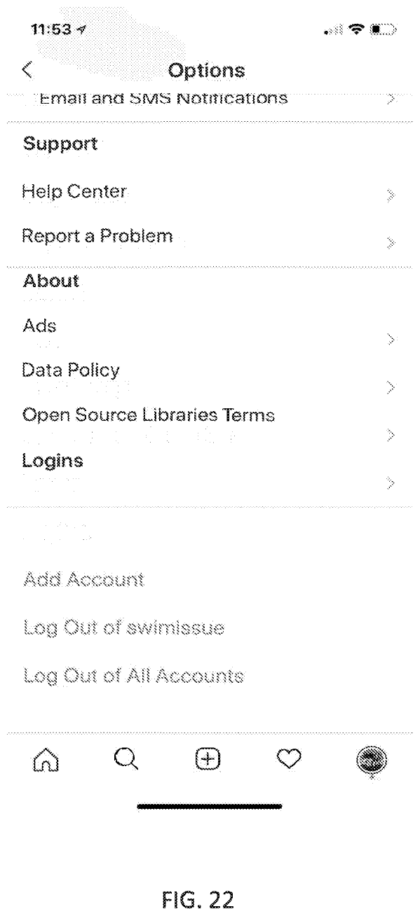

FIG. 18 illustrates a profile page of the system in accordance with some embodiments of the invention. In some embodiments, the user can use the display page to change a profile image, update a name, username, website, biography, and private information such as email, phone number, and gender. Further, FIGS. 19-22 illustrate options pages of the system in accordance with some embodiments of the invention, including one or more options that can be viewed, updated and altered by a user.

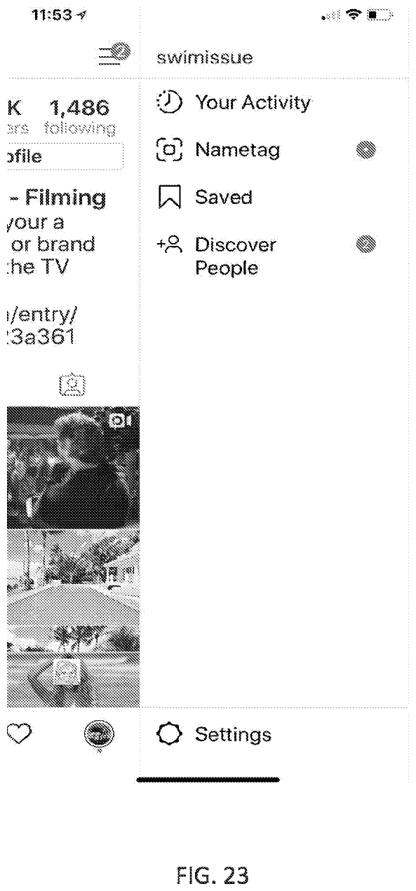

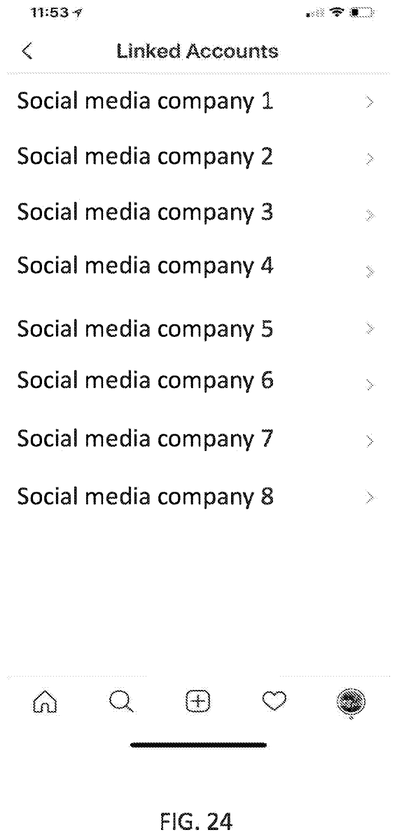

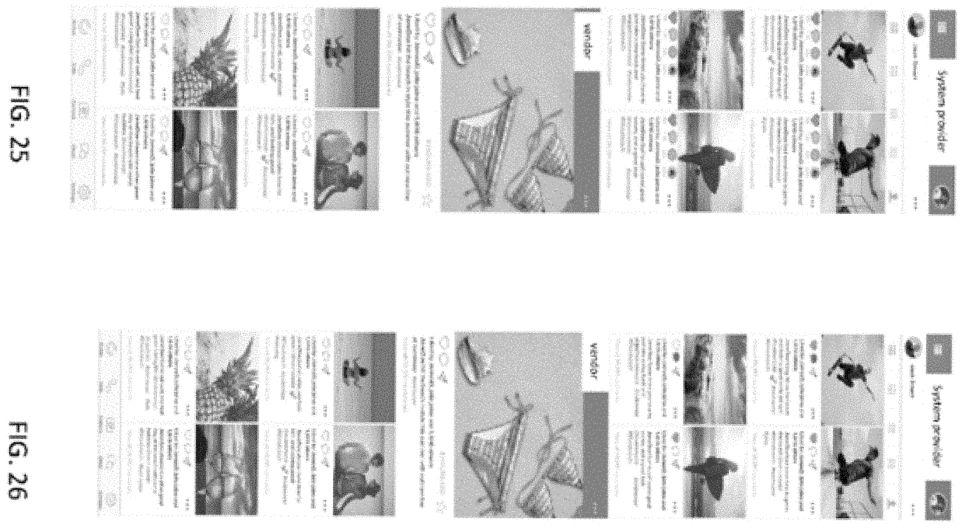

FIG. 23 illustrates an activity page of the system in accordance with some embodiments of the invention. FIG. 24 illustrates a social media linking page of the system in accordance with some embodiments of the invention. In some embodiments, the display can include links to one or more social media platforms that can be selected by a user.

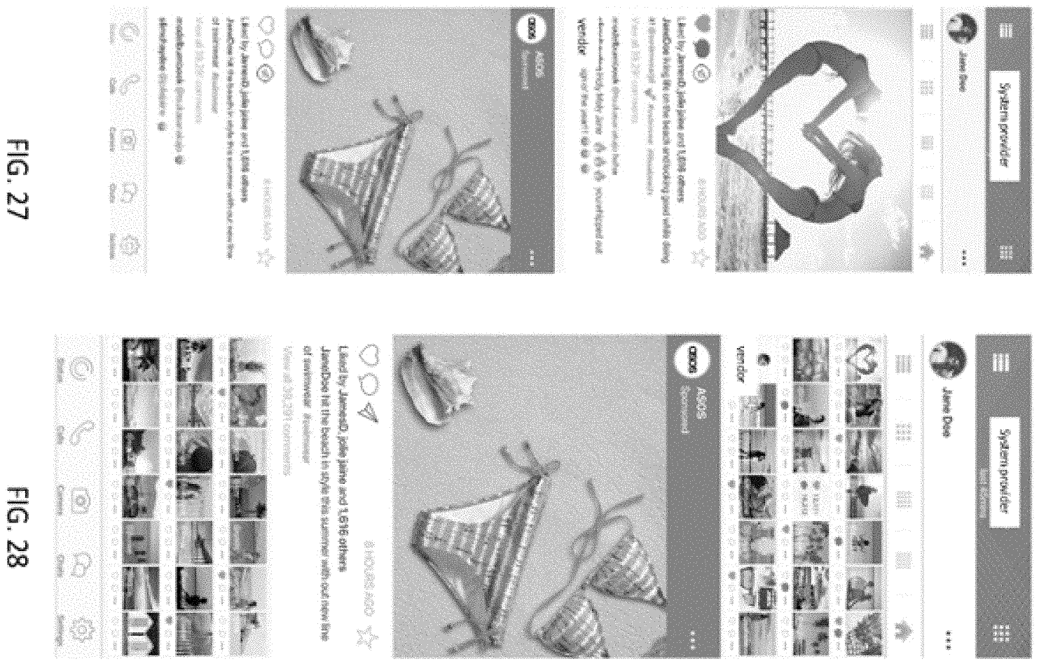

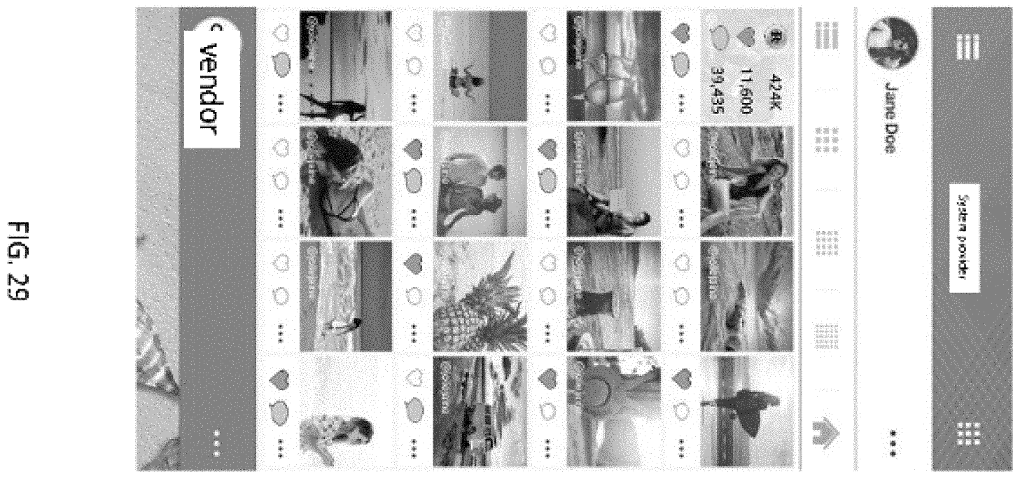

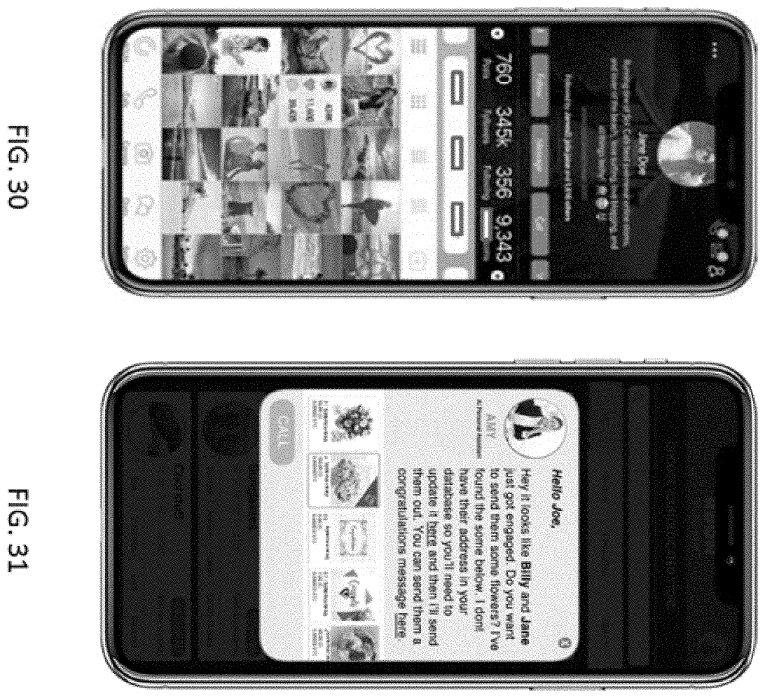

FIGS. 25-29 illustrate user and vendor review pages of the system in accordance with some embodiments of the invention. In some embodiments, the display can include vendor provided content. In some embodiments, the display pages include options to share, options to like, options to comment, options to buy, or options to sell products or services.

FIG. 30 illustrates a user main page of the system in accordance with some embodiments of the invention. FIG. 31 illustrates a user communication page of the system in accordance with some embodiments of the invention. In some embodiments, the display page can include a personal assistant page offering services to the user. In some embodiments, the system artificial intelligence engine can generate a personal assistant offering services to the user as shown.

In some embodiments, the system includes one or more adjustable application and chat settings. Some embodiments enable fun stickers as a quick and a fun way to communicate. In some embodiments, the system includes a media gallery. In some embodiments, a media library contains all uploaded files, making searching easier and helping a user organize a user's content. In some embodiments, the system includes image preview, and a user can see a small thumbnail of images before opening them. In some embodiments, the system includes exports to email, and a user can export data from a user's system application to an email address, thus ensuring a copy that can be forwarded to another person if required.

In some embodiments, the system includes functions to capture images where a user can take photos within the system application. This allows a user to do everything from capturing the image to editing all within one app, instead of having to import an image taken with another camera application.

In some embodiments, the system includes the option to delete message history, and a user can delete past messages, (e.g., if they contain confidential or private information). In some embodiments, a user can set a user's status. A status can be used to share a user's mood, what a user are doing, or to share important information with all a user's contacts at once.

In some embodiments, the system includes functions where drafts are automatically saved, including where if a user is typing a message and it is closed, the system will automatically keep the text. In some further embodiments, the system includes functions to contact any system application user, and a user can browse and contact any of a user's fellow system application users.

In some embodiments, the system supports widgets, and a user can add widgets to the home screen. This allows a user to have more flexibility and to see information at a glance, without going into the system application.

In some embodiments, the system supports the use of GPS to meet people, and a user can see who is near to a user's location, making it easier to meet. In some embodiments, the system application has a browser built-in and a user can open links and view websites while still inside the system application.

In some embodiments, the system includes a walkie-talkie feature, and a user's device can mimic a walkie-talkie, using the push-to-talk feature. In some further embodiments, the system includes a “drift-bottle” option. With a drift-bottle option enabled, a user can throw an anonymous message “into the sea” to be received anywhere in the world, and a user can also pick up messages and reply.

In some embodiments, the system includes built-in games. With built-in games, and a user can have fun playing with friends. In some embodiments, the system includes a dedicated dating application, where in some embodiments, premium services allow users to verify wealth of a prospective date.

In some embodiments, the system can utilize or couple to an electronic wallet API of an electronic wallet application such as Coinbase Toshi®. In some embodiments, users can proceed with setting up a coinbase wallet by downloading and installing the “Coinbase Wallet” application, creating a new wallet and accepting the terms, securing an account and setting up passcode (e.g., such as a six-digit passcode, or, smartphone or tablet fingerprint-enabled access). Users can proceed to create a recovery phase (e.g., using twelve words for recovery). The application can enable “Smart Wallets”, with system tokens, Bitcoin, etc., and provide a public address or key public key as wallet's unique account number, and a personal identification number. In some embodiments, when system tokens are ready to be sent, a user will need to click ‘Add Custom Token’, leading to a screen with displayed token totals. TOSHI is a trademark of Coinbase, Inc.

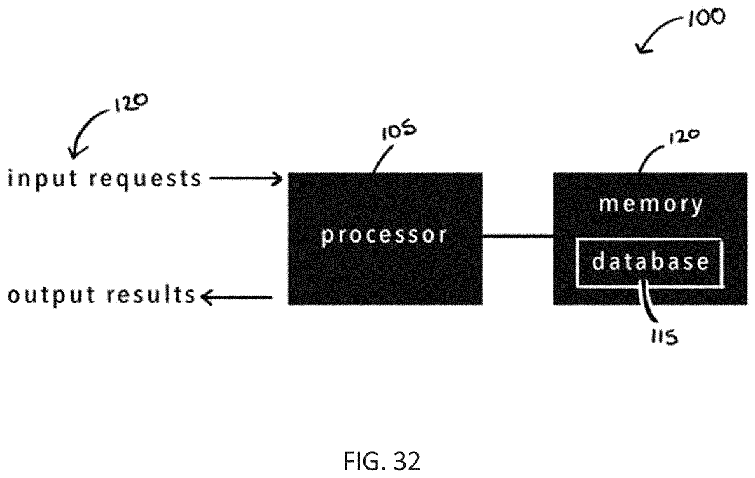

Turning to FIG. 32, a block diagram of a system 100 can implement any one or more of the method of the system disclosed herein. The system 100 includes a processor 105 connected with a memory 110, the memory 110 configured to store data. In some embodiments, the processor 105 is configured to interface or otherwise communicate with the memory 110, for example, via electrical signals propagated along a conductive trace or wire. In an alternative embodiment, the processor 105 can interface with the memory 110 via a wireless connection. In some embodiments, the memory 110 can include a database 115, a plurality of data or entries stored in the database 115 of the memory 110.

As discussed in greater detail herein, in some embodiments, the processor 105 can be tasked with executing software or other logical instructions to perform one or more of the aforementioned methods of the system. In some embodiments, input requests 120 can be received by the processor 105 (e.g., via signals transmitted from a user at a remote system or device, such as a handheld device like a smartphone or tablet, to the processor 105 via a network or internet connection). In an alternative embodiment, the input requests 120 can be received by the processor 105 via a user input device that is not at a geographically remote location (e.g., via a connected keyboard, mouse, etc. at a local computer terminal). In some embodiments, after performing tasks or instructions based upon the user input requests 120, for example, looking up information or data stored in the memory 110, the processor 105 can output results 130 back to the user that are based upon the input requests 120.

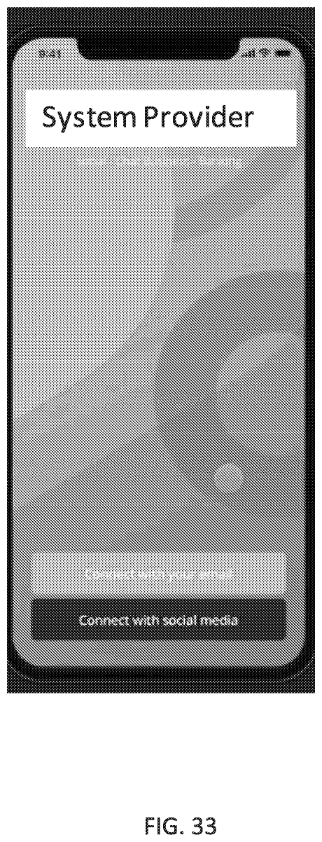

FIG. 33 illustrates a system provider connection display page in accordance with some embodiments of the invention. In some embodiments, the system application can display a system welcome or portal page enabling a user to connect with the system. In some embodiments, the system provider connection display page can include one or more system connection choices, including, but not limited to, email and/or social media.

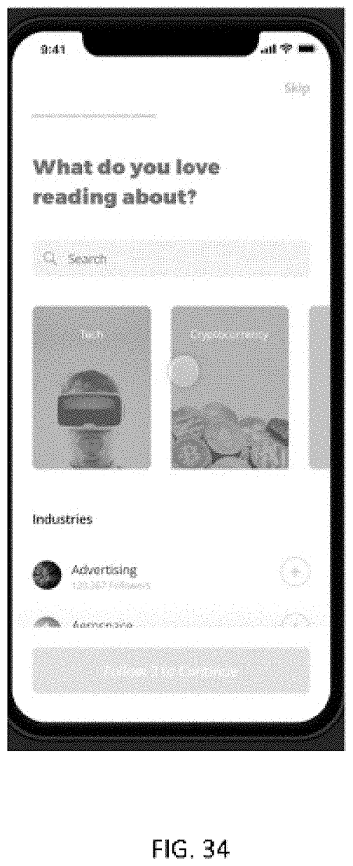

FIG. 34 illustrates a content and/or subject matter search and query display page in accordance with some embodiments of the invention. In some embodiments, the system application can generate a display including selectable content. In some embodiments, system can include a search field enabling a user to search for content. In some embodiments, selectable content can be displayed and/or selected by subject, and/or genre, and/or industry. In some embodiments, the user can be enabled to select more than one content and/or content subject. In some embodiments, a representation of the content can be displayed as text, graphics or images, and/or a combination thereof.

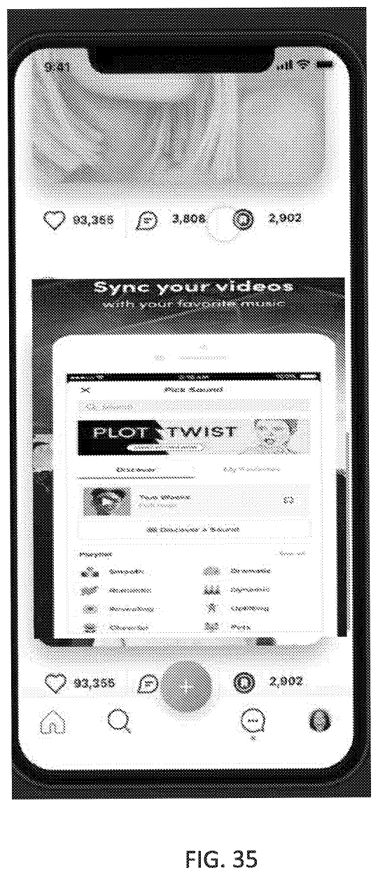

FIG. 35 illustrates a media selection and play display page in accordance with some embodiments of the invention. In some embodiments, the system application can generate a display page including one or more selectable media such as images and/or video. In some embodiments, a user can select, and/or view, and/or play one or more selectable media such as images and/or video. In some embodiments, a user can comment, provide an opinion (e.g., such as “like”), and/or communicate the content to another user.

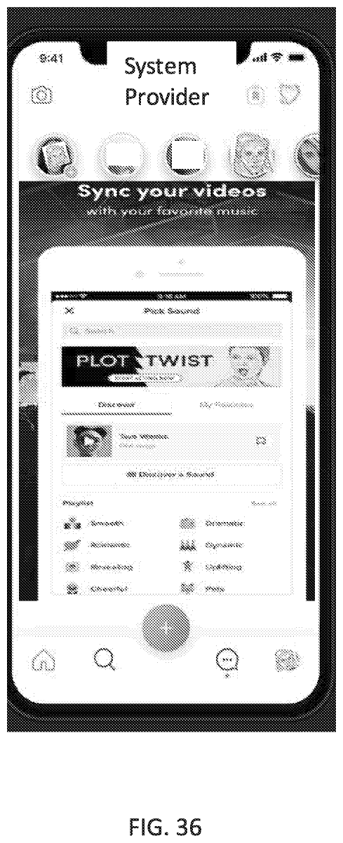

FIG. 36 illustrates media view page in accordance with some embodiments of the invention. In some embodiments, the system application can generate a display page including one or more viewable media such as images and/or video. In some embodiments, a user can select, and/or view, and/or play one or more selectable media such as images and/or video. In some embodiments, a user can comment, provide an opinion (e.g., such as “like”), or communicate the content to another user.

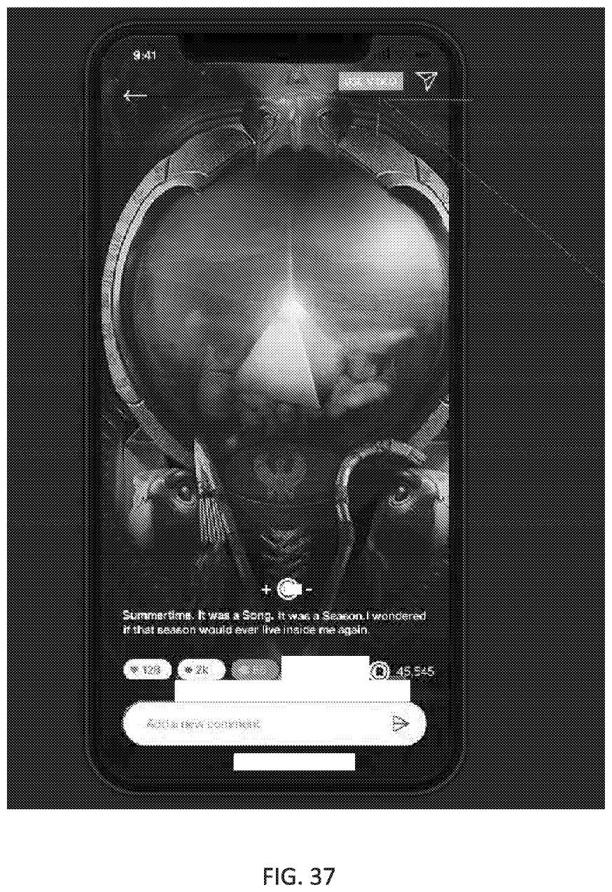

FIG. 37 illustrates a media view and comment display page in accordance with some embodiments of the invention. In some embodiments, the system application can generate a display page including one or more viewable media such as images and/or video. In some embodiments, a user can provide a comment on one or more selectable media such as images and/or video.

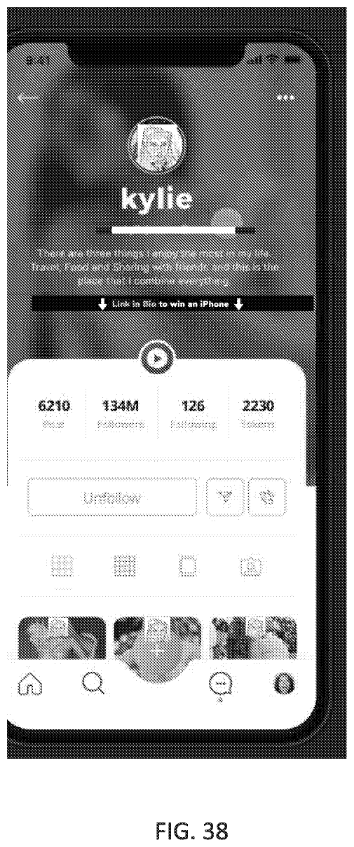

FIG. 38 illustrates a user follow display page in accordance with some embodiments of the invention. In some embodiments, the system application can generate a display page enabling a user to follow or unfollow one or more users, and/or one or more content or subjects.

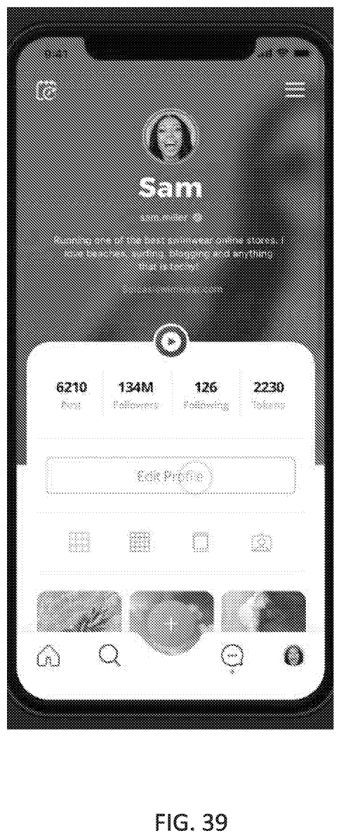

FIG. 39 illustrates a profile edit display page in accordance with some embodiments of the invention. In some embodiments, the system can enable a user to input information to a profile edit page.

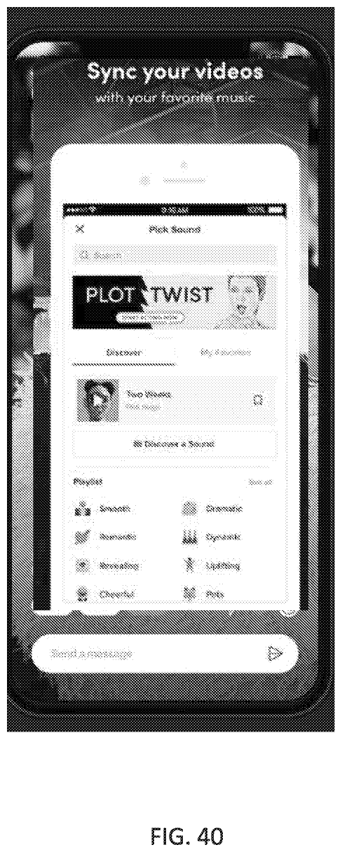

FIG. 40 illustrates a messaging display page in accordance with some embodiments of the invention. In some embodiments, the system application can enable a user to send a message to a system user and/or to a content source, and/or to a subject of the content.

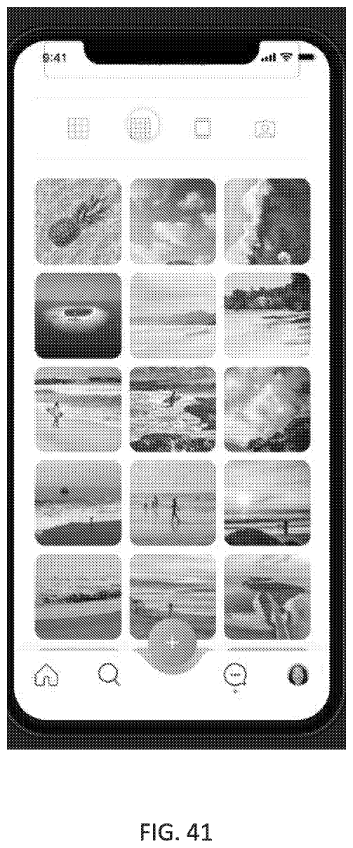

FIG. 41 illustrates a media selection page in accordance with some embodiments of the invention. In some embodiments, the system application can generate a display of selectable media content, posted media content, and/or available media content.

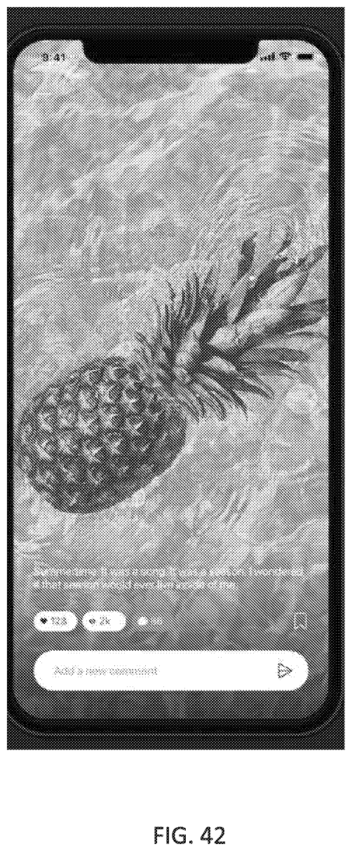

FIG. 42 illustrates a comment display page in accordance with some embodiments of the invention. In some embodiments, the system application can enable a user to send a message to a system user and/or to a content source, and/or to a subject of the content.

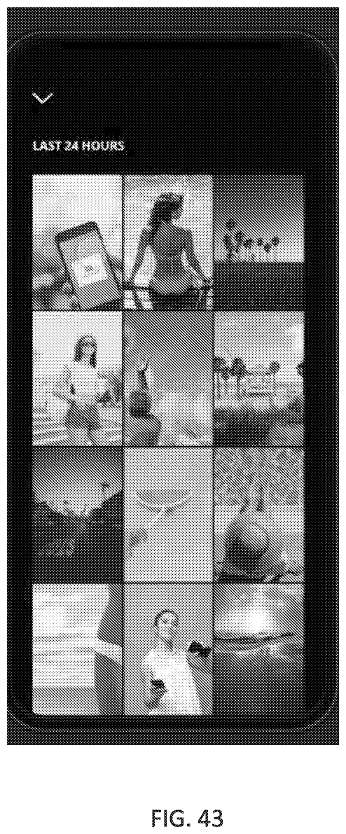

FIG. 43 illustrates a media or user posting history page in accordance with some embodiments of the invention. In some embodiments, the system application can generate a view of content as a function of availability time, access time, posting time, and/or age.

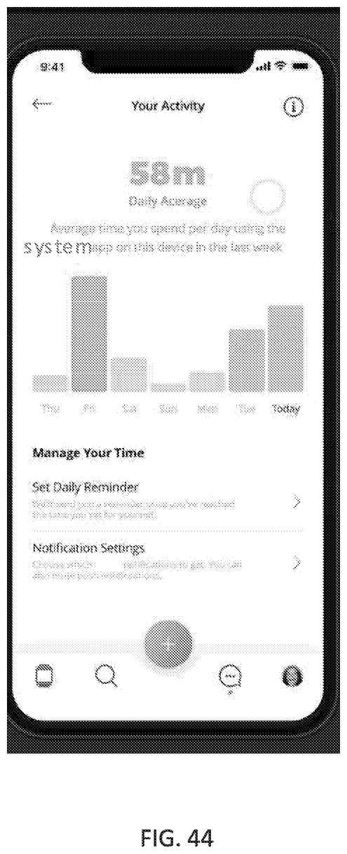

FIG. 44 illustrates a system usage display page in accordance with some embodiments of the invention. In some embodiments, the system application can generate a system usage display page including, but not limited to, a display of average time spent on the system per day, a bar chart of use per day, and a manage time setting display, including, but not limited to, a daily reminder and notification setting display.

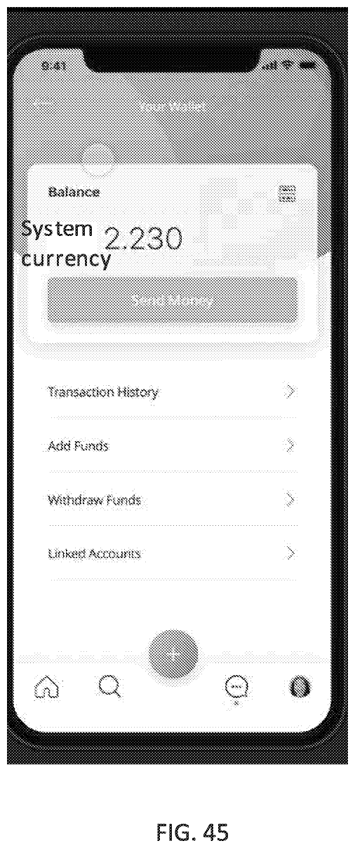

FIG. 45 illustrates a “YourWallet” display page in accordance with some embodiments of the invention. In some embodiments, the system application can generate a system balance display including, but not limited to, a total balance of system currency, a send money icon usable to send money, a transaction history selector, an add funds selector, a withdraw funds selector, and a linked accounts selector.

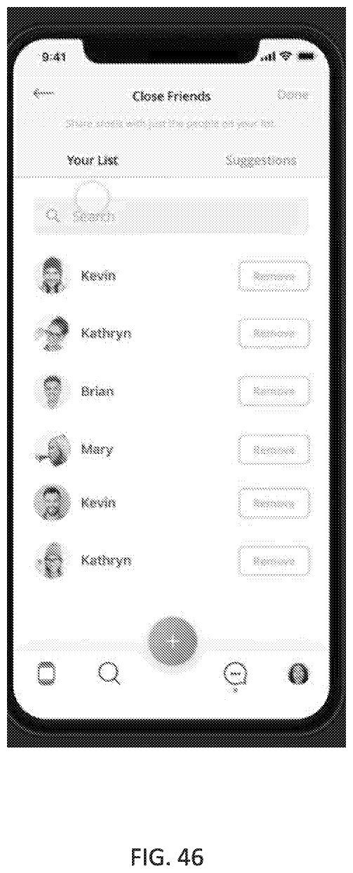

FIG. 46 illustrates a friend suggestion display page in accordance with some embodiments of the invention. In some embodiments, the system application can display one or more friends, suggested friends, and options to add or remove friends.

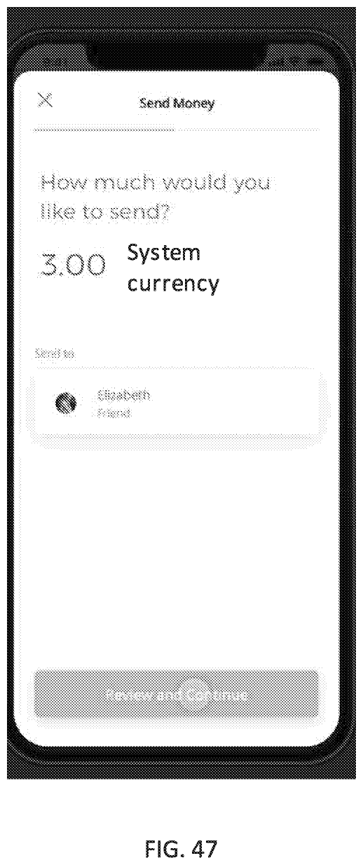

FIG. 47 illustrates a send money page in accordance with some embodiments of the invention. In some embodiments, the system application can generate a display enabling a user to send money to one or more friends, and/or users.

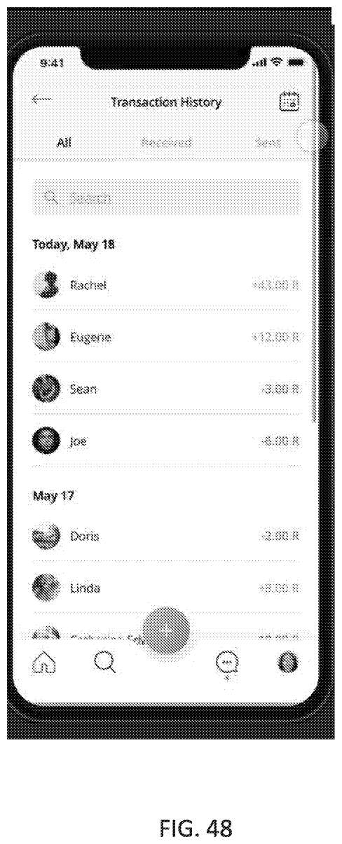

FIG. 48 illustrates a transaction history page in accordance with some embodiments of the invention. In some embodiments, the system application can generate a display showing one or more historical records of transactions.

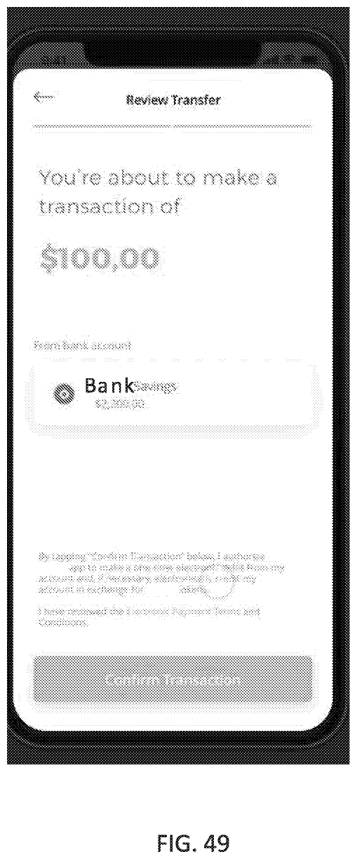

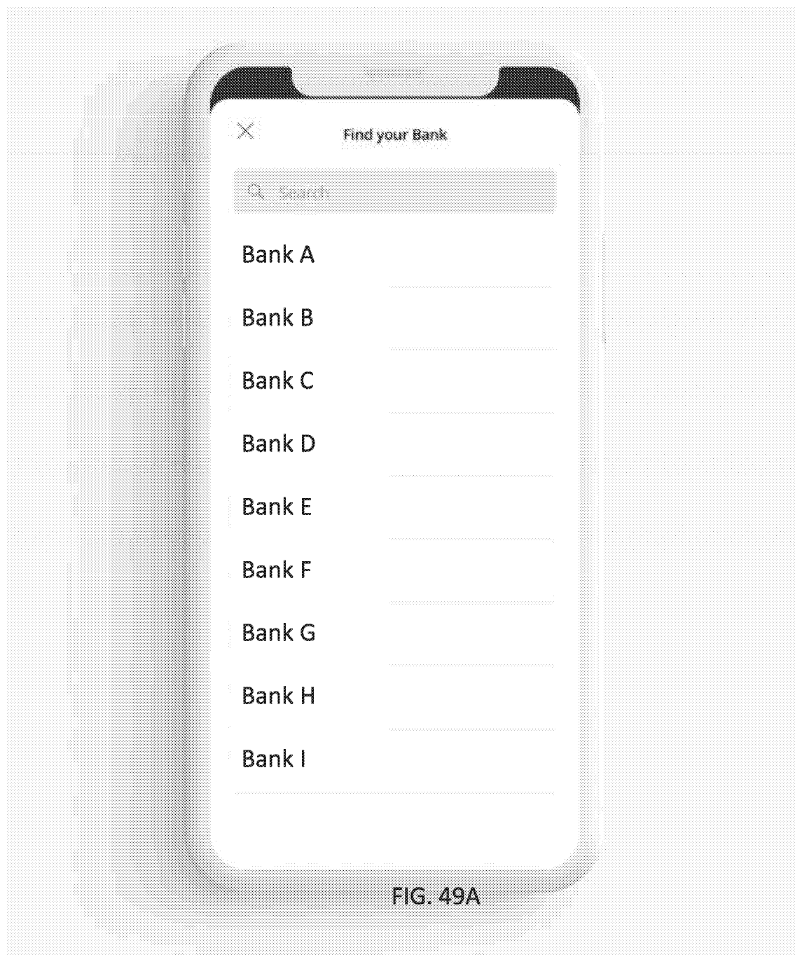

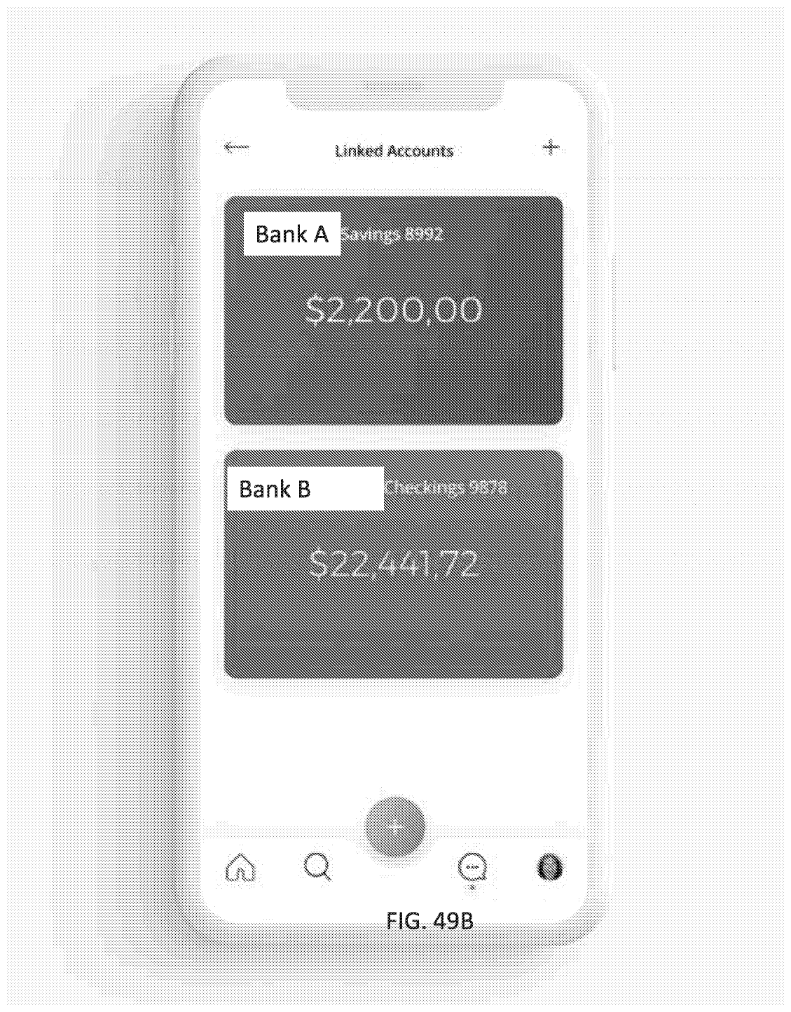

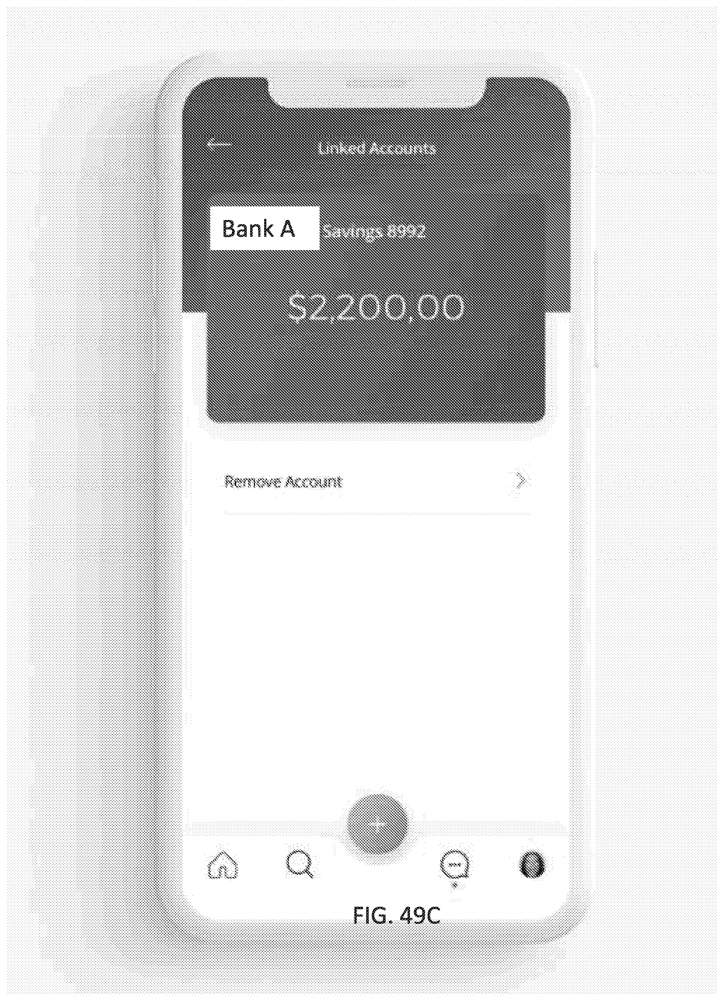

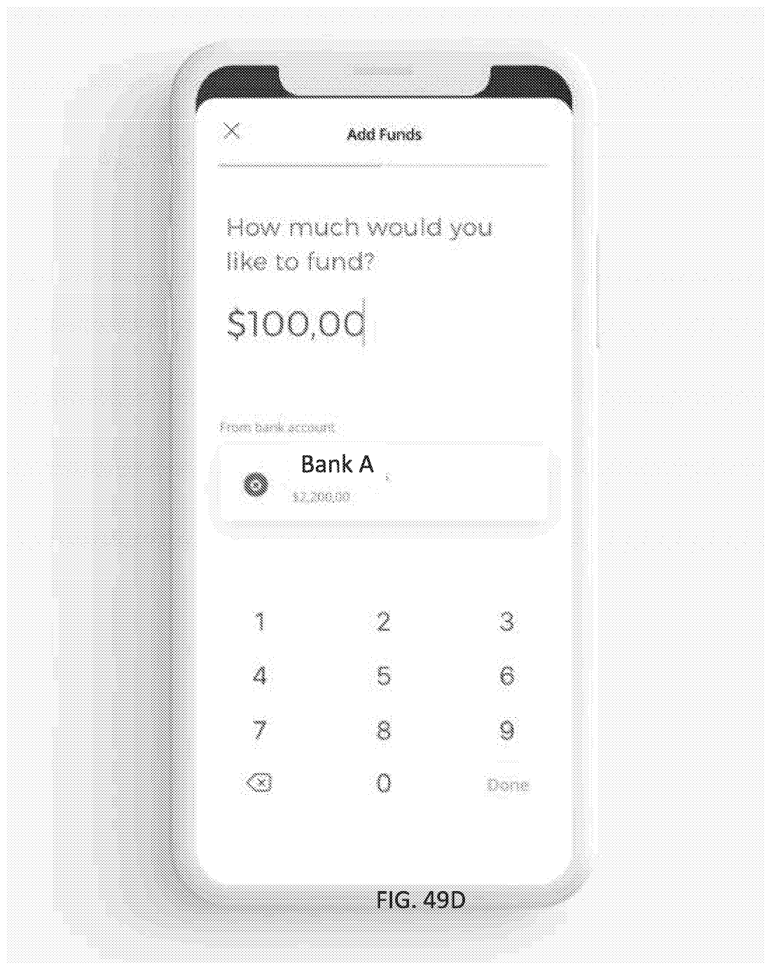

FIG. 49 illustrates a review transfer transaction display page in accordance with some embodiments of the invention. In some embodiments, the system application can generate a review of one or more transactions in the review transfer transaction display page.

FIG. 49A shows a find bank page in accordance with some embodiments of the invention. In some embodiments, the system can display one or more selectable banks for a transaction by the user. FIG. 49B shows linked accounts page in accordance with some embodiments of the invention. In some embodiments, one or more of a user's linked accounts and balances can be displayed. In some embodiments, a user can select an account as illustrated in FIG. 49C, showing a selected linked accounts page in accordance with some embodiments of the invention. FIG. 49D shows an add funds display page in accordance with some embodiments of the invention. In some embodiments, a user can use the display to add funds to an account.

In some embodiments, an artificial intelligence algorithm of the system application can determine if one or more users are liked or disliked by one or more individuals and/or other users. In some embodiments, an artificial intelligence algorithm of the system application can make a determination based on information from one or more friends and/or family of a user, which other user or users are on average liking and/or commenting on the user within a specified posting period (e.g., such as one month or less).

In some further embodiments, an artificial intelligence algorithm of the system application can determine if the average amount of likes from a given user has decreased or increased based on a monthly average. In some embodiments, if an artificial intelligence algorithm of the system application determines that during a specified time span (e.g., two months), one of the user's closest friends or family member reduced the amount of interaction, likes, or comments on the user's posts, then the user's system standing or profile can be altered and/or the user can be notified.

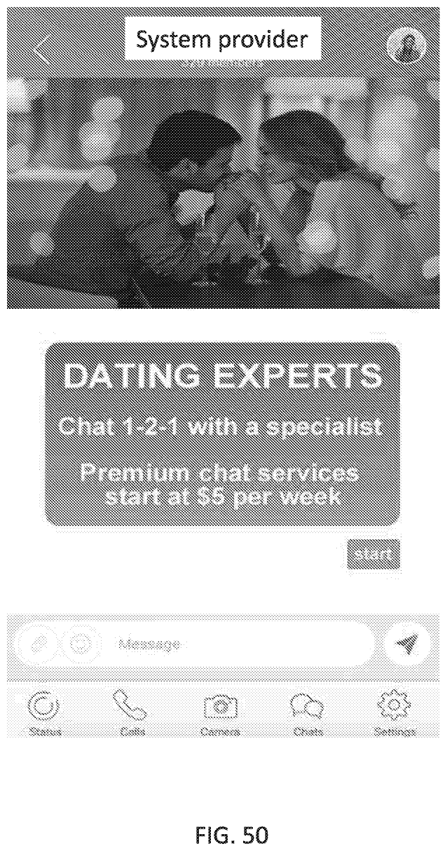

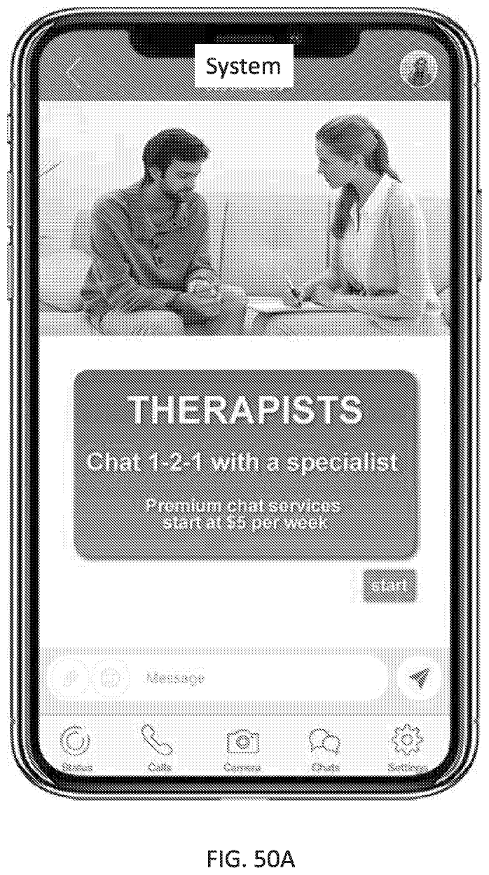

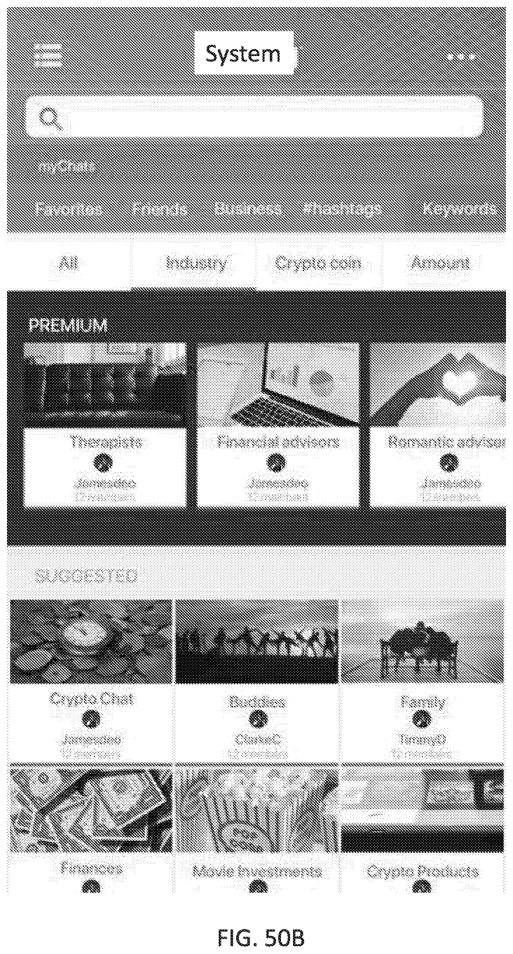

Referring to FIG. 50, and as discussed earlier, in some embodiments, the artificial intelligence algorithm or live personal assistance of the system, which is a paid for service, can be available at any time providing an independent person or virtual person to converse with the user. In some embodiments, the system application can create premium-type chat rooms (e.g., providing romance advice, therapy and/or happiness and/or well-being advice, and financial and/or business advice, and other experts).

In some embodiments, the system comprises an artificial intelligence algorithm that can communicate with a user (e.g., through voice and/or text, and/or imagery) based on a user's browsing history and system activity. In some embodiments, the artificial intelligence algorithm of the system can talk to a user like a real person speaking from a user's phone. For example, in some embodiments, when a user receives a text message, the system can configure the phone to say “Hello Tim, you have received a message from Gabby”, where “Tim” is the user, and “Gabby” is a person or virtual person, friend, or family member. In some embodiments, the system can ask the user if the they would like to send an immediate artificial intelligence response, such as “Yes or No?”.

Some further embodiments of voice-type artificial intelligence can include suggestions based on browsing history and in-application activity. For example, some responses can include “Tim, Alex B has arrived in town and is 15 miles away. Would you like to send them a message?”, and/or “Tim, have you eaten today? You normally eat around 3:30 pm, would you like me to pull up some of your favorite restaurants”. In some embodiments, the system can be enabled to receive a test verbal input from a favorite friend or actor, and the artificial intelligence can mimic and copy their voice for the user's voice artificial intelligence alerts in the future.

In some embodiments, the system can comprise an artificial intelligence algorithm that can include call-center supported artificial intelligence help and personal assistance. In some embodiments, the artificial intelligence can be supported by live call-center staff. In some embodiments, a system user can receive expert advice related to romance, business, and/or health, where the system can include the ability to connect to a call-center through a voice function of the system for emergencies, locations, information the user may need when driving and/or when engaged by another activity.

FIG. 50A illustrates a further example or a premium and/or paid service access display page in accordance with some embodiments of the invention. In some embodiments, the system can enable access to therapy through a therapist. In some embodiments, this display can be selected from a display as shown in FIG. 50B, illustrating a selection page for premium and/or paid service access in accordance with some embodiments of the invention.

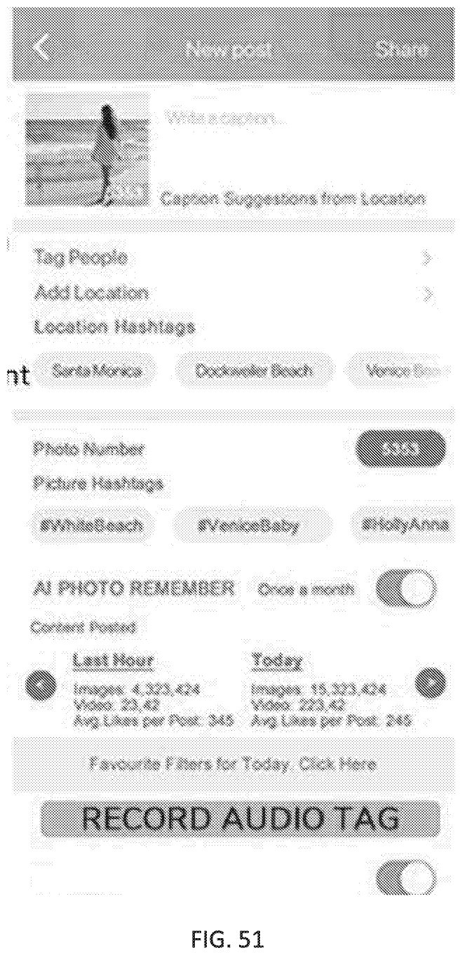

Referring to FIG. 51, showing an image and/or video posting display page, in some embodiments of the invention, an artificial intelligence algorithm of the system application can perform advanced categorization of one or more images uploaded by the system. In some embodiments, once a user takes a photograph and/or video within the system application and/or uploads a photograph and/or video, a pop-up can appear at the bottom of each image or video allowing for a user to add one or more descriptions to better categorize the image and/or video, and thus making it easier to find.

In some embodiments, the system can enable addition of one or more friends, and/or add a location, and/or add fun or descriptive tags, and/or assign a year or month, and/or a number. In some embodiments, the system application can automatically categorize one or more posted images and/or videos under each of these areas. In some further embodiments, the system can categorize images and/or videos in a list depending on the most popular and/or most opened, and/or most accessed, and/or most recently shared, and/or most recently opened.

In some further embodiments, the system application can assign a number (e.g., on the bottom left of the image and/or video), thus enabling a user to remember where or which number range that the image and/or video was stored in. In some embodiments, the system can include a “remember me photo” feature. In some embodiments, the system can categorize each image or video a user takes by clicking the remember me “star”. In some embodiments, this can allow the image and/or video to be stored in the “favorites” folder and/or in the artificial intelligence pop-up. In some further embodiments, this image and/or video can pop-up every month or every week depending on a user's settings menu selection with the artificial intelligence image and/or video section of the application.

In some embodiments, the system can utilize an artificial intelligence “best filter”. In some embodiments of the invention, the artificial intelligence algorithm can store and/or utilize one or more filters to enhance one or more images and/or videos within the system application. In some embodiments, users and/or developers can also add popular filters and emojis to use within the system application and receive system tokens for other users choosing their filters.

In some embodiments of the invention, an artificial intelligence algorithm of the system application can determine what filter has been used most during a specific time span, and inform the user as a pop-up as they choose which filter to use. In some embodiments, the system can inform a user regarding which three filters have been the most used that day. In some embodiments, the system can inform a user regarding which three filters have been the most popular that week. In some further embodiments, the system can inform a user regarding which filters have been the most popular that month.

In some embodiments of the invention, the system can inform a user regarding which filter is most popular for outside image and/or videos, and/or for inside image and/or videos, and/or which are the most popular filters used by top users on the application. In some embodiments of the invention, the system can inform a user regarding which filters are used at night, during the day, and/or during the summer or winter periods. In some embodiments, the user will also be able to click a button and preview a list of the most popular filters used as described above. Some embodiments include a display of a list of premium filters that are instantly accessible as soon as each user wants to post a picture.

In some embodiments of the invention, an artificial intelligence algorithm of the system application can determine the best time to post. In some embodiments, the artificial intelligence can automatically calculate the best time to post based likes per content and/or video post. In some embodiments, the artificial intelligence can score any artificial intelligence feedback as a certain percentage out of 100. In some embodiments of the invention, the system can provide valuable facts and figures displaying the total number of videos and pictures posted that day and that hour. In some embodiments, these figures can be displayed on the bottom of a picture post page. In some embodiments of the invention, the artificial intelligence algorithm of the system can calculate and take an average of all the pictures posted that day. In some embodiments, the artificial intelligence algorithm of the system can display the average number of likes and comments for each piece of content posted that day.

As described earlier as related to FIG. 4B showing a dedicated store page including white-label storefront access, some embodiments enable users to view and select white-label products or services. Further, in some embodiments of the invention, an artificial intelligence algorithm of the system can utilize or comprise white-label products or services. In some embodiments, based on user history and/or user preference and/or usage and activity with the system, the system can select the best or preferred products or services from one or more e-commerce platforms, including, but not limited to, Amazon® and Alibaba®. In some embodiments, the system can sort white-label products or services by categories in preparation for merchandizing through white-label stores that enable users to sell to their friends and family. In some embodiments, the stores can be built, stored, and hosted within the system. In some embodiments, the stores can enable users to earn money or cryptocurrency by promoting products or services in their white-label store via a unique link to each user that is generated when they accept to “activate” a store. In some embodiments, only those products or services with a specific count of positive reviews and/or a rating of a specific number of stars (e.g., such as seven or more) can be listed using Amazon® and Alibaba® services. In summary, the white-label stores can be curated stores by the system, and provided to system users to sell and promote to their family and friends to instantly earn system tokens, and/or other crypto-currency or USD, where the system can ship, manage and handle all packaging and shipping functions.

In some embodiments of the invention, a system white-label product or service process can include, one or more of the steps:

1. register for white-label store;

2. choose a category for the white-label store;

3. select products to be sold at the top of the white-label store as favorites;

4. promote the white-label store on social media via sending a store link to the white-label store to all family and friends and/or to “DMs” or direct mail services;

5. for each product sold receive a percentage of revenue;

6. utilize, experience, and enjoy.

In some embodiments of the invention, a system white-label product or service process can include products with a mark-up to initial price on an e-commerce website with a percentage of the mark-up being applied to system platform maintenance, and with the remainder being transferred to the product promoter. In some embodiments of the invention, when combined with social media, anyone can become an influencer and can earn commission from each successful sale.

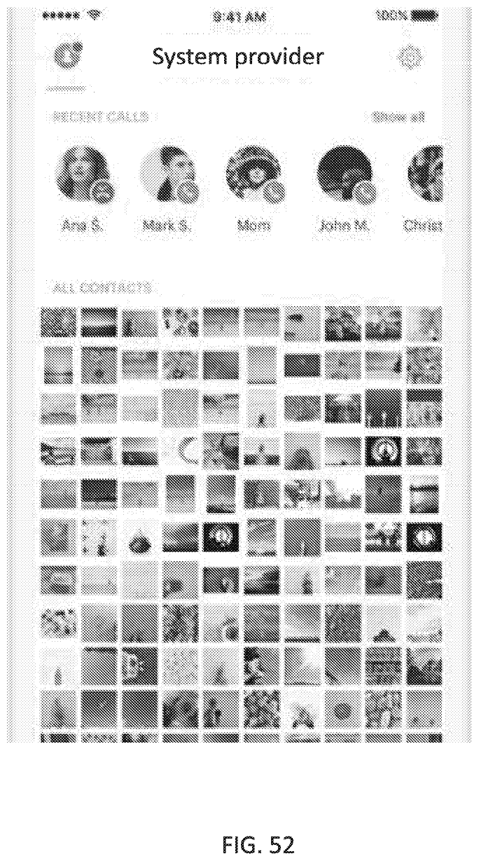

In some embodiments, the system can enable a user to categorize contacts and/or a text inbox. In some embodiments, the system can function similar to Instagram®, and can utilize a system inbox able to search multiple text contacts within the user's inbox very easily. In some embodiments, the system can display the latest image sent by a sender, where each user isn't displayed by name or profile picture, but is sent by an image and/or video within the user's text communication. Referring to FIG. 52, in some embodiments, this can allow for hundreds of inbox text chats to be displayed on one screen. In some embodiments, this can enable the user the ability to see hundreds of contacts within the user's inbox substantially immediately or in real-time. In some embodiments, the system can categorize the user's text inbox and contacts in an improved way via images sent to the user, where images are displayed instead of names to provide a user with more contacts all on the same page.

Some embodiments include an artificial intelligence search directory. In some embodiments, based on user browsing, content posts, comments, hashtags, pictures, likes, and/or preferences, the system artificial intelligence can include or coupled to a custom built crypto-currency database of companies, news sites, investors, developers, ICOs and exchanges. The system directory can provide the mass market and millennials a Google®-style search directory enabling the user to take advantage of any blockchain-enabled service or product. In some embodiments, this can enable the system to locate companies that can help a user liquidate assets, real estate or property within Ethereum-powered blockchain, or find celebrity-backed ICOs, and the best investments to make within the sector.

In some embodiments, if a user wishes to create a bot or add to sell with the system artificial intelligence eco-system, the system can locate and contact blockchain or Ethereum developers. In some embodiments, the system artificial intelligence search and listing directory can be one of the first places a user can use to research blockchain-enabled services or products. In some embodiments, the system can include partnerships with hundreds of bitcoins sites and companies, and can include a directory with thousands of products items to buy using bitcoin, and a directory providing hundreds of companies that accept bitcoin.

Some embodiments include a “MyUtilities” function supported by system artificial intelligence enabled to pay bills, home or rent payments, insurance and utilities effortlessly and less expensively. In some embodiments, the system can utilize a network of crypto-currency partners, developers and ICO enterprises to provide “recommended” blockchain companies to enhance the user's well-being and way of life. In some embodiments, the system can include partnerships with ICO companies that provide healthcare insurance at discounted rates with instant access to private doctors, alternative and lower priced energy companies, automated rent and mortgage service providers, and home and car insurance blockchain underwriters. In some embodiments, the system can provide a user's digital wallet, enabling the user to establish monthly bill or rent payment solutions avoiding missed payments and late charges. Furthermore, the system can take advantage of next generation utility, electricity, and/or insurance blockchain companies aimed at reducing bills, and making bills easier to manage. In some embodiments, discounted prices provided by system sign-up agreements can improve as user sign-ups increase.

In some embodiments, the system comprises a blockchain search engine. In some embodiments, the system can provide search spider-bot code to crypto-currency and bitcoin website owners and developers. In some embodiments, the code can be inserted into an ICO or blockchain website that can display that site within system's search engine pages displayed on both the application and desktop versions of system. In some embodiments, the search results can display dedicated crypto-currency services, utilities, ICOs and blockchain companies. In some embodiments, website owners can be enabled to update the blockchain bot spider code with meta-tags that allow the system bots to search and display their results from searched keywords. In some embodiments, the system can generate advertising revenues from pay-per-click advertisers, like Google®, while providing dedicated search engines for crypto-currency websites, services and companies using the blockchain.

In some embodiments, the system can enable buying products or services via bitcoin. In some embodiments, the system can provide a browser or web-enabled marketplace for anyone wanting to buy, sell or trade items via bitcoin and other crypto-currencies. In some embodiments, the system can provide a marketplace on user-friendly application pages allowing users to list and sell any items they would like to sell directly to bitcoin buyers.

In some embodiments, the system can enable investments via bitcoin. In some embodiments, as a system's network of users sign up to the system, users can be enabled with the ability to invest in blockchain companies, sell art, buy real-estate, and provide many investment and financial opportunities accepting crypto-currency and bitcoin. In some embodiments, blockchain-enabled features of the system can allow owners to tokenize their companies for sale to a syndicate or group of investors, private institutes, and/or venture capitalists, enabling blockchain investors to easily join together to buy and sell companies. In some embodiments, the system can partner with blockchain and smart contract companies that can allow syndicates of individuals to make joint purchases of corporations, hotels, real estate or purchase luxury items such as yachts, works of art, equities and commodities. These acquisitions can be accomplished seamlessly with system's automated smart contract partners inside the blockchain community.

In some embodiments, the system can enable a dedicated television, web, or over-the-air TV channel enabling a user to run and broadcast a television channel, mini-series or “myStory” broadcasts. This can comprise comedy, news, technology updates, or weather, enabling a user to run and manage a mini-TV studio. Like “myVideo” stories, the system TV channel can save all user video uploads in one loop video to create a seamless video stream. In some embodiments, the system can embed videos from the Internet to provide a one to twenty-four video stream, and the system can support embedded “myVideos” clips and/or create a long-running video intercut with a user's favorite “myStory” video, plus other videos from the Internet that have the rights to use. Further, in some embodiments, the system can enable a user to set advertising rates on video broadcasts and loops, and start earning application coins from advertisers, playing their adverts during your channel broadcasts, and allowing users to convert the application coin crypto-currency with a user's country's hard currency.

In some embodiments, the system can enable facial recognition. In some embodiments, security concerns including sending and/or spending and/or receiving crypto-currency are no longer a factor with facial recognition technology embedded into the system application. In some embodiments, facial scans can be a requirement to obtain a personal account, with the exception of business accounts, and can be utilized to send or spend crypto-currency through the blockchain via the system application, similar to “FaceID” used to unlock a user's phone. In some embodiments, payments can be made instantly with the system's “FaceID” feature.

In some embodiments, the system can enable image recognition, using artificial intelligence to search social media platforms, looking for image and/or videos, and comparing them to extensive data sets. In some embodiments, brands can use image recognition to find content similar to their own on social media, including identifying a brand's logo or recognizing organically placed product placement amongst social media users. In some embodiments, artificial intelligence image recognition can monitor what people are saying about a brand without the need for text. In some embodiments, brands can track their social communications, and without users needing to type the company name, will be able to tap into their own online coverage solely through artificial intelligence recognized identifiers.

In some embodiments, the system can enable strategic marketing for businesses. In some embodiments, marketers can personalize content for their customers by understanding buying habits, people's everyday environments, and what motivates them to make their decisions where the artificial intelligence algorithm of the system can learn these habits at a rate much faster than any human by monitoring crypto-currency buying patterns, favorites, insights, and user interest groups (UIGs), as well as the demographics, statistics, and personality associated with the individual users.

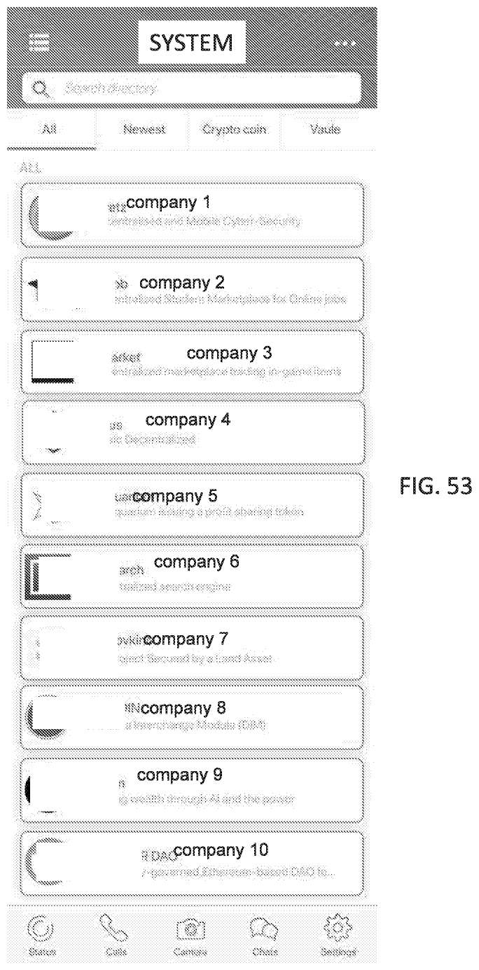

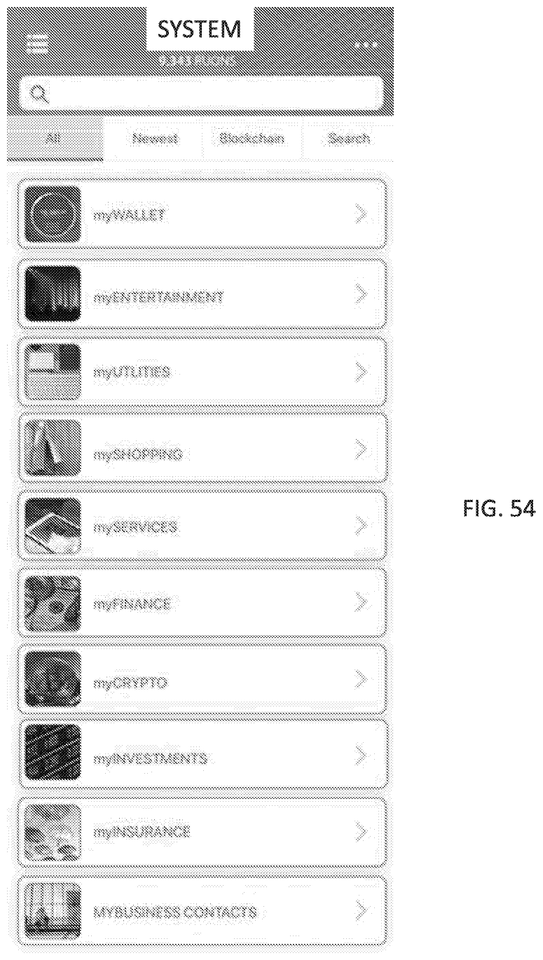

FIG. 53 shows a blockchain listing search directory in accordance with some embodiments of the invention. In some embodiments, the display can enable a user to search and select one or more blockchain technology providers. Further, FIG. 54 illustrates a system utilities selection page in accordance with some embodiments of the invention. In some embodiments, the system can enable a user to select and use one or more system-managed services, including any service processes by the artificial intelligence algorithm of the system. In some embodiments, the system can provide one or more icons for cryptos-currency exchanges. In some embodiments, a “buy” and “sell” icon or button can enable a user to buy and sell one or more crypto-currencies, and/or provide the average best time to buy and sell. Sales or purchases of these items can be made during the free jurisdictional-free period, either in international waters or in space via the SovereignSky network. This method can avoid double taxation or any other fees or restrictions to sales activity. The system will have a team dedicated to law informant and illegal use. People breaking the rules will be banned instantly and reported to authorities

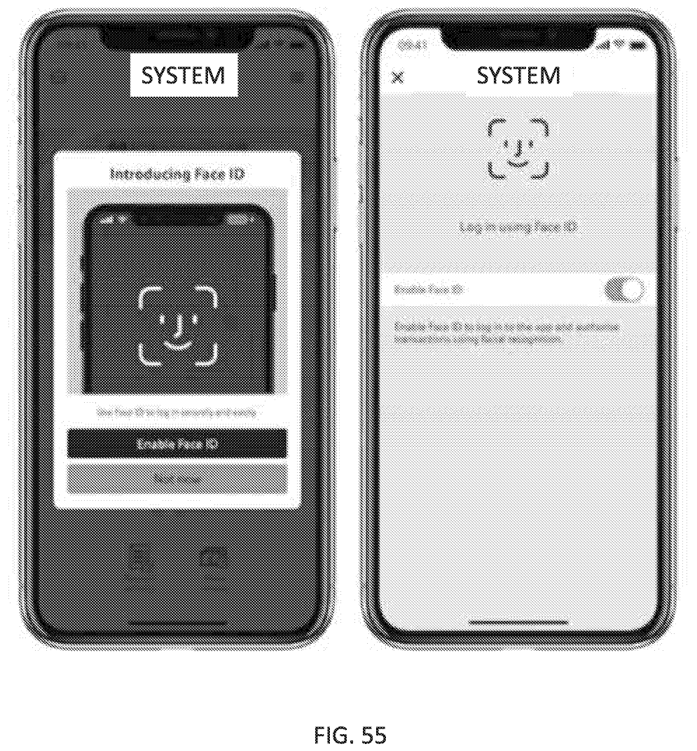

In some embodiments, a secure access method can be integrated with the system. For example, FIG. 55 shows secure access facial recognition displays in accordance with some embodiments of the invention. In some embodiments, face and thumb recognition will or can be used for many parts of accessing the site including “secret” or “locked” areas of the application where private materials and videos and photos can't be kept safe and not hacked into. All banking systems and balances can be accessed via either face and thumb recognition.

In some further embodiments, the system can provide one or more security vaults within any chat or other communication application of the system. In some embodiments, the one or more vaults (or virtual vaults) can be used to secure information and content, preventing access by anyone other than the user and/or one or more individuals with user-granted access. In some embodiments, such a system can be accessed using any conventional password technology and/or by using one or more biometric technologies, including, but not limited to, face and/or retinal scanning and recognition. In some embodiments, the vault can be used to store financial information, passwords, text conversations, content, and more private pictures and videos.

In some embodiments, the vault can be used by a user to view web browsers within the application (e.g., such as by using Google®, FireFox®, or Safari®) and/or the system's own encrypted web browser. In some embodiments, if the user chooses to select ‘Add to Vault” then any links or posts or other content are saved securely and privately inside the application (i.e., within the virtual vault), and can be accessible only via an additional password or facial recognition software. Further, in some embodiments, a “Lock” button within the vault can be used when using text or web browsing services within the vault area. In this instance, a button at the bottom of the user interface display page can be pressed or accessed by the user to close the entire application, locking everything being viewed or typed inside, while subsequently opening a homepage or another browser selected by the user.

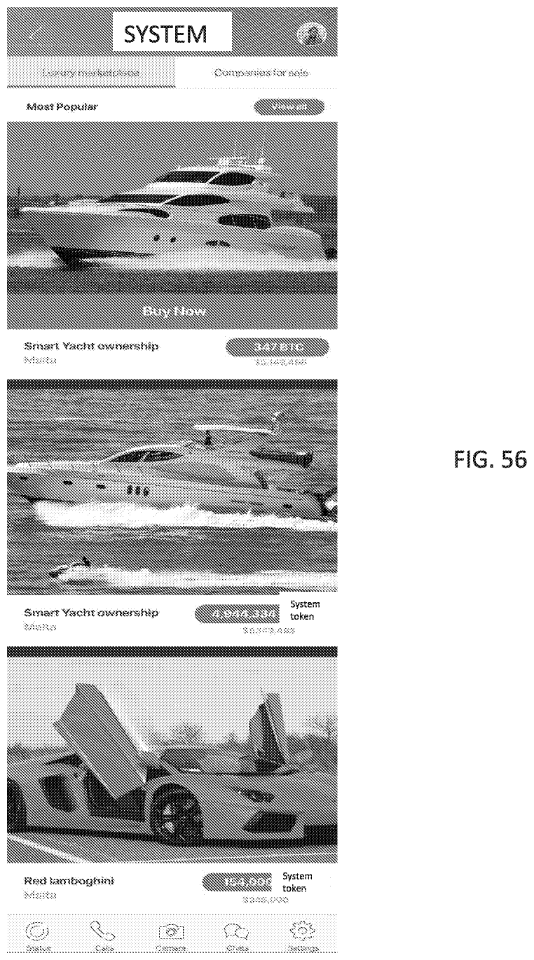

FIG. 56 shows a BTC investment display page in accordance with some embodiments of the invention. In some embodiments, the system can display one or more luxury marketplaces and/or one or more companies for sale. In some embodiments, sales or purchases of these items can be made jurisdictional-free either in international waters or in space via the SovereignSky network.

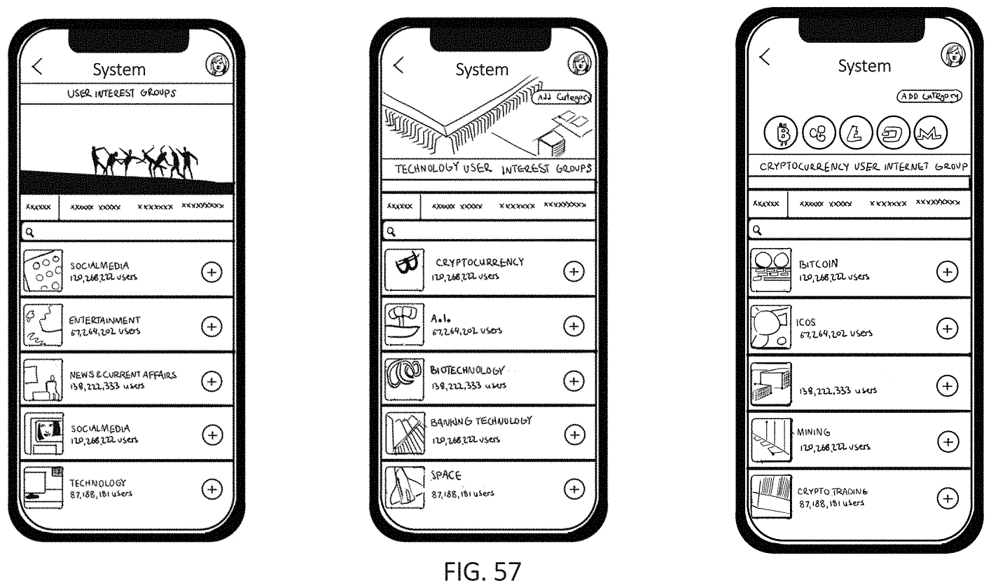

FIG. 57 shows various non-limiting feature descriptions for UIGs. In some embodiments, the system can provide users with a significant following with like-minded people through a sign-up process using one or more UIG features. In some embodiments, after inviting social media contacts, linked business contacts and email contacts, a user can be given the option to select one or more main interests. In some embodiments, the main interests can include groups such as: leisure, holidays, members clubs, internet, movies, sports, fashion, technology, gaming, tv, reading, cooking, romance. In some embodiments, when selected, each core interest group can include more niche subgroups with the main core group (e.g., the reading group can be split into hardbacks, romance, book signing, book groups, amazon books, top sellers, action/thrillers, mystery, adult-themed, bedtime reading, blogs/articles, technology reading, spacetime readings, cookbooks, news reading, jokes/humor, business interests, TED articles, research, and one or more of a user's own sub-categories). In some embodiments, as each pre-registered user signs-up, these interest groups can fill up with thousands of users joining these niche groups. Not only will this provide a powerful categorized targeted advertising tool, but users will have every user with each niche interest group as a follower from the launch. For example, a John Doe user signs up and chooses five UIG that best relate and identify to him, e.g., such as movies; “Sci-fi” (with 12,302 followers), gaming; command and conquer (with 450 followers), food; hamburgers (with 1,055 followers), sports; college football (with 4,539 followers) and shopping; shopify (with 4,0320 followers). In some embodiments, the system application and pre-registration technology can add all people in similar niche interest groups as the user's followers, and represents the user's most important interests out of all others. In some embodiments, when the system goes live, a John Doe user can have a total of 7,000 followers which like and are interested in the very same thing he is interested in. This will be relevant when the user decides to open a store or news channel, as it is very likely that the user will choose a similar interest, and therefore already have a built-in audience of like-minded and interested followers sharing similar interests. If John Doe user decided to create a news channel, TV channel or dedicated store which is not associated to one of his original interest groups well, for extra system tokens, the user can be enabled to pay to add a related unique interest group (and all its followers) from selecting related groups within the user's settings. This provides a powerful way to instantly attain followers with like-minded interests to the user's profile and services and to store pages. Similarly, once an interest group has been added to a user's page with all their followers, users can categorize each follower into friends, family, business contacts, leads and followers. In some embodiments, when joining a UIG, users can elect if they want to be added to other user profiles, and via the UIG protocol, they can elect if they want to get a notification to accept a group follower request from one of the groups. No user is added to follow another user without the request being accepted or permission requested when joining the group.

In some embodiments, each of the UIGs have their own “Chat Room”. In some embodiments, the chat room can be made accessible by the system from the user profile page under “myUIGS”, where in some embodiments, there will be the three links to those chat rooms. Some embodiments comprise chat rooms with one or more artificial intelligence dedicated topics, including, but not limited to, virtual assistants, Google® Translate, Emoji, financial markets, banking applications, e-commerce recommendations, social network friend recommendations, ride-sharing applications, Internet radio, spam filters, YouTube®, chat bots, automobiles, online games, video games, healthcare, booking travel, airplanes, a newsfeed or user's newsfeed, and Google®.

Some embodiments comprise chat rooms with one or more AIDS dedicated topics, including, but not limited to, people with HIV/AIDS, prevalence of HIV/AIDS, number of people with HIV, number of new infections per year, HIV incidence, HIV/AIDS deaths by age group, HIV/AIDS death rates, HIV/AIDS death rates by age, children living with HIV, new HIV infections of children, orphaned children from AIDS, HIV, AIDS and gender, differences in AIDS deaths in men and women, differences of HIV prevalence between men and women, virology, transmission, prognosis, society and culture, acquired immunodeficiency syndrome, and pathophysiology.

Some embodiments comprise chat rooms with one or more acting dedicated topics, including, but not limited to, professional and amateur acting, training, improvisation, physiological effects, semiotics of acting, resume and auditioning, rehearsing, audience and the actor, heart rate while acting, stress, method acting, Meisner technique, viewpoints, Diderot's “Paradox of Acting”, genuine and feigned emotion, theories of traditions, acting “B.A.B.E”, acting Coach, acting without the drama, and acting technique.

Some embodiments comprise chat rooms with one or more action movie dedicated topics, including, but not limited to, action comedy films, action drama films, action horror films, action thriller films, action adventure films, chase films, crime action films, girls with guns films, heroic bloodshed films, martial arts films, “MonsterVerse” movies, period action films, religious action films, science fiction action films, spy films, superhero films, supernatural action films, swashbuckler films, sword and sorcery films, and “Inventing Modern Adolescence: The Children of Immigrants in Turn-of-the-Century America”.

Some embodiments comprise chat rooms with one or more activism dedicated topics, including, but not limited to, protests by type, awareness activism, boycotts, civil disobedience, community organizing, deliberative groups, demonstrations, denialism, direct action, ethical investment, initiatives, internet activism, judicial activism, lobbying, media campaigns, petitions, philanthropy, protest tactics, protests, and activist publications.

Some embodiments comprise chat rooms with one or more adult humor dedicated topics, including, but not limited to, anecdotal, blue, burlesque, dark, gallows, or morbid, deadpan or dry, droll, epigrammatic, farcical, high or highbrow, hyperbolic, ironic, juvenile or sophomoric, mordant, parodic, satirical, screwball, self-deprecating, situational, slapstick, stand-up, “Trade: How Can You Use Accountancy Effectively with Trade”, and “Future Aspects: What Direction Will Accountancy Take in the Future”.

Some embodiments comprise chat rooms with one or more advertising dedicated topics, including, but not limited to, advertising by type, advertising by company, advertising by medium, advertising by country, ad-blocking software, advertisements, advertising by product, advertising-free media, adware, advertising awards, brokered programming (1 C, 7), advertising campaigns, advertising characters, advertising and marketing controversies, false advertising, advertising industry, modeling, advertising museums, advertising people, and professional symbols.

Some embodiments comprise chat rooms with one or more Africa dedicated topics, including, but not limited to, spotting Ebola in the Crowd, Old Drug, New Tricks, “How Does HIV Exposure Impact Uninfected Babies?”, “African Studies Center Expands Curriculum”, “Blood Test May Predict Who Lives or Dies with Ebola”, “Lesotho: Life on the Edge”, “Mozambique: Market-Driven”, “Johannesburg: Works in Progress”, “The Soul of the Blue Nile”, “Molecule Makers”, “Mapmaker/Matchmaker”, “Crossing Borders”, “Farouk El-Baz Tapped by Egypt President”, early civilizations, ninth to eighteenth centuries, height of slave trade, colonialism and the “Scramble for Africa”, independence struggles, Berlin Conference, post-colonial Africa, and African plate.

Some embodiments comprise chat rooms with one or more African American dedicated topics, including, but not limited to, African American, African immigrants, Afro-American peoples of the Americas, Afro-Mexican, Atlantic Creole, Bahamian American, Barbadian American, Black Belt (United States region), Black Canadians, Black Indians in the United States, Black Nova Scotians, Black Seminoles, Dominickers, Gullah, Haitian Americans, Haitian Canadian, Jamaican American, Jamaican Canadian, Louisiana Creole people, and Nigerian American.

Some embodiments comprise chat rooms with one or more aging dedicated topics, including, but not limited to, the “Family Caregiver Association”, “AARP Caregiving”, “Today's Caregiver”, “Caregiving in America”, “The CDC and Healthy Aging”, “Rosalynn Carter Institute for Caregiving”, “Family Caregiver Alliance”, “NIH Senior Health”, “Health and Age”, “CDC Healthy Aging”, “AARP Health”, “Westchester County Department of Health”, “General Information”, “Westchester County Department of Health”, “Senior Health Information”, “Health Reform Information from The Kaiser Family Foundation”, “Medicare Rights Center”, “The Intergenerational Center: Temple University”, “Generations United”, “Play is Forever: The Benefits of Intergenerational Play”, “Intergenerational Programs and Aging”, “Penn State”, “Livable Communities”, “Communities for all Ages”, and “50+ Fact or Fiction”.

Some embodiments comprise chat rooms with one or more agriculture dedicated topics, including, but not limited to, agriculture by continent, agriculture by country, agriculture by region, agriculture by type, intensive farming, organic farming, sustainable agriculture, people in agriculture, agriculture-related lists, 20^{th} century farming techniques, agronomy, agriculture awards, agricultural buildings, composting, domestication, agricultural economics, agricultural education, agriculture and the environment, agricultural establishments, harvest, and horticulture and gardening.

Some embodiments comprise chat rooms with one or more alcoholic drinks dedicated topics, including, but not limited to, alcoholic drinks by country, alcoholic drinks by continent, historical alcoholic drinks, alcohol measurement, alcoholic drink brands, caffeinated alcoholic drinks, alcoholic drink companies, distilled drinks, fermented drinks, foods with alcoholic drinks, history of alcoholic drinks, mixed drinks, premixed alcoholic drinks, works about alcoholic drinks, alcohol powder, alcohol sachet, alcohol-induced respiratory reactions, frozen alcoholic drink, “Festival du rum Haiti”, and Babine (alcoholic drink).

Some embodiments comprise chat rooms with one or more alternative energy dedicated topics, including, but not limited to, coal as an alternative to wood, petroleum as an alternative to whale oil, ethanol as an alternative to fossil fuels, coal gasification as an alternative to petroleum, ecologically friendly alternatives, algae fuel, biomass briquettes, biological hydrogen production, hydroelectricity, offshore wind, marine and hydrokinetic energy, nuclear power, alternative energy in transportation, mechanical energy, solar, wind, biomass, ethanol biofuels, other biofuels, and geothermal.

Some embodiments comprise chat rooms with one or more alternative health dedicated topics, including, but not limited to, alternative diagnoses, alternative medical diagnostic methods, alternative medical systems, alternative medical treatments, concepts in alternative medicine, alternative medicine organization, people in alternative medicine, alternative medicine publications, traditional Japanese medicine, alternative veterinary medicine, alternative medicine stubs, alternative medicine, history of alternative medicine, terminology of alternative medicine, “Portal: Complementary and alternative medicine”, list of forms of alternative medicine, regulation of alternative medicine, acupuncture, AKTIP (therapeutic institute), and alternative cancer treatments.

Some embodiments comprise chat rooms with one or more alternative dedicated topics, including, but not limited to, the politics of news choice, journalism and the internet, alternative and activist media, television news and the construction of the terrorist threat, international news and the electronic media, facts and fictions: “News Rituals in the Construction of Reality”, “Social Ethics and the Press”, “Alternative Medicine and the Health Professions”, “News, Gender, and Power”, “The Myth of News”, “Foreign Policy, and Intervention”, “Assessing an Experiment in Social Responsibility”, “The Audience in the News”, “News from Abroad”, “The Sources Who Explain the News”, “Ties That Blind in Canadian/American Relations: Politics of News Discourse”, “We're Talking about Them”, “They're Talking about Us”, “A Legal History of the Hot News Doctrine and Implications for the Digital Age”, “News of the World: World Cultures Look at Television News”, “Why Local News Programs Don't Cover People of Color”, and “Network Cutbacks in the Nation's Capital”.

Some embodiments comprise chat rooms with one or more alternative dedicated topics, including, but not limited to, alternative rock albums, alternative rock discographies, alternative rock festivals, alternative rock genres, alternative rock musicians, alternative rock navigational boxes, alternative rock record labels, alternative rock songs, “Portal: Alternative rock”, “120 Minutes, 1991”: “The Year Punk Broke”, “2010 in alternative rock”, “Alternative Nation”, “Alternative rock”, “Alternative Songs”, “Beautiful Noise” (film), “Homerpalooza”, “Latin Alternative Music Conference”, “List of grunge bass players”, “Modern rock”, “MTV Europe Music Award for Best Alternative”, and “Our Band Could Be Your Life”.

Some embodiments comprise chat rooms with one or more amateur radio dedicated topics, including, but not limited to, amateur radio by country, amateur radio call signs, amateur radio bands, brevity codes, amateur radio companies, amateur radio emergency communications, amateur radio history, amateur radio licensing, amateur radio magazines, amateur radio operating awards, operating signals, amateur radio organizations, packet radio, amateur radio people, radio frequency propagation, radio-sport, amateur radio receivers, amateur radio satellites, amateur radio software, and amateur radio transceivers.

Some embodiments comprise chat rooms with one or more ambient music dedicated topics, including, but not limited to, ambient albums, ambient composers, ambient dub albums, ambient musicians, ambient songs, dark ambient, illbient, new-age music, ambient music radio programs, ambient music record labels, ambient music, ambient house, ambient music design, ambient pop, ambient techno, ambient video, “ChansoNoir”, “Chillits”, Chinese ambient music, “Deathprod”, and “Dettinger”.

Some embodiments comprise chat rooms with one or more American football dedicated topics, including, but not limited to, American football by city, American football by continent, American football by country, American football-related lists, American football competitions, American football culture, American football equipment, history of American football, American football incidents, American football occupations, American football organizations, American football people, American football plays, American football positions, American football records and statistics, seasons in American football, semi-professional American football, American football strategy, American football teams, and American football terminology.

Some embodiments comprise chat rooms with one or more American history dedicated topics, including, but not limited to, American theater history, African-American social history, African-American history, South American history, Central American history, American social history, American naval history, Latin American economic history, American religious history, “History's Irruption in the Look-to-Camera”, “Teaching history Then: The Origins of the Journal and the history Teaching Movement of the 1970s”, “Teaching history Then and Now: A Story of Stability and Change in Schools”, “World history in State Standards: A Research Assignment for College Juniors and Seniors, history and the ‘I’ Trapped in the Middle”: “Negotiating the Past in Roth's the Ghost Writer and the Plot against America”, “History in Ralph Ellison's Juneteenth”, “Social history in Europe”, “History on Film/film on history, history of Rocketry and Astronautics”: “Proceedings of the 45th History Symposium of the International Academy of Astronautics, Cape Town, South Africa; V. 42 of the AAS History Series”, and V. 31 of the IAA History Symposia”, “History's Way Homeward: A Regionalist Approach to the Renovation of a Discipline, and History Wars and School Curricula”: “The New History Curriculum in Australia”.

Some embodiments comprise chat rooms with one or more American literature dedicated topics, including, but not limited to, American literature by ethnic background, American literature by medium, American literature by state, American writers, American literary agencies, American book publishers (people), American Southern literature, American literary awards, Bibliographies of American writers, American book series, American captivity narratives, American fiction, Guamanian literature, History of literature in the United States, LGBT literature in the United States, American literature-related lists, American literary magazines, American literary movements, Multiracial literature, and American non-fiction literature.

Some embodiments comprise chat rooms with one or more Anarchism dedicated topics, including, but not limited to, anarchism by continent, anarchism by country, anarchist schools of thought, anarchism by region, anarchists, anti-anarchism, anarchist communities, anarchist culture, the history of anarchism, anarchism lists, anarchist movements, anarchist organizations, anarchist symbols, anarchist theory, anarchist works, works about anarchism, anarchism stubs, anarcho-syndicalism, anti-statism, and law without the state.

Some embodiments comprise chat rooms with one or more anatomy dedicated topics, including, but not limited to, anatomists, anatomical planes, anatomical terminology, anatomy journals, anatomy portals, anatomy websites, animal anatomy, brain anatomy, cell anatomy, comparative anatomy, computational anatomy, embryology, fungal morphology and anatomy, histology, history of anatomy, organs (anatomy), anatomical pathology, plant anatomy, anatomical preservation, and sexual anatomy.

Some embodiments comprise chat rooms with one or more ancient history dedicated topics, including, but not limited to, “Sparta: Historical analysis vs. pop cultural depictions”, “Ancient Greece and sexuality”, “Alexander the Great: Ancient conquerors, Hannibal and Rome”, “Greek drama: Sophocles, The historical Helen of Troy”, “Hippocrates and his influence on modern medicine”, “Athens and the development of democratic thought”, “The Greek hero and the contemporary definition of heroism”, “A historiography of the Peloponnesian War”, “Roman military tactics”, “Roman architecture and social roles”, “Slave revolts in Rome”, “Political turmoil and the death of Julius Caesar”, “The historical Jesus and conflict with Rome”, “Rome and the development of Christianity”, “The gnostic gospels, Divisions of labor in Rome (Social classes)”, “Constantine the Great”, and “Emperors of Rome: Establishing the best and worst”.

Some embodiments comprise chat rooms with one or more animals dedicated topics, including, but not limited to, animal redirects, animals by adaptation, animals by location, animals by year of formal description, individual animals, animal births, animal cognition, animal locomotion, animal physiology, bilaterians, cnidarians, animal common names, cryptids, ctenophores, evolution of animals, animal health, animals and humans, images of animals, lists of animals, and nocturnal animals.

Some embodiments comprise chat rooms with one or more animation dedicated topics, including, but not limited to, animation by continent, animation by country, animation by genre, animation by medium, animation by studio, animation-related lists, animation fandom, animatronics, anime, anime-influenced western animation, animation books, animated characters, animation collections, computer animation, dance animation, animation education, animation events, history of animation, images of animation, and animation industry.

Some embodiments comprise chat rooms with one or more Anime dedicated topics, including, but not limited to, nime and manga by topic, anime and manga lists, anime debuts by date, anime and manga by demographic, anime and manga by genre, anime by medium, anime and manga by source, anime by studio, Japanese animators, anime series, anime with original screenplays, books about anime, Dōjin anime, dragon ball anime, fictional elements from anime and manga, anime and manga fandom, Geneon USA, anime industry, anime-influenced western animation, anime and manga museums in japan, and musicals based on anime and manga.

Some embodiments comprise chat rooms with one or more anthropology dedicated topics, including, but not limited to, differences in growth and development, race and the causes of racism, genetic engineering, differences in death rituals, definitions of culture, marriage rituals in different cultures, beliefs in magic and the supernatural, different “ranks” in society (peasants, royalty, etc.), mythologies and its effects on modern culture, the role of storytelling in different cultures, social media and its impact on cultures (first vs. second and third world), using anthropology as a forensic science, studying twins in different cultures and throughout time, political organizations and anthropology, closed societies, heroes in societies, human evolution, aboriginal/native cultures and anthropology, gangs vs. fraternities vs. families, and social status and role.

Some embodiments comprise chat rooms with one or more anti-aging dedicated topics, including, but not limited to, “Add Some Vitamin A to Your Routine”, “Avoid Excess Weight Gain, Skip the Sugary Stuff”, “Hydrate”, “Skip the All-Nighters”, “Take Sun Damage Seriously”, “Protect Your Skin with Proper Clothing”, “Wash After a Workout”, “Skip the Smokes”, “It's Never Too Late To Start Caring For Yourself”, “Develop a Solid Skincare Routine”, “Skip the Harsh Scrubs”, “Start From the Inside Out”, “Say No to Tanning”, “Add in Some Omega-3s”, “Increase Your Antioxidant Intake”, “Get a Posh Pillowcase”, “Go Nuts, Keep it Cool, and Opt For Oils”.

Some embodiments comprise chat rooms with one or more antiques dedicated topics, including, but not limited to, antique boat museum, antique firearms, antique furniture, antique shop, antique telescope society, antique tool, antique trader, antiques info, antiques restoration, antiques trade gazette, Antiqueweek, art & antiques, “The AWA review”, balloon clock, banjo clock, betty lamp, blackamoor (decorative arts), blue ridge (dishware), the brass armadillo, and British antique dealers' association.

Some embodiments comprise chat rooms with one or more archaeology dedicated topics, including, but not limited to, archaeological sub-disciplines, archaeology by location, archaeology-related lists, archaeologists, archaeology by ethnicity, archaeology in popular culture, archaeological artifacts, archaeology awards, archaeological collections, archaeological corpora, cultural heritage, archaeological cultures, history of archaeology, archaeology images, archaeology law, methods in archaeology, archaeological museums, archaeological organizations, periods and stages in archaeology, and philosophy of archaeology.

Some embodiments comprise chat rooms with one or more architecture dedicated topics, including, but not limited to, architecture by country, architecture by date, architecture by region, architecture lists, architectural styles, architects, accessible building, architecture awards, bridge design, building codes, building engineering, building materials, buildings and structures, architectural communication, architectural competitions, architectural controversies, architectural design, destruction of buildings, architectural education, and architectural elements.

Some embodiments comprise chat rooms with one or more art history dedicated topics, including, but not limited to, “Methodologies”, “Timeline of prominent methods”, “Pliny the Elder and Ancient Precedents”, “Vasari and Artists' Biographies”, “Winckelmann and Art criticism”, “Wolfflin and Stylistic Analysis”, “Riegl”, “Wickhoff, and the Vienna School”, “Panofsky and Iconography”, “Freud and Psychoanalysis”, “Jung and Archetypes”, “Marx and Ideology”, “Feminist Art history”, “Barthes and Semiotics”, “Museum Studies and Collecting”, “New Materialism”, “Nationalist Art History”, “Divisions By Period”, “Professional Organizations”, “Notes and references”, and “Further Reading”.

Some embodiments comprise chat rooms with one or more arthritis dedicated topics, including, but not limited to, an ACR score, adult-onset Still's disease, Ankylosing spondylitis, Arthritis mutilans, Arthroplasty, Boutonniere deformity, calcium pyrophosphate dihydrate crystal deposition disease, chondroprotection, collagen-induced arthritis, enteropathic arthropathy, epidemic polyarthritis, facet joint arthrosis, familial Mediterranean fever, gene therapy for osteoarthritis, gout, granulomatosis with polyangiitis, handigodu syndrome, HFE hereditary haemochromatosis, hypermobility (joints), and inflammatory arthritis.

Some embodiments comprise chat rooms with one or more arts dedicated topics, including, but not limited to, modern art, art education, art forgery, graphic arts, conceptual art, spanish art, korean art, russian art, art censorship, folk art, classifications, visual arts, architecture, ceramics, conceptual art, drawing, painting, photography, sculpture, and literary arts.

Some embodiments comprise chat rooms with one or more Asia dedicated topics, including, but not limited to, “Islam in Asia”, “Omen in Asia”, “Democracy and Southeast Asia”, “Communism in Asia”, “Missionaries in Asia”, “Democracy and Asia”, “Nationalism in Asia”, “Corporate Governance in Asia”, “AIDS in Asia”, “Human Rights and Asia”, “The Asia-Pacific in Asian American Transmigration: Lydia Minatoya's the Strangeness of Beauty”, “Asia's Institutional Creation and Evolution*”, “Southeast Asia and the major powers: Engagement Not Entanglement”, “Managing Asia Pacific's Energy Dependence on the Middle East: Is There a Role for Central Asia?”, “Asia in Japan's Embrace”, “Asia-Pacific Economic and Security Cooperation”: “New Regional Agendas/Governing the Asia Pacific”: “Beyond the “New Regionalism”, “Southeast Asia in the US Rebalance: Perceptions from a Divided Region”, “Central Asia: Foundations of Change”, “Discovering Asia: John McKinnon Outlines the Work of the Asia New Zealand Foundation in 2013”, “Southeast Asia and the English School of International Relations”: “A Region-Theory Dialogue, and Developing ‘Asia Literacy’ through the Australian Curriculum-English”.

Some embodiments comprise chat rooms with one or more asthma dedicated topics, including, but not limited to, acute severe asthma, alcohol-induced respiratory reactions, allergies in children, aspirin exacerbated respiratory disease, asthma and allergy friendly, asthma life impact scale, asthma-related microbes, Asthmagen, Baker's asthma, brittle asthma, bronchial thermoplasty, bronchospasm, anti-asthmatic drugs (5 C, 20 P), asthma organizations (8 P), deaths from asthma, epidemiology of asthma, exercise-induced bronchoconstriction, exhaled nitric oxide, reactive airway disease, and respiratory risks of indoor swimming pools.

Some embodiments comprise chat rooms with one or more astrology/psychics dedicated topics, including, but not limited to, astrology advice, “Aries”, “Taurus”, “Gemini”, “Cancer”, “Leo”, “Virgo”, “Libra”, “Scorpio”, “Sagittarius”, “Capricorn”, “Aquarius”, “Pisces”, “Jyotish (Vedic astrology)”, “Personal Astrology Predictions”, “Personal Question”, horoscopes (astrology), horoscope interpretations, “Kundali (Vedic astrology)”, and “Individual Chart Advice (astrology)”.

Some embodiments comprise chat rooms with one or more astronomy dedicated topics, including, but not limited to, astronomy by location, astronomical objects, astronomical sub-disciplines, outer space, space art, astronomers, astronomical controversies, astronomical hypotheses, celestial coordinate system, astronomical clocks, constellations, cosmogony, cultural depictions of astronomers, dark-sky preserves, astronomy data and publications, astronomical dynamical systems, astronomy education, astronomical events, astronomy events, and history of astronomy.

Some embodiments comprise chat rooms with one or more atheists/agnostic dedicated topics, including, but not limited to, atheism by continent, atheism by country, atheists, atheism activism, arguments against the existence of god, atheism in popular culture, atheist existentialists, atheist organizations, atheistic existentialism, books with atheism-related themes, criticism of atheism, discrimination against atheists, films with atheism-related themes, former atheists and agnostics, atheism-related lists, objectivism (Ayn Rand), persecution of atheists, atheism publications, religion and atheism, and atheism stubs.

Some embodiments comprise chat rooms with one or more audio equipment dedicated topics, including, but not limited to, audio amplifier specifications, audio amplifiers, digital audio, dynamics processing, audio effects, audio equipment manufacturers, audio mixing, music hardware, sound production technology, signal connectors, sound archives, synchronization, tone, equilizers and filter, audio transducers, audio analyzer, audio control surface, audio crossover, audio equipment, audio equipment testing, and audio feedback.

Some embodiments comprise chat rooms with one or more Australia dedicated topics, including, but not limited to, Australia-related lists, articles citing AIATSIS, buildings and structures in Australia, Australian culture, economy of Australia, education in Australia, environment of Australia, geography of Australia, government of Australia, health in Australia, history of Australia, organisations based in Australia, Australian people, politics of Australia, Australian society, Wikipedia books on Australia, Australia stubs, “Mac Australia Topics Middle Primary eBook CD”, “Become an Active Citizen”, and “Mac Australia Topics Upper Primary eBook CD”.

Some embodiments comprise chat rooms with one or more aviation/aerospace dedicated topics, including, but not limited to, aviation by city, aviation by continent, aviation by country, aviation-related lists, aerodromes, aircraft, airlines, air freight, air traffic management, aircraft operations, aircrew clothing, airspeed, aviation industry, aviation portals, aviators, civil aviation, aviation communications, aviation and the environment, fixed-base operators, and flight training.

Some embodiments comprise chat rooms with one or more “BDSM” dedicated topics, including, but not limited to, fundamentals, terminology and subtypes, etymology, behavioral and physiological aspects, types of play, safety, social aspects, roles, types of relationships, scenes, etiquette, parties and clubs, psychology, prevalence, medical categorization, DSM, ICD, coming out, social (non-medical) research, and gender differences in research.

Some embodiments comprise chat rooms with one or more babes dedicated topics, including, but not limited to, “Academy of Our Lady of Guam”, “Academy of the Holy Names (Florida)”, “Battin High School”, “Bishop Keough Regional High School”, “Carrollton School of the Sacred Heart”, “Catherine McAuley High School”, “Columbia Religious and Industrial School for Jewish Girls”, “Convent of the Sacred Heart High School (California)”, “Convent of the Visitation School”, “Coretta Scott King Young Women's Leadership Academy”, “Duchesne Academy of the Sacred Heart (Nebraska)”, “Forest Ridge School of the Sacred Heart”, “Garrison Forest School”, “Georgetown Visitation Preparatory School”, “Holy Names Academy”, “Lincoln School (Providence, R.I.)”, “Marian High School (Nebraska)”, “Mercy High School (Burlingame, Calif.)”, “Mercy High School (Connecticut)”, and “Mercy High School (Omaha, Nebr.)”.

Some embodiments comprise chat rooms with one or more babies dedicated topics, including, but not limited to, baby boomers, “Babi Yar”, “Generation X”, infant psychology, Roman Polanski, Kate Chopin, infant communication, surrogate motherhood, T. Berry Brazelton, “Babies Are Not What We Thought”, “What Babies Are Teaching Us about Violence”, “Magic Babies, About Real Babies”, “The Power of Beliefs: What Babies Are Teaching Us”, “War Babies Cry for Peace! War Babies Cry for Justice!”, “Living in the Shadows of Past Atrocities: War Babies of Bosnia”, “Our Babies”, “Ourselves: How Biology and Culture Shape the Way We Parent”, “Bubble Babies: Fourth Graders Predict and Test How Parental Care Improves Offspring Survivorship”, “Supporting Babies' Wholeness in the 21st Century: An Integrated Model of Early Development”, “Manual Activity and Onset of First Words in Babies Exposed and Not Exposed to Baby Signing”, and “Welcoming Consciousness: Supporting Babies' Wholeness from the Beginning of Life, an Integrated Model of Early Development”.

Some embodiments comprise chat rooms with one or more badminton dedicated topics, including, but not limited to, rules, court, serving, scoring, lets, equipment, racquets, strings, grip, shuttlecock, shoes, technique, strokes, position of the shuttlecock and receiving player, vertical position of the shuttlecock, spin, biomechanics, other factors, and deception, strategy.

Some embodiments comprise chat rooms with one or more ballet dedicated topics, including, but not limited to, etymology, styles, classical ballet, romantic ballet, neoclassical ballet, contemporary ballet, technical methods of ballet instruction, French method, Vaganova method, Cecchetti method, Bournonville method, the Royal Academy of Dance Method (rad), Balanchine method, costumes, the renaissance and baroque, seventeenth century, eighteenth century, nineteenth century, twentieth century, and ballet as a career.

Some embodiments comprise chat rooms with one or more banking dedicated topics, including, but not limited to, analysis of the amount of money that you will need to retire in thirty years, analysis of nursing home costs, capitalizing on hot investment trends for 2015, effects of Volkswagen's leadership crisis, analysis of jobs that will not exist in the future, analyzing personal debt and the job market, best ways to pay for education: student loans or personal loan, maximizing profits in a small company, regulations in commercial banking, creativity in banking, quality in retail banking, “how does minimum wage effect poverty?”, identifying conflicts in capital accumulation, importance of risk management, various risk management procedures, strategic planning, emerging markets, expanding into global market, corporate social responsibility, and term structure of interest rates.

Some embodiments comprise chat rooms with one or more bargains/coupons dedicated topics, including, but not limited to, plea bargaining, collective bargaining, “Why Plea Bargains Are Not Confessions”, “Criminal Law—Plea Bargains—District Court Denies Plea Bargain Due to the Public Interest in Understanding the Opioid Epidemic”, “Honesty and Opacity in Charge Bargains”, “Hard Bargains: The Coercive Power of Drug Laws in Federal Court”, “Opportunity Lost?—the Ineffective Assistance Doctrine's Applicability to Foregone Plea Bargains”, “Waivering about the Dirty Business of Plea Bargains-A Comment”, “Coping with Bargains in the Ultimatum Game: The Triple Circuit Hypothesis”, “Hard Bargains: The Politics of Heterosexuality”, “Modest Labor-Management Bargains Continue in 1984 despite the Recovery”, “Bargains or Rip-Offs?” “Reference Price Effects in Conjoint Stated Demand”, “Bargains in the Corporate Convertible Bond Market”, “Bad Bargains: The Mistake of Allowing Cost-Benefit Analyses in Class Action Certification Decisions”, “Tough Love”, “Hard Bargains: Rape and Coercion in Balzac”, “Contemporary Social Policy Analysis and Employee Benefit Programs: Boomers, Benefits, and Bargains”, “The Screening/bargaining Tradeoff”, “Rational Expectations of Leniency: Implicit Plea Agreements and the Prosecutor's Role as a Minister of Justice”, “The Innocence Effect”, and “An Economic Analysis of the Trial Penalty: A Comparative Analysis of Three Alternative Trial Settings”.

Some embodiments comprise chat rooms with one or more baseball dedicated topics, including, but not limited to, rules and gameplay, personnel, players, other, strategy and tactics, pitching and fielding tactics, batting and baserunning tactics, history, in the United States, establishment of professional leagues, “Rise of Ruth and Racial Integration”, attendance records and the age of steroids, “Around the world”, “Distinctive elements”, “No clock to kill”, “Individual focus”, “Uniqueness of each baseball park”, statistics, sabermetrics, and popularity and cultural impact.

Some embodiments comprise chat rooms with one or more basketball dedicated topics, including, but not limited to, creation, college basketball, high school basketball, professional basketball, international basketball, women's basketball, rules and regulations, playing regulations, equipment, violations, fouls, common techniques and practices, positions, strategy, shooting, rebounding, passing, dribbling, blocking, and height.

Some embodiments comprise chat rooms with one or more beauty dedicated topics, including, but not limited to, aesthetic beauty, beauty salons, cosmetic surgery, cosmetics, eye color, female beauty, hair color, hair removal, hairdressing, male beauty, modeling, nail care, oral care, beauty organizations, beauty pageants, skin care, songs about beauty, “Yo soy Betty”, “la fea”, African-American beauty, and Association of Nail Technicians.

Some embodiments comprise chat rooms with one or more beer dedicated topics, including, but not limited to, beer by continent, beer by country, beer by region, beer culture, beer brands, beer dishes, types of beer, beer and brewery stubs, 1900 English beer poisoning, beer chemistry, beer measurement, beer Mixes, beer shop, Mike's Hard Lemonade Co, “Portal:Beer”, “If You're out of Schlitz, You're out of Beer!”, “Beer & Skits and the Winnipeg Press Club”: “A Marriage Made in a Smoky Room”, “Labor and Beer in the Transkei”, “South Africa: Xhosa Work Parties in Historical and Contemporary Perspective”, “Judaism in the Works of Beer-Hofmann and Feuchtwanger”, “The Geography of Beer: Regions, Environment, and Societies”.

Some embodiments comprise chat rooms with one or more beverages dedicated topics, including, but not limited to, American soft drinks, Romanian soft drinks, carbonated drinks, cola, cream sodas, diet drinks, discontinued soft drinks, drink advertising characters, drink brands, soft drink flavors, ginger ale, juice brands, lemon drinks, powdered drink mixes, relaxation drinks, root beer, soft beers and malt drinks, Tango (drink), images of soft drinks, and soft drink logos.

Some embodiments comprise chat rooms with one or more bicycling dedicated topics, including, but not limited to, small-wheel bicycle, “27.5 Mountain bike”, “29er (bicycle)”, aero bike, amphibious cycle, art bike, “Avatar 2000”, belt-driven bicycle, billboard bicycle, BMX bike, “Boda boda”, “Bootie (bicycle)”, “Cab-Bike”, chainless bicycle, chopper bicycle, clown bicycle, cold-weather biking, conference bike, crank forward, and cruiser bicycle.

Some embodiments comprise chat rooms with one or more billiards dedicated topics, including, but not limited to, “Gambling and the Law in the Nineteenth Century South: Evidence from Nacogdoches County, Texas, 1838-1839”, “Quiet Eye Duration Is Responsive to Variability of Practice and to the Axis of Target Changes”, “What I Think Korzybski Thought-And What I Think about It”, “Reading at Godmersham: Edward's Library and Marianne's Books”, “Resisting Interpretation”, “Reading with Lincoln/Marching to the Drumbeat of Abolitionism”: “Wheaton College in the Civil War/Captives in Gray”: “The Civil War Prisons of the Union”, “Big Boys' Clinics, Force and Motion”, “Force and Motion”, “Exploring Mathematical Exploration: How Two College Students Formulated and Solved Their Own Mathematical Problems”, “Drinking Games, Karaoke Songs, and Yangge Dances”: “Youth Cultural Production in Rural China (1)”, “Visual Illusions and the Control of Ball Placement in Goal-Directed Hitting”, “Diversions”, “A Vision Lost Dr. Robert J. Preston and the Southwestern Lunatic Asylum”, “1887-1906”, “Force and Motion”, “Product Demonstrations and Female Telephilia”, “The Toad Woman”, “Force and Motion, and Exile in Richmond: The Confederate Journal of Henri Garidel”.

Some embodiments comprise chat rooms with one or more biology dedicated topics, including, but not limited to, history of biology by subdiscipline, anatomy, astrobiology, biochemistry, biomedicine, bionics, biophysics, botany, cell biology, chemical biology, chronobiology, computational biology, conservation biology, developmental biology, ecology, evolutionary biology, genetics, geobiology, gerontology, and human biology.

Some embodiments comprise chat rooms with one or more biographies dedicated topics, including, but not limited to, famous biographies, historical biographies, congressional biographies, autobiography, historical biography, emergence of the genre, modern biography, hagiography, recent years, biographical research, critical issues, biographies to read aloud with kids: “From Alvin Ailey to Zishe the Strongman”, “Portraits of Perseverance: Creating Picturebook Biographies with Third Graders”, “The Legendary Biographies of Tamerlane: Islam and Heroic Apocrypha in Central Asia”, “Biographies That Inspire Readers”, “A Method for Understanding Their Method: Discovering Scientific Inquiry through Biographies of Famous Scientists”, “Catherine the Great and Royal Biographies”, “Reflections and Applications: Too Many Biographies”, “Too Little Time: Good Books to “Think With””, “Writing Lives”, “Writing Lies: The Pursuit of Apocryphal Biographies”, “Personal Biographies Used to Build a Learning Community”, and “Using Biographies in Science Class”.

Some embodiments comprise chat rooms with one or more biotechnology dedicated topics, including, but not limited to, aggregate modulus, American Society of Biomechanics, “Aquatic feeding mechanisms”, Arthropod exoskeleton, “Balance (ability)”, biofluid dynamics, biomechanics of sprint running, bipedal gait cycle, brush border, Canadian Society for Biomechanics, center of pressure (terrestrial locomotion), co-metabolism, core (anatomy), dynamic similarity (Reynolds and Womersley numbers), eco-mechanics, endoskeleton, exoskeleton, flapping counter-torque, force platform, and forensic biomechanics.

Some embodiments comprise chat rooms with one or more bird watching dedicated topics, including, but not limited to, birding, birdwatching, and twitching, “The history of birdwatching”, “Economic and environmental impact”, activities, monitoring, environmental education, competition, networking and organization, equipment and technology, sound equipment, photography, videography, portable media players, remote birdwatching, communication, code of conduct, socio-psychology, “Famous birdwatchers, In media, and books”.

Some embodiments comprise chat rooms with one or more bird dedicated topics, including, but not limited to, birds by common name, birds by location, birds by year of formal description, birds portal, birds by classification, bird anatomy, bird behavior, bird common names, bird colors, bird conservation, bird ecology, evolution of birds, flightless birds, birds and humans, hybridization in birds, avian incertae sedis, images of birds, introduced birds, metaphors referring to birds, and bird mortality.

Some embodiments comprise chat rooms with one or more bisexual culture dedicated topics, including, but not limited to, sexual orientation, identity, and behavior, Kinsey scale, demographics and prevalence, studies, theories and social responses, brain structure and chromosomes, volutionary theory, masculinization, renatal hormones, sex drive, community, general social impacts, perceptions and discrimination, symbols, “In BDSM”, “In feminism”, media, film, literature, music, and television.

Some embodiments comprise chat rooms with one or more bisexual Sex dedicated topics, including, but not limited to, bi-curious, biphobia, bisexual chic, bisexual erasure, bisexual lighting, bisexual pornography, bisexual pride flag, biphobia, bisexual community, female bisexuality, male bisexuality, bisexual people, bisexual rights activists, bisexuality in the United States, “Template: Bisexuality topics”, gender roles in non-heterosexual communities, heteroflexibility, the history of bisexuality, Innate bisexuality, and Klein sexual orientation grid.

Some embodiments comprise chat rooms with one or more Bizzare/Oddities dedicated topics, including, but not limited to, “Ovulation: a lap dancer's secret weapon”, “Which can jump higher, the dog flea or the cat flea?”, “On Ethicists and Theft, Wet underwear: Not comfortable”, “Do woodpeckers get headaches?”, “Booty calls: the best of both worlds?”, “Mosquitoes like cheese”, “Weighing up lead and feathers”, “Cat food—yummy?”, “The unhidden dangers of sword swallowing”, “beer bottle vs. human skull”, “the propulsion parameters of penguin poop”, “lady gaga and pop art”, “Even chickens prefer beautiful people”, “Erase bad memories, keep good ones”, “The rectal route to curing hiccups”, “Can pigeons tell a Picasso from a Monet?”, “The nature of navel lint”, “The effects of cocaine on bees”, and “Fruit bat fellatio”.

Some embodiments comprise chat rooms with one or more blues music dedicated topics, including, but not limited to, blues music etymology, lyrics, form, history, origins, prewar blues, urban blues, 1980s to the present, musical impact, in popular culture, notes, African American music, Miles Davis, “Russia Gets the Blues”: “Music, Culture, and Community in Unsettled Times, Dont Play No Blues”: “Race, Music, and Mourning in Faulkner's Sanctuary”, “Working Girl Blues: The Life and Music of Hazel Dickens”, “Riffing on Memory and Playing through the Break: Blues in Lewis Nordan's Music of the Swamp and Wolf Whistle”, “Transatlantic Roots Music: Folk, Blues, and National Identities”, postmodernism, pop music, and “blues practice in Nelson George's Post-Soul Culture”, “Transatlantic Roots Music: Folk, and Blues and National Identities”.

Some embodiments comprise chat rooms with one or more board games dedicated topics, including, but not limited to, board games by period, board games by country, board games by genre, board games by mechanic, traditional board games, board game awards, board games competitions, board game designers, electronic board games, French board games, board game gameplay and terminology, German board games, history of board games, board game publishing companies, television programs based on board games, three-dimensional board games, video board games, board game websites, works about board games, and board game stubs.

Some embodiments comprise chat rooms with one or more boating dedicated topics, including, but not limited to, boats, boating accident deaths, boating associations, cruising (maritime), disabled boating, boat festivals, boating lakes, paddling, boat racing, rafting, rowing, sailing, boat shows, yachting, boat parade, boat tour, center of lateral resistance, electric shock drowning, “find a crew”, “highlandtown lake”, and “how to avoid huge ships”.

Some embodiments comprise chat rooms with one or more bodybuilding dedicated topics, including, but not limited to, early history, “Eugen Sandow”, first large-scale bodybuilding competition, notable early bodybuilders, new organizations, anabolic/androgenic steroid use, world bodybuilding federation, Olympic sport discussion, professional bodybuilding, natural bodybuilding, female bodybuilding, competition, preparations, bulking and cutting, clean bulking, dirty bulking, pre-competition, muscle growth, weight training, and injecting oil into muscles.

Some embodiments comprise chat rooms with one or more books dedicated topics, including, but not limited to, etymology, antiquity, tablet, scroll, codex, manuscripts, middle east, wood block printing, movable type and incunabula, 19th century to 21st century, modern manufacturing, processes, layout, printing, binding, finishing, digital printing, e-book, design, and sizes.

Some embodiments comprise chat rooms with one or more botany dedicated topics, including, but not limited to, photosynthesis, botany, deciduous, vegetation, evergreen, plant nutrition, “Rose of Sharon”, allelopathy, phytoremediation, photoperiodism, petrifaction, pioneer species, phytotherapy, angiosperm phylogeny group, ecotype, adventitiousness, myco-heterotrophy, plant ecology, rapid plant movement, and history of botany.

Some embodiments comprise chat rooms with one or more bowling dedicated topics, including, but not limited to, ancient history, post-classical history, modern history, “In the 16th to 18th centuries”, “In the 19th century”, “In the 20th century”, “In the 21st century”, variations, Pin bowling, Target bowling, Accessibility, “In popular culture”, “With notable individuals”, “on-screen”, “in films”, “on television”, paintings, “Paul Bow”, “lesDust Bowl”, “Golden Bowl”, and “Grapes of Wrath”.

Some embodiments comprise chat rooms with one or more boxing dedicated topics, including, but not limited to, boxing by city, boxing by continent, boxing by country, amateur boxing, bare-knuckle boxing, boxing media, chess boxing, boxing clubs, boxing competitions, boxing culture, deaths due to injuries sustained in boxing, boxing gyms, history of boxing, boxing-related lists, boxing logos, boxing organizations, boxing people, boxing rules and regulations, boxing terminology, boxing venues, women's boxing, and boxing stubs.

Some embodiments comprise chat rooms with one or more brain disorders dedicated topics, including, but not limited to, acquired non-inflammatory myopathy, Acute motor axonal neuropathy, Adie syndrome, Adiposogenital dystrophy, Agene process, Agrammatism, Aicardi syndrome, alcohol withdrawal syndrome, alcoholic hallucinosis, auditory processing disorder, Autism, Autosomal recessive cerebellar ataxia type 1, Avellis syndrome, Balance disorder, Bilint's syndrome, Basilar invagination, Behr syndrome, central nervous system disorders, hallucinations, and Episodic and paroxysmal disorders.

Some embodiments comprise chat rooms with one or more Brazil dedicated topics, including, but not limited to, Brazil-related lists, buildings and structures in Brazil, Brazilian culture, economy of Brazil, education in Brazil, environment of Brazil, geography of Brazil, government of Brazil, health in Brazil, history of Brazil, organizations based in Brazil, the Brazilian people, politics of Brazil, Brazilian society, images of Brazil, Brazil stubs, outline of Brazil, culture of Brazil, geography of Brazil, and education in Brazil.

Some embodiments comprise chat rooms with one or more British literature dedicated topics, including, but not limited to, British identity, “The coming of the Anglo-Saxons: 449-c. 1066”, “The other languages of early Britain”, Old English literature, late medieval literature: 1066-1485, middle English, medieval drama, “The Renaissance: 1485-1660”, and “Elizabethan era: 1558-1603”.

Some embodiments comprise chat rooms with one or more “Britpop” dedicated topics, including, but not limited to, “The Shaming of Britpop”, “All White on the Night: How the Mythology of Britpop Rewrote the History of British Music”, “Don't Look Back in Anger: The Simultaneous Rise of Blair and Britpop Marked a Brief Moment of Unity between Culture and Politics. So Where Did It All Go Wrong? (the Back Half)”, “Into the Sun: Will Blur Ever Be Free of the “Britpop” Label? after a Difficult Period”, “the Band Is Back with a Warmer, Happier New Album”, “Never Mind the Britpop-Here's What “Cool Britannia” Was Really Listening To”, “Britannia Rules No More: Britpop, Britart, Britlit and Britflix Have All Failed to Generate Enduring Cultural Myths”, We Should Be Celebrating Plurality Not Homogeneity”, “Arts”, “Winning the Indie Cold War”, “The Download”, “The City and Its Female Characters in the Lyrics of the Britpop Band Pulp, Boys Boys Boys: Gender, Race and the English Music Question”, “Review of Brad Osborn, Everything in Its Right Place: Analyzing Radiohead (Oxford University Press, 2016)”, “Vinyl: A History of the Analogue Record”, “Track Studies—Popular Music and Postcolonial Analysis”, “Pop Culture in Europe”, “Books Recently Published”, “Using MCDM Methods for Selecting the Best Multi-Role Artist of Rock Bands in 2000s”, “In Memoriam: William J. Stuntz, Origins and first years”, and “The Battle of Britpop”.

Some embodiments comprise chat rooms with one or more Buddhism dedicated topics, including, but not limited to, Buddhism-related lists, Buddhism by location, anti-Buddhism, Buddhist archaeological sites, Gautama Buddha, Buddhas, Buddhism templates, Buddhist belief and doctrine, Buddhist saints, Buddhists, Buddhist buildings, comparative Buddhism, Buddhism-related controversies, Buddhist cosmology, Buddhist culture, Buddhist deities, Buddhist education, Buddhist governments, gender and Buddhism, and history of Buddhism.

Some embodiments comprise chat rooms with one or more business dedicated topics, including, but not limited to, antiques, art and craft supplies, art dealers and galleries, camera and photographic supplies, digital art, memorabilia, music store (instruments and sheet music), sewing, needlework, and fabrics, stamp and coin, stationary, printing and writing paper, vintage and collectibles, clothing, furniture, baby products (other), safety and health, bath and body, fragrances and perfumes, makeup and cosmetics, audio books, and digital content.

Some embodiments comprise chat rooms with one or more computer-aided-drawing (CAD) dedicated topics, including, but not limited to, “Alibre Design”, “AllyCAD”, “Autodesk AutoCAD”, “Autodesk Inventor”, “AxSTREAM”, “Bentley Systems—MicroStation”, “Bricsys BricsCAD”, “Dassault Systemes CATIA”, “Dassault Systemes SolidWorks”, “KeyCreator”, “Siemens NX”, “Siemens Solid Edge”, “PTC PTC Creo (formerly known as Pro/ENGINEER)”, “T-FLEX CAD”, “Trimble SketchUp”, “AgiliCity Modelur”, “TurboCAD”, “RONCAD”, “MEDUSA”, and “ProgeCAD”.

Some embodiments comprise chat rooms with one or more camping dedicated topics, including, but not limited to, camping by country, backpacking, books about camping, camping equipment, campsites, caravans and travel trailers, recreational vehicles, summer camps, camping stubs, campfire, camping food, camping in churches, campsite, canoe camping, glamping, hammock camping, “Kitafahrten”, “Lean-to”, “Motorhome”, and outdoor cooking.

Some embodiments comprise chat rooms with one or more Canada dedicated topics, including, but not limited to, etymology, history, indigenous peoples, European colonization, confederation and expansion, early 20th century, contemporary era, geography and climate, government and politics, law, foreign relations and military, provinces and territories, economy, science and technology, demographics, education, health, ethnicity, religion, and languages.

Some embodiments comprise chat rooms with one or more cancer dedicated topics, including, but not limited to, breast cancer, invasive lobular carcinoma, tubular carcinoma, invasive cribriform carcinoma, medullary carcinoma, male breast cancer, phyllodes tumor, inflammatory breast cancer, astrocytoma, brainstem glioma, pilocytic astrocytoma, ependymoma, primitive neuroectodermal tumor, chondrosarcoma, Ewing's sarcoma, malignant fibrous histiocytoma of bone/osteosarcoma, osteosarcoma, rhabdomyosarcoma, heart cancer, and anal cancer.

Some embodiments comprise chat rooms with one or more canoeing/kayaking dedicated topics, including, but not limited to, canoeing by continent, canoeing by country, canoeing-related lists, women's canoeing, battles involving canoes, canoeists, canoes, canoeing deaths, canoeing disciplines, canoeing logos, canoeing media, canoe organizations, records in canoeing, years in canoeing, canoeing, canoe camping, canoe paddle strokes, cayuco, fur brigade, and standup paddle-boarding.

Some embodiments comprise chat rooms with one or more capitalism dedicated topics, including, but not limited to, etymology, history, agrarian capitalism, mercantilism, industrial capitalism, modern capitalism, relationship to democracy, varieties of capitalism, characteristics, the market, profit motive, private property, market competition, economic growth, as a mode of production, supply and demand, graphical representation of supply and demand, supply schedule, demand schedule, and equilibrium.

Some embodiments comprise chat rooms with one or more car parts dedicated topics, including, but not limited to, car body and main part, body components, including windows and trim, doors, windows, electrical and electronics, audio/video devices, cameras, electrical supply system, gauges and meters, ignition electronic system, lighting and signaling system, sensors, starting system, electrical switches, wiring harnesses, interior, floor components and parts, other components, car seat, and power-train and chassis.

Some embodiments comprise chat rooms with one or more card games dedicated topics, including, but not limited to, playing cards, typical structure of card games, number and association of players, direction of play, determining who deals, hands, rounds and games, shuffling, deal, rules, rule infractions, trick-taking games, matching games, shedding games, accumulating games, fishing games, comparing games, solitaire (patience) games, drinking card games, multi-genre games, and collectible card games (CCGs).

Some embodiments comprise chat rooms with one or more career planning dedicated topics, including, but not limited to, “what interests you?”, “skill assessment”, “following your dreams”, “networking”, “informational interviewing”, “interviewing”, “secondary education”, “salary issues”, “paying your dues”, “entrepreneurship”, “putting family first”, “career change choosing a new career path”, “getting laid off”, “career tests”, “volunteer work”, rural or urban location, abilities, “Your Cover Letter and Resume”, “Your school's career development office”, and cost of living.

Some embodiments comprise chat rooms with one or more Caribbean dedicated topics, including, but not limited to, lists of buildings and structures in the Caribbean, Caribbean education-related lists, Lists of events in the Caribbean, Caribbean geography-related lists, Lists of organizations based in the Caribbean, lists of Caribbean people, Caribbean politics-related lists, Caribbean religion-related lists, Caribbean sport-related lists, transport in the Caribbean-related lists, Anguilla-related lists, Antigua and Barbuda-related lists, Bahamas-related lists, Barbados-related lists, Belize-related lists, Bonaire-related lists, British Virgin Islands-related lists, Cayman Islands-related lists, Costa Rica-related lists, and Cuba-related lists.

Some embodiments comprise chat rooms with one or more automobile dedicated topics, including, but not limited to, cars by country, cars by decade, car-related lists, set indices on cars, automobile associations, car body styles, car brands, car classifications, car crime, car culture, history of the automobile, individual cars, car-related media, car models, car ownership, car performance, auto racing, automotive terminology, vehicle law, and images of cars.

Some embodiments comprise chat rooms with one or more cartoons dedicated topics, including, but not limited to, the “Billy Ireland Cartoon Library & Museum”, caricature, comics, comics studies, editorial cartoon, “Histoire de M. Vieux Bois”, list of comic strips, list of cartoonists, list of editorial cartoonists, teen humor comics, animation, scientific cartoons, political cartoons, print media, fine art, scientific cartoons, bibliography, current editorial cartoons, “Dan Becker”, the history of cartoons, and Keppler cartoons.

Some embodiments comprise chat rooms with one or more catholic dedicated topics, including, but not limited to, catholic organization, “Holy See”, papacy, “Roman Curia”, and “College of Cardinals”, “Canon law”, “Latin and Eastern churches”, dioceses, parishes, organizations and institutes, membership, doctrine, “Nature of God”, “Nature of the church”, “Final Judgment”, “Saints and devotions”, “Virgin Mary”, “Sacraments”, “Sacraments of initiation”, “Sacraments of healing”, “Sacraments at the service of communion”, “Liturgy”, “Western rites”, “Eastern rites”, and “Social and cultural issues”.

Some embodiments comprise chat rooms with one or more cats dedicated topics, including, but not limited to, etymology, alternative term, associated terms, taxonomy, evolution, before domestication, domestication, characteristics, size, skeleton, skull, ambulation, claws, senses, vision, hearing, smell, accessory smell, taste, and whiskers.

Some embodiments comprise chat rooms with one or more celebrities dedicated topics, including, but not limited to, list of actors with academy award nominations, list of celebrities with advanced degrees, list of “Alfred Hitchcock presents” guest stars, list of “All That musical guests”, list of “The Andy Griffith Show guest stars”, “The Bad Popes”, “Barbara Walters' 10 Most Fascinating People”, “List of inductees of Canada's Walk of Fame”, “List of Countdown champions”, “List of celebrities appearing on Daily Cooks Challenge”, “Fame in the 20th Century”, “Forbes Celebrity 100”, “Forbes China Celebrity 100”, “Forbes Korea Power Celebrity”, “Gallup's List of Most Widely Admired People of the 20th Century”, “List of Futurama guest stars”, “List of guest stars on Knight Rider”, “List of guest stars with The Wiggles”, “List of Have I Got News for You presenters”, and “Heroes for My Daughter”.

Some embodiments comprise chat rooms with one or more cell phone dedicated topics, including, but not limited to, cell phones types, smartphone, feature phone, kosher phone, infrastructure, hardware, central processing unit, display, sound, battery, sim card, software, software platforms, mobile application, application stores, sales, by manufacturer, by mobile phone operator, use, and general.

Some embodiments comprise chat rooms with one or more Celtic music dedicated topics, including, but not limited to, Celtic traditional music, Irish music, music of Scotland, “Reels”, “Pibroch”, “Waulking song”, “Puirt à beul”, “Kan ha diskan”, “Sean-nós song”, Celtic hip-hop, Celtic rock, Celtic metal, Celtic punk, Celtic fusion, progressive music, folk music, “Celtic music and the Growth of the Feis Movement”, “Celtic Modern Music at the Global Fringe”, “Escaping the Celtic Tiger”, “World Music and the Millennium”, and “The Gift of Celtic Sight”.

Some embodiments comprise chat rooms with one or more Central America dedicated topics, including, but not limited to, Central America, different definitions, ports and harbors, geography, biodiversity, flora, fauna, geology, demographics, languages, ethnic groups, religious groups, culture, sport, politics, integration, foreign relations, parliament, economy, tourism, and transport.

Some embodiments comprise chat rooms with one or more chaos/complexity dedicated topics, including, but not limited to, attractor dimensions, attractor reconstruction, “User:Anatole Katok/Proposed/Ergodic theory”, “Bubbling transition”, “Butterfly effect”, “User: Chaos”, “Chaos in neurons”, “Chaos in optics”, “Chaotic micro-lasers”, “Chaotic spiking oscillators”, “Chua circuit”, “Coherence resonance”, “Controlling chaos”, “Crises”, “User:Eugene M. Izhikevich/Proposed/Chaotic advection”, entropy, Kepler map, dynamical billiards, fractals, and Grassberger-Procaccia algorithm.

Some embodiments comprise chat rooms with one or more cheerleading dedicated topics, including, but not limited to, before organized cheerleading, beginning of organized cheer, female participation, cheerleading firsts, professional cheerleading, advancements and traditions of cheerleading, evolution, types of teams in the united states today, school-sponsored, middle school, high school, college, youth league/athletic association, all-star, professional, associations, federations, and organizations, competitions and companies, title ix sports status, dangers of cheerleading, and in popular culture.

Some embodiments comprise chat rooms with one or more chemical engineering dedicated topics, including, but not limited to, biochemical engineering, chemical engineering awards, chemical engineering books, chemical engineering organizations, chemical engineering software, chemical engineering thermodynamics, chemical engineers, chemical reaction engineering, electrochemical engineering, environmental engineering, fluid dynamics, green chemistry, chemical engineering journals, particle technology, piping, chemical process engineering, chemical product engineering, products of chemical industry, tissue engineering, and isotope electrochemistry.

Some embodiments comprise chat rooms with one or more chemistry dedicated topics, including, but not limited to, chemists, chemistry set index pages, chemical elements, acid-base chemistry, allotropes, analytical chemistry, astrochemistry, atmospheric chemistry, atomic physics, biochemistry, chemical bonding, carbohydrate chemistry, chemical biology, chemical data pages, chemical energy, chemical industry, chemical mixtures, cheminformatics, chemistry awards, and chemistry conferences.

Some embodiments comprise chat rooms with one or more chess dedicated topics, including, but not limited to, rules, setup, movement, castling, En-passant, promotion, check, end of the game, win, draw, time control, history, predecessors, “1200-1700: Origins of the modern game”, “1700-1873: The Romantic Era in chess”, “1873-1945: Birth of a sport”, “1945-present: Post-World War II era”, place in culture, pre-modern, and modern.

Some embodiments comprise chat rooms with one or more children's books dedicated topics, including, but not limited to, early-modern Europe, origins of the modern genre, golden age, national traditions, adventure fiction for children, magazines and comics, United States, Continental Europe, Russia and the Soviet Union, classification, by genre, by age category, illustration, scholarship, literary criticism, stereotypes, racism and cultural bias, “The Empire”, imperialism and colonialism, gender roles and representation of women, debate over controversial content, and the effect on early childhood development.

Some embodiments comprise chat rooms with one or more China dedicated topics, including, but not limited to, contemporary Chinese politics, “The Sleeping Giant: Becoming the World's Largest Economy”, “Tibet and the Chinese Government”, “Environmental Issues In China”, “Mao's Little Red Book”, “The Communist Experiment: The People's Republic of China”, “The People's Republic of China and the Former Soviet Union: Parallels and Deviations of Marxism”, “Censorship and China”, “One Child Policy: Population Control and Modern China”, “Human Rights and China”, “Made in China: A Production Phenomenon”, “The South China Sea: An Exploration”, “Cross Cultural Competency: Business Interactions in China”, “The Tianamen Square Incident: An Analysis and Implications”, “The 2008 Olympics: An Outside Perspective of China”, “China and Africa Alliances”, “The Chinese Exclusion Act: The Migration of Chinese Workers and Western Response”, “Interpretation of the Chinese State Through the Orientalism Lens of Edward Said”, “The Great Wall of China: An Engineering Marvel”, and “The Silk Road and Chinese Culture”.

Some embodiments comprise chat rooms with one or more Christian music dedicated topics, including, but not limited to, history of music in the biblical period, worship services, instrumental accompaniment, contemporary christian music, industry, media, music festivals and conferences, concerts, christian radio, christian rock, church music, contemporary worship music, christian hip hop, christian metal, theology and lyrics, musical identity, performance, popularity, latin christian music, and christian alternative rock.

Some embodiments comprise chat rooms with one or more Christianity dedicated topics, including, but not limited to, etymology, beliefs, creeds, Jesus, death and resurrection, salvation, trinity, trinitarians, non-trinitarianism, eschatology, death and afterlife, practices, communal worship, sacraments, liturgical calendar, symbols, baptism, prayer, scriptures, and catholic interpretation.

Some embodiments comprise chat rooms with one or more Christmas dedicated topics, including, but not limited to, nativity of Jesus, Christmas art, Christmas-linked holidays, Christmas economics, Christmas fiction, Christmas literature, Christmas traditions, Christmas images, Christmas navigational boxes, Christmas (surname), Christmas and holiday season, Christmas controversies, “An Evergreen Christmas”, “Christmas by medium”, “Nativity of Jesus”, “Nittel Nacht”, “Portal:Christmas”, “Princess Mary Christmas gift box”, “White Christmas (weather)”, and “Christmas by medium”.

Some embodiments comprise chat rooms with one or more cigar dedicated topics, including, but not limited to, “Andre Garcia”, “Blunt (cannabis)”, “Blunt (cigar)”, “Box-pressed”, “Cabinet selection”, “Cheroot”, “Cigar Aficionado”, “Cigar ash”, “Cigar band”, “Cigar bar”, “Cigar boom”, “Cigar box”, “Cigar case”, “Cigar cutter watch fob”, “Cigar etiquette”, “Cigarillo”, “Consumers Cigar Box Company”, “Corojo”, “Criollo tobacco”, and “Cigar cutter”.

Some embodiments comprise chat rooms with one or more civil engineering dedicated topics, including, but not limited to, low cost grain storage structures, rural water supply, ground water inventory, development of rainfall runoff relationship for small catchments, investigation on nylon fiber reinforced roofing units, lime stabilized bricks, for soil bricks subjected to accelerated weathering conditions, mechanical properties of co-fiber reinforced cement composites, rammed earth walls, ground water potential and problems, development and use of unit hydrograph, block wise studies of rural houses, reinforced brick panel, ground water inventory, operational research in buildings, six sigma possibilities in building construction, air pollution, evaluation of uneven pavement surface, engineering and natural resources study of a village, and qualitative analysis of irrigation water.

Some embodiments comprise chat rooms with one or more classic film dedicated topics, including, but not limited to, films by genre, abstract animation, afrofuturist films, compilation films, experimental film, film noir, “Films a clef”, “Girls with guns films”, horror comedy, Jiangshi fiction, Kaiju, magic realism, midnight movie, mythopoeia, newsreels, rumberas, sports films, thrillers, underground films, and weird west.

Some embodiments comprise chat rooms with one or more classic rock dedicated topics, including, but not limited to, “1950s: Rock and roll”, early 1960s, pop rock and instrumental rock, surf music, British invasion, garage rock, psychedelia and progressivism, blues and folk fusions, psychedelic rock, progressive rock, jazz rock, early 1970s, roots rock, glam rock, soft rock, hard rock and early heavy metal, Christian rock, punk era, punk rock, new wave, and post-punk.

Some embodiments comprise chat rooms with one or more classical music dedicated topics, including, but not limited to, characteristics, literature, instrumentation and vocal practices, medieval music, renaissance music, baroque music, romantic music, modernist music, contemporary classical music, postmodern music, post-postmodern instrumentation, performance, gender of performers, complexity, history, roots, early period, common-practice period, baroque music, and classical-era (or period) music.

Some embodiments comprise chat rooms with one or more classical dedicated topics, including, but not limited to, ancient Greek studies, ancient philosophy studies, American classical league, ancient classics for English readers, Apophthegmatum opus, Archaeological Institute of America, classical archaeology, Arete, “Athenians Project”, classical associations and societies, classics journals, computing in classical studies, classical educational institutes, classical war films, classical historiography, classical philology, professorships in classics, classics publications, study of ancient Rome, and classical scholars.

Some embodiments comprise chat rooms with one or more climbing dedicated topics, including, but not limited to, climbing, aid climbing, clean climbing, Climbing clubs, Climbing wall, climbing equipment, climbing organizations, fall factor, list of climbers—notable rock and ice climbers, list of climbing topics, glossary of climbing terms, glossary of knots common in climbing, outdoor education, outdoor activity, rock climbing, running belay, parkour, scrambling, solo climbing, speed climbing, and climbs and expeditions.

Some embodiments comprise chat rooms with one or more clothing dedicated topics, including, but not limited to, origin of clothing, functions, scholarship, cultural aspects, gender differentiation, social status, religion, origin and history, early use, making clothing, contemporary clothing, western dress code, spread of western styles, ethnic and cultural heritage, sport and activity, fashion, political issues, working conditions in the garments industry, fur, and life cycle.

Some embodiments comprise chat rooms with one or more coffee dedicated topics, including, but not limited to, coffeehouses, etymology, legendary accounts, historical transmission, biology, cultivation, ecological effects, production, processing, roasting, grading roasted beans, roast characteristics, decaffeination, storage, brewing, nutrition, serving, instant coffee, sale and distribution, and commodity market.

Some embodiments comprise chat rooms with one or more cognitive science dedicated topics, including, but not limited to, academic programs in cognitive science, artificial intelligence, cognitive science awards, cognitive disorders, cognitive linguistics, cognitive modeling, cognitive musicology, cognitive science lists, cognitive science research institutes, cognitive scientists, conceptual systems, consciousness studies, cybernetics, cognitive development, enactive cognition, environmental psychology, epistemics, epistemology, ethology, and generative linguistics.

Some embodiments comprise chat rooms with one or more cold war dedicated topics, including, but not limited to, Cold War history by country, Cold War by continent, Cold War by period, aftermath of the Cold War, aftermath of World War II, Cold War casualties, Cold War conflicts, Cold War in popular culture, Corfu channel incident, Cross-Strait conflict, Cuban missile crisis, Eastern bloc, Cold War fortifications, Cold War historiography, Cold War-related lists, military equipment of the Cold War, Cold War organizations, people of the Cold War, Cold War policies, and Cold War sites.

Some embodiments comprise chat rooms with one or more collecting dedicated topics, including, but not limited to, “National Collections of Scotland”, art collections, Internet archive collections, museum collections, national numismatic collections, photographic collections and books, poetry collections, private collections, scale model collections, “Arts Council Collection”, “Collection Management Policy”, “East Asian Library and the Gest Collection”, fossil and petrology collections, “New South Wales”, “Gordon W. Prange Collection”, “Julius S. Held Collection of Rare Books”, “Leeds University Library's Cookery Collection”, “Macaulay Library”, “Mobile Cook's Galley”, “Museum of the Riverina”, “List of French art works in the National Museum of Serbia”, and “Paintings in Hospitals”.

Some embodiments comprise chat rooms with one or more comedy movie dedicated topics, including, but not limited to, silent film era, sub-genres, comedy of manners, slapstick, fish out of water, parody, anarchic comedy, black comedy, gross out, screwball comedy, hybrid sub-genres, action comedy, comedy horror, comedy thriller, fantasy comedy, comic science fiction, military comedy, romantic comedy, comedy film characters, and comedy films by decade.

Some embodiments comprise chat rooms with one or more comic book dedicated topics, including, but not limited to, comic book structure, American comic books, underground comic books, alternative comics, graphic novels, digital comics, market size, comic book collecting, advertisements, asian comics, Japanese manga, Djinshi, Korean manhwa, Webtoons, Chinese manhua, European comics, Franco-Belgian comics, British comics, Spanish comics, and Italian comics.

Some embodiments comprise chat rooms with one or more communism dedicated topics, including, but not limited to, communism in the Arab world, communism in the Middle-East, communism by continent, communism by country, communists, communist states, anarcho-communism, anti-communism, anti-revisionism, Apoism, Christian communism, communism-based civil wars, council communism, former communist economies, hammer and sickle, historians of communism, Jewish communist movements, left communism, Leninism, and Marxism.

Some embodiments comprise chat rooms with one or more computer graphics dedicated topics, including, but not limited to, computer architecture for the future, advancing artificial intelligence, improving data security, software development for wearable gadgets, computers and robotics, sensor systems and wireless communication, privacy, memory and security in the era of cloud storage, privacy with automated application initiation, networking and systems for the future, enhancing human computer interaction, software engineering and programming languages, open-source software, machine learning, visualization and data management, quantum computing, enhancing search algorithms, computer science and advancement of biology and biomedicine, using computers in education, arresting data mining on public systems, and automated and reasoning robots.

Some embodiments comprise chat rooms with one or more computer hardware dedicated topics, including, but not limited to, computer hardware by company, computer hardware by type, lists of computer hardware, benchmarks (computing), hardware bugs, classes of computers, clock signal, computer hardware companies, hardware acceleration, hardware partitioning, history of computing hardware, hardware in Linux (1 C, 2 P), computer hardware researchers, computer hardware standards, computer hardware tuning, hardware virtualization, computer hardware logos, computer hardware stubs, hardware backdoor, and hardware compatibility list.

Some embodiments comprise chat rooms with one or more computer science dedicated topics, including, but not limited to, computer architecture for the future, advancing artificial intelligence, improving data security, software development for wearable gadgets, computers and robotics, sensor systems and wireless communication, privacy, memory and security in the era of cloud storage, privacy with automated app initiation, networking and systems for the future, enhancing human computer interactions, software engineering and programming languages, open source software, machine learning, visualization and data management, quantum computing, enhancing search algorithms, computer science and advancement of biology and biomedicine, using computers in education, arresting data mining on public systems, and automated and reasoning robots.

Some embodiments comprise chat rooms with one or more computer security dedicated topics, including, but not limited to, computer architecture for the future, advancing artificial intelligence, improving data security, software development for wearable gadgets, computers and robotics, sensor systems and wireless communication, privacy, memory and security in the era of cloud storage, privacy with automated application initiation, networking and systems for the future, enhancing human computer interactions, software engineering and programming languages, open source software, machine learning, visualization and data management, quantum computing, enhancing search algorithms, computer science and advancement of biology and biomedicine, using computers in education, arresting data mining on public systems, and automated and reasoning robots.

Some embodiments comprise chat rooms with one or more computer dedicated topics, including, but not limited to, computing by computer model, computer architecture, classes of computers, data centers, computers and the environment, evaluation of computers, computer hardware, computer hardware companies, history of computing, information appliances, computer-related introductions by year, computer programming, computer systems, computer maintenance, microcomputer, “Mixlink”, motion history images, “WATIAC”, “WDR paper computer”, and “Wevolver”.

Some embodiments comprise chat rooms with one or more conservative politics dedicated topics, including, but not limited to, liberal conservatism, conservative liberalism, libertarian conservatism, fiscal conservatism, national and traditional conservatism, cultural and social conservatism, religious conservatism, paternalistic conservatism, authoritarian conservatism, history, development of western conservatism, United Kingdom, revival, historic conservatism in different countries, modern conservatism in different countries, characteristics of conservatism in France, Italy, Russia, Poland, United Kingdom, United States and Israel, psychology, bibliography, politics in culture, and politics by issue.

Some embodiments comprise chat rooms with one or more conspiracies dedicated topics, including, but not limited to, conspiracy theories, “Pontiac's Conspiracy”, “Know-Nothing Party”, “Aaron Burr”, “Tying Conspiracies”, “Foreign Price-Fixing Conspiracies”, “Exposing Confederate Conspiracies in America's Heartland”, “Umberto Eco's Numero Zero: A J'accuse of Forgeries, Lies, Conspiracies and Bitter Truths”, “Conspiracies and Fabrication of Texts in Foucault's Pendulum and the Prague Cemetery”, “John Wilkes Booth and the Lincoln Conspiracies, Conspiracies and Coincidences”, “The Virginia Slave Conspiracies of 1800 and 1802 by Douglas R. Egerton”, “Contracts, Combinations, Conspiracies, and Conservation: Antitrust in Oil Unitization and the Intertemporal Problem”, “Cartographic Conspiracies: Maps, Misinformation, and Exploitation in Peter Carey's “American Dreams””, “Spear-Tackles and Sporting Conspiracies”, “National Security”, “Personal Insecurity”, and “Political Conspiracies: The Persistence of Americans' Beliefs in 9/11 Conspiracy Theories”, “The Problems with Alleging Federal Government Conspiracies under 42 U.S.C. § 1985(3)”, “Conspiracies and the Continuing Violations Doctrine under the Sherman Act: In Re Pre-Filled Propane Tank Antitrust Litigation”, “Collusion in Procurement Auctions: An Experimental Examination, and Can Attorneys and Clients Conspire?”.

Some embodiments comprise chat rooms with one or more construction dedicated topics, including, but not limited to, construction by continent, construction by country, architecture, artificial landforms, artisans, building, buildings and structures under construction, civil engineering, coastal construction, computer-aided engineering, demolition, dredging companies, construction equipment, fasteners, hardware (mechanical), history of construction, construction industry, infrastructure, construction law, and construction management.

Some embodiments comprise chat rooms with one or more consumer information dedicated topics, including, but not limited to, consumer magazines, consumer behavior, consumer confidence, consumerism, consumption (macroeconomics), consumer goods, home economics, consumer organizations, consumer protection, collective buying power, consumer economy, consumer education, consumer health laws, consumer innovativeness, consumer privacy, consumer revolution, consumer service, consumer surplus for software products, consumtariat, and economic materialism.

Some embodiments comprise chat rooms with one or more continuing dedicated topics, including, but not limited to, continuing education, “CEB” (“Continuing Education of the Bar”), “Do Space”, “EthosCE”, “EUCEN”, “Feltre School”, “Frsteneck Castle”, further education, in-service program, “Institute of Continuing Education”, “Insurance Continuing Education”, “Intel Teach”, “International Adult and Continuing Education Hall of Fame”, “Continuing legal education”, “Leisure Learning Unlimited”, “Marketing Research Institute International (MRII)”, “Master class”, “Continuing medical education”, “National Academy of Medical Sciences”, and “Continuing education unit”.

Some embodiments comprise chat rooms with one or more counter-culture dedicated topics, including, but not limited to, alternative journalism, anti-consumerism, cacophony society, counter-culture communities, counter-culture festivals, counter-culture of the 1960s, protest camps, squats, “420 (cannabis culture)”, Nicholas Albery, anti-consumerism, “Arts Lab”, “At the Hub”, “Avindaro (book)”, Brian Barritt, “Battle of the Beanfield”, “Beatnik”, “BIT (alternative information centre)”, “Black Bear Ranch”, and “Centro Iberico”.

Some embodiments comprise chat rooms with one or more country music dedicated topics, including, but not limited to, country music origins, “Role of East Tennessee”, “Generations”, “First generation (1920s)”, “Second generation (1930s-1940s)”, “Singing cowboys and Western swing”, “Changing instrumentation”, “Hillbilly boogie”, “Bluegrass”, “folk and gospel”, “Honky tonk”, “Third generation (1950s-1960s)”, “Rockabilly”, “The Nashville and countrypolitan sounds”, “Country-soul crossover”, “Bakersfield sound”, “Decline of Western music and the cowboy ballad”, “Fourth generation (1970s-1980s)”, “Outlaw country and Red Dirt”, “Country pop”, and “Country rock”.

Some embodiments comprise chat rooms with one or more crafts dedicated topics, including, but not limited to, craft occupations, crafts organizations, bamboo-working, basket weaving, beadwork, calligraphy, crafts deities, do it yourself, drawing, crafts educators, German crafts, glass art, glossaries of crafts, handicrafts, hat making, Japanese crafts, leather crafting, metalworking, Mexican crafts, and paper folding.

Some embodiments comprise chat rooms with one or more cricket dedicated topics, including, but not limited to, cricket origins, “growth of amateur and professional cricket in England”, “English cricket in the 18th and 19th centuries”, “Cricket becomes an international sport”, “World cricket in the 20th century”, “The rise of limited overs cricket”, “Laws and gameplay”, “Playing area”, “Match structure and closure”, “Bat and ball”, “Basic gameplay: bowler to batsman”, “Fielding”, “Specialist roles”, clothing and equipment, innings, overs, umpires and scorers, spirit of the game, bowling and dismissal, and batting, runs and extras.

Some embodiments comprise chat rooms with one or more crime dedicated topics, including, but not limited to, crimes by period, crimes by country trator, violent crime, crime against banks, crimes against children, crimes against humanity, crimes committed against law enforcement, crimes against women, assault, attacks, baiting (blood sport), body snatching, bribery, cemetery vandalism and desecration, commercial crimes, common law offences in England and Wales, conspiracy, conspiracy (criminal), corruption, and criminal transmission of HIV.

Some embodiments comprise chat rooms with one or more crochet dedicated topics, including, but not limited to, crochet etymology, origins, Irish crochet, modern practice and culture, materials, crochet hook, yarn, process, types of stitches, international crochet terms and notations, differences from and similarities to knitting, charity, health benefits, literacy, mathematics and hyperbolic crochet, architecture, yarn bombing, “How to Single Crochet—SC”, “How to Triple/Treble Crochet—TR”, and “How to Tunisian Crochet—TFS”.

Some embodiments comprise chat rooms with one or more cult films dedicated topics, including, but not limited to, any of “General overview, Transgression and censorship, Subcultural appeal and fandom, Types, So bad it's good, Camp and guilty pleasures, Nostalgia, Midnight movies, Art and exploitation, B and genre films, Animation, Nonfiction, Mainstream popularity, Spirit Possession, Power, and the Absent Presence of Islam: Re-Viewing Les Maitres fous/Possession Par Les Esprits, Pouvoir et Absence-Presence De I'islam: Un Nouveau Regard Sur Les Maitres Fous, Who's Bleeding Whom? Analyzing the Cultural Flows of Blaxploitation Cinema, Then and Now, Lens on a Hard Body: Cult Documentary and Class Politics, I Love Dick, Totally, Tenderly, Tragically: Godard's Contempt and the Composition Qu'il Y Aurait (That Might Have Been), Latino/a Hero-Making in Robert Rodriguez's Films: Identity and Ideology, and Transcending Time: Jean Harlow and Hollywood's Narrative of Decline”.

Some embodiments comprise chat rooms with one or more Culture/Ethnicity dedicated topics, including, but not limited to, “Culture by location, Topics in culture, Cultural lists, Cultures, Cultural anthropology, Artificial objects, Arts, Clothing, Culture-related controversies, Cultural concepts, Cultural critics, Cultural exchange, Education, Cultural education, Encyclopedias of culture and ethnicity, Culture and the environment, Essays about culture, Ethnicity, Cultural events, and Cultural generations”.

Some embodiments comprise chat rooms with one or more cyberculture dedicated topics, including, but not limited to, “Manifestations, Qualities, Identity—“Architectures of credibility”, Anonymous versus known, Linked to physical identity versus internet-based identity only, Unrated commentary system versus rated commentary system, Positive feedback-oriented versus mixed feedback (positive and negative) oriented, Moderated versus unmoderated, Cyberculture studies, Cybersex, E-Commerce, Games, Internet forums, Internet memes, Microblogs, Online videos, Peer-to-peer file sharing, Social networks, Cybersex, and E-Commerce”.

Some embodiments comprise chat rooms with one or more DJs and mixing dedicated topics, including, but not limited to, “Types, Radio DJs, Club DJs, Turntablists, Residents, Deejays (in reggae), Other types, Equipment, Turntables, CDJs, DJ mixers, Headphones, Software, Timecode, DJ controllers, Other equipment, Techniques, Miming, and Female DJs”.

Some embodiments comprise chat rooms with one or more dance music dedicated topics, including, but not limited to, “Performance and participation, Origins, Dance and music, Dance and rhythm, Approaches to dance, Concert dance, Participatory and social dance, Cultural traditions, Dance education, Occupations, Professional dancers, Dance teachers, Choreographers, Competitions, Gallery, Historical dance music, Electronic, Dansband Popular dance music, Radio formats, and by decade”.

Some embodiments comprise chat rooms with one or more dancing dedicated topics, including, but not limited to, “dances by ethnicity or region, Ballets, Concert dance, Erotic dance, Folk dance, Free and improvised dance, Group dances, Ice dance, Masked dances, Pole sports, Ritual dances, Sacred dance, Social dance, Triple time dances, War dances, Hiplet (dance style, Solo dance, The Strictly, Vernacular dance, and Aerial dance”.

Some embodiments comprise chat rooms with one or more database dedicated topics, including, but not limited to, “Terminology and overview, History, 1960s, navigational DBMS, 1970s, relational DBMS, Integrated approach, Late 1970s, SQL DBMS, 1980s, on the desktop, 1990s, object-oriented, 2000s, NoSQL and NewSQL, Use cases, Classification, Database interaction, Database management system, Application, Application Program Interface, Database languages, Storage, Materialized views, Replication, and Security”.

Some embodiments comprise chat rooms with one or more dating tips dedicated topics, including, but not limited to, “Amejo, Back-up partner, Beirut Knights, Box social, Childhood sweetheart, College and university dating, Cook and Date, Courtship, Courtship in the Philippines, Courtship, marriage, and divorce in Cambodia, Cupid plc, Date rape, First date, Dating violence, Dating coach, Dating Do's and Don'ts, Dating game show, Eligible bachelor, Filter theory (sociology), Genetic matchmaking, and Gray rape”.

Some embodiments comprise chat rooms with one or more day-trading dedicated topics, including, but not limited to, “Profit and risks, History, Financial settlement, Electronic communication networks, SOES, Before the bubble, Technology bubble (1997-2000), Techniques, Trend following, Contrarian investing, Range trading, Scalping, Rebate trading, News playing, Price action, Artificial intelligence, Cost, Commission, Spread, and Market data”.

Some embodiments comprise chat rooms with one or more dentistry dedicated topics, including, but not limited to, “Dentistry by country, Dentistry branches, Dental academics, Dentists, Diseases of oral cavity, salivary glands and jaws, Dental drugs, Dentistry education, Dental examinations, History of dentistry, Human mouth anatomy, Dentistry-related lists, Dental companies, Dentistry occupations, Dental organizations, Dentistry definitions, Dentistry procedures, Water fluoridation, Works about dentistry, Dentistry stubs, and Who's Smiling Now?Disparities in American Dental Health”.

Some embodiments comprise chat rooms with one or more design dedicated topics, including, but not limited to, “Design as a process, The rational model, Example sequence of stages, Criticism of the rational model, The action-centric model, Descriptions of design activities, Design disciplines, Philosophies and studies of design, Philosophies for guiding design, Approaches to design, Methods of designing, Terminology, Design and art, Design and engineering, Design and production, Process design, Automotive design, Biological design, Configuration design, and Design management”.

Some embodiments comprise chat rooms with one or more desktop publishing dedicated topics, including, but not limited to, “Adobe Creative Suite, Adobe FrameMaker, Adobe InDesign, Adobe PageMaker, Banner Mania, Bookmaking software, Calamus (DTP), Comparison of desktop publishing software, Corel Ventura, Adobe Creative Cloud, CutePDF, Digital publication app, Fatpaint, Fleet Street Publisher, FlightCheck, GeoPublish, IBooks Author, ICalamus, InPage, and IStudio Publisher”.

Some embodiments comprise chat rooms with one or more diabetes dedicated topics, including, but not limited to, “AIDA interactive educational freeware diabetes simulator, Ambulatory glucose profile, Amylin, Diabetes in Australia, Banting Lectures, Bardoxolone methyl, Basal (medicine), Basal rate, Blood sugar level, Blood sugar regulation, C-peptide, Captain Novolin, Carbohydrate counting, Certified diabetes educator, Chromium in glucose metabolism, Chronic Somogyi rebound, Clarke Error Grid, Complications of diabetes mellitus, Consensus error grid, and Cystic fibrosis-related diabetes”.

Some embodiments comprise chat rooms with one or more disability dedicated topics, including, but not limited to, “Disability by country, Disability by type, Disability-related lists, Accessibility, Assistance animals, Augmentative and alternative communication, Bionics, Disability culture, History of disability, Medical assessment and evaluation instruments, Mental health, Mobility devices, Disability observances, Disability organizations, People involved with disability, Disability politics, Disability rights, Disability robots, Disability and sexuality, and Disabled sports”.

Some embodiments comprise chat rooms with one or more disco dedicated topics, including, but not limited to, “Afro/cosmic music, Baby Loves Disco, Disco ball, Beatmatching, The Birds of Paris, Break (music), Club drug, Club Quarter, Disc jockey, Disco Cuttlefish, Disco Demolition Night, Disco Fever, Disco polo, Disco Step-by-Step, Disco: A Decade of Saturday Nights, The Donna Summer Special, Dorian Gray (club), English Disco Lovers, Euro disco, and Four on the floor (music)”.

Some embodiments comprise chat rooms with one or more divorce dedicated topics, including, but not limited to, “Divorce by country, Child custody, Child support, Divorce in Islam, Fathers' rights, Divorce law, Mothers' rights, Whore of Babylon, Works about divorce, Family disruption, Family law, Fathers' rights movement, Fear of commitment, Freiburg Declaration, Get (divorce document), John Gottman, Grey divorce, Grounds for divorce, List of parenting issues affecting separated parents, and Parents' rights movement”.

Some embodiments comprise chat rooms with one or more doctor/surgeon dedicated topics, including, but not limited to, “Doctor-Patient Relationship, Boris Paster, nakWomen in Medicine, Albert Schweitzer, Patient Confidentiality, Patients' Rights, Dr. Seuss (Theodor Geisel), Mentoring in Health Care, Regulating Doctors, The Lost Generation: “Barefoot Doctors” in Post-Reform China, Attitudes and Practices of Doctors toward Spouse Assault Victims: An Australian Study, Barefoot Doctors and Western Medicine in China, Locum Doctors-Curse or Blessing for Hospitals?, Stress among Medical Doctors Working in Public Hospitals of the Ngaka Modiri Molema District (Mafikeng Health Region), North West Province, South Africa, Retaining Doctors in Rural Timor-Leste: A Critical Appraisal of the Opportunities and challenges/Retenir Les Medecins Dans Les Zones Rurales Du Timor-Leste: Une Evaluation Critique Des Opportunites et Des defis/Como Conservar a Los Medicos En Las Zonas Rurales De Timor-Leste: Una Valoracion Critica De Las Oportunidades Y Desafios, Job Satisfaction Amongst Doctors, Work Stressors, Social Support, and Burnout in Junior Doctors: Exploring Direct and Indirect Pathways, How Do Doctors Become Killers?, Making It in British Medicine: Essential Guidance for International Doctors, Anxiety, Depression, and Health Attitudes and Coping Strategies in Doctors and Teachers in a Cape Town Setting”.

Some embodiments comprise chat rooms with one or more group dating dedicated topics, including, but not limited to, “Terminology, Taxonomy, Origin, Biology, Anatomy, Size and weight, Senses, Coat, Tail, Differences from wolves, Health, Lifespan, Reproduction, Neutering, Inbreeding depression, Intelligence, behavior, and communication, Intelligence, Behavior, Communication, and Ecology”.

Some embodiments comprise chat rooms with one or more doll and/or puppets dedicated topics, including, but not limited to, “Admiral Ackbar, The Adventures of Pinocchio, Agro (puppet), Andy Pandy, Avenue Q, Bambang Sumantri, Barkley (Sesame Street), Bernd das Brot, Bertie the Bunyip, HaBigbagim, Billy Brit, Boglin, Charlemane, Cousin Skeeter, Dustin the Turkey, Ed the Sock, Edd the Duck, Emlyn the Gremlyn, Emu (puppet), and Famil-e Door”.

Some embodiments comprise chat rooms with one or more drama movies dedicated topics, including, but not limited to, “Humanity, No one born a racist, Love, Social media, Loyalty of the Dog, Psycho, Education system, Child marriage, Safety of women, Haunted House, Blind people, Any persons life story that is not usually not shown in films but important to our survival, for example barber, truck driver, traffic police, street sweepers etc., Love of mother, Murder mystery, Depression, Life, Human race, AI and automation, Aliens, and Surrogacy”.

Some embodiments comprise chat rooms with one or more drawing dedicated topics, including, but not limited to, “Special Drawing Rights, African-American Art, Teaching Art, Hans Holbein the Younger, Migrant Drawing: Disrupted Spaces & Dispersive Notations, Using Drawing Strategically: Drawing Activities Make Life Science Meaningful to Third- and Fourth-Grade Students, Drawing for Meaning: Students Develop Three-Dimensional Skills through Scientific Drawings, Design Drawing: A Means toward Visual Literacy and the Exploration of Ideas in the Classroom: Drawing Is the Most Immediate and Natural Tool for Generating and Expressing Ideas5. Drawing: The Social Construction of Knowledge, Drawing off the Page: How New 3D Technologies Provide Insight into Cognitive and Pedagogical Assumptions about Mathematics, Drawing Techniques in Assessment: A Summary Review of 60 Survey-Based Studies of Training and Professional Settings, Drawing on the Past for Insight and Direction: Ten Considerations in Legislative and Policy Development for Art Education, Intergenerational Collaborative Drawing: A Research Method for Researching With/about Young Children, Communicating and Thinking through Drawing Activity in Early Childhood, Bordering the Familiar: Drawing Education Legislation in the Northeastern United States, 1871-1876, Thinking and Learning through Drawing in Primary Classrooms, Towards a Theory of Children's Drawing as Social Practice, Look Little, Look Often: The Influence of Gaze Frequency on Drawing Accuracy, Understanding Emirati Children's Drawing in Relation to Self and Identity through the Interaction of Social Context, and Bridging the Spatial Visualization Skills Gap through Engineering Drawing Using the Whole-to-Parts Approach”.

Some embodiments comprise chat rooms with one or more drug dedicated topics, including, but not limited to, “investigational analgesics, Annual pharmaceutical drug sales, Timeline of antibiotics, antidepressants, investigational antidepressants, investigational antipsychotics, antiviral drugs, investigational anxiolytics, Doping at the Asian Games, drugs banned by WADA, combined sex-hormonal preparations, cytochrome P450 modulators, dopaminergic drugs, doping cases in sport, Drug precursors, deaths from drug overdose and intoxication, Drugs controlled by the German Betaubungsmittelgesetz, entheogenic/hallucinogenic species, growth hormone secretagogues, and investigational hormonal agents”.

Some embodiments comprise chat rooms with one or more “drum'n' bass” dedicated topics, including, but not limited to, “Musical features, Influences, Drum and bassline elements, Tempo, Context, Live drum and bass, List of drum and bass artists who perform using live instruments, Subgenres, Regional scenes, Genres influenced by drum and bass, Record labels, Formats and distribution, Purchasing, Distributors (wholesale), Media presence, Radio, Internet radio, North American Radio, Magazines, and Literature”.

Some embodiments comprise chat rooms with one or more eastern studies dedicated topics, including, but not limited to, “Oriental studies, Center for Middle Eastern Studies, Journal of Near Eastern Studies, Eastern Europe, Middle Eastern studies, Centre for Eastern Studies, Jewish studies, Yemen College of Middle Eastern Studies, Journal of Eastern African Studies, The Fares Center for Eastern Mediterranean Studies, UCL School of Slavonic and East European Studies, Krymskyi Institute of Eastern Studies, Orientalism (book) (section Post-colonial Culture Studies), Persian studies, Center for South Asian and Middle Eastern Studies, International Journal of Middle East Studies, Syriac studies, Aramaic studies, Development studies, and Ottoman studies”.

Some embodiments comprise chat rooms with one or more eating disorder dedicated topics, including, but not limited to, “Classification, ICD and DSM, Signs and symptoms, Pro-ana subculture, Psychopathology, Causes, Genetics, Psychological, Personality traits, Celiac disease, Environmental influences, Mechanisms, Diagnosis, Medical, Psychological, Differential diagnoses, Prevention, Treatment, Outcomes, and Epidemiology”.

Some embodiments comprise chat rooms with one or more ecology dedicated topics, including, but not limited to, “ecology by country, Ecology by region, Ecology by taxon, Ecology lists, Artificial ecosystems, Ecology awards, Biocides, Biodegradation, Biodiversity, Biogeochemical cycle, Biogeography, Bioindicators, Biota, Conservation, Ecological data, Deep ecology, Ecological experiments, Ecologists, Ecoregions, and Extinction”.

Some embodiments comprise chat rooms with one or more e-commerce dedicated topics, including, but not limited to, “E-commerce by country, Commerce websites, Companies' terms of service, Computer security, Online content distribution, Cryptocurrencies, Digital currencies, Dot-com bubble, EDI, Electronic funds transfer, Electronic trading systems, Financial cryptography, Free e-commerce software, Internet advertising methods, Merchant services, Micropayment, New economy, Online banking, Online companies, Online payments, and PayPal®”.

Some embodiments comprise chat rooms with one or more economics dedicated topics, including, but not limited to, “Schools of economic thought, Subfields of economics, Economics profession and organizations, Economics lists, Economics catchphrases, Economics curves, Economic data, Economics awards, Economics effects, Economics laws, Marginal concepts, Economics models, Economics paradoxes, Philosophy of economics, Economic puzzles, Economic taxonomy, Economic theories, Economics and time, Works about economics, and Futures and Options”.

Some embodiments comprise chat rooms with one or more education dedicated topics, including, but not limited to, “Attention deficit disorder, Charter schools, College admission policies, College athletes, College tuition planning, Distance education, Diploma mills, Education and funding, Grade inflation, Greek letter societies, Hazing, Home schooling, Intelligence tests, Learning disabilities, Literacy in America, No Child Left Behind, Plagiarism, Prayer in schools, Sex education, and School vouchers”.

Some embodiments comprise chat rooms with one or more electrical engineering dedicated topics, including, but not limited to, “Analog circuits, Audio amplifier specifications, Broadcast engineering, Computer hardware, Computer science, Digital electronics, Display technology, Distributed element circuits, Electrical and electronic engineering awards, Electrical circuits, Electrical diagrams, Electronic circuits, Electronic design, Electronic engineering awards, Electronics engineers, Electronics manufacturing, Flexible electronics, Hardware description languages, Hardware verification languages, and History of electronic engineering”.

Some embodiments comprise chat rooms with one or more electronic device dedicated topics, including, but not limited to, “Audio equipment manufacturers, Audio players, Blu-ray Disc, Calculators, Compact disc, Personal computing, Consumer electronics brands, Consumer electronics retailers, Dashboard head units, Dedicated application electronic devices, Dedicated e-book devices, Digital media players, Digital media receivers, Display devices, DVD, Electronic toys, GPS navigation devices, Home automation, In-car entertainment, Lists of consumer electronics manufacturers, and Mobile phones”.

Some embodiments comprise chat rooms with one or more electronic parts dedicated topics, including, but not limited to, “semiconductors, Diodes, Transistors, Integrated circuits, Optoelectronic devices, Display technologies, Vacuum tubes (valves), Discharge devices, Power sources, Passive components, Resistors, Capacitors, Magnetic (inductive) devices, Memristor, Networks, Transducers, sensors, detectors, Antennas, Assemblies, modules, Prototyping aids, and Electromechanical”.

Some embodiments comprise chat rooms with one or more electronica/IDM dedicated topics, including, but not limited to, “Aeons (duo), Alternative dance, Ambient techno, Amp (TV series), Bitpop, Chilean Electronic Music, Chill-out music, Chiptune, Downtempo, Electronic dance music, Fierce Angel, Folktronica, Funktronica, Glitch (music), Intelligent dance music, Livetronica, Machine-pop, Mixing It, Module file, and Nonclassical”.

Some embodiments comprise chat rooms with one or more embedded systems dedicated topics, including, but not limited to, “Ada (programming language), Automotive software, Avionics, Avionics computers, Digital cameras, Embedded microprocessors, Embedded operating systems, Engine control systems, Firmware, Graphing calculators, Information appliances, Microcontrollers, Microsoft® Auto devices, Onboard computers, Real-time computing, Robotics, Robots, Single-board computers, Smart devices, and Software related to embedded Linux”.

Some embodiments comprise chat rooms with one or more encryption dedicated topics, including, but not limited to, “Cryptography lists and comparisons, Cryptographic algorithms, Applications of cryptography, Cryptographic attacks, Classical cryptography, Cryptography contests, Cryptographers, Disk encryption, Cryptologic education, Cryptographic hardware, History of cryptography, Key management, Kleptography, Cryptography law, National Security Agency cryptography, Cryptography organizations, Post-quantum cryptography, Cryptographic primitives, Cryptographic protocols, Public-key cryptography, and Cryptography publications”.

Some embodiments comprise chat rooms with one or more energy industry dedicated topics, including, but not limited to, “Economics, Management, Classifications, Government, Financial market, Environmental impact, Politics, Policy, Security, Development, Transportation, Crisis, Mergers and Acquisitions, Alternative energy, Canadian Centre for Energy Information, Energetics, Energy accounting, Energy quality, Energy transformation, and Hydrogen economy”.

Some embodiments comprise chat rooms with one or more entertaining dedicated topics, including, but not limited to, “entertainment by continent, Entertainment by country, Entertainment by city, Action (genre), Adult entertainment, Amusement parks, Animals in entertainment, Balloons (entertainment), Cheerleading, Children's entertainment, Comedy, Media and entertainment controversies, Dance, Drama, Entertainers, Entertainment scandals, Entertainment events, and Film”.

Some embodiments comprise chat rooms with one or more entrepreneurship dedicated topics, including, but not limited to, “relationship between small business and entrepreneurship, Types of entrepreneurs, Ethnic, Institutional, Cultural, Feminist, Social, Nascent, Project-based, Millennial, Entrepreneurial behaviors, Uncertainty perception and risk-taking, Coachability and advice taking, Strategies, Designing individual/opportunity nexus, Opportunity perception and biases, Styles, Communication, Links to sea piracy, and Psychological makeup”.

Some embodiments comprise chat rooms with one or more environment dedicated topics, including, but not limited to, “Environment (biophysical), the physical and biological factors along with their chemical interactions that affect an organism or a group of organisms, Environmental epidemiology, Environmental health, Environmental psychology, Environment (biology), Environment (thermology), Environment (systems), the surroundings of a physical system that may interact with the system by exchanging mass, energy, or other properties, Natural environment or physical environment, in ecology, consisting of all living and non-living things, Environmental art, Environmental determinism, Environmental engineering, Environmental movement, Environmental policy, Environmental quality, Environmental science, the study of the interactions among the physical, chemical, and biological components of the environment, Environmental sustainability, Bachelor of Environment (disambiguation), Environment Act (disambiguation), Environmental Science Research Project Topic Ideas Help, and Reasons why a Dissertation Topic won't be Approved”.

Some embodiments comprise chat rooms with one or more equestrian/horses dedicated topics, including, but not limited to, “equestrians by competition, Equestrians by nationality, Female equestrians, Male equestrians, Carriage drivers, Dressage riders, Dressage trainers, Event riders, People in horse racing, Horse trainers, Hunt seat riders, Jockeys, LGBT equestrians, Medalists in equestrian, Paralympic equestrians, Show jumping riders, Show jumping trainers, Equestrian biography stubs, Equestrian sports, and Equestrian statue”.

Some embodiments comprise chat rooms with one or more ergonomics dedicated topics, including, but not limited to, “accessibility, Adapted automobiles, Anthropometry, Cognitive ergonomics, Ergonomics companies, Organizational ergonomics, Physical ergonomics, Posture, Usability, Human factors and ergonomics, Human Factors in Engineering and Design, Human factors integration, Human performance technology, Human-machine system, The Chartered Institute of Ergonomics and Human Factors, International Conference on Applied Human Factors and Ergonomics, International Ergonomics Association, Manual handling of loads, Matte display, and Monitor filter”.

Some embodiments comprise chat rooms with one or more erotic literature dedicated topics, including, but not limited to, “Arabic erotic literature, BDSM literature, Erotic fiction, Greco-Roman erotic literature, Erotica magazines, Erotic poetry, Erotic publishers, Erotic literature, Sadism and masochism in fiction, Adult (magazine), A Carne, De figuris Veneris, Dinosaur erotica, Enfer, Hooker with a heart of gold, Milesian tale, I Modi, Monster erotica, My Life and Loves, and Selfish (book)”.

Some embodiments comprise chat rooms with one or more ethics dedicated topics, including, but not limited to, “Issues in ethics, Advice (opinion), Applied ethics, Aristotelianism, Concepts in ethics, Environmental philosophy, Ethical consumerism, Ethical theories, Ethicists, Ethics organizations, History of ethics, Ethics lists, Ethics literature, Meta-ethics, Moral psychology, Morality, Moral philosophers, Philosophers of ethics and morality, Philosophy of love, and Population ethics”.

Some embodiments comprise chat rooms with one or more ethnic music dedicated topics, including, but not limited to, “Traditional folk music, Definitions, Characteristics, Terminology, Origins, Subject matter, Folk song transformations and variations, Regional forms, Early folk music, fieldwork and scholarship, 19th-century Europe, North America, National and regional forms, Folk music revivals, First British folk revival, Contemporary folk music, Festivals, Citations, Opera, Different Era's in music, and Music in Films”.

Some embodiments comprise chat rooms with one or more Europe dedicated topics, including, but not limited to, “Contemporary definition, History of the concept, Prehistory, Classical antiquity, Early Middle Ages, High and Late Middle Ages, Early modern period, 18th and 19th centuries, 20th century to the present, Geography, Climate, Geology, Flora, Fauna, Politics, List of states and territories, Economy, Economic history, Demographics, and Adaptation”.

Some embodiments comprise chat rooms with one or more evolution dedicated topics, including, but not limited to, “Classical times, Medieval, Pre-Darwinian, Darwinian revolution, Pangenesis and heredity, The ‘modern synthesis’, Further syntheses, Heredity, Variation, Mutation, Sex and recombination, Gene flow, Mechanisms, Natural selection, Biased mutation, Genetic drift, Genetic hitchhiking, Gene flow, and Outcomes, Adaptation”.

Some embodiments comprise chat rooms with one or more exotic pets dedicated topics, including, but not limited to, “Use of Ultrasonography in Wildlife Species, Dangerous Animal Crisis Management, Poisonings in the Captive Reptile, Ophthalmology of Exotic Pets, Avian and Exotic Animal Dermatology, Diagnostic Imaging, Ketoconazole, Infectious Disease Scenarios, Some animals kept as exotic pets, Issues, Legality, Trafficking, Impact on the world, Health, Husbandry, Risk to humans, Primates, AMPHIBIANS, Ophthalmology of Exotic Pets, and Exotic animals are increasingly being kept as pets in American homes”.

Some embodiments comprise chat rooms with one or more extreme sports dedicated topics, including, but not limited to, “BASE jumping, BMX, Bodyboarding[citation needed, Bungee jumping, Canyoning[citation needed, Cave diving, Climbing, Extreme pogo, Extreme skiing, Extreme ironing, Flow—riding[citation needed, Freediving, Free-flying, Freeride, Free-running, Free-skiing [citation needed, Freestyle scootering[citation needed, Freestyle skiing, Hang gliding, and Ice climbing”.

Some embodiments comprise chat rooms with one or more Facebook® dedicated topics, including, but not limited to, “Advertising Agency, Architect, Art Restoration, Artistic Services, Broadcasting & Media Production, Entertainment Service, Fashion Designer, Graphic Design, Image Consultant, Market Research Consultant, Marketing Consultant, Modeling Agency, Movie & Television Studio, Music Production, Photographer, Arts & Marketing, Photographic Services & Equipment, Public Relations, Publisher, and Screen Printing & Embroidery”.

Some embodiments comprise chat rooms with one or more family dedicated topics, including, but not limited to, “Family by continent, Family by country, Families, Adoption, fostering, orphan care and displacement, Childhood, Cousins, Divorce, Domestic violence, Familicides, Family businesses, Family economics, Family in fiction, Family member holidays, Family planning, Family therapy, Feminism and the family, Filial piety, Foster care, Housewives, and Family-in-law”.

Some embodiments comprise chat rooms with one or more fantasy book dedicated topics, including, but not limited to, “Fantasy books by series, Fantasy anthologies, Paranormal romance anthologies, Encyclopedias of fictional worlds, Fantasy graphic novels, Fantasy role-playing game supplements, Fantasy gamebooks, Lists of fantasy books, Fantasy novels, Science fantasy literature (Fantasy short story collections, Fantasy books by fictional universe, Fantasy book stubs, The Carnelian Throne, The Castle of the Otter, The Cottingley Secret, Crazy Hair, Crooked Kingdom, Singhasan Battisi, and The Snail and the Whale”.

Some embodiments comprise chat rooms with one or more fashoin dedicated topics, including, but not limited to, “Fashion by nationality, Fashion accessories, Fashion aesthetics, Anti-fashion, Fashion awards, Beauty, Body art, Body modification, Clothing, Fashion design, Fashion dolls, Fashion events, Fashion industry, Fashion-related fetishism, Footwear) Hairstyles, High fashion brands, History of fashion, Fashion illustrators s, and Jeans”.

Some embodiments comprise chat rooms with one or more feminism dedicated topics, including, but not limited to, “Apoism, Feminism and the arts, Criticism of feminism, Feminist economics, Feminism and education, Feminist events, Feminist movements and ideologies, Fourth-wave feminism, Gender studies, Feminism and health, Feminism and history, LGBT and feminism, Men and feminism, Feminist movement, Feminist organizations, People associated with feminism, Feminist philosophy, Sexual harassment in the United States, Feminism and sexuality, and Feminism and society”.

Some embodiments comprise chat rooms with one or more figure skating dedicated topics, including, but not limited to, “Figure skating by city, Figure skating by continent, Figure skating by country, Figure skating competitions, Figure skating disciplines, Doping cases in figure skating, Figure skating elements, Figure skating equipment, Ice shows, Figure skating-related lists, Figure skating media, Figure skating museums and halls of fame, Figure skating organisations, Figure skating people, Figure skating reality television series, Figure skating records and statistics, Seasons in figure skating, Figure skating venues, Figure skating video games, and Years in figure skating”.

Some embodiments comprise chat rooms with one or more film noir dedicated topics, including, but not limited to, “Cinematic sources, Literary sources, Classic period, Overview, Directors and the business of noir, Outside the United States, Neo-noir and echoes of the classic mode, Science fiction noir, Parodies, Identifying characteristics, Visual style, Structure and narrational devices, Plots, characters, and settings, Worldview, morality, and tone, Color film noir, Feminist Film Criticism, More Than Night: Film Noir in Its Contexts, Hollywood's Dark Cinema: The American Film Noir, Nightmare Alley: Film Noir and the American Dream, and Psychology in American Film Noir and Hitchcock's Gothic Thrillers”.

Some embodiments comprise chat rooms with one or more filmmaking dedicated topics, including, but not limited to, “Amateur filmmaking, Animation, Cars designed and produced for films, Choreographed combat, Cinematography, Filmmaking collaborations, Film companies, Film and video terminology, Filmmakers, Filmmaking pioneers, Filmmaking occupations), Film production, Screenwriting, Stock footage, Film studios, Cinematic techniques, Film and video technology, Works about filmmaking, Works with live action and animation, and Filmmaking stubs”.

Some embodiments comprise chat rooms with one or more financial planning dedicated topics, including, but not limited to, “Chartered Financial Planner, Preet Banerjee, William Bengen, Matthew S. Collier, Tony De Thomasis, Spike Dudley, Wim Duisenberg, Financial planner, Financial Planners in Malaysia, Jacob Gold, Deena Katz, Elaine King, Piet Lieftinck, Sora Ma, Ed Mieszkowski, Clark Scarff, and Dave Yeske”.

Some embodiments comprise chat rooms with one or more fine arts dedicated topics, including, but not limited to, “Cultural perspectives, Visual arts, Two-dimensional works, Painting and drawing, Mosaics, Printmaking, Calligraphy, Photography, Three-dimensional works, Architecture, Pottery, Sculpture, Conceptual art, Poetry, Music, Performing Arts, Dance, Theatre, Film, and Celebrating the Arts: A Children's Fine Arts Festival”.

Some embodiments comprise chat rooms with one or more Firefox dedicated topics, including, but not limited to, “Naxos Music Library World, Connotea, Protecting Patron Privacy on the Internet, News Readers and Other Handy Utilities, Open-Source Software on the Desktop, ShareStream, Firefox add-ons, Features of Firefox, Firefox Focus, Firefox for Android, Firefox for iOS, Firefox Portable, Template:Firefox release compatibility, Firefox version history, History of Firefox, Java Embedding Plugin, Mozilla Archive Format, Mozilla localizations, Netscape (web browser), and A Guide for Librarians, Researchers and Educators, 2nd Ed”.

Some embodiments comprise chat rooms with one or more fish dedicated topics, including, but not limited to, “Fish by year of formal description, Fish by adaptation, Fish anatomy, Fish common names, Fish conservation, Fish cell lines, Fish in heraldry, Fish by habitat, Fish health, Fish and humans, Lists of fishes, Fish by location, Fish physiology, Fish reproduction, Fish taxa, Fish redirects, Fish stubs, Fish, Outline of fish, and Blind fish”.

Some embodiments comprise chat rooms with one or more fishing dedicated topics, including, but not limited to, “Fishing by continent, Fishing by country, Fishing and the environment, Fishing equipment, Fisheries, Fishers, Fishing conflicts, Fishing organizations, History of fishing, Fishing industry, Fishing knots, Fishing museums, Nets (devices), Fish ponds, Recreational fishing, Fishing techniques and methods, Works about fishing, Works and media about fishing, Fishing stubs, and Fishing navigational boxes”.

Some embodiments comprise chat rooms with one or more fitness dedicated topics, including, but not limited to, “High-Intensity Interval Training, Group Training, Wearable Technology, Bodyweight Training, Strength Training, Educated, Certified, and Experienced Fitness Professionals, Yoga, Personal Training, Fitness Programs for Older Adults, Functional Fitness, The Best Workout Tank Tops That Show Off Your Back, Educated, certified, and experienced fitness professionals, Strength training, Exercise Is Medicine, Measurement in Physical Education, Physical Fitness in Prepubescent Children, Managing a Growing Business, Aerobic Fitness Thresholds Associated with Fifth Grade Academic Achievement, Physical Fitness Test Administration Practices and Students' Cognitive Understanding of Physical Fitness, and Fitness Participants Perceived Quality by Age and Practiced Activity”.

Some embodiments comprise chat rooms with one or more fly fishing dedicated topics, including, but not limited to, “Endemic fish of the Neretva basin, Krusnica river, Neretva, Ugar basin, Una (Sava) basin, Upper Neretva, Vrbas basin, Dan Bailey (conservationist), Bamboo fly rod, Bibliography of fly fishing, Bibliography of fly fishing (fly tying, stories, fiction), Bibliography of fly fishing (species related), Blacker's Art of Fly Making, Book of the Black Bass, A Book on Angling, Megan Boyd, Joe Brooks (fly fisherman), Fly Fishers International, Fly fishing, and Fly Fishing (book)”.

Some embodiments comprise chat rooms with one or more folk music dedicated topics, including, but not limited to, “Folk music by country, Folk albums, Folk music awards, Contemporary folk music, Folk music discographies, Folk festivals, Folk music navigational boxes, Folk music genres, Folk music groups, Folk music instruments, Folk music media, Folk musicians, Folk music organizations, Folk record labels, Folk songs, Folk music venues, Folk instrument, Folk process, Haydn and folk music, and North American folk music traditions”.

Some embodiments comprise chat rooms with one or more food and cooking dedicated topics, including, but not limited to, “Foods by cooking technique, Prepared foods by main ingredient, Animal feed, Appetizers, Breads, Chocolate, Cold foods, Condiments, Confectionery, Convenience foods, Culinary dishes, Dairy products, Desserts, Dips (food), Dried foods, Dumplings, Edible algae, Edible gels, Edible plants, and Eggs”.

Some embodiments comprise chat rooms with one or more “for kids” dedicated topics, including, but not limited to, “Child labour, Child pretenders, Child prodigies, Feral children, Fictional children, Illegitimate children of monarchs, Kidnapped children, Missing children, Murdered children, Children of peers and peeresses, People who were expelled from school, Pseudonymous children, Royal children, Child soldiers, Teenage single-handed circumnavigating sailors, Twin children, Bangladesh Shishu Academy, Child Friendly Spaces, Child health and nutrition in Africa, Child-Friendly Constituency, and Childhood in war”.

Some embodiments comprise chat rooms with one or more foreign film dedicated topics, including, but not limited to, “American remakes of Argentine films, American remakes of British films, American remakes of Canadian films, American remakes of Danish films, American remakes of Dutch films, American remakes of French films, American remakes of German films, American remakes of Hong Kong films, American remakes of Italian films, American remakes of Japanese films, American remakes of Mexican films, American remakes of Norwegian films, American remakes of South Korean films, American remakes of Spanish films, American remakes of Swedish films, American remakes of Thai films, The Angriest Man in Brooklyn, Bachelor Mother, Between Us Girls, Broken Horses, and A Common Man (film)”.

Some embodiments comprise chat rooms with one or more forensics dedicated topics, including, but not limited to, “forensic disciplines, Causes of death, Counter forensics, Forensic equipment, Forensic evidence, Forensic facilities, Forensic genetics, Forensic pathology, Forensic science journals, Forensic occupations, Forensics organizations, Forensic phenomena, Forensic science in popular culture, Forensic scientists, Forensic techniques, Academic works about forensics, Works about forensics, Forensics stubs, Forensic Interviews, Forensic Psychology, and Crime Scene Investigation”.

Some embodiments comprise chat rooms with one or more forestry dedicated topics, including, but not limited to, “Forestry by continent, Forestry by country, Deforestation, Dendrology, Documentary films about forests and trees, Forest ecology, Forestry education, Forestry and the environment, Forestry equipment, Forestry events, Forest museums, Forestry initiatives, Forestry journals, Forestry-related lists, Logging, Lumberjack sports, Forest management, Forest products, Pulp and paper industry, Forestry research, and Seeds”.

Some embodiments comprise chat rooms with one or more forums dedicated topics, including, but not limited to, “Aviation Internet forums, Bulletin board systems, Craigslist, Crime forums, Entertainment Internet forums, Internet forum hosting, Internet forums by country, LGBT-related Internet forums, Political Internet forums, Question-and-answer websites, Reddit, Slashdot, Internet forum software, Sport Internet forums, Subreddits, Internet forum terminology, Usenet, Should the government censor information?, Should the government provide health care?, and Should the military be allowed to recruit at high schools?”

Some embodiments comprise chat rooms with one or more France dedicated topics, including, but not limited to, “Standard naming scheme, Alternative words for Germans, Request for information on Monaco—EU relations, Re: Economy of Paris disputed content, Louis XIV of France, DYK, Congres du Parlement frangais, French scientist Biography, Translation Citation, Proposed WikiProject France, French people in the colonies, Recent created articles, List of castles in France—request for suggestions, Saint-Martin and Saint-Barthelemy, Big 1848 project, Working on French colonial history: need cat advice, Polish-French relations, WikiProject Francophonie?, RfC notification, and Jacques Rivette”.

Some embodiments comprise chat rooms with one or more funk dedicated topics, including, but not limited to, “Etymology, Characteristics, Rhythm and tempo, Harmony, Improvisation, Instruments and vocals, Bass, Drums, Electric guitar, Keyboards, Vocals and lyrics, Other instruments, Costumes and style, New Orleans, P-Funk: Parliament-Funkadelic, Jazz funk, Headhunters, On the Corner, 1980s and synthesizer funk, and Late 1980s to present”.

Some embodiments comprise chat rooms with one or more futurism dedicated topics, including, but not limited to, “New York World's Fair, Dror Benshetrit, Warren Ellis, Futurism (literature), Futurist Painting: Technical Manifesto, I Saw the FIG. 5 in Gold, Indigenous Futurisms, Invitation to a Beheading, Manifesto of Futurism, Filippo Tommaso Marinetti, Christopher R. W. Nevinson, Oberiu, Panfuturism, Russian Futurism, Futurism by genre, Futurism by region, Futurist architects, Futurist artists, Contimporanul, and Futurist movements”.

Some embodiments comprise chat rooms with one or more gadgets dedicated topics, including, but not limited to, “Audio equipment manufacturers, Audio players, Blu-ray Disc, Calculators, Compact disc, Personal computing, Consumer electronics brands, Consumer electronics retailers, Dashboard head units, Dedicated application electronic devices, Dedicated e-book devices, Digital media players, Digital media receivers, Display devices, DVD, Electronic toys, GPS navigation devices, Home automation, In-car entertainment, Lists of consumer electronics manufacturers, and Mobile phones”.

Some embodiments comprise chat rooms with one or more gambling dedicated topics, including, but not limited to, “Gambling by country, Casinos, Gambling companies, Gaming devices, Gambling mathematics, Gambling ships, Gambling games, Online gambling, Gambling people, Gambling regulation, Gambling and society, Gambling technology, Gambling terminology, Wagering, Works about gambling, Gambling stubs, Insurance, Asset recovery, Types, and Casino games”.

Some embodiments comprise chat rooms with one or more gardening dedicated topics, including, but not limited to, “ancient times, The Middle Ages, Cottage gardens, Garden features and accessories, Comparison with farming, Gardens as art, Social aspects, Garden pests, Garden pest control, Garden Guns, The Middle Ages, Cottage gardens, Garden sharing, Community gardening, Container gardening, Water gardening, Native plant gardening, Gardens as art, Garden pests, and horticulture and gardening books”.

Some embodiments comprise chat rooms with one or more gay culture dedicated topics, including, but not limited to, “gay art, Gay bathhouses, Bear (gay culture), Gay male erotica, Fictional gay males, Gay effeminacy, Gay events, Gay male BDSM, Gay masculinity, Gay (male) media, Gay men's organizations, Pederasty, Gay culture in the United States, Gay male culture, Relationships, Online culture and communities, Lesbian culture, Bisexual culture, Transgender culture, and Online culture and communities”.

Some embodiments comprise chat rooms with one or more genealogy dedicated topics, including, but not limited to, “American genealogy, Czech genealogy, Indian genealogy, Irish genealogy, Korean genealogy, Nigerian genealogy, Russian genealogy, Serbian genealogy, Slovak genealogy, Sri Lankan genealogy, Syrian genealogy, Ukrainian genealogy, Academic genealogies, British genealogy, Causes of death, Censuses, Genealogy and The Church of Jesus Christ of Latter-day Saints, Family associations, Family coats of arms, and Family history”.

Some embodiments comprise chat rooms with one or more genetics dedicated topics, including, but not limited to, “Genetics by country, Genetics by type of organism, Algae biomass producers, Applied genetics, Genetics awards, Behavioural genetics, Biobanks, Chromosomes, Classical genetics, Cloning, Congenital disorders, Cytogenetics, Genetics databases, Genetics education, Genetic engineering, Epigenetics, Genetics experiments, Genes, Genetic anomalies, and Geneticists”.

Some embodiments comprise chat rooms with one or more geography dedicated topics, including, but not limited to, “Geography by place, Geographers, Geography-related lists, Geography awards, Branches of geography, Geographic classifications, Geography conferences, Geography education, Environmental studies, Exploration, Geocodes, Geographic data and information, Geographical superlatives, Geographical zones, Geography competitions, History of geography, Land systems, Landscape, Natural disasters in North Carolina, and Navigation”.

Some embodiments comprise chat rooms with one or more geoscience dedicated topics, including, but not limited to, “Fields of study, Earth's interior, Earth's atmosphere, Earth's magnetic field, Methodology, Earth's spheres, Partial list of the major earth science topics, Atmosphere, Biosphere, Hydrosphere, Lithosphere (geosphere), Pedosphere, Systems, A new, modern, era for research, The structure of the Earth, Global temperatures and climate change, Heritage, Environmental Health, Natural Hazards, and Construction & Engineering”.

Some embodiments comprise chat rooms with one or more Germany dedicated topics, including, but not limited to, “Buildings and structures in Germany, Communications in Germany, German culture, Deafness in Germany, Economy of Germany, Education in Germany, Environment of Germany, Events in Germany, Geography of Germany, Germany portals, Government of Germany, Health in Germany, History of Germany, Housing in Germany, Missing person cases in Germany, Organizations based in Germany, German people, Politics of Germany, Regions of Germany, and Religion in Germany”.

Some embodiments comprise chat rooms with one or more Glaucoma dedicated topics, including, but not limited to, “Signs and symptoms, Causes, Dietary, Ethnicity, Genetics, Other, Pathophysiology, Diagnosis, Primary glaucoma and its variants, Developmental glaucoma, Secondary glaucoma, Absolute glaucoma, Types, Screening, Treatment, Medication, Laser, Surgery, Prognosis, and Epidemiology”.

Some embodiments comprise chat rooms with one or more golf dedicated topics, including, but not limited to, “Golf by city, Golf by continent, Golf by country, Golf-related lists, Women's golf, Amata Friendship Cup (Amateur golf, Golf associations, Golf awards, Golf clubs and courses, Golf equipment, Forms of golf, History of golf, Golf instruction, Junior golf, Golf logos, Golf media, Golf museums and halls of fame, Golf people, and Pitch and putt”.

Some embodiments comprise chat rooms with one or more gospel music dedicated topics, including, but not limited to, “gospel albums, Gospel music associations, Gospel music awards, Gospel music genres, Gospel music festivals, Gospel music lists, Gospel music media, Gospel musicians, Gospel songs, Gospel music stubs, Style, Roots and background, Gospel music genres and subgenres, Christian country music, British Black Gospel, Comparison to other hymnody, Bibliography, Get Happy (gospel music), Gospel Aerobics, and Gospel Music Heritage Month”.

Some embodiments comprise chat rooms with one or more goth culture dedicated topics, including, but not limited to, “Music, Origins and development, Gothic genre, Art, historical and cultural influences, Visual art influences, 20th century influences, 21st century, Characteristics of the scene, Icons, Fashion, Influences, Styling, Reciprocity, Critique, Films, Books and magazines, Graphic art, Events, Interior design, and Sociology”.

Some embodiments comprise chat rooms with one or more government dedicated topics, including, but not limited to, “Government by city, Government by continent, Government by country, Government by region, Local government, National governments, Governments of country subdivisions, Forms of government, Government institutions, Executive branches of government, Judiciaries, Legislatures, Government agencies, Active citizenship, Administrative divisions, Appointments, Government audit, Governance and civic leadership awards, Government buildings, and Caretaker governments”.

Some embodiments comprise chat rooms with one or more graphic designs dedicated topics, including, but not limited to, “graphic designers, Albums by cover artist, Color, Cover art awards, Film and television opening sequences, Graphic poetry, Graphics, Infographics, Lithography, Logos, News design, Patterns, Printing, Printmaking, Graphic design schools, Graphics software, Graphic design studios, Template generators, Typography, and Graphic designer stubs”.

Some embodiments comprise chat rooms with one or more guitar dedicated topics, including, but not limited to, “acoustic guitars, Bass guitars, Classical guitar, Guitar competitions, Electric guitars, Guitar literature, Guitar magazines, Guitar parts and accessories, Guitar performance techniques, Guitar synthesizers, Guitar video games, Guitarists, Individual guitars, Jazz guitar, Guitar makers, Guitar manufacturing companies, Semi-acoustic guitars, Guitar-related software, Steel guitar, and Guitar tunings”.

Some embodiments comprise chat rooms with one or more guns dedicated topics, including, but not limited to, “Etymology, Operating principle, Components, Barrel, Projectile, Terminology, Types, Military, Machine guns, Handguns, Autocannon, Artillery, Tank, Hunting, Rescue equipment, Training and entertainment, Energy, Automatic shotgun, Long gun, and Arquebus”.

Some embodiments comprise chat rooms with one or more gymnastics dedicated topics, including, but not limited to, “Gymnastics by city, Gymnastics by continent, Gymnastics by country, Gymnastics-related lists, Men's gymnastics, Women's gymnastics, Acrobatic gymnastics, Aerobic gymnastics, Aesthetic group gymnastics, Gymnastics apparatus, Artistic gymnastics, Cheerleading, Gymnastics competitions, History of Gymnastics, Gymnastics logos, Gymnastics maneuvers, Gymnastics media, National gymnastics teams, Gymnastics organizations and Gymnastics people”.

Some embodiments comprise chat rooms with one or more hacking dedicated topics, including, but not limited to, “white Hat Hacker. This type of hacker is benign, Black Hat Hacker. The opposites of White Hats, Black Hats are the “bad” hackers, Grey Hat Hacker. The last main category of hackers is a mix of both first ones, Virus, Computer worm, Spyware, Hijacker, Trojan horse, Email, Ransomware, Phishing, Hacking by year, Advanced persistent threat, Hacker conventions, Email hacking, Hacker groups, Hackers in video games, Hacking of Yahoo!, Hacker magazines, and Phreaking”.

Some embodiments comprise chat rooms with one or more health dedicated topics, including, but not limited to, “Potential issues, Mental health, Maintaining, Diet, Exercise, Sleep, Role of science, Role of public health, Self-care strategies, Occupational, Income and social status, Social support networks, Education and literacy, Employment/working conditions, Social environments, Physical environments, Personal health practices and coping skills, Healthy child development, Biology and genetics, and Health care services”.

Some embodiments comprise chat rooms with one or more heart condition dedicated topics, including, but not limited to, “Acute Coronary Syndrome, Angina, Aortic Aneurysm, Aortic Valve Regurgitation, Aortic Valve Stenosis, Atherosclerosis, Atrial Fibrillation, Bradycardia, Breast Cancer Treatment and Your Heart, Cancer Treatment and Exercise, Cardio-Oncology, Cardiomyopathy, Chemotherapy and Your Heart, Congenital Heart Defects, Coronary Artery Disease, Deep Vein Thrombosis, Diabetes (Type 2 Diabetes), Diabetes and Heart Disease, Dilated Cardiomyopathy, and Endocarditis”.

Some embodiments comprise chat rooms with one or more heavy metal dedicated topics, including, but not limited to, “Heavy metal albums, Heavy metal concerts, Heavy metal discographies, Heavy metal genres, Heavy metal by location, Heavy metal media, Heavy metal musical groups, Heavy metal musicians, Heavy metal performance techniques, Heavy metal producers, Heavy metal record labels, Heavy metal songs, Heavy metal subculture, Timelines of heavy metal, Heavy metal stubs, Disney Super Guitar, Heavy metal lyrics, Trap metal, Portal:Heavy metal, and Template:Heavy metal music”.

Some embodiments comprise chat rooms with one or more hedonism dedicated topics, including, but not limited to, “Etymology and lexicon, History of development, Sumerian civilization, Ancient Egypt, Classic schools of antiquity, Cyrenaic school, Epicureanism, Yangism, Judaism, Christianity, Hinduism, Utilitarianism, Libertinage, Contemporary approaches, Michel Onfray, Abolitionism, Hedonism as a scientific basis for long-term future forecasting, Criticisms, and Islamic criticisms”.

Some embodiments comprise chat rooms with one or more Hentai Anime dedicated topics, including, but not limited to, “Adventure Kid, Akiba Girls, Aki Sora, Alien from the Darkness, Angel, Angel Blade[1], Angels in the Court, Angel of Darkness, Another Lady Innocent, Beat Angel Escalayer, Behind Closed Doors, Bible Black series, Blood Royale, Boku no Pico (Yaoi), Bondage Mansion, Barabanba, Campus, Call Me Tonight, Cream Lemon, and Crimson Climax[1]”.

Some embodiments comprise chat rooms with one or more hiking dedicated topics, including, but not limited to, “Significant hiking destinations, Long-distance hiking, Equipment, Environmental impact, Etiquette, Hazards, See also, Types, Trails, Related activities, Dog hiking, Glacier hiking, Llama hiking, Nordic Walking, Scrambling, Swim-hiking, Waterfalling, Trails, and Related activities”.

Some embodiments comprise chat rooms with one or more Hinduism dedicated topics, including, but not limited to, “Women in Hinduism, Hindu Nationalism, Reincarnation, Dharma, Sri Aurobindo Ghose, Indian Art, Typology, Indigenous understanding, Western understanding, Diversity and unity, Diversity, Sense of unity, Beliefs, Purusharthas (objectives of human life), Karma and samsara, Moksha, Concept of God, Authority, and Main traditions”.

Some embodiments comprise chat rooms with one or more hip-hop and/or rap dedicated topics, including, but not limited to, “Alternative Rap, Bounce, Dirty South, East Coast Rap, Gangsta Rap, Hardcore Rap, Hip-Hop, Latin Rap, Old School Rap, Rap, Underground Rap, West Coast Rap, Origin of the term, Precursors, Origins, Introduction of rapping, Jamaican origins of outdoor sound systems, Influence of disco, and Transition to recording”.

Some embodiments comprise chat rooms with one or more history dedicated topics, including, but not limited to, “Etymology, Description, History and prehistory, Historiography, Philosophy of history, Historical methods, Marxian theory of history, Areas of study, Periods, Prehistoric periodization, Geographical locations, Military history, History of religion, Social history, Subfields, Cultural history, Diplomatic history, Economic history, Environmental history, and World history”.

Some embodiments comprise chat rooms with one or more hockey dedicated topics, including, but not limited to, “shoulder pads, Jockstrap with cup pocket and protective cup, Hockey stick, Puck or ball, Bandy, Field hockey, Ice hockey, Ice sledge hockey, Roller hockey (inline), Roller hockey (quad), Street hockey, Other forms of hockey, Hockey Proves Therapeutic for Veterans, This Hockey Honey Isn't Impressed, Special Hockey. (Athletics), Hockey Lockout Chills Canuck TV Networks, Charles Schulz: Hockey's Late Bloomer, Ice Hockey Leads to Thaw towards the Classics, Hockey Time Is Here!, and Hockey Writers Give NHL Players High Marks”.

Some embodiments comprise chat rooms with one or more home business dedicated topics, including, but not limited to, “Freelance Writer. If you're a great writer, then you could make a great freelance writer, Virtual Assistant, Researcher and Fact-Checker, Social Media Manager, Blogger and Affiliate Marketer, Freelance Designer, Freelance Coder, Online Thrifter, Data Entry Guru, College Consultant, Online Tutor, Minority Business Success, Business Valuation, Your Plan for Small Business Success, African American Business History, The Girls' Guide to Building a Million-Dollar Business, Divergent Capitalisms, The Financing of Small Business, Competitive Intelligence, and 25 Strategies for Business Success”.

Some embodiments comprise chat rooms with one or more home improvement dedicated topics, including, but not limited to, “upgrading heating, Upgrading with luxuries, Plumbing and electrical, Waterproofing basements, Soundproofing, Maintenance, Roof tear-off, New construction windows, Concrete and masonry, Repainting fences, Repairing plumbing and electrical, Wall papers, Furniture polish, Additional space, Additional living space, Turning marginal areas, Safety and preparedness, Burglar alarm systems, Security, and Storm cellars as protection”.

Some embodiments comprise chat rooms with one or more homebrewing dedicated topics, including, but not limited to, “Altbier, Amber ale, Barley wine, Berliner Weisse, Biere de Garde, Bitter, Blonde Ale, Bock, Brown ale, California Common/Steam Beer, Cream Ale, Dortmunder Export, Doppelbock, Dunkel, Dunkelweizen, Eisbock, Flanders red ale, Golden/Summer ale, Gose, and Gueuze”.

Some embodiments comprise chat rooms with one or more homemaking dedicated topics, including, but not limited to, “homemaking and Marriage—19th Century, Homemaking and Marriage—20th Century, Homemaking and Marriage—21st Century, Housekeeping, Cooking, Cleaning, Laundry, Maintenance, Home maintenance, Lawn maintenance, Management, House organization, Interior design, De-cluttering, Household purchasing, Servants, Work strategies, Household production, and Wages for housework”.

Some embodiments comprise chat rooms with one or more homeschooling dedicated topics, including, but not limited to, “Motivations, Teaching methods, Informal learning, Structured versus unstructured, Unit studies, All-in-one curricula, Unschooling and natural learning, Autonomous learning, Homeschool cooperatives, Research, 5Test results, 5Outcomes, 5Debate about outcomes, 5Socialization, General criticism, International status and statistics, International status and statistics—Australia, International status and statistics-Brazil, International status and statistics-Canada, and International status and statistics-Israel”.

Some embodiments comprise chat rooms with one or more horror movie dedicated topics, including, but not limited to, “like split movie+4, Possession, Slasher, Found Footage and Point of View, Ghost, Zombie, Haunted House, Urban Legend, Cat and Mouse, Alien Lifeforms, The Newcomers, Dark, Revenge, Backwoods, Psychopathic, Monster, Drama, Body Horror, Torture Porn, and Vampire”.

Some embodiments comprise chat rooms with one or more hotel dedicated topics, including, but not limited to, “luxury hotels, Lifestyle resorts, Full-service, Boutique, Focused or select service, Economy and limited service, Extended stay, Timeshare and destination clubs, Motel, Microstay, Management, Unique and specialty hotels, Historic inns and boutique hotels, Resort hotels, Other speciality hotels, Bunker hotels, Cave hotels, Cliff hotels, Capsule hotels, Day room hotels, and Garden hotels”.

Some embodiments comprise chat rooms with one or more house music dedicated topics, including, but not limited to, “characteristics, Influences and precursors, Origins (1980s), Chicago house, Origins of the term, Lyrical themes, Regional scenes (1980s-1990s), Detroit sound: 1986-1989, UK: 1986-early 1990s, US: late 1980s-early 1990s, The Jersey Sound, Most expensive purchase, Late 1980s-1990s, 21st century, Events6.17, Overwater hotels, Records, Largest, Oldest, and Long term residence”.

Some embodiments comprise chat rooms with one or more humanitarianism dedicated topics, including, but not limited to, “Consortium of British Humanitarian Agencies, Geneva Conventions, Good Samaritan, Human rights, Humanism, Humanitarian Accountability Partnership International, Humanitarian aid, Humanitarian education, Humanitarian principles, Humanitarian-political, Homaranismo, Humanity (virtue), International humanitarian law, Misanthrope (partial opposite), Mundialization, Philanthropy, World citizen, World Humanitarian Day, Emergency response, and Digital humanitarianism”.

Some embodiments comprise chat rooms with one or more humanities dedicated topics, including, but not limited to, “Anthropology, Archaeology, Area studies, Art history, Arts, Humanities awards, Humanities bibliographies, Books, Calligraphy, Chronology, Comedy, Humanities conferences, Digital humanities, Disability studies, Drama, Humanities education, Entertainment, Environmental humanities, Ethnic studies, and Fiction”.

Some embodiments comprise chat rooms with one or more humor dedicated topics, including, but not limited to, “Sociological factors, Ancient Greece, India, In Arabic and Persian culture, Caribbean, China, Social transformation model, Physical attractiveness, Psychological well-being, Physiological effects, In the workplace, Studies, Laughter, Health, Ageing, Physiology, Formula, Root components, Methods, and Behavior, place and size”.

Some embodiments comprise chat rooms with one or more hunting dedicated topics, including, but not limited to, “Lower to Middle Paleolithic, Upper Paleolithic to Mesolithic, Neolithic and Antiquity, Pastoral and agricultural societies, Use of dogs, Religion, Indian and Eastern religions, Christianity, Judaism, and Islam, National traditions, New Zealand, Shikar (Indian subcontinent), Safari, United Kingdom, Shooting traditions, United States, Shooting, Regulation, Varmint hunting, Fair chase, and Ranches”.

Some embodiments comprise chat rooms with one or more information technology dedicated topics, including, but not limited to, “Computing, Data processing, Health information technology, Information and communications technology (ICT), Information management, Journal of Cases on Information Technology, Knowledge society, List of the largest information technology companies, Outline of information technology, Computer science, History of computer technology, Electronic data processing, Data storage, Databases, Data retrieval, Data transmission, Data manipulation, Perspectives, Academic perspective, and Commercial and employment perspective”.

Some embodiments comprise chat rooms with one or more independent film dedicated topics, including, but not limited to, “Edison Trust, Studio system, United Artists and resistance to the studio system, Society of Independent Motion Picture Producers, Low-budget films, Exploitation boom and the MPAA rating system, New Hollywood and independent filmmaking, Outside Hollywood, Independent Cinema movement, Indie film, Internationally, 2010s: digital filmmaking, Technology and independent films in the 1990s-2000s, British Independent Film Awards, Independent Spirit Awards, List of film festivals, and Outline of film”.

Some embodiments comprise chat rooms with one or more India dedicated topics, including, but not limited to, “Ancient India, Medieval India, Early modern India, Modern India, Geography, Biodiversity, Politics and government, Politics, Government, Subdivisions, Foreign, economic and strategic relations, Economy, Industries, Socio-economic challenges, Demographics, Languages, Religions, Culture, Art and architecture, and Literature”.

Some embodiments comprise chat rooms with one or more Indie Rock/Pop dedicated topics, including, but not limited to, “Adult Alternative Pop/Rock, Alternative Country-Rock, Alternative Dance, Alternative Pop/Rock, Ambient Pop, American Underground, British Trad Rock, Britpop, C-86, Chamber Pop, Cocktail, Cold Wave, College Rock, Cowpunk, Darkwave, Dream Pop, Ska-Punk, Skatepunk, Slowcore, and Space Rock”.

Some embodiments comprise chat rooms with one or more industrial design dedicated topics, including, but not limited to, “Industrial Design Schools Specialized Programs, Industrial Design Schools, Industrial Design Technology Degrees, Product Design Engineer, Airline interior design/styling, Transportation design, Tool design, Stencil making, Automobile design, Automobile interior design, Sports equipment design, Design directing, Product photographing, Safety clothing and equipment design, Model building, Lighting design, Furniture reproduction, Glass technology, and Heavy equipment design”.

Some embodiments comprise chat rooms with one or more industrial music dedicated topics, including, but not limited to, “Industrial music groups by nationality, Dark ambient music groups, Electro-industrial music groups, Electronic body music groups, Industrial metal musical groups, Martial industrial groups, Industrial rock musical groups, Industrial music group navigational boxes, Abu Lahab (musical project), Black Sun Productions, Euphorbia (band), Post Scriptvm, Precursors, Industrial Records, Wax Trax! Records, Expansion of the scene, Characteristics and history, Expansion and offshoots (late 1980s and early 1990s), and Mainstream success (1990s and 2000s)”.

Some embodiments comprise chat rooms with one or more industrial messaging dedicated topics, including, but not limited to, “types of telecommunication, Types of telecommunication networks, Aspects of telecommunication transmission, History of telecommunication, Major telecommunications equipment manufacturers, Major telecommunications service providers, Telecommunication organizations, Telecommunication publications, Persons influential in telecommunication, E-mail, Fax, Instant messaging, Radio, Satellite, Telegraphy, Telephony, Television broadcasting, Videoconferencing, VoIP, and Computer networks”.

Some embodiments comprise chat rooms with one or more insurance dedicated topics, including, but not limited to, “Early methods, Modern insurance, Principles, Insurability, Legal, Indemnification, Exclusions, Social effects, Methods of insurance, Insurers' business model, Underwriting and investing, Claims, Marketing, Types, Auto insurance, Gap insurance, Health insurance, Income protection insurance, Casualty insurance, and Life insurance”.

Some embodiments comprise chat rooms with one or more international development dedicated topics, including, but not limited to, “Post World War 2, Theories, Global Goals, Millennium Development Goals, Sustainable Development Goals, Other goals, Concepts, International economic inequality, Dignity, Participation, Appropriateness, Sustainability, Capacity building, Rights-based approach, Practice, Measurement, Migration and remittance, Sectors, Water and sanitation, and Health”.

Some embodiments comprise chat rooms with one or more interior design dedicated topics, including, but not limited to, “Commercial interior design and management, Transition to professional interior design, Expansion, Interior decorators and interior designers, Interior designer, Color in interior design, Specialties, Residential, Commercial, Other, Profession, Education, Working conditions, Styles, Art Deco, Modern Art, Arab Materials, Media popularization, Gallery, and Notable interior decorators”.

Some embodiments comprise chat rooms with one or more Internet dedicated topics, including, but not limited to, “Terminology, History, Governance, Infrastructure, Routing and service tiers, Access, Internet and mobile, Protocols, Services, World Wide Web, Communication, Data transfer, Social impact, Users, Usage, Social networking and entertainment, Electronic business, Telecommuting, Collaborative publishing, and Politics and political revolutions”.

Some embodiments comprise chat rooms with one or more Internet dedicated topics, including, but not limited to, “Introduction. The Internet is a vast place, and the amount of information potentially available is hard to imagine, E-mail, Mailing Lists (LISTSERV), Telnet, Gopher, FTP, World Wide Web, USENET, CSO name server, Mac HQX file, PC binary, Full Text Index (Gopher menu), Telnet Session, Binary File—Event (not in 2.06), Image (other than GIF), MIME multipart/mixed message, TN3270 Session Calendar (not in 2.06), GIF image, and HTML, HyperText Markup Language.”

Some embodiments comprise chat rooms with one or more investing dedicated topics, including, but not limited to, “Stocks, Bonds, Investment Funds, Bank Products, Options, Annuities, Retirement, Saving for Education, Alternative &amp; Complex Products, Blockchain Icon, Commodity Futures, Security Futures, Insurance, Types of investments, Investment strategies, Value investment, Intermediaries and collective investments, Famous investors, Investment valuation, Asset, and Capital accumulation”.

Some embodiments comprise chat rooms with one or more iPOD dedicated topics, including, but not limited to, “Stocks, Bonds, Investment Funds, Bank Products, Options, Annuities, Retirement, Saving for Education, Alternative &amp; Complex Products, Blockchain Icon, Commodity Futures, Security Futures, Insurance, Types of investments, Investment strategies, Value investment, Intermediaries and collective investments, Famous investors, Investment valuation, Asset, and Timeline of iPod models”.

Some embodiments comprise chat rooms with one or more Iraq dedicated topics, including, but not limited to, “Pre-historic era, Ancient Iraq, Bronze Age, Iron Age, Babylonian and Persian periods, Middle Ages, Ottoman Iraq, British administration and independent Kingdom, Republic and Ba'athist Iraq, 2003-2007, 2008-present, Geography, Climate, Government and politics, Law, Military, Foreign relations, Human rights, Administrative divisions, and Economy”.

Some embodiments comprise chat rooms with one or more Ireland dedicated topics, including, but not limited to, “Prehistoric Ireland, Late antiquity and early medieval times, Norman and English invasions, The Kingdom of Ireland, Union with Great Britain, Partition, Politics, Republic of Ireland, Northern Ireland, All-island institutions, Economy, Tourism, Energy, Geography, Climate, Flora and fauna, Impact of agriculture, Demographics, Divisions and settlements, and Migration”.

Some embodiments comprise chat rooms with one or more Islam dedicated topics, including, but not limited to, “Etymology and meaning, Articles of faith, Concept of God, Angels, Revelations, Prophets and sunnah, Resurrection and judgment, Divine will, Acts of worship, Testimony, Prayer, Charity, Fasting, Pilgrimage, Quranic recitation and memorization, Law, Scholars, Schools of jurisprudence, Economics, and Jihad”.

Some embodiments comprise chat rooms with one or more Israel dedicated topics, including, but not limited to, “Prehistory, Antiquity, Classical period, Middle Ages and modern history, Zionism and British Mandate, After World War II, Early years of the State of Israel, Further conflict and peace process, Geography and environment, Tectonics and seismicity, Climate, Demographics, Major urban areas, Language, Religion, Education, Government and politics, Legal system, Administrative divisions, and Israeli-occupied territories”.

Some embodiments comprise chat rooms with one or more Italy dedicated topics, including, but not limited to, “Women in Italy, Italian Fascism, Italian History, Venetian History, Florentine History, Italian Sculpture, Italian Politics and Government, Italian Americans, Prehistory and antiquity, Ancient Rome, Middle Ages, Early Modern, Italian unification, Monarchical period, Fascist regime, Republican Italy, Geography, Waters, Volcanology, and Environment”.

Some embodiments comprise chat rooms with one or more Japan dedicated topics, including, but not limited to, “Ancient Japan, Japan, Prewar Period, Japan, Tokugawa Period, Japan, Meiji Period, Japan, Heian Period, Japan, Kamakura Period, Japan, Nara Period, Japan, Postwar Period, Democracy and Japan, Women in Japan, Buddhism in Japan, Russia—Japan Relations, Allied Occupation of Japan, New Religions of Japan, Christianity in Japan, U.S.—Japan Relations, Japan, World War II Period, Japanese History, Japanese Aesthetics, and Japanese Poetry”.

Some embodiments comprise chat rooms with one or more Java dedicated topics, including, but not limited to, “Etymology, Geography, Natural environment, Administration, History, Hindu-Buddhist kingdoms era, Spread of Islam and rise of Islamic sultanates, Colonial periods, Independence, Demography, Demographic profile, Population development, Ethnicity and culture, Languages, Special Capital Region of Jakarta, Special Region of Yogyakarta, Banten, capital: Serang, West Java, capital: Bandung, Central Java, capital: Semarang, and East Java, capital: Surabaya”.

Some embodiments comprise chat rooms with one or more Jazz dedicated topics, including, but not limited to, “Jazz Musicians (Primary Sources), Thelonious Monk, Duke Ellington, Dizzy Gillespie, Louis Armstrong, Miles Davis, Ragtime Music, Blues Music, John Coltrane, Charles Mingus, 1920's America, Scott Joplin, American Music, African American Music, History of Music, Great Gatsby, Sterling Brown, Harlem Renaissance, Blended African and European music sensibilities, and African rhythmic retention”.

Some embodiments comprise chat rooms with one or more Jewelry dedicated topics, including, but not limited to, “Form and function, Materials and methods, Diamonds, Other gemstones, Metal finishes, Impact on society, History, Prehistory, Europe and the Middle East, Asia, North and South America, Native American, Pacific, Modern, Masonic, Body modification, and Jeweler market”.

Some embodiments comprise chat rooms with one or more journalism dedicated topics, including, but not limited to, “Journalism, Investigative Journalism, Public Journalism, Literary Journalism, Journalism Education, Tabloid Journalism, Yellow Journalism, Journalism History, Sports Journalism, Broadcast Journalism, Blogs and Journalism, Use of Sources in Journalism, Pulitzer Prize, Muckrakers, Diversity in the Newsroom, Democracy and the Media, and Tabloid Newspapers”.

Some embodiments comprise chat rooms with one or more Judaism dedicated topics, including, but not limited to, “Reform Judaism, Conservative Judaism, Orthodox Judaism, Crypto-Judaism, Zionism, Jewish Theology, Jewish Women, Jewish Philosophy, Jewish-Christian Relations, Homosexuality and Religion, Jewish Dietary Laws, Human Rights and the Middle East, Portrayal of Jews in Literature, Isaac (Biblical Figure), Christianity, American Religious History, and Jews in New York”.

Some embodiments comprise chat rooms with one or more Karaoke dedicated topics, including, but not limited to, “1960s: Development of audio-visual-recording devices, 1970s: Development of the karaoke machine, 1980s, 1990s, Technology, Early age, Video games, VCDs, On mobile phones, On computers and the Internet, In automobiles, Alternative playback devices, Terms, In culture, Public places, Asia, North America and Europe, Taiwan, South Korea, and The Philippines”.

Some embodiments comprise chat rooms with one or more kids dedicated topics, including, but not limited to, “Children by nationality, Children by occupation, Children by person, Lists of children, Female children, Child activists, Child beauty pageant contestants, Child labour, Child pretenders, Feral children, Fictional children, Illegitimate children of monarchs, Kidnapped children), Missing children, Murdered children, Children of peers and peeresses, Pseudonymous children, Royal children (2 C, 51 P), Christian child saints (3 C, 67 P), and Child soldiers (5 C, 58 P)”.

Some embodiments comprise chat rooms with one or more Kinesiology dedicated topics, including, but not limited to, “Basics, Principles, Adaptation through exercise, Neuroplasticity, Motor redundancy, Scope of practice, Licensing and regulation, Canada, Health service, History of kinesiology, Technology in kinesiology, Anatomical terms of motion, Exercise physiology, Human musculoskeletal system, Kinanthropometry, Kinesiogenomics, Kinesiological stretching, Mental practice of action, and Motor imagery”.

Some embodiments comprise chat rooms with one or more knitting dedicated topics, including, but not limited to, “Courses and wales, Weft and warp knitting, Knit and purl stitches, Right- and left-plaited stitches, Edges and joins between fabrics, Cables, increases, and lace, Ornamentations and additions, History and culture, Properties of fabrics, Texture, Color, Hand knitting process, Mega knitting, Materials, Yarn, Metal Wire, Glass/Wax, Tools, Needles, and Mega needles”.

Some embodiments comprise chat rooms with one or more Korea dedicated topics, including, but not limited to, “Prehistory and Gojoseon, Proto-Three Kingdoms, Three Kingdoms, North-South States Period, Goryeo dynasty, Joseon dynasty, Korean Empire, Japanese occupation and Japan-Korea Annexation, Division, Korean War, List of heads of state (since 1897), Demographics, Language, Culture and arts, Literature, Music, Religion, Cuisine, Education, and Science and technology”.

Some embodiments comprise chat rooms with one or more landscaping dedicated topics, including, but not limited to, “landscape Painting, Landscape and Community, Chinese Landscape Painting, Thomas Gainsborough, Winslow Homer, John Constable, Claude Monet, Johannes Vermeer, Thomas Cole, Japanese Art, J. M. W. Turner, Understanding the land, Additional information, Health and safety, Important landscaping companies & personalities, See also, and References”.

Some embodiments comprise chat rooms with one or more latin music dedicated topics, including, but not limited to, “Latin pop, Cumbia, Tropical music, Corrido, Norteno, Conjunto, Rumba, Banda music, Rock en espanol, Latin jazz, Grupera, Nueva Canción Chilena, Salsa, Bachata, Tango, Merengue, Latin Pop, Latin Urban Music and Reggaeton, Brazilian Music, and Latin Rock and Alternative Music”.

Some embodiments comprise chat rooms with one or more law dedicated topics, including, but not limited to, “Mainstream definitions, Whether it is possible or desirable to define law, Legal theory, Philosophy, Positive law and non-positive law discussions, Economic analysis, Sociology, Legal methods, Legal systems, Civil law, Common law and equity, Religious law, Sharia law, Legal institutions, Judiciary, Legislature, Executive, Military and police, Bureaucracy, and Legal profession”.

Some embodiments comprise chat rooms with one or more learning disorder dedicated topics, including, but not limited to, “Effects, Causes, Diagnosis, IQ-achievement discrepancy, Response to intervention, Latino English language learners, Spanish-speaking ELL, Assessment, Types, By stage of information processing, By function impaired, Management, Society and culture, School laws, Critique of the medical model, Culture, Social roots of learning disabilities in the U.S, and Contrast with other conditions”.

Some embodiments comprise chat rooms with one or more left-handed dedicated topics, including, but not limited to, “Division of labor, Genetic factors, Epigenetic factors, Prenatal hormone exposure, Prenatal vestibular asymmetry, Ultrasound, Handedness developmental timeline, Correlation with other factors, Intelligence, Early childhood intelligence, Health, Income, Left-handedness and sports, Gender, Sexuality and gender identity, In culture, Negative appeal, International Left-Handers Day, and In other animals”.

Some embodiments comprise chat rooms with one or more lesbian culture dedicated topics, including, but not limited to, “lesbian erotica, Fictional lesbians, Lesbian BDSM, Lesbian culture in Canada, Lesbian culture in the United Kingdom, Lesbian culture in the United States, Lesbian events, Lesbian feminism, Lesbian fiction, Lesbian literature, Lesbian slang, Lesbian-related media, Lesbian organizations, Flying Lesbians, Journal of Lesbian Studies, Les (Vietnam), Les+ Magazine, Lesbian bar, Lesbian bed death, and Lesbian Movement (Denmark)”.

Some embodiments comprise chat rooms with one or more liberal politics dedicated topics, including, but not limited to, “liberalism by continent, Liberalism by country, Liberal arts education, Atlantic Revolutions, Books about liberalism, Classical liberalism, Democracy, Federalism, Habeas corpus, Keynesian economics, LGBT liberalism, Liberal Catholicism, Liberal feminism, Liberal socialism, Liberals (Canada), National liberalism, Liberal organizations, Liberalism and religion, Social liberalism, Spanish confiscation, and Welfare state”.

Some embodiments comprise chat rooms with one or more liberties/rights dedicated topics, including, but not limited to, “Civil liberties by country, History of civil rights and liberties by country, Civil rights protests, Civil rights activists, Civil rights case law, Democratic rights, Education rights, Equality rights, Freedom of expression, Fair trial rights, Feminism, Freedom of information, Jewish political status, Civil rights lawyers, Civil rights and liberties legislation, Linguistic rights, Movements for civil rights, Civil rights organizations, People convicted of depriving others of their civil rights, Prisoners' and ex-prisoners' rights (2 C, 1 P), and Privacy (16 C, 95 P)”.

Some embodiments comprise chat rooms with one or more library resources dedicated topics, including, but not limited to, “Bibliographic databases and indexes, Map collections, Ask a Librarian, Computer booking system, Course reserve, Digital reference, ERAMS, Library instruction, Library makerspace, Map collection, Microform, OverDrive, Inc., Pathfinder (library science), Reference desk, Reference interview, Special collections, Electronic Books, Electronic Dictionaries and Encyclopedias, Journals and eJournals, Official Publications, Online Newspapers, and Referencing Resources”.

Some embodiments comprise chat rooms with one or more lingerie dedicated topics, including, but not limited to, “Neutral Slip, Colorful Babydoll, Slinky Robe, Playful Romper, Lacy Bodysuit, Black Thigh-Highs, Matching Silk Pajamas, Lingerie brands, Lingerie retailers, Bikinis, Brassieres, Corsetry, Hosiery, Lingerie, Babydoll, Basque (clothing), Bodystocking, Boudoir cap, Boyshorts, and Bralessness”.

Some embodiments comprise chat rooms with one or more linguistics dedicated topics, including, but not limited to, “linguistics lists, Linguists, Alien language, Anthropological linguistics, Applied linguistics, Language classification, Cognitive linguistics, Communication theory, Corpus linguistics, Dialectology, Dichotomies, Discourse analysis, Ethnolinguistics, Linguistics events, Grammar, Historical linguistics, History of linguistics, Interlinguistics, Language comparison, and Language contact”.

Some embodiments comprise chat rooms with one or more Linux/Unix dedicated topics, including, but not limited to, “Amdahl UTS, Arch Hurd, BeleniX, Celerra, Coherent (operating system), COSIX, Debian GNU/Hurd, Debian GNU/kFreeBSD, Domain/OS, DragonFly BSD, Fiwix, GeckOS, GNU, GNU Hurd, HeliOS, Idris (operating system), IGUANA Computing, Interactive Systems Corporation, Inspur K-UX, and Kylin (operating system)”.

Some embodiments comprise chat rooms with one or more literature dedicated topics, including, but not limited to, “literary awards by genre and type, Literary characters by genre, Comics by genre, Fiction by genre, Literary genres by country, Novellas by genre, Novels by genre, Poetry by genre, Short stories by genre, Short story collections by genre, Writers by genre, Allegory, Alternative literature, Apocalyptic literature, Children's literature, Christmas literature, Comics, Cyberpunk literature, Decadent literature, and Dialogues”.

Some embodiments comprise chat rooms with one or more live theatre dedicated topics, including, but not limited to, “Theatre by city, Theatre by country, Theatre by culture, Theatre by date, Theatre in Europe, History of theatre, Parts of a theatre, Theatre-related lists, Acting, Alternative theatre, Amateur theatre, Theatre awards, Ballet, Theatre characters, Christmas onstage, Contemporary theatre, Theatre controversies, Costumes, Theatre criticism, Theatre databases, and Drama”.

Some embodiments comprise chat rooms with one or more logic dedicated topics, including, but not limited to, “Abstraction, Ambiguity, Logical consequence, Logical truth, Meaning (philosophy of language), Non-classical logic, Paradoxes, Philosophers of logic, Syntax (logic), Truth, Philosophy of logic, Analytic-synthetic distinction, Argument-deduction-proof distinctions, Maria Baghramian, Begriffsschrift, Rudolf Carnap, Concatenation theory, Critique of Pure Reason, Donald Davidson (philosopher), Dagfinn Follesdal, and Grammaticality”.

Some embodiments comprise chat rooms with one or more lounge music dedicated topics, including, but not limited to, “Exotica, space age pop, jazz, bossa nova, cha-cha-cha, mambo, Polynesian music, swing, Beautiful music, Book cafe, Chillout, Downtempo, Easy listening, Exotica, Space age pop, Crooner, Light music, Nightclub music, Sentimental ballad, and Ultra-Lounge CDs”.

Some embodiments comprise chat rooms with one or more luxury dedicated topics, including, but not limited to, “luxury brands, Luxury hotels, Luxury real estate, Anubhuti coach, Bal Harbour Shops, Black Astrum, Infinity pool, Luisa Via Roma, Luxury box, Luxury goods of China, Millennium Luxury Coaches, Royal Albatross (ship), Superyacht, Luxury Rip-Off, INCENTIVES: Luxury Rewards, Luxury Brands: Dwindling Aspirations, Luxury: The Great American Import, Luxury Takes a Dive, Luxury Goes Undercover, Luxury Brands: Spoiled Goods, and More Than Meets the Eye”.

Some embodiments comprise chat rooms with one or more MacOS dedicated topics, including, but not limited to, “MacOS Server, MacOS APIs, MacOS development, GNUstep-Mac OS X, IOS, MacOS security technology, Screenshots of macOS software, MacOS software, MacOS user interface, List of macOS components, MacOS Server, Activity Monitor, AirDrop, App Store (macOS), Apple Color Emoji, Apple Disk Image, Apple File System, Apple Help Viewer, Apple Icon Image format, and Apple Open Directory”.

Some embodiments comprise chat rooms with one or more agricultural machinery dedicated topics, including, but not limited to, “Historic machinery, Industrial machinery, Lawn and garden tractors, Machine manufacturers, Packaging machinery, Textile machinery, Outline of industrial machinery, Agricultural machinery, Animal engine, Grease fitting, Guarding of Machinery Convention, 1963, Mechanization, Moving parts, Snow blower, Slaying the Jurisprudential Beast: Virginia's Flawed Multi-Factor Approach to Differentiating “Ordinary Building Materials” from “Equipment” and “Machinery” under Code § 8.01-250, Productivity, Machinery and Skills: Clothing Manufacture in Britain and Germany, A Key to Dating Vintage Woodworking Machinery, Waltham Machine Works: Developers of High-Precision Benchtop Automatic Machinery, and Productivity Growth Low in the Oilfield Machinery Industry”.

Some embodiments comprise chat rooms with one or more magic dedicated topics, including, but not limited to, “Magical Realism, The Magic Mountain, History of Magic, Salman Rushdie, Superstition, Voodoo, Harry Potter Controversy, Wolfgang Amadeus Mozart, Bronislaw Malinowski, Oz Series (by L. Frank Baum), Paul Klee, Ancient Magic and Ritual Power, FREE! Studies in Magic from Latin Literature, Magic and Ritual in the Ancient World, Magic in the Roman World: Pagans, Jews, and Christians, Magic and Magicians in the Greco-Roman World, Making Magic: Religion, Magic, and Science in the Modern World, Magic, Witchcraft and the Otherworld: An Anthropology, Magic and Impotence in the Middle Ages, and Jewish Magic and Superstition: A Study in Folk Religion”.

Some embodiments comprise chat rooms with one or more Management/HR dedicated topics, including, but not limited to, “project management by type, Asset management, Brand management, Business process management, Change management, Customer relationship management, Emergency management, Financial management, Hospitality management, Human resource management, Information management, Information technology management, Knowledge management, Natural resource management, Performance management, Product management, Project management, Quality management, Research management, and Risk management”.

Some embodiments comprise chat rooms with one or more manufacturing dedicated topics, including, but not limited to, “manufacturing by country, Artificial materials, Manufacturing buildings and structures, Manufacturing businesspeople, Digital manufacturing, Industrial equipment, Manufactured goods, History of manufacturing, Industrial engineering, Industrial processes, Manufacturing-related lists, Manufacturing software, Space manufacturing, Manufacturing trade associations, Manufacturing trade unions, Unit operations, Waste, Metal Manufacturing: Significant Risks and Hidden Opportunities, Manufacturing Employment, and Manufacturing Employment”.

Some embodiments comprise chat rooms with one or more marine biology dedicated topics, including, but not limited to, “EBSCO Publishing Wades into Oceanography and Marine Biology, [2] Virtual Marine Biology: Using a New Technology for Videoconferencing over the Internet, Students Are Helping a Local Aquarium Conduct Marine Research, Establishing Standards for Aquarium Trade. (Marine Biology), Marine Biology Provides a Link to Catastrophes, Sir John Murray: (1841-1914) the Founder of Modern Oceanography, John Murray Pioneered Research on the Ocean Depths and Oceanic Sediments and Was a Leading Light in Marine Biology, Bleaching Could Help Corals Survive. (Marine Biology), Don't Blubber, It's Biology: Everyone Should Watch a Whale Being Dissected-It Teaches Us about Life, Marine Reserves Bring NZ Waters Back to Life, A Startling New Marine Habitat in Alaska, At Work: MARINE BIOLOGIST, Bay Watchers: One of the Most Biodiverse Marine Environments in the World, Kimbe Bay in Papua New Guinea Is Home to More Than 860 Species of Fish and 400 Species of Hard Coral. the Bay May Soon Be the First Marine Protected Area in the Country in Recognition of Its Incredibly Rich Marine Life, Ocean Rescue: Can We Head off a Marine Cataclysm?, Dijanna Figueroa: From the Lab to the Big Screen: A Marine Biologist Emerges to Co-Star in Aliens of the Deep, Marine Life Research Anchors High-End Computing at Seaside HBCU, Marine Life Research Anchors High-End Computing at Seaside HBCU. (Tech Talk), TECH TALK; Marine Life Research Anchors High-End Computing at Seaside HBCU, Bold Strokes: Marine Wildlife Artist Guy Harvey Nurtures His Cause along with His Business, A First: Scientists Oust a Marine Invader, Sea Change: The World's Commercial Fisheries Are in Terminal Decline. and with the Recent Announcement of the Latest EU Fisheries Council Quotas Drawing the Usual Condemnation from Conservationists, a Group of Scientists Is Now Suggesting That It's Time to Revolutionise the Way in Which Our Marine Resources Are Managed, and The WHOI Marine Mammal Center Is Born”.

Some embodiments comprise chat rooms with one or more marketing dedicated topics, including, but not limited to, “Mark Poster, Mark Rothko, Mark Twain, Gospel of Mark, Mark Van Doren, Mark Twain (Primary Works—Nonfiction), Josephine Preston Peabody (Mrs. Lionel S. Marks), Pudd'nhead Wilson (by Mark Twain), Mark Twain (Primary Works—Novels and Short Stories), Huckleberry Finn, Tom Sawyer, A Connecticut Yankee in King Arthur's Court, Symbolist Poets (Primary Works), Creative Impact Award; from Their Head Office in the Wirral, Webtise Offer an Unmatched Digital Marketing Service, Executive Hiring on Upswing in City/professional-Level Salary Hike Seen, Horizontal Oil and Gas Drilling Gets Legislature's Attention, and Refiners Strive to Make Operations More Adaptable”.

Some embodiments comprise chat rooms with one or more married life dedicated topics, including, but not limited to, “Calls to Discuss Married Priests in UK, How Do Single Non-Married Women Save for Retirement?, For Love or Money: Why Married Men Make More, Marriage Gets Real: Newly Married Same-Sex Couples in Massachusetts Are Fitting In-As Long as They Stay Local and Don't Ask the Feds for Recognition, Gay Men, Straight Lives: Like a Certain Governor, Many Gay Men Married to Women Are Now Coming out, Longing to Live the Life They've Been Missing, Models of Holiness and Married Life: Couple's Beatification Spotlights Marital Sanctity, What's Wrong with Welcoming Back Married Priests?, Married Filing Separate Returns, For Children, A Celebration of Black Married Life, Get Married, Madonna, Married Priests: A Countercultural Witness, Bishops Ask Pope to Allow Married Priests: Faith Life in Peril among Inuit, Dene in Northern Canada, Many Single Women Prefer Married Men, Nuking the Nuclear Family: ‘Married . . . with Children’ Is Crass, Low Class and the Longest-Running Show on TV. Deal with It, Can Married Men and Women Just Be Friends with the Opposite Sex? No. ‘It's Not Impossible; It's Impractical’, Montreal Catholics Vote for Women, Married Men Priests, Married to the STUDIO, Married Priest Celebrating Mass in Saginaw: Parish Cites Canon Law, Invites Priest, Married to the Army, and Celibacy & the Future of the Priesthood: Priests Should Be Married”.

Some embodiments comprise chat rooms with one or more martial arts dedicated topics, including, but not limited to, “martial arts by continent, Martial arts by country, Martial arts by regional origin, Martial arts by type, Martial arts-related lists, Martial arts culture, Martial arts equipment, Martial arts events, Martial arts in fiction, Historical martial arts, Martial arts logos, Martial arts media, Martial arts organizations, Martial arts people, Martial arts ranking, Martial art techniques, Martial arts terminology, Martial arts uniforms, Women's martial arts, and Years in martial arts”.

Some embodiments comprise chat rooms with one or more matchmaking dedicated topics, including, but not limited to, “Jasbina Ahluwalia, Ambiance Matchmaking, Anonymous matching, Arranged marriage, Cupid plc, Dating agency, Dating game show, Genetic matchmaking, Giggem, Kelleher International, Amber Kelleher-Andrews, Lucky and Squash, Mail-order bride, Matrimonial website, Online dating service, Opportunity Network (matchmaking), Romance scam, Romance tours, Shanghai marriage market, Shidduch crisis, and Shidduch crisis”.

Some embodiments comprise chat rooms with one or more mathematics dedicated topics, including, but not limited to, “teaching Mathematics, Mathematics History, Mathematical Psychology, Mathematics Instruction, Philosophy of Mathematics, Mathematical Logic (Symbolic Logic), Mathematical Problem Solving, Women and Mathematics, STEM Education (Science, Technology, Engineering, Mathematics), Metamathematics, Math Anxiety, Claudius Ptolemaeus (Ptolemy), Word Problems, Finance, Kurt Godel, Leon Walras, W. V. Quine, Women in Science, Blaise Pascal, and Michael Dummett”.

Some embodiments comprise chat rooms with one or more mechanical engineering dedicated topics, including, but not limited to, “mechanical engineering awards, Mechanical engineering competitions, Mechanical engineers, Electromagnetic brakes and clutches, Electromechanical engineering, Engine tuning instruments, Firearm construction, Gearless electric drive, History of mechanical engineering, Machinery, Machines, Maintenance, Mechanical designers, Mechanical failure, Mechanical fasteners, Mechanical standards, Mechanical tests, Mechanics, Engineering mechanics, and Mechanisms (engineering)”.

Some embodiments comprise chat rooms with one or more medical science dedicated topics, including, but not limited to, “Academic health science centres, Audiology, Auxology, Biological engineering, Dentistry, Epidemiology, Health physicists, Healthcare journals, Medical research, Medicine, Midwifery, Nursing, Pharmaceutical sciences, Public health, Seventh-day Adventists in health science, Social work, Translational medicine, Veterinary medicine, Science at the Borders: Immigrant Medical Inspection and the Shaping of the Modern Industrial Labor Force, and Moving beyond Consent for Citizen Science in Big Data Health and Medical Research”.

Some embodiments comprise chat rooms with one or more medieval history dedicated topics, including, but not limited to, “Medieval Economic History, Medieval Theater History, Medieval Drama, Medieval Church, History of Music, Chester Cycle, Cathedrals, Hundred Years War, Miracle and Mystery Plays, Epic Vladimir: Medieval History Blockbuster, Christopher Dyer: Daniel Snowman Meets the Historian of Life and Living in Medieval Britain. (Today's History), Living History in Medieval Visby, The Social History of the English Medieval Cathedral, The Great Escape: Medieval Historian Nicholas Orme Believes That the Teaching of History in Britain's Universities Is Better Now Than It Has Ever Been, Why Study the Medieval Past? Janet L. Nelson Argues That the Study of Medieval History in British Schools Is Just What the Twenty-First Century Requires. (Today's History), The Allure of Anne: Alison Weir, Best-Selling Historian of the Medieval and Sixteenth-Century Royal Families, Explains How She First Encountered the Power of History in a Strange Feeling of Identification with Anne Boleyn. (Point of Departure), The Historian as Time Traveler: Ian Mortimer, Who Has Been an Archivist and a Poet before Becoming a Medieval Historian and Biographer, Describes Why a Blend of Empathy and Evidence Is the Key to Getting the Most out of History, The Flavors of the Past: Humors, Class and Religion Ruled Medieval ‘Epicurean Paradise’, Going Medieval, and Going Medieval”.

Some embodiments comprise chat rooms with one or more memorabilia dedicated topics, including, but not limited to, “modeling Markets for Sports Memorabilia, Buttons to Bumper Stickers: Political Campaign Memorabilia: Campaign Memorabilia Can Help Students Connect Past with Present, Heritage, Not Hate? Collecting Black Memorabilia. (Essay), Intercollegiate Student-Athlete Signed Memorabilia: Student-Athletes' Attitudes toward an Untapped Revenue Source, Is That a Real LeBron Ball? RFID and Sports Memorabilia, Diana Memorabilia: Mail Order Values in Popular American Magazines, Stanley Memorabilia, Scrapbooks, Snapshots and Memorabilia: Hidden Archives of Performance, Dance Band Leader Joe Cappo and the Collection of His Memorabilia and Music at Michigan State University, Labour/Left Memorabilia, 1880-1980: A Photographic Presentation, Ecosystemic Shakespeare: Vegetable Memorabilia in the Sonnets, Editor's Notebook, Front Porch, Discriminating Buyers of Baseball Cards: Does Race Affect Value?, The Chips Are In: Enhancing Sports through RFID Technology, Stolen Valour, The Gustav Mahler-Alfred Rose Collection at the University of Western Ontario, Using Racist Images to Combat Racism and Encourage Resistance, Beyond Text: Burns, Byron and Their Material Cultural Afterlife, and Preservation Serendipity: The Gallaudet University Archives and the Veditz Transcription”.

Some embodiments comprise chat rooms with one or more men's issue dedicated topics, including, but not limited to, “The Challenges of Prostate Cancer: A Major Men's Health Issue, New Perspectives on the Maturing Field of Men's Health: Introduction to a Special Conference Issue, Men's Health in the 21st Century, Practical Solutions to Addressing Men's Health Disparities: Guest Editorial, Practical Solutions to Addressing Men's Health Disparities: Guest Editorial, Introduction: The Center for Men's Leadership and Service at Saint John's University, Devising a National Men's Health Policy Document: The Current Challenges to Men's Health in Iran, Men's Health and Well-Being: The Case against a Separate Field, Why Is Men's Health and Well-Being Policy Not Implemented in Australia?, Why Is Men's Health and Well-Being Policy Not Implemented in Australia?, Has the Health System Failed Men? the Perceptions of the Men's Movement on Men's Health in Australia, Men's Perceptions of Masculinities and Sexual Health Risks in Igboland, Nigeria, Older Men's Wellbeing through Community Participation in Australia, Textbook of Men's Mental Health, Men's Health Week: Focus on Obesity, Review of Martin Fischer, Mannermacht Und Mannerleid. Kritische Theologische Mannerforschung Im Kontext Genderperspektivierter Theologie Als Beitrag Zu Einer Gleichstellung der Geschechter [Men's Power and Men's Pain: A Critical Theological Investigation of Men in the Context of a Gender Perspective Theology as a Contribution to Equality of the Sexes] (Gottingen: Edition Ruprecht, 2008), 314 Pp, Involved Fathering and Men's Adult Development: Provisional Balances, The Case for Retaining a Focus on “Masculinities” in Men's Health Research, Gender Matters: Aging Men's Health, and The Coverage of Prostate Cancer and Impotence in Four Popular Men's Magazines (1991-2000)”.

Some embodiments comprise chat rooms with one or more mental health dedicated topics, including, but not limited to, “Religion and Mental Health, Mental Health Policy, Psychiatric Nursing, Child Psychology, Thomas Szasz, Women and Depression, Child Psychiatry, Mental Health First Aid: Addressing Mental Health as a Public Health Priority, Mental Health and Social Services: Results from the School Health Policies and Programs Study 2006, Mental Health Services in Public Schools: A Preliminary Study of School Counselor Perceptions, Mental Health Care Access and Treatment Utilization in African American Communities: An Integrative Care Framework, Mental Health Facilitator (MHF) Service Implementation in Schools in Malawi, Africa: A Strategy for Increasing Community Human Resources, Mental Health Benefits Financed by Employers, Mental Health Law Reform for a New Government in New Brunswick, Integrating Mental Health into Public Health: The Community Mental Health Development Project in India, Transforming Mental Health Care for Older Veterans in the Veterans Health Administration, Mental Health a Major Priority in Reconstruction of Iraq's Health System, Mental Health Financing in Six Eastern European Countries, Mental Health Services in Primary Care: Implications for Clinical Mental Health Counselors and Other Mental Health Providers, and Mental Health and Wellbeing”.

Some embodiments comprise chat rooms with one or more meteorology dedicated topics, including, but not limited to, “Meteorology lists, Atmospheric scientists, Atmosphere of Earth, Atmospheric circulation, Meteorology awards, Branches of meteorology, Climatology, Meteorology competitions, Meteorological concepts, Meteorological data and networks, Sky and weather deities, Meteorological diagrams, Atmospheric dynamics, Earth sciences graphics software, Meteorology and climate education, Meteorology, health and behavior, Meteorology in history, Meteorological indices, Meteorological institutions and stations, and Meteorological instrumentation and equipment”.

Some embodiments comprise chat rooms with one or more Mexico dedicated topics, including, but not limited to, “Colonial Mexico, Yucatan, Mexico History, Mexico City History, Gulf of Mexico, U.S.—Mexico Border, Chihuahua, Mexico History, Women in Mexico, U.S.—Mexico Relations, New Mexico Archaeology, New Mexico History, Mexican Politics and Government, Mexican History, Mexican Economic History, Mexican Emigration to the U.S, Mexican Immigration to the U.S, Francisco Madero, Ancient Mesoamerica, Chaco Canyon, Mexican Revolution, and Maquiladoras”.

Some embodiments comprise chat rooms with one or more microbiology dedicated topics, including, but not limited to, “Antimicrobials, Applied microbiology, Bacteriology, Environmental microbiology, Microbiology equipment, Eukaryotic microbiology, Geomicrobiology, Infectious diseases, Microbiology literature, Microbial growth and nutrition, Microbial population biology, Microbiologists, Microbiology organizations, Microbiology techniques, Microbiology terms, Microorganisms, Secretion, Virology, Microbiology stubs, and The Influenza Enigma: Recent Advances in Microbiology and Molecular Sequencing Have Vastly Improved Our Understanding of How Human Influenza Viruses Evolve and Spread. but Several Unanswered Questions Continue to Vex Researchers”.

Some embodiments comprise chat rooms with one or more Middle East dedicated topics, including, but not limited to, “Oil and the Middle East, Human Rights and the Middle East, Middle East History, Babylonia and Assyria, Arab League, Arab Christians, Islamic Art, Arab-Israeli Conflict, Arab Nationalism, Biochemical Warfare, Ibn Saud, Israeli Foreign Policy, Tigris River, Nuclear Proliferation, Mideast Peace Process, Water and the Arab-Israeli Conflict, Euphrates River, and Fertile Crescent”.

Some embodiments comprise chat rooms with one or more military dedicated topics, including, but not limited to, “Military Strategy, Military Psychology, Military Intelligence, Military Aviation, Military History, Military Leadership, Military Education, Military Justice, Military Tribunals, Military Recruiting, Military Wives, Military Intervention, Military Government, Military and Politics, Latin American Military Regimes, British Military History, Military Families and Stress, Chinese Military History, History of Military Medicine, and Gays in the Military”.

Some embodiments comprise chat rooms with one or more mining/metallurgy dedicated topics, including, but not limited to, “Archaeometallurgy, Bimetal, Corrosion, Deoxidizers, Fusible alloys, History of metallurgy, Intermetallics, Metallurgical facilities, Metallurgical industry by country, Metallurgical processes, Metallurgists, Metallurgical organizations, Professorships in metallurgy and materials science, Acicular ferrite, Alloy, Alloyant, Alpha case, Aluminium alloy inclusions, Aluminothermic reaction, and Amalgamated zinc”.

Some embodiments comprise chat rooms with one or more mobile computing dedicated topics, including, but not limited to, “dedicated application electronic devices, Docking stations, Laptops, Mobile device management, Personal digital assistants, Mobile phones, Pocket computers, Smartphones, Smartwatches, Mobile software, Tablet computers, Ultra Mobile PC, Wearable computers, Barcode system, BlackDog, Bluetooth, Bring your own device, Carputer, Digital Ocean, and Digital textbook”.

Some embodiments comprise chat rooms with one or more Mormon dedicated topics, including, but not limited to, “Mormons and Mormonism, Joseph Smith, Brigham Young, Polygamy, American Religious History, Oneida Community, The Mormon Jesus: A Biography, Benson, Ex-Mormon Cartoonist, Says Romney Not Telling Truth, The Book of Mormon Girl, Better Reporting during the ‘Mormon Moment’, American Crucifixion: The Murder of Joseph Smith and the Fate of the Mormon Church, Romney's Mormon Faith No Presidential Obstacle, Some Say, A Mormon President? the LDS Difference, A Mormon Moment: America's Biggest Homegrown Religion Is Looking More Christian. but It's Still a Different World, Mormon Metamorphosis: The Neglected Story, Mormon Catholicism, It's Mormon in America, Film Looks at Mormon Role in Boosting Prop 8 Defeat of Same-Sex Marriage, America's Next Top Mormon, and Challenging the Mormon Church”.

Some embodiments comprise chat rooms with one or more motor sports dedicated topics, including, but not limited to, “Motorsport by city, Motorsport by continent, Motorsport by country, Motorsport by type, Motorsport-related lists, Auto racing, Motorsport competitions, Motorsports in fiction, History of motorsport, Motorsport logos, Motor racing, Motorboat racing, Motorcycle sport, Motorsport organizations, Off-roading, Motorsport people, Snowmobile racing, Motorsport teams, Motorsport terminology, and Motorsport venues”.

Some embodiments comprise chat rooms with one or more motorcycle dedicated topics, including, but not limited to, “Motorcycles by brand, Motorcycles by country, Motorcycles by engine, Motorcycles by year of introduction, Motorcycles by period, Lists of motorcycles, Motorcycle builders, Motorcycle classifications, Motorcycle designers, Motorcycle dynamics, Electric motorcycles, Fictional motorcycles, Images of motorcycles, Motorcycling media, Motorcycle manufacturers, Motorcycle museums, Motorcycling retailers, Sidecars, Motorcycle technology, and Vehicle law”.

Some embodiments comprise chat rooms with one or more movie dedicated topics, including, but not limited to, “Monster Movies, Silent Movies, Science Fiction Movies, Film Genres, Directing Film and Television, Music in Films, Film History, John Ford (Film Director), American Cinema, War Films, Film Criticism, Motion Picture Industry, Oliver Stone, Spanish Cinema, Cinephilia, Shakespeare on Film, Italian Cinema, British Cinema, The Birth of a Nation, and Horror Films”.

Some embodiments comprise chat rooms with one or more multimedia dedicated topics, including, but not limited to, “Multimedia and Art Education, Multimedia: Finally—a Practical Communication Tool, Multimedia for Everyone, New Multimedia Standard for PCs, Multimedia Computing for Today's Schools, Multimedia Frontiers, Multimedia Technology Report: Broad Spectum Applications Encouraging Competition, Multimedia: A New Technology for the CPA, Multimedia Technology Report: Broad Spectrum Applications Encouraging Competition, Would the Real Multimedia Please Stand Up?, Would the Real Multimedia Please Stand Up?, Student-Generated Multimedia Projects in the Classroom, 3Com Launches Multimedia Laboratory to Help Corporate Customer Adopt Multimedia Applications, Sorting through the Multimedia Maze, Compound Documents, Multimedia, and Edible Information, Report Predicts Multimedia Opportunity Will Be $30 Billion in 1998, A Guide to Multimedia in the Next Millenium, Do-It-Yourself Multimedia, The Magic of Multimedia: And the Courier-Journal Is Just One of Many Newspapers That Discovered the Magic of Multimedia, and Step into Multimedia”.

Some embodiments comprise chat rooms with one or more music dedicated topics, including, but not limited to, “Religious Music, Indian Music, Protest Music, Music Education, German Music, Teaching Music, Popular Music, Reggae Music, Jewish Music, French Music, Church Music, Romantic Music, African Music, Japanese Music, Oriental Music, Chinese Music, Gospel Music, Music Appreciation, Chamber Music, and Baroque Music”.

Some embodiments comprise chat rooms with one or more music composition dedicated topics, including, but not limited to, “A Principled Approach to Teaching Music Composition to Children, Multidimensional Artistic Education: The Mathematical Perspective of Music Composition. Indicative Analysis of Applications in the Work Jalons by Iannis Xenakis, Assessing a Collaborative Online Environment for Music Composition, Women, New Music and the Composition of Becomings, Béla Bartók's Arab Music Research and Composition, Being Well, Being Musical: Music Composition as a Resource and Occupation for Older People, Analyses of Nineteenth- and Twentieth-Century Music, 1940-2000/grawemeyer Award for Music Composition; the First Twenty Years, Suggested Guidelines for the Composition of Vocal Music, Students Learn Composition When Creating Music Videos, The Queer Composition of America's Sound: Gay Modernists, American Music, and National Identity, Composition of Song Accompaniment as a Form of Developing Future Music Teachers' Harmonic Hearing, composition Instruction and Cognitive Performance: Results of a Pilot Study, Children's Musical Empowerment in Two Composition Task Designs, Aural Dictation Affects High Achievement in Sight Singing, Performance and Composition Skills, Exploration of the Cause for the One-Thousand-Year Popularity of the Tang Dynasty Musical Composition, A Parting Tune with a Thrice Repeated Refrain, White Noise: Composition, Colonization, and Colour1, Notes on Composing and Composition, Composition And/or Literature: The End(s) of Education, Erasable Tablets as Tools for Musical Composition, and Integrating Multimodality into Composition Curricula: Survey Methodolgy and Results from a Cccc Research Grant”.

Some embodiments comprise chat rooms with one or more music instruments dedicated topics, including, but not limited to, “3rd bridge guitar, Accordina, Accordion, Accordola, Acoustic bass guitar, Acoustic guitar, Aeolian harp, Aeolsklavier, Agidigbo, Agung/Agong, Agung a tamlang, Ajaeng, Alimba, AlphaSphere, Alphorn, Alto clarinet, Alto horn, Alto sarrusophone, Alto saxophone, and Angelique”.

Some embodiments comprise chat rooms with one or more music theory dedicated topics, including, but not limited to, “Musical analysis, Music diagrams, Musical form, Harmony, Hindustani music theory, Music theory journals, Music theory lists, Mathematics of music, Melody, Microtonality, Music theory templates, Philosophy of music, Pitch (music), Post-tonal music theory, Rhythm and meter, Music semiology, Musical symmetry, Musical techniques, Music textbooks, and Music theorists”.

Some embodiments comprise chat rooms with one or more musical dedicated topics, including, but not limited to, “Religious Music, Indian Music, Protest Music, Music Education, German Music, Teaching Music, Popular Music, Reggae Music, Jewish Music, French Music, Church Music, Romantic Music, African Music, Japanese Music, Oriental Music, Chinese Music, Gospel Music, Music Appreciation, Chamber Music, and Baroque Music”.

Some embodiments comprise chat rooms with one or more musician resources dedicated topics, including, but not limited to, “Fractured Atlas, Musicnomad, Rehearsal space finder, Craigslist, Gigsalad, ReverbNation, Gigmasters, Splitgigs, Sonicbids, Songkick, Bandsintown, GigWish, GigFinder, CDbaby, Dizzyjam, BandPage, BandApp, Music Gorilla, Twitmusic, and Eventful”.

Some embodiments comprise chat rooms with one or more mutual funds dedicated topics, including, but not limited to, “AIM Funds, Allianz, Amana Mutual Funds Trust, American Century Companies, American Funds Distributors, Amundi Pioneer, Asia Frontier Capital, Ave Maria Mutual Funds, Baron Funds, BB&T, BlackRock, BoE Stockbrokers, Bridgeway Capital Management, Calvert Investments, Capital Group Companies, Charles Schwab Corporation, Cheswold Lane Asset Management, Columbia Management Group, Credit Suisse, and Delaware Investments”.

Some embodiments comprise chat rooms with one or more mystery novels dedicated topics, including, but not limited to, “Standard Private Eye, Cozy Mysteries, Classic Detective, Police Procedurals, Hard-Boiled, Hard-Boiled and Soft-Boiled, Cozy Mysteries or “Cozies”, Procedurals, Thrillers/Suspense, Classics, Derivative, Domestic, Investigator type, Location-based, Local interest, Locked Room, Historic, Mult, Noir, and Romantic Suspense”.

Some embodiments comprise chat rooms with one or more mythology dedicated topics, including, but not limited to, “Etiological Myths, Historical Myths, Psychological Myths, Egyptian mythology, Hathor, Greek mythology, Pandora's Box, Chinese myth, Battle of Kurukshetra, Mahabharata, Bhagavad Gita, Pandavas, Arjuna, Homer's Iliad, Mythology and literature, Formation of myths, Myths as depictions of historical events, and Modern mythology”.

Some embodiments comprise chat rooms with one or more nanotechnology dedicated topics, including, but not limited to, “Nanotechnologists, Nanotechnology companies, DNA nanotechnology, Nanotechnology and the environment, Nanotechnology in fiction, Nanotechnology institutions, Lithography (microfabrication), Molecular electronics, Molecular machines, Nanoelectronics, Nanomachines, Nanomaterials, Nanomedicine, Nanotechnology publications, Quantum electronics, Scanning probe microscopy, Silicon photonics, Supramolecular chemistry, Thin films, and Nanotechnology stubs”.

Some embodiments comprise chat rooms with one or more North American dedicated topics, including, but not limited to, “Native American Mythology, Native American Women, Native American Literature, Native American History, Native American Religions, Native American Folklore, Native American Languages, Native American Music, Native American Art, Native American Literature (Primary Works), Native American History (Primary Sources), Media Images of Native Americans, American Indian Education, Pawnee Indians, Crow Indians, Cheyenne Indians, Choctaw Indians, Chippewa (Ojibwa) Indians, Anasazi Indians, and Shawnee”.

Some embodiments comprise chat rooms with one or more nature dedicated topics, including, but not limited to, “Arid Lands, Climate Adaptation and Sustainability, Conservation Biology, Ecohydrology and Biogeochemistry, Ecosystem Services, Fire Ecology, Fisheries Ecology and Management, Geospatial Science and Modeling, Genetics and Molecular Ecology, Global Change Management, Invasive Species, Natural Products Discovery and Development, Plant and Soil Ecology, Population and Community Ecology, Ecology, Management, and Restoration of Rangelands, Remote Sensing, Restoration Ecology, Social Dimensions of Natural Resource Management, Watershed Management, and Wildlife Ecology and Management”.

Some embodiments comprise chat rooms with one or more Netherlands dedicated topics, including, but not limited to, “People by region in the Netherlands, Regions of the Netherlands by province, Dutch Caribbean, Holland, Metropolitan areas of the Netherlands, Achterhoek, Alblasserwaard, Amstelland, Amsterdam metropolitan area, Arnhem-Nijmegen metropolitan area, Batavia (region), Biesbosch National Park, Bommelerwaard, Brabantse Stedenrij, Campine, City Region of Amsterdam, Drechtsteden, Duin-en Bollenstreek, Dutch Caribbean, and Flevopolder”.

Some embodiments comprise chat rooms with one or more network security dedicated topics, including, but not limited to, “Access control, Antivirus and antimalware software, Advanced Malware Protection, Application security, Services for Security, Behavioral analytics, Data loss prevention, Data Loss Prevention, Email security, Firewalls, More about firewalls, Intrusion prevention systems, Learn the fundamentals of IPS (5:48 min), Mobile device security, Mobile Device Management, Network segmentation, Security information and event management, Identity Services Engine with SIEM (PDF—439 KB), VPN, Web security, Web Security Cloud Web Security, and Wireless security”.

Some embodiments comprise chat rooms with one or more neuroscience dedicated topics, including, but not limited to, “Electroencephalography, Intermittent rhythmic delta activity, Category: Neurophysiology, Computational Neuroscience, Translational and Clinical Neuroscience, Neuroscience Research Areas|NYU Langone Health, https:/med.nyu.edu/departments-institutes/neuroscience/research/research-areas, Branches of neuroscience, History of neuroscience, Nervous system, Neuroscience organizations, Persons influential in the field of neuroscience, Related sciences, See also, References, External links, Brain mapping, Electrophysiology, Extracellular recording, Intracellular recording, and Brain stimulation”.

Some embodiments comprise chat rooms with one or more “New Age” dedicated topics, including, but not limited to, “Philosophical, Movement, Influences, Proponents, Historical, Contemporary, Astrology, Social movements, Meditative, Music, Spiritual/religious, Holistic health, Consciousness, Special abilities, Geographic energy centers, Systems of the physical world, Extraterrestrial life, New Age of Enlightenment, The New Age Movement; the Politics of Transcendence, and The New Age of the Sun”.

Some embodiments comprise chat rooms with one or more New York dedicated topics, including, but not limited to, “Immigration and New York, U.S. Civil War and New York, Education in New York, N.Y. City Politics, New York History, New York Times, Jews in New York, Port of New York, Colonial New York, Nineteenth-Century New York, N.Y. Yankees, New York City History, New York School of Poetry, African Americans in New York, Joseph Pulitzer, Rudolph Giuliani, Wall Street, Alex Katz, Franz Kline, and Nelson Rockefeller”.

Some embodiments comprise chat rooms with one or more news (general) dedicated topics, including, but not limited to, “UK Politics, Afghanistan, Crime, Prisoner, The Pope, Pope Francis, The Royal Family, Technology, Space, World News, Iran, MPs' expenses, Weird stories, Road and rail transport, Telegraph Lists, London 2012, Matt cartoon archive, Royal Mail, Religion, and Dinosaurs”.

Some embodiments comprise chat rooms with one or more night-life dedicated topics, including, but not limited to, “Cabaret, Cinemas and movie theaters, Nightclubs, New York City nightlife, Night markets, Nightlife in Paris, Pubs, Bottle service, DesignMyNight.com, Diner, Evening economy, Face control, The Late Shows, Limelight (2011 film), Museums at Night, Nightlife in Bangkok, Nuit Blanche, Pay card, Rush Street (Chicago), Teen Dance Ordinance, and White Night festivals”.

Some embodiments comprise chat rooms with one or more nonprofit/charity dedicated topics, including, but not limited to, “Charities by beneficiaries, Charities by continent, Charities by country, Charities by topic, Founders of charities, Housing associations, International charities, Memorial funds, Mounts of piety, National trusts, Peer-to-peer charities, Charity regulators, Religious charities, Charity scandals, Trustees of charities, Charitable trusts, Welfare and service organizations, Wikipedia categories named after charities, 501(c)(16)—Cooperative Organizations to Finance Crop Operations, and 501(c)(17)—Supplemental Unemployment Benefits Trust”.

Some embodiments comprise chat rooms with one or more nuclear Science dedicated topics, including, but not limited to, “Alpha and proton radioactivity above tin-100, Alpha particles, Analog states, Angular correlations, Asymmetric, pear-shaped nuclei, Atomic nucleus, Beta particles, Beta-delayed neutron emission, Breakdown of shell closure in helium-10, Carbon-nitrogen-oxygen cycles (astrophysics), Chain reaction (physics), Charge symmetry, Charged particle interactions, Chirality in rotating nuclei, Coulomb excitation, Crystal counter, Decay heat, Deep inelastic collisions, Definitive evidence for new elements 113 and 115, and Delayed neutron”.

Some embodiments comprise chat rooms with one or more nursing dedicated topics, including, but not limited to, “Nursing, Nursing Education, Nursing Leadership, Psychiatric Nursing, Nursing Homes, History of Nursing, Nurse-Patient Relationship, Community Health Nursing, Nurses in Wartime, Nurses in the U.S. Civil War, Hildegard Peplau, Home Care, Breastfeeding, History of Military Medicine, Clara Barton, Patient Confidentiality, Patients' Rights, Women in the Military, and Mentoring in Health Care”.

Some embodiments comprise chat rooms with one or more nutrition dedicated topics, including, but not limited to, “Alcohol and health, Animal fats, Animal nutrition, Copper in health, Nutritional deficiencies, Dehydration, Dietary supplements, Dietetics, Diets, Nutritional diseases, Drinking water, Eating behaviors, Food science, Food studies journals, Force-feeding, Human weight, Hunger, Infant feeding, Nutrition and dietetics journals, Medical food, and Nutrients”.

Some embodiments comprise chat rooms with one or more Oceania dedicated topics, including, but not limited to, “Oceanian portals, Australia (continent), Buildings and structures in Oceania, Economy of Oceania, Environment of Oceania, Geography of Oceania, History of Oceania, Law in Oceania, Oceania-related lists, Masks in Oceania, Military in Oceania, Monarchies of Oceania, Oceania ecozone, Organizations based in Oceania, Oceanian people, Politics of Oceania, Oceanian society, Sport in Oceania, Time in Oceania, and Tourist attractions in Oceania”.

Some embodiments comprise chat rooms with one or more oldies Music dedicated topics, including, but not limited to, “1. Oldies Get Younger. (AM/FM), Golden Oldies Band Celebrates Golden Anniversary, Golden Oldies, Golden Newbies Golden Oldies: Will Some of 2002's Smash Hits Receive the Same Long-Lasting Acclaim as a Number of Hollywood Classics Being Reissued in DVD Format? (Entertainment), The Lost Summer: This Is for Us Oldies. Remember When the Summers Lasted Longer Back Then, When All Men Seemed to Wear Hats, and Women Acted like Ladies? Drowning in Music, Choosing the Music That Moves You, The Magic of Music, With a Song in Their Hearts: Music's Power over Dementia, Selling Songs for a Song; Record Labels Want a Bigger Cut of Digital Music Profits, Choice of Music for Hospital Rooms, The Rap on Rap: It's the Hottest Thing in Music. So Why Won't the Industry Pay More for It?, Currents in Today's Music Give Voice to Hope, Holiness and a Sense That It's All OK, What If There Were No Music?, 30/30 Hindsight: Readers Take Aim at Trends in Gear & Music, Sound System Lets Music Fans Customize CDs, The Sound of Music: Public Park and Recreation Directors Sing the Praises of Outdoor Concerts, Music for the Ages, The Sound of MUSIC, and I Can't Live without My Darling iPod; My Music Player Is like a Time Machine: It Takes Me Back to the Days before I Was a Soccer Mom”.

Some embodiments comprise chat rooms with one or more online Games dedicated topics, including, but not limited to, “Sport Games, Shooting Games, Cross-platform online play, Simulation, Board Games, Massively multiplayer online games, First person shooters, Arcade Games, Action and adventure games, Casino Games, Card Games, Strategy Games, Off the Hook: Exploring Reasons for Quitting Playing Online Games in China, Personality and Motivations for Playing Online Games, Early Adolescent Players' Playfulness and Psychological Needs in Online Games, The Motivations of Adolescents Who Are Addicted to Online Games: A Cognitive Perspective, Agreeableness and Leisure Satisfaction in the Context of Online Games, A Time Series Analysis on the Effects of Deregulation on Online Games: A Case of Social Casino in Korea, Effectiveness of Interactive, Online Games in Learning Neuroscience and Students' Perception of the Games as Learning Tools: A Pre-Experimental Study, and An Empirical Study of the Effect of Conscientiousness on Leisure Satisfaction When Playing Online Games”.

Some embodiments comprise chat rooms with one or more open-source dedicated topics, including, but not limited to, “Apache License 2.0, BSD 3-Clause “New” or “Revised” license, BSD 2-Clause “Simplified” or “FreeBSD” license, GNU General Public License (GPL) v3.0, GNU Library or “Lesser” General Public License (LGPL), MIT license, Mozilla Public License 2.0, Common Development and Distribution License, Eclipse Public License, Creative Commons License, Open Source Essentials: What Every Management Accountant Needs to Know about Open Source Systems, Open Source Myth Busters: The Reality Behind Seven Commonly Held Beliefs about Open Source and What Direction They'll Take Your Institution, Open-Source Software in School Libraries, Open Source, Open Learning. Why Open Source Makes Sense for Education, Open Source Software: Navigating the Ecosystem, Open Source Software: Innovation and Disruption, Open Source Becomes More Accessible, Discovering Open Source: Discovery: Using VuFind to Create MnPALS Plus: We Decided to Implement and Work to Enhance an Open Source Set of Discovery Applications to Provide a More Economical Solution for Our Libraries, Open Source Search: Clarity or Confusion?, and Open Source EHRs Offer Time-Intensive Option”.

Some embodiments comprise chat rooms with one or more opera dedicated topics, including, but not limited to, “Opera, Opera History, Metropolitan Opera, Soap Operas, John Gay, Bertolt Brecht, Giacomo Puccini, Richard Strauss, Vocal Music, Gilbert and Sullivan, Media Fandom, Alban Berg, Arnold Schoenberg, John Barth, Chinese Drama, George Frideric Handel, Paul Hindemith, and Russian Music”.

Some embodiments comprise chat rooms with one or more operating System dedicated topics, including, but not limited to, “Batch Operating System, Time-Sharing Operating Systems, Distributed Operating System, Network Operating System, Real-Time Operating System, OS—Overview, OS—Types, OS—Services, OS—Properties, OS—Processes, OS—Process Scheduling, OS—Scheduling algorithms, OS—Multi-threading, OS—Memory Management, OS—Virtual Memory, OS—I/O Hardware, OS—I/O Software, OS—File System, OS—Security, OS—Linux, and OS—Exa”.

Some embodiments comprise chat rooms with one or more options/futures dedicated topics, including, but not limited to, “Calls, Puts, American Style, European Style, Exchange Traded Options, Over The Counter Options, Option Type by Expiration, Option Type by Underlying Security, Employee Stock Options, Cash Settled Options, Exotic Options, Near month in-the-money options, The Protective Put, Stock Options, Weekly Options, Mini-Options, Index options, Mini Index Options, Binary Options, Options on Futures, ES Weekly Options, and ES Weekly Options”.

Some embodiments comprise chat rooms with one or more orthodox dedicated topics, including, but not limited to, “Armenian Apostolic Church. Armenian Patriarch of Constantinople, Coptic Orthodox Church of Alexandria. French Coptic Orthodox Church, Syriac Orthodox Church of Antioch, Malankara Orthodox Syrian Church, Ethiopian Orthodox Tewahedo Church, Eritrean Orthodox Tewahedo Church, Eastern Orthodoxy by country, Eastern Orthodoxy by continent, Eastern Orthodox Christians, Eastern Orthodoxy-related lists, Greek Orthodoxy, Independent Eastern Orthodox denominations, Russian Orthodoxy, Eastern Orthodox Church, Eastern Orthodox belief and doctrine, Eastern Orthodox Christian communities, Eastern Orthodox cemeteries, Eastern Orthodox ecumenical and interfaith relations, Eastern Orthodox education, History of Eastern Orthodoxy, and Eastern Orthodox liturgy”.

Some embodiments comprise chat rooms with one or more outdoors dedicated topics, including, but not limited to, “Hiking and camping, Hunting and fishing, Canoeing, kayaking and rafting, Sailing and motorboating, Biking, Rock Climbing, Horseback riding, Skiing, Restoration and conservation volunteering, Trekking, Wildlife safari, Snorkeling, Angling/fly fishing, Gliding, Safari, Amusement park, Indigenous culture, Outdoor fitness, Rock climbing, Camping, and Scuba diving”.

Some embodiments comprise chat rooms with one or more person-to-person (P2P) dedicated topics, including, but not limited to, “Airbnb, Anonymous P2P, Breathing Games, Car Next Door, Distributed social network, Friend-to-friend, Getaround, GoTenna, GuestToGuest, JustShareIt, List of on-demand companies, Multiven, P2P Foundation, Peer production, Peer support, Peer to peer investing, Peer-to-peer banking, Peer-to-peer carsha, Peer-to-peer insurance, and Peer-to-peer lending”.

Some embodiments comprise chat rooms with one or more “PUP” dedicated topics, including, but not limited to, “Early history, PHP 3 and 4, PUP 5, PHP 6 and Unicode, PUP 7, Release history, Mascot, Syntax, Data types, Functions, PUP Objects, Implementations, Licensing, Development and community, Installation and configuration, Use, and Security”.

Some embodiments comprise chat rooms with one or more paganism dedicated topics, including, but not limited to, “Nomenclature and etymology, Pagan, Hellene, Heathen, Definition, Perception, History, Bronze Age to Early Iron Age, Classical antiquity, Late Antiquity and Christianization, Muhammad and Islamization in Arabia, Early Modern period, Romanticism, Modern Paganism, Ethnic religions of pre-Christian Europe, icca—in all its many forms, neo-Shamanism, neo-Druidism, Asatru and other forms of Norse neopaganism, and neo-Native American practices”.

Some embodiments comprise chat rooms with one or more painting dedicated topics, including, but not limited to, “Genre Painting, Miniature Painting, Portrait Painting, Landscape Painting, Chinese Landscape Painting, Japanese Scroll Painting, Greek Vase Painting, John Constable, Hudson River School, Japanese Art, Buddhist Art, Roman Art, Dutch Art, Indian Art, Persian Art, Psychology of Art, Greek Art, British Art, French Art, and Egyptian Art”.

Some embodiments comprise chat rooms with one or more paleontology dedicated topics, including, but not limited to, “Micropaleontology. Study of microscopic fossils, Paleobotany. Study of fossilized plants. Palynology. Study of pre-historic pollen and spores, Invertebrate Paleontology. Study of invertebrate animal fossils, Vertebrae Paleontology, Study of vertebrae animal fossils, Paleoanthropology, Taphonomy, Ichnology, Subordinate and related fields, Notable paleontologists, History of paleontology, Eighteenth century, First half of the nineteenth century, Second half of the nineteenth century, Some developments in the twentieth century, Dinosaurs, Radiocarbon Dating, Fossils, Paleontology: The Profession, and Paleontology in the National Park Service”.

Some embodiments comprise chat rooms with one or more paranormal dedicated topics, including, but not limited to, “Psychics and Mediums, Ghosts and Poltergeists, Extrasensory Perception (ESP), Etymology, Paranormal subjects, Ghost hunting, Ufology, Cryptozoology, Paranormal research, Anecdotal approach, Parapsychology, Participant-observer approach, Skeptical scientific investigation, Psychology, Neuroscience, Criticism, Belief polls, and Paranormal challenges”.

Some embodiments comprise chat rooms with one or more parenting dedicated topics, including, but not limited to, “Gay Parents, Teenage Parents, Single Parents, Parent-Teacher Relationship, Parents of Teenagers, Parental Participation in Education, Children of Divorced Parents, Motherhood, Child Abduction, Fatherhood, Remarriage, Mothers and Daughters, Child Custody, Childhood, Infertility, Adoption, Children and Death, Kidnapping, Child Support, and Alimony”.

Some embodiments comprise chat rooms with one or more percussion dedicated topics, including, but not limited to, “Function, Percussion notation, Classification, By methods of sound production, Idiophone, Membranophone, Chordophone, Aerophone, By musical function or orchestration, Definite pitch of Music, Indefinite pitch, By prevalence in common knowledge, Conventional or popular, Unconventional, By cultural significance or tradition, Folk percussion instruments, Common drums, By capability of melodic production, By percussive beater, and Names for percussionists”.

Some embodiments comprise chat rooms with one or more performing art dedicated topics, including, but not limited to, “Performers, Types, Theatre, Dance, Music, History, History of Western performing arts, Renaissance, Modern Era, Post-War performance, History of Eastern performing arts, Middle East, Iran, India, China, Thailand, Cambodia, and Japan”.

Some embodiments comprise chat rooms with one or more peripheral devices dedicated topics, including, but not limited to, “Internal & External, Hard drives, Removable disk drives, Floppy disks (1.4 MB), ZIP disks (100/250 MB), CD-ROM (700 MB), DVD-ROM (˜5 GB/side), read only (-ROM), write once (-R), re-writeable (-RW), Combination drive, CD-RW/DVD-ROM, CD-RW/DVD-R, Processing devices, in system unit and are comprised of circuitry, Storage devices -, Communication devices, Keyboards, mouse, trackballs, joysticks, touchpads, light pens, and Dot Pitch”.

Some embodiments comprise chat rooms with one or more “Perl” dedicated topics, including, but not limited to, “Early versions, Early Perl 5, 2000-present, PONIE, Name, Camel symbol, Onion symbol, Raptor symbol, Overview, Features, Design, Applications, Implementation, Availability, Windows, Database interfaces, Comparative performance, Optimizing, Perl community, and State of the Onion”.

Some embodiments comprise chat rooms with one or more personal site dedicated topics, including, but not limited to, “Affiliate, Affiliate agency, Archive site, Attack site, Blog (weblog), Brand-building site, Celebrity website, Comparison shopping website, Crowdfunding website, Click-to-donate site, Community site, Content site, Classified ads site, Corporate website, Dating website, Electronic commerce (e-commerce) site, Fake news website, Forum website, Gallery website, and Government site”.

Some embodiments comprise chat rooms with one or more petroleum dedicated topics, including, but not limited to, “Petroleum Industry, OPEC (Organization of Petroleum Exporting Countries), Oil and Venezuela, Fossil Fuels, BC Oil and Gas Commission, Conradson carbon residue, Decline curve analysis, Deepwater drilling, DeGolyer and MacNaughton, Downstream (petroleum industry), Dry-hole clause, Duplex strainers, Foreign Reports, Foster Natural Gas/Oil Report, Gaffney, Cline & Associates, Greedy Lying Bastards, Gulf Publishing Company, Hart Energy, History of the petroleum industry, and Sadad Ibrahim AI Husseini”.

Some embodiments comprise chat rooms with one or more pet dedicated topics, including, but not limited to, “Aquarium Coral Reefs, Aquarium Plants, Aquarium Tropical Fish, Birds, Cats, Dogs, Horse Breeds, Reptiles, Amphibians, Saltwater Fish, Small Animals, What Pet is Right for Me?, Kinds of pets, Best pets for my lifestyle, Considerations for choosing a pet, Characteristics of the perfect pet, Narrowing down to your pet choice, List of the types of pets, Small parrots: Parakeets, Cockatiels, Lovebirds, Conures, Lorikeets, Large parrots: Amazons, African Greys, Cockatoos, Macaws, Mid-sized parrots: Caiques, Eclectus, Pionus, Meyers Parrot, Red-bellied parrot, Senegal Parrot, Other types of parrots, and Finches”.

Some embodiments comprise chat rooms with one or more pharmacology dedicated topics, including, but not limited to, “Clinical pharmacology, Neuropharmacology, Psychopharmacology, Cardiovascular pharmacology, Pharmacogenetics, Pharmacogenomics, Pharmacoepidemiology, Safety pharmacology, Systems pharmacology, Toxicology, Theoretical pharmacology, Posology, Environmental pharmacology, Experimental pharmacology, Scientific background, Medicine development and safety testing, Drug legislation and safety, and Education”.

Some embodiments comprise chat rooms with one or more philosophy dedicated topics, including, but not limited to, “Analytic Philosophy, Chinese Philosophy, Communist Philosophy, Moral Philosophy, Intentionality (Philosophy), Modern Philosophy, Continental Philosophy, Ancient Philosophy, Medieval Philosophy, Buddhist Philosophy, African Philosophy, European Philosophy, Asian Philosophy, Greek Philosophy, Feminist Philosophy, French Philosophy, Political Philosophy, British Philosophy, American Philosophy, and Western Philosophy”.

Some embodiments comprise chat rooms with one or more photography gear dedicated topics, including, but not limited to, “Camera Tripod. Few camera accessories are as versatile and necessary as a tripod, Remote Shutter Release, Prime Lens, External Flash (Speedlight), AA Batteries+Battery Charger, SD Memory Cards, Camera Cleaning Kit, Camera Strap, Camera Bag, Photography Skills Are More Important Than Gear, Exploring Channels, Blending Element, Opacity, Lock Your Layer, Delving Deeper Into Photoshop, Dribbble, Dafont, Urbanfonts, and Fontspace”.

Some embodiments comprise chat rooms with one or more photography dedicated topics, including, but not limited to, “History of Photography, Ansel Adams, Walker Evans, Alfred Stieglitz, Wedding Photography, Chelsea Cara Photography, Event Photography, Portrait Photography, Product Photography, Fine Art Photography, Fashion Photography, Architectural Photography, Travel Photography, Advertising or Lifestyle Photography, Photojournalism, Pet Photography, Sports Photography, Aerial Photography, Scientific or Specialty Photography, and Stock Photography”.

Some embodiments comprise chat rooms with one or more photoshop dedicated topics, including, but not limited to, “Early history, File format, Plugins, Photoshop tools, Pen tool, Clone Stamp Tool, Shape tools, Measuring and navigation, Selection tools, Cropping, Slicing, Moving, Marquee, Lasso, Magic wand, Eraser, Video editing, 3D extrusion, Mobile integration, and 3D printing tools”.

Some embodiments comprise chat rooms with one or more physical therapy dedicated topics, including, but not limited to, “Pediatric Physical Therapy, Geriatric Physical Therapy, Vestibular Rehabilitation, Neurological Physical Therapy, Orthopedic Physical Therapy, Cardiovascular/Pulmonary Physical Therapy, Cardiovascular and pulmonary physiotherapy, Clinical electrophysiology, Geriatric, Integumentary, Neurological, Orthopedic, Pediatric, Sports, Community Physiotherapy, Women's health, Palliative care, Back pain treatment, Physical therapist-patient collaborative relationship, and Effectiveness”.

Some embodiments comprise chat rooms with one or more physics dedicated topics, including, but not limited to, “Albert Einstein, Handicapped Children, Exercise and Weight Loss, Dating Violence, Quantum mechanics, Optics, and atomic, molecular, and optical physics, Condensed matter physics, High energy/particle physics and nuclear physics, Cosmology, Interdisciplinary fields, Physical Geography, Physical Stereotypes, Philosophy of Physics, Spanking (Physical Punishment), Physical Education and Training, People with Physical Disabilities, Niels Bohr, Corporal Punishment, Oceanography, and Quantum Theory”.

Some embodiments comprise chat rooms with one or more physiology dedicated topics, including, but not limited to, “Comparative physiology, Electrophysiology, Evolutionary physiology, Molecular physiology, Neurophysiology, Physiologists, Acid-base physiology, Animal physiology, Biomechanics, Biomineralization, Biomolecules by physiological function, Cardiovascular physiology, Cells by function, Chemical compounds by physiological function, Circadian rhythm, Electrophysiology, Exercise physiology, Healing, Homeostasis, and Human physiology”.

Some embodiments comprise chat rooms with one or more poetry dedicated topics, including, but not limited to, “Lyric Poetry, Metaphysical Poetry, Teaching Poetry, British Poetry, Children's Poetry, Spanish Poetry, Objectivist Poetry, Confessional Poetry, French Poetry, Victorian Poetry, Russian Poetry, Prose Poetry, Chinese Poetry, Irish Poetry, German Poetry, Japanese Poetry, War Poetry, Elizabethan Poetry, American Poetry, and African Poetry (Primary Sources)”.

Some embodiments comprise chat rooms with one or more poker dedicated topics, including, but not limited to, “Texas Hold'em, Pot-Limit Omaha, 7 Card Stud, Razz, Omaha Hi-Lo, 2-7 Triple Draw, 5 Card Draw, Chinese Poker, Popular poker variants, Mixed poker games, Specific poker variant games, High Chicago or Low Chicago, Follow the Queen, Countdown, Billabong and Shanghai, Guts, Five-O poker, and Kuhn poker”.

Some embodiments comprise chat rooms with one or more political science dedicated topics, including, but not limited to, comparative politics, including area studies, International relations, Political philosophy or political theory, Public administration, Public law, Political science by continent, Political science by country, Subfields of political science, Political science awards, Political communication, Political culture, Political science education, Elite theory, Jurisprudence, Law enforcement theory, Political science organizations, Public opinion, Public policy, Political scientists, and Survey methodology.

Some embodiments comprise chat rooms with one or more politics dedicated topics, including, but not limited to, “Political Corruption, Political Psychology, Political Parties, Political Correctness, Political Theory, Political Machines, Comparative Politics, Political Economy, Political Anthropology, Political Violence, Chicago Politics, Political Communication, Political Novel, Political Science, Political Philosophy, Political Advertising, Political Pundits, Political Geography, Political Realignment, and World Politics”.

Some embodiments comprise chat rooms with one or more pop music dedicated topics, including, but not limited to, “California Sound, Chamber pop, Chillwave, Country pop, Dance-pop, Electroclash, Electropop, Experimental pop, Hypnagogic pop, Indian pop, Latin pop, Space age pop, Afro pop music, Art pop, Avant-pop music, Baroque pop, Beat music, Brill Building songs, Bubblegum pop, and C-pop”.

Some embodiments comprise chat rooms with one or more post-modernism dedicated topics, including, but not limited to, “Postmodern Literature, Jean Baudrillard, Poststructuralism, Genderqueer, Hyperreality, Jacques Lacan, Modernity, Post-structuralism, Postcolonialism, Postmodern feminism, Queer theory, Science and technology studies, Third-wave feminism, Abjection, Alterity, Arborescent, Roy Ascott, Jean Baudrillard, Bigender, and James Brusseau”.

Some embodiments comprise chat rooms with one or more psychiatry dedicated topics, including, but not limited to, “Adolescent Psychiatry, Child Psychiatry, Military Psychology, Forensic Psychology, Thomas Szasz, Psychology of Women, Rollo May, Psychiatry by country, Psychiatrists, Psychiatry academics, Psychiatric assessment, Psychiatry awards, Psychiatry controversies, Psychiatric diagnosis, Psychiatric diseases and disorders, Psychiatry education, Ethics in psychiatry, History of psychiatry, Psychiatric institutions, and Psychiatric jurisprudence”.

Some embodiments comprise chat rooms with one or more psychology dedicated topics, including, but not limited to, “Psychology, Political Psychology, Psychological Assessment, Mathematical Psychology, Analytical Psychology, Adolescent Psychology, Genetic Psychology, Environmental Psychology, Developmental Psychology, Educational Psychology, School Psychology, Media Psychology, Criminal Psychology, Animal Psychology, Social Psychology, Psychological Trauma, Consumer Psychology, Comparative Psychology, Clinical Psychology, and Experimental Psychology”.

Some embodiments comprise chat rooms with one or more punk rock dedicated topics, including, but not limited to, “Afro-punk, Anarcho punk, Art punk, Christian punk, Deathrock, Garage punk, Glam punk, Hardcore punk, Horror punk, Oil, Peace punk, Punk pathetique, Queercore, Riot Grrrl, Skate punk, Street punk, Taqwacore, Trallpunk, Punk rock fusion subgenres, and Spanish raw punk”.

Some embodiments comprise chat rooms with one or more puzzles dedicated topics, including, but not limited to, “puzzle manufacturers, Mazes, Mechanical puzzles, Games media, Word puzzles, Trivia puzzles, Riddles, Pattern Guessing, Anagrams, Puzzle books, Chess problems, Combination puzzles, Puzzle competitions, Cryptography contests, Puzzle designers, Escape rooms, Guessing games, Locked room mysteries, Logic puzzles, and Puzzle magazines”.

Some embodiments comprise chat rooms with one or more quilting dedicated topics, including, but not limited to, “Amish Quilts, Applique Quilts, Autograph Quilts, Baltimore Album or Album Quilts, Charm Quilts, Detail from a charm quilt, Crazy Quilts, Embroidered Quilts, Hawaiian Quilts, Medallion Quilts, Memory Quilt, Miniature Quilts, Patchwork or Pieced Quilts, Pictorial or Story Quilts, Sampler Quilts, T Shirt Quilts, and Whole Cloth Quilts”.

Some embodiments comprise chat rooms with one or more quiz dedicated topics, including, but not limited to, “Arts & Culture, Business & Management, Cars & Vehicles, Computers & Electronics, Current Events, Vocabulary, Education & Science, Entertainment & Music, Food & Drink, Film & Movies, Games & Toys, Garden & Flora, General Knowledge*, Healthcare & Medicine, History, Internet, People & Society, Pets & Animals, and Politics & Government”.

Some embodiments comprise chat rooms with one or more quote dedicated topics, including, but not limited to, “Adversity & Hardship Quotes, Agriculture & Gardening Quotes, Animals & Pets Quotes, Arts & Humanities Quotes, Beauty & Personality Quotes, Behavior & Manners Quotes, Body Language & Actions Quotes, Body Parts Quotes, Business & Economy Quotes, Business & Services Quotes, Celestial Bodies Quotes, Comparision Quotes, Computers & Technology Quotes, Creation & Innovation Quotes, Crime & Law Quotes, Culture & Tradition Quotes, Education & Literacy Quotes, Emotions & Sensations Quotes, Entertainment & Fun Quotes, and Environment & Natural Calamity Quotes”.

Some embodiments comprise chat rooms with one or more racquetball dedicated topics, including, but not limited to, “Equipment, Ball colours, Rules, Scoring, Hinders, Game variations, Shots of the game, Service, Offensive shots, Defensive shots, Strategy, Major competitions and players, US Open, Other championships, Comparison to racketball, here are 5 types of racquetballs; The difference between the balls is primarily speed, The most used ball is blue, Blue balls are good speed balls, and The fastest balls are red and they are basically used for outdoor racquetball”.

Some embodiments comprise chat rooms with one or more radio broadcast dedicated topics, including, but not limited to, “ITU definition, Stations, Types, AM, Shortwave, medium wave and long wave, FM, Pirate radio, Terrestrial digital radio, Extensions, Satellite, Program formats, Aberhart on Social Credit: A Radio Broadcast, Avoiding Slim Reasoning and Shady Results: A Proposal for Indecency and Obscenity Regulation in Radio and Broadcast Television, Pioneer Financial News: National Broadcast Journalist Wilma Soss, NBC Radio, 1954-1980, Pevsner: The Complete Broadcast Talks. Architecture and Art on Radio and Television, 1945-1977/pevsner: The BBC Years. Listening to the Visual Arts, Broadcast History from Many Perspectives, Radio Broadcasting and Schools for the Blind: Existing Programs and Fledgling Student-Run Station at the Arizona State Schools for the Deaf and the Blind, Lost Sound: The Forgotten Art of Radio Storytelling, Kenneth Rexroth and Radio Reading, Edward L. Bliss, Jr.: Broadcast Journalist, Author, and Teacher”.

Some embodiments comprise chat rooms with one or more rave culture dedicated topics, including, but not limited to, “Castlemorton Common Festival, Creamfields, DiY Sound System, The Eclipse (club), Exodus Collective, Fantazia (rave music promoter), Gatecrasher, Genesis '88, Godskitchen, Helter Skelter (rave music promoter), The Orb, Raindance (rave music promoter), Sanctuary Music Arena, Shelley's Laserdome, Spiral Tribe, Sterns Nightclub, Sunrise/Back to the Future, Tilllate, and Tribal Gathering”.

Some embodiments comprise chat rooms with one or more real estate dedicated topics, including, but not limited to, “Residential real estate, Sales and marketing, See also, References, External links, Attached/multi-unit dwellings, Apartment (American English) or Flat (British English), Multi-family house, Terraced house (a. k. a. townhouse or rowhouse), Condominium (American English), Cooperative, Semi-detached dwellings, Duplex, Detached dwellings, Detached house or single-family detached house, Portable dwellings, Mobile homes or residential caravans, Houseboats, and Tents”.

Some embodiments comprise chat rooms with one or more recording gear dedicated topics, including, but not limited to, “Aircraft recorders, Cameras, Computer storage devices, Digital video recorders, Sound recording technology, Tape recording, Accident data recorder, Cassette deck, Chart recorder, Data logger, DTE (direct to edit), DVD recorder, Elektronika VM-12, Event data recorder, Flight recorder, Guard tour patrol system, JVC HR-3300, Linear timecode, Monolog, and MVEDR”.

Some embodiments comprise chat rooms with one or more Reggae dedicated topics, including, but not limited to, “Pre-reggae styles. 1.1 Mento. 1.2 Ska. 1.3 Rocksteady, Early reggae, Roots reggae, Dub, Rockers, Lovers rock, Newer styles and spin-offs. 7.1 Hip hop and rap. 7.2 Dancehall. 7.3 Raggamuffin. 7.4 Reggaeton. 7.5 Reggae fusion, References, Dancehall, Dub music, Reggae fusion, Lovers rock, Ragga, Reggae rock, Reggaeton, Reggae genres, African reggae, Alternative reggaeton, Dancehall, and Dembow”.

Some embodiments comprise chat rooms with one or more relationship dedicated topics, including, but not limited to, “Casual sex, Celibacy, Common-law marriage, Consorts of deities, Relationship counseling, Dating, Extramarital relationships, Kissing, Love, Marriage, Matchmaking, Monogamy, Multiracial affairs, Polyamory, Relationship breakup, Royal favourites, Same-sex relationship, Seduction, Sexual attraction, and Sexual fidelity”.

Some embodiments comprise chat rooms with one or more religion dedicated topics, including, but not limited to, “Comparative Religion, Greek Religion, Natural Religion, Roman Religion, Civil Religion, African Religions, Philosophy of Religion, Anthropology of Religion, Psychology of Religion, Sociology of Religion, Religion and Evolution, Women and Religion, Science and Religion, Religion and Mental Health, Fasting and Religion, Religion in Film, Freedom of Religion, China and Religion, French Wars of Religion, and Communism and Religion”.

Some embodiments comprise chat rooms with one or more research dedicated topics, including, but not limited to, “Communication Research, Research Ethics, Quantitative Research, Advertising Research, Memory Research, Brain Research, Educational Research, Marketing Research, Action Research, Reading Research, Qualitative Research, Operations Research (OR), Stem Cell Research, Information Literacy, Advertising Content Analysis, Databases, Marketing, Information Retrieval (in Computing), Art History, and Endel Tulving”.

Some embodiments comprise chat rooms with one or more restaurant dedicated topics, including, but not limited to, “Ethnic, Fast food, Fast casual, Casual dining, Premium casual, Family style, Fine dining, Variations, Brasserie and bistro, Buffet and smrgsbord, Cafe, Cafeteria, Coffee House, Destination restaurant, Greasy spoon, Tabletop cooking, Mongolian barbecue, Pub, Teppanyaki-style, and Paper Writing”.

Some embodiments comprise chat rooms with one or more restoration dedicated topics, including, but not limited to, “Restoration Comedy, Restoration Drama, English Restoration, French Restoration, Restorative Justice, Religious Freedom Restoration Act (RFRA), British Drama, Mary White Rowlandson, Archaeology, Architectural conservation, Art and cultural repatriation, Art technological sources, Collections care, Conservation and restoration training, Conservator-restorers, Corrosion prevention, Crafts, Cultural heritage conservation, Digital preservation, and Film preservation”.

Some embodiments comprise chat rooms with one or more robotics dedicated topics, including, but not limited to, “robotics by company, Robotics by country, History of robotics, Adaptable robotics, Agricultural robotics, Robot architectures, Articulated robotics, BEAM robotics, Bio-robotics, Cloud robotics, Robotics concepts, Robot control, Cyborgs, Entertainment robotics, Robotics events, Robotics hardware, Healthcare robotics, Home automation, Industrial robotics, and Laws of robotics”.

Some embodiments comprise chat rooms with one or more rock music dedicated topics, including, but not limited to, “Adult Alternative Rock, American Trad Rock, Arena Rock, Blues-Rock, British Invasion, Death Metal/Black Metal, Glam Rock, Hair Metal, Hard Rock, Metal, Jam Bands, Prog-Rock/Art Rock, Psychedelic, Rock & Roll, Rockabilly, Roots Rock, Singer/Songwriter, Southern Rock, Surf, and Tex-Mex”.

Some embodiments comprise chat rooms with one or more rodeo dedicated topics, including, but not limited to, “Etymology, History of rodeo, Women, Competitive events, Timed events, Roping, Other timed events, Rough stock competition, Less common events, Other activities, Governing organizations in the United States, Canada, Minority participation in the United States and Canada, Latin America, Mexico, Colombia and Venezuela, Brazil, Argentina, Chile, and Australia”.

Some embodiments comprise chat rooms with one or more role playing games dedicated topics, including, but not limited to, “Purpose, Varieties, Tabletop, Live action, Electronic media, Single-player, Multiplayer, People, Gamemaster, Player character, Non-player character10, Rodeos worldwide, Rodeo associations, Portal.Role-playing games, Role-playing game terms, Gaming conventions, History of role-playing games, Timeline of role-playing games, List of role-playing game artists, and List of designers of role-playing games”.

Some embodiments comprise chat rooms with one or more romance novels dedicated topics, including, but not limited to, “Development, Rise of the category romance, The beginnings of American romance fiction, Category romance adapts, Further change, Critical attention, Formats, Category romance, Single-title romances, Subgenres, Contemporary romance, Historical romance, Romantic suspense, Paranormal romance, Science fiction romance, Fantasy romance, Time-travel romances, Inspirational romance, Multicultural romance, and Erotic romance”.

Some embodiments comprise chat rooms with one or more rugby dedicated topics, including, but not limited to, “American flag rugby, Barette (sport), Beach rugby, Mini rugby, Samoa rules, Rugby sevens, Snow rugby, Tag rugby, Rugby tens, Touch rugby, Wheelchair rugby, Women's rugby union, Rugby sevens, Rugby tens, Wheelchair rugby, and Women's rugby union”.

Some embodiments comprise chat rooms with one or more running dedicated topics, including, but not limited to, “Footstrike, Midstance, Propulsion phase, Swing phase, Upper extremity function, Footstrike debate, Stride length, hip and knee function, Elements of good running technique, Upright posture and a slight forward lean, Stride rate and types, Benefits of running, Cardiovascular benefits, Weight loss benefits, Mental Health, Running injuries, High impact, Chafing, Iliotibial Band Syndrome, Medial Tibial Stress Syndrome, and Running events”.

Some embodiments comprise chat rooms with one or more Russia dedicated topics, including, but not limited to, “Tsarist Russia, Privatization in Russia, Islam in Russia, Democracy and Russia, Russia—Japan Relations, Education in Russia, Great Britain—Russia Relations, U.S.—Russia Relations, Serfdom in Russia, Nationalism in Russia, Women in Russia, Alexander II (Tsar of Russia), Jews in Eastern Europe and Russia, Russian Revolution, Nicholas II, Russian History, Russian Civil War, Russian Federation, Vladimir Putin, and Chechnya”.

Some embodiments comprise chat rooms with one or more “SEO” dedicated topics, including, but not limited to, “Title of the website, Meta Description, robots.txt file, XML site map, Header Tags, SEO Friendly URL Test, Image Alt Test, Page Authority, 301 redirection test, website URL mobile friendly nature, Domain Authority, Google®. Search Results Preview, Articles Submissions, Forum Submissions, Events Submissions, Press Release Submissions, Social Bookmarking Submissions, Search Engine Submissions, Business Listings, and Question and Answers Submissions”.

Some embodiments comprise chat rooms with one or more sailing dedicated topics, including, but not limited to, “Compass Work, Financial Aspects of Sailing, Knots, Masters Sailing, New to Sailing, Online Sailing Games and Simulators, Other Great Sailing Videos, Racing Rules of Sailing, Sail Training, Sailing Terms: a Glossary, Sports Medicine for Sailors, and Sportsmanship”.

Some embodiments comprise chat rooms with one or more satire dedicated topics, including, but not limited to, “Satire by country, Ironic and humorous awards, Black comedy, Caricature, Editorial cartooning, Fratire, Satirical games, Iambic poets, Parodies, Political satire, Religious parodies and satires, Ritual clowns, Roast (comedy), Satirical works, Satirists, Her Kind (poem), High comedy, Satirical hip hop, In at the Death, and Grotesque body”.

Some embodiments comprise chat rooms with one or more science dedicated topics, including, but not limited to, “Scientific disciplines, Science-related lists, Scientists, Science books, Scientific buildings, Scientific classification, Scientific comparisons, Science education, Scientific exploration, Scientific folklore, Fringe science, Scientific instruments, Scientific laws, Scientific method, Natural history, Natural philosophy, Science occupations, Open science, Facilities and organizations of science, and Scientific organizations”.

Some embodiments comprise chat rooms with one or more science fiction dedicated topics, including, but not limited to, “Elements, International examples, Subgenres, Related genres, Alternative terms, See also, References, Sources, External links, Overarching themes, Beings, Body and mind alterations, Habitats, Political themes, Technologies, Travel, See also, and References”.

Some embodiments comprise chat rooms with one or more scientology dedicated topics, including, but not limited to, “Celebrities, Criminal Involvement, News, Controversies and Background, Hubbard, L. Ron, McPherson, Lisa, Miscavige, David, Narconon, News Videos, Personal Stories, Real Estate, Scientology Litigation, Scientology Programs, Scientology Sued, Scientology's Private Investigators, Stress Tests and the E-Meter, Study Tech/Applied Scholastics, Thought Reform, and Volunteer Ministers”.

Some embodiments comprise chat rooms with one or more scouting dedicated topics, including, but not limited to, “Fingerprinting, Rifle Shooting, Archery, Leatherwork, Wilderness Survival, Wood Carving, Kayaking, Canoeing, Chess, and Fishing”.

Some embodiments comprise chat rooms with one or more scrapbooking dedicated topics, including, but not limited to, “Use a Map for a Background, Cut Fun Photos into Shapes, Ditch the Glue, Add an Envelope for Bits and Bobs, Press Flowers for a Pop of Color, Two Words: Washi Tape, Embroider Your Journey, Use Paint Chips, Re-purpose Photo Scraps, Create a Visual Photo Grid, Turn Photos Into Text, Break Out the Watercolors, Don't Forget the Text, Use Black and White for Contrast, Find the Best Angle, Add Some Ribbon, and Invest in a Stamp Set”.

Some embodiments comprise chat rooms with one or more scuba diving dedicated topics, including, but not limited to, “Accident Guide, Adventure Divers, Advanced Divers, AED Course, Alternobaric Vertigo, Article of the Month, Assistant Instructor, Boat Diving, Bubblemaker, Bubble Rings, Bull Shark, Christmas Tree Worms, Coral Reefs, Courses, CPR and First Aid, DAN, Daytrips, Destinations, Discover Scuba Diving, and Divemaster”.

Some embodiments comprise chat rooms with one or more sculpting dedicated topics, including, but not limited to, “Purposes and subjects, Materials and techniques, Wood carving, Social status of sculptors, Anti-sculpture movements, History, Prehistoric periods, Ancient Near East, Ancient Egypt, Ancient Greece, Classical, Hellenistic, Europe after the Greeks, Roman sculpture, Early Medieval and Byzantine, Romanesque, Ethiopia and Eritrea, Pre-Columbian, Moving toward modern art, and 19th-early 20th century, early Modernism and continuing realism”.

Some embodiments comprise chat rooms with one or more search dedicated topics, including, but not limited to, “Options and variations, Option: Transclude intersections into categories, Option: Named indexes, separate from categories, Option: Separate intersection space, Other variations, Changes to categorization policy, Primary categories, Categories as a table of contents: Browsing, Categories as an index: Primary categories, Categories as classification, Multiple taxonomies, Categories as a database search, Future related upgrades, Category viewed as an outline, Searching in categories, Proof of concept implementation, Tools currently available, Semantic Mediawiki, Mediawiki extension “Multi-Category Search”, and Magnus Manske category intersection tool”.

Some embodiments comprise chat rooms with one or more self-improvement dedicated topics, including, but not limited to, “Articles, Abundance, Abuse and Recovery, Accelerated Learning, Achievement, Acupuncture, Addiction and Recovery, Adult and Senior Development, Aerobics, Affirmations and Positive Affirmations, Aging and Longevity, Agoraphobia, Akashic Records, Alternative Medicine, Alzheimer's, Anger Management, Anti-Aging, Anxiety, Applied Kinesiology, and Aromatherapy”.

Some embodiments comprise chat rooms with one or more semiconductor dedicated topics, including, but not limited to, “diode, Transistor, Bipolar junction transistor, Field-effect transistor, Semiconductor device materials, List of common semiconductor devices, Semiconductor device applications, Component identifiers, History of semiconductor device development, Cat's-whisker detector, Metal rectifier, World War II, Development of the diode, Development of the transistor, The first transistor, Origin of the term “transistor”, Improvements in transistor design, See also, and References”.

Some embodiments comprise chat rooms with one or more senior citizen dedicated topics, including, but not limited to, “AARP, Retirement Life Matters, Love to Know Seniors, Interviews with experts, Assisted Living Directory, Road Scholar, Evergreen Clu, Technology, The Senior's Guide to Computers, Age in Place Technology Watch, Humor, Suddenly Senior, What can, Swap Meet Dave, Health, Web MD, Find jobs, Finance and Money, and Dating”.

Some embodiments comprise chat rooms with one or more sewing dedicated topics, including, but not limited to, “Tools of the Trade, Hand Sewing Stitches, sewing stitches, Running Stitch, Basting Stitch, Backstitch, Catch-stitch (Cross-Stitch), Slip Stitch, Blanket Stitch (Buttonhole Stitch), Sewing Machine Stitches, sewing stitches, Standard Forward/Backward Stitching, ZigZag Stitch, Buttonholes, Blind Hem Stitch, Seam Finishes, sewing stitches, Zigzag, Turn and Stitch, and Bias Tape”.

Some embodiments comprise chat rooms with one or more sexual health dedicated topics, including, but not limited to, “Acquired Immune Deficiency Syndrome (AIDS), Chancroid, Chlamydia, Genital Herpes/HSV, Genital HPV Infection, Gonorrhea, Syphilis, Trichomoniasis, Viral Hepatitis, Bleeding or spotting after sexual intercourse, Discharge from the penis in men, Frequent urination, Irregular growths (warts) in the genital area, Lower abdominal pain, Pain during intercourse, Painful or burning sensation when urinating, Rash, Sores on or in the vagina, on the labia, on or around the anus or mouth, Testicular pain in men, and Vaginal discharge (may be foul-smelling or discolored)”.

Some embodiments comprise chat rooms with one or more sexuality dedicated topics, including, but not limited to, “development, Nature versus nurture, Gender differences, Biological and physiological aspects, Physical anatomy and reproduction, Sexual response cycle, Evolution of the neurobiological factors of human sexuality, Sexual dysfunction and sexual problems, Psychological aspects, Sexuality and age, Child sexuality, Sexuality in late adulthood, Sociocultural aspects, Religious sexual morality, Sexuality in history, Reproductive and sexual rights, Sexual behavior, General activities and health, Creating a relationship, and Sexual attraction”.

Some embodiments comprise chat rooms with one or more Shakespeare dedicated topics, including, but not limited to, “Adaptations of works by William Shakespeare, Shakespeare authorship question, Awards for classical theatre, Shakespearean characters, Early editions of Shakespeare, Shakespeare festivals, Folger Shakespeare Library, King's Men (playing company), People associated with Shakespeare, Shakespearean phrases, Shakespearean scholarship, Shakespeare Birthplace Trust, Stage productions of plays by William Shakespeare, Shakespearean theatre companies, Works about William Shakespeare, Works by William Shakespeare, Shakespeare as an important revolution in literature, The life of Shakespeare and tragedy, A realistic study of Shakespeare's writing career, and Analysis of different writings of the author”.

Some embodiments comprise chat rooms with one or more shopping dedicated topics, including, but not limited to, “Shops by country, Shops by city, Bookstores, Butcher shops, Cannabis shops, Chocolateries, Company stores, Confectionery stores, Convenience stores, Duty-free shops, Fictional shops, Magic shops, Pawn shops, Pet stores, Sex shops, Variety stores, Retailers by type of merchandise sold, Retail companies by continent, Retail companies by year of establishment, and Lists of retailers”.

Some embodiments comprise chat rooms with one or more skateboarding dedicated topics, including, but not limited to, “Freestyle-Skateboard, Slalom Skateboard, Downhill Skateboard, Vert Skateboard, Street Skateboard, Park Skateboard, Pool Skateboard, Cruising Skateboard, Other styles, Skateboarding by country, Skateboarding companies, Skateboarding equipment, Skateboarding competitions, Skateboarding logos, Skateboarding media, Skateboarders, Skateboarding spots, Skateparks, Skateboarding styles, and Skateboarding tricks”.

Some embodiments comprise chat rooms with one or more skiing dedicated topics, including, but not limited to, “Adaptive Skiing, Backcountry skiing, Extreme skiing, Freeskiing, Glade skiing, Grass skiing, Half-pipe skiing, Heliskiing, Mogul skiing, Ski mountaineering, Night skiing, Ski-orienteering, Para-alpine skiing, Roller skiing, Ski ballet, Ski cross, Ski jumping, Slopestyle, Ski touring, and Ski warfare”.

Some embodiments comprise chat rooms with one or more skydiving dedicated topics, including, but not limited to, “Standard skydiving, Tandem skydiving, Formation jumping, Freeflying, Wingsuit flying, Canopy formation, Static line, BASE jumping, Big Skydiving Formations or Big Ways, Wingsuit, Swooping or Canopy Piloting, Cutaway, Drop Zone, Fandango, Fathom, The Full Cupboard of Life, The Gypsy Moths, Parachute Battalion, Parachute Jumper, and Parachute Nurse”.

Some embodiments comprise chat rooms with one or more snowboarding dedicated topics, including, but not limited to, “FreeCarve, Splitboarding, Slopestyle, Big Air, Half-pipe, Boardercross, Big mountain, Jibbing, Freeriding, Freestyle, Alpine snowboarding, Slopestyle, Big air, Half-pipe, Boardercross, Snowboard racing, Competitions, Subculture, Safety and precautions, and Media”.

Some embodiments comprise chat rooms with one or more soap opera dedicated topics, including, but not limited to, “Soap operas by genre, Soap operas by country, Television soap operas, Soap opera actors, Soap opera characters, Soap opera episodes, Soap opera and telenovela images, Soap opera lists, Soap opera producers, Soap opera storylines, Soap opera terminology, Works about soap operas, Soap opera writers, Armenian soap operas, Chokher Tara Tui, Fantaserye and telefantasya, Feuilleton televise, Ke Apon Ke Por, Medical drama, and Teleserye”.

Some embodiments comprise chat rooms with one or more soccer dedicated topics, including, but not limited to, “Association football by city, Association football by continent, Association football by country, Association football-related lists, Amateur association football, Association football champions, Association football competitions, Association football culture, Association football equipment, History of association football, Laws of association football, Association football logos, Association football media, Military association football, Association football occupations, Association football organizations, Association football people, Association football positions, Association football tactics and, and Association football teams”.

Some embodiments comprise chat rooms with one or more socialism dedicated topics, including, but not limited to, “Early interpretations, Differences between various schools, Socialist planned economy, Market socialism, Socialist market economy, Socialist ideologies, Utopian socialism, Marxist communism, Marxism-Leninism, Stalinism, Maoism, Trotskyism, Council and left communism, Autonomism, Anarchism, Mutualism, Collectivist anarchism, Anarchist communism, Anarcho-syndicalism, and Social democracy”.

Some embodiments comprise chat rooms with one or more sociology dedicated topics, including, but not limited to, “Sociology by country, Subfields of sociology, Sociology lists, Sociological terminology, Sociologists, Academic works about sociology, Alienation, History of sociology, Methods in sociology, Sociological organizations, Sociological theories, Sociology stubs, Sociology of science, Social dynamics, Urban sociology, Biographical research, Decommodification, Illusion of inclusion, Sladdbarn, and Social murder”.

Some embodiments comprise chat rooms with one or more software dedicated topics, including, but not limited to, “Applications, Applications, Office Productivity, Automation, Robotics, Controls, Decision Support, Knowledge & Media, Games, Ecommerce & Markets, Marketing, Algorithms, Artificial Intelligence, Software Development, Systems, Databases, Integration, Operating Systems, Libraries & APIs, and Drivers”.

Some embodiments comprise chat rooms with one or more song writing dedicated topics, including, but not limited to, “You find out that your lover has different political views than you, You decide that you will the person you're dating as long as they agree to a long list of requirements, You tell the person you are in love with that they have until the end of this song to say I love you, Make love to me sideways, I love you almost as much as he does, Love cuts like a plastic knife, Love is in the eye of the beholder, and I am blind in one eye, Why do you love me?, I'm pretty sure you have me confused with one of my octuplet brothers, If you take too long to love me, I might die, Tomorrow never comes so love me yesterday, Love is kinda funny. Is that why you're laughing at me?, People only love you because you have a cool name, When we get married, I don't want you to just do the cooking and dishes . . . I want you to do other housework as well, You put the lowercase “o” in Love, I loved you the moment I met you . . . But now that I've seen you in person, I'm not too sure. (Internet love song), Let me Google® your noodle, All I want from you is love and money, Money can't buy love, but I'll love you if you give me money, Money can't buy love, and but it can rent it”.

Some embodiments comprise chat rooms with one or more soul/R&B dedicated topics, including, but not limited to, “Rhythm and blues, pop, soul, funk, hip hop, electronic, Contents, Origins, 1960s, 1970s and later, Notable record labels and producers, Motown records, Stax Records and Atlantic records, Subgenres, Detroit (Motown) soul, Deep soul and southern soul, Memphis soul, Birmingham soul, New Orleans soul, and Chicago soul”.

Some embodiments comprise chat rooms with one or more soundtrack dedicated topics, including, but not limited to, “film scores, Alien (franchise) soundtracks, Animated film soundtracks, Soundtrack albums from James Bond films, The Chronicles of Narnia music, DC Extended Universe soundtracks, Film and television discographies, Disney film soundtracks, Friday (franchise) music, The Godfather music, Music of the Harry Potter films, High School Musical albums, Hindi film soundtracks, Indiana Jones music, The Lord of the Rings film music, Malayalam film soundtracks, Marvel Cinematic Universe soundtracks, The Matrix (franchise) albums, Rocky soundtracks, and Music in Shakespeare”.

Some embodiments comprise chat rooms with one or more South America dedicated topics, including, but not limited to, “South American Countries (29), Argentina (8), Chile (4), Peru (6), General South American History topics, Latin American History, South American History, Afro-Brazilians, Agrarian Reform in Latin America, Andes Region History, Bolivar, Simon, Chaco War, Conquistadors, Freire, Paulo, Incas, Latin American Economic History, Latin American Military Regimes, Latin American Revolutions, Neoliberalism (Latin American), and Oil and Venezuela”.

Some embodiments comprise chat rooms with one or more space exploration dedicated topics, including, but not limited to, “Abort Crew, Abort Motor, ABoVE, ABRS (Advanced Biological Research System), ACT-America, Active Galactic Nuclei, Actiwatch (Actiwatch), Actiwatch Spectrum (Actiwatch Spectrum System), ADF (Avian Development Facility), Advanced Space Suits, Aeronautics, Africa, AIM (Aeronomy of Ice in the Mesosphere), Air, Al Worden, Alan Bean, Alan Bean, Alan Shepard, Alpha Magnetic Spectrometer (AMS), and Basin Testing”.

Some embodiments comprise chat rooms with one or more Spain dedicated topics, including, but not limited to, “Spain-related lists, Buildings and structures in Spain, Spanish culture, Economy of Spain, Education in Spain, Environment of Spain, Geography of Spain, Government of Spain, Health in Spain, History of Spain, Organizations based in Spain, Spanish people, Politics of Spain, Public Administration of Spain, Spanish society, Images of Spain, Spain stubs, Spain has 47 UNESCO World Heritage Sites, The next time you use a stapler, thank the Spanish, and Spain produces over half of the world's olive oil”.

Some embodiments comprise chat rooms with one or more spa dedicated topics, including, but not limited to, “Dental spa, Destination spa, Mineral spa, AI Zulfi, Spa architecture, Roman Baths (Bath), Bathsheba's spring and bower, Birley Spa, Blue Lagoon (geothermal spa), Cacheuta Spa, Caldea, Calistoga Spa Hot Springs, Dog and Duck, St George's Fields, Dorton Spa, Ein Gedi Spa, The Gents Place, Héviz Spa, Hockley Valley, Hydro massage, and Jeti-Ögüz resort”.

Some embodiments comprise chat rooms with one or more spirituality dedicated topics, including, but not limited to, “Advaita, Anthroposophy, Austronesian spirituality, Catholic spirituality, A Course in Miracles, Eastern Christian spirituality, Enneagram, Spiritual faculties, Feminist spirituality, Films about spirituality, Spiritual gifts, Gnosticism, Literature about spirituality, Meditation, Mind-body interventions, Neo-Vedanta, Neurotheology, New Age, Nondualism, and Spiritual organizations”.

Some embodiments comprise chat rooms with one or more general sports dedicated topics, including, but not limited to, “Sports by continent, Sports by country, Men's sports, Women's sports, Sports events by sport type, Sport variants, Individual sports, Team sports, Acrobatic sports, Air sports, Amateur sports, Ancient sports, Animals in sport, Athletic sports, Ball games, Beach sports, Boardsports, Bull sports, Children's sport, and Combat sports.”

Some embodiments comprise chat rooms with one or more squash dedicated topics, including, but not limited to, “Spaghetti Squash, Squash Rules, Posh Winter Squash, Squash Season, Butternut Squash, Yellow Squash, Winter Squash, Starting with Squash. It's a Creamy-Sweet Base for Three Dinner Starters, 3 Ways with Butternut Squash, 1985's Vegetable Breakthrough: “Sunburst” Squash, 3 Ways with Butternut Squash: A Flavorful Stew, Spicy Soup, and Moist Cake Show How Butternut Squash Is Fall's Most Versatile Ingredient, Five Basic Ways to Cook Winter Squash, Onward with Spaghetti Squash, Super Squash, Not Hash Browns. They're Cooked Spaghetti Squash, The Flavor of Fall: Baked or Roasted, Butternut Squash Delivers Chilly-Season Comfort, Cooked or Raw, Squash Blossoms Taste and Look Good, Shortcut Squash: It's Prepped and Ready for Quick Winter Dishes, and Shortcut Squash, 20. What's So Great about Winter Squash?”.

Some embodiments comprise chat rooms with one or more statistics dedicated topics, including, but not limited to, “Statisticians, Statistics-related lists, Statistics profession and organizations, Applied statistics, Computational statistics, Statistical data, Statistical methods, Philosophy of statistics, Statistical software, Statistical theory, Statistics stubs, Statistics Grows as Key College and Career Skill, NationMaster and StateMaster Solve Great Statistics Problem-Almost, Church Statistics Hard to Come By, Sales Rep ‘Effort Statistics' Paint a Revealing Picture of What Works, Who's Working, Micro-Based Interlibrary Loan Statistics: A Project Report, Church Directory Stuck with Outdated Statistics, Descriptive Statistics: Use These Tools to Analyze Data Vital to Practice-Improvement Projects, Behind the Statistics: Keeping Track of Multicultural Literature, and Statistics Skills Predict Education Success: News”.

Some embodiments comprise chat rooms with one or more stumble-upon dedicated topics, including, but not limited to, “StumbleUpon, Yelp Expand Social Networks' Range, The Science Sharing: Platforms Inject Data into the Art of Going Viral, Missed Some Sessions at SLA 2008? No Problem!, Redesign Made Easy: How to Build a Better Website, Web Kaleidoscopes, Web 2.0 Alphabet: Part II, The New Socialism, Social Media in Libraries Keys to Deeper Engagement, Intelways, What Content Curation Can Do for Your Business-And Three Things It Can't, Social Search for Market Intelligence, Digital Power List: Angels, Tech, In Search of the Next YouTube: New Crop of Sites Promises Users and Creators a More Engaging Video Experience, Download Me, Too Much of Anything Is Never Good-Even If It's Data: Dean Praetorius, Director of Trends and Social Media at the Huffington Post, Explains How His Sites Leverage Stats to Create Engaging Content, Comic Strip Justice, Bite-Sized Business School: Personal Development Module, I Listen, I Tweet, I Lead: Notes on Digital Leadership, and Search Engine Update”.

Some embodiments comprise chat rooms with one or more stumble-upon news dedicated topics, including, but not limited to, “Networking News: Traditional News Outlets Turn to Social Networking Web Sites in an Effort to Build Their Online Audiences, Missed Some Sessions at SLA 2008? No Problem!, Web 2.0 Alphabet: Part II, Intelways, What Content Curation Can Do for Your Business-And Three Things It Can't, Digital Power List: Angels, Tech, Too Much of Anything Is Never Good-Even If It's Data: Dean Praetorius, Director of Trends and Social Media at the Huffington Post, Explains How His Sites Leverage Stats to Create Engaging Content, Search Engine Update, Optimizing Bylined Articles for Business Development: Steps for Using Social Media to Generate Inquires, Welcome to the Sharing Economy: Reflections on the New Social Culture, Andrew Walmsley on Digital: Social Networks Are Here to Stay, Andrew Walmsley on Digital: A Vote for the Straw Poll, A SWOT Analysis for Social Media in Libraries, Should You Blog?, Linking Newspaper Readers to the Best Political Coverage, Digg Helps Send Time's Traffic into Orbit: Shared Recommendations Are a Key Weapon in the Fight for Traffic, Intelways, and Digital Leadership”.

Some embodiments comprise chat rooms with one or more sub-culture dedicated topics, including, but not limited to, “Bibliographies of subcultures, Body modification, Counterculture, Criminal subcultures, DIY culture, Emo, Fandom, Fashion aesthetics, Freak scene, Freemasonic culture, Goth subculture, Hacker culture, Hippie movement, Hipster (contemporary subculture), History of subcultures, Japanese subcultures, Motorcycling subculture, Musical subcultures, New Age, and Skinhead”.

Some embodiments comprise chat rooms with one or more substance abuse dedicated topics, including, but not limited to, “Adult & Teen Challenge, Alcohol abuse, Alcohol myopia, Anabolic-androgenic steroids abuse, Benzodiazepine use disorder, Frank Chaloupka, AFosB, Dopey (podcast), Substance abuse, Drug overdose, Drug rehabilitation, Education sector responses to substance abuse, Epigenetics of cocaine addiction, Evolutionary models of human drug use, Gateway drug theory, Erick Guerrero, Harm reduction, Inhalant, Life-process model of addiction, and List of regular users of amphetamine”.

Some embodiments comprise chat rooms with one or more sufism dedicated topics, including, but not limited to, “Sufism by continent, Ahmed Raza Khan Barelvi, Alevism, Anti-Sufism, Sufi art, Barelvi, Dervish, Esoteric interpretation of the Quran, Sufi literature, Sufi mosques, Sufi music, Names of God in Sufism, Sufi orders, Sufi organizations, Sufi philosophy, Sufi psychology, Scholars of Sufism, Sufi shrines, Sufi poetry, and Sufis”.

Some embodiments comprise chat rooms with one or more Sunni dedicated topics, including, but not limited to, “Sunni Muslims by nationality, Abu Bakr family, Sunni clerics, Converts to Sunni Islam, Deobandis, Grand Muftis, Sunni imams, Sunni Islamists, Salafis, Sunni Muslim scholars, Sunni Sufis, Sunni Muslims by madh'hab, Wahhabists, Salman Abedi, Ahmad al-Badawi, Al-Fudayl ibn ‘Iyād, Asma al-Assad, Abd al-Karīm al-Jīlī, List of Ash'aris and Maturidis, and Abdullah Makapaar”.

Some embodiments comprise chat rooms with one or more supercomputing dedicated topics, including, but not limited to, “supercomputing in China, Supercomputing in Europe, Supercomputing in Japan, Supercomputing in Pakistan, Supercomputing in the Philippines, Supercomputer operating systems, Supercomputers, Supercomputing in India, ACM/IEEE Supercomputing Conference, Advanced Simulation and Computing Program, All of Us (initiative), Citizen Cyberscience Centre, Embedded Supercomputing, Exascale computing, Hilbert curve scheduling, InfiniBand, ISC High Performance, The Journal of Supercomputing, Jungle computing, and Massively parallel”.

Some embodiments comprise chat rooms with one or more surfing dedicated topics, including, but not limited to, “Surfing by country, Big wave surfing, Bodyboarding, Surfing competitions, Surf culture, Surfing equipment, Kitesurfing, Lake surfing, Surfing locations, Surfing logos, Surfing media, Olympic surfing venues, Surfing organizations, River surfing, Surf forecasting, Surf lifesaving, Surfboard shapers, Surfers, Windsurfing, and Women's surfing”.

Some embodiments comprise chat rooms with one or more survivalist dedicated topics, including, but not limited to, “Jerry Ahern, Bradford Angier, Ragnar Benson, Barton Biggs, Korban Blake, Andre-Frangois Bourbeau, Tom Brown Jr, Dave Canterbury, Bruce D. Clayton, Jeff Cooper, David Cornthwaite, Mick Dodge, Leslie Fish, Pat Frank, Eric Frein, Forrest Galante, Matt Graham (survivalist), Richard Harry Graves, Bear Grylls, and Mykel Hawke”.

Some embodiments comprise chat rooms with one or more swimming dedicated topics, including, but not limited to, “Swimming by city, Swimming by continent, Swimming by country, Events in swimming, Years in swimming, Aquathlon, Swimming awards, Swimming coaches, Swimming commentators, Swimming competitions, Swimming culture, Drowning, Swimming equipment, Finswimming, Swimming-related lists, Swimming logos, Masters swimming, Swimming media, Neutral buoyancy training, and Open water swimming”.

Some embodiments comprise chat rooms with one or more tattoos and/or piercing dedicated topics, including, but not limited to, “Tattoo artists, Tattooing by body part, Heavily tattooed people, Tattooing and law, Media depictions of tattooing, Tattooing and medicine, Tattooing and religion, Tattoo designs, Tattooing traditions, Black-and-gray, Cover-up (tattoo), Flash (tattoo), History of tattooing, Human billboard, Identification in Nazi concentration camps, Fukushi Masaichi, Microblading, Modern primitive, New York Tattoo Museum, and Permanent makeup”.

Some embodiments comprise chat rooms with one or more taxation dedicated topics, including, but not limited to, “Taxation by country, Taxes by type, Taxation-related lists, Tax accounting, Tax administration, Tax forms, Tax fraud, History of taxation, International taxation, Tax law, Tax noncompliance, Tax organizations, Tax occupations, Tax policy, Tax software, Tax terms, Theory of taxation, Writers on taxation, Tax stubs, and Tax stubs”.

Some embodiments comprise chat rooms with one or more tea dedicated topics, including, but not limited to, “Tea by continent, Tea by country, Tea culture, History of tea, Tea houses, Tea dishes, Tea industry, Teaware, Tea varieties, Works about tea, Tea stubs, Camellia taliensis, Candida theae, Canned tea, Cha Gordo, Compressed tea, Etymology of tea, GABA tea, Instant tea, and Health effects of tea”.

Some embodiments comprise chat rooms with one or more “techno” dedicated topics, including, but not limited to, “Techno albums, Techno genres, Techno record labels, Techno songs, Techno musicians, Techno, Ambient techno, Atomic Jam, Detroit Electronic Music Archive, Eve & Rave, Techdombe, Hard Wax, I Love Techno, Kvadrat (film), Mayday (music festival), Nature One, Rave music, William Rottger, Ruhr in Love, and Sea You Festival”.

Some embodiments comprise chat rooms with one or more technology dedicated topics, including, but not limited to, “Technology by type, Technology-related lists, People associated with technology, People in technology, Technological change, Technical communication, Technological comparisons, Computers, Technology development, Engineering, Technology evangelism, Regulation of technologies, History of technology, Hypothetical technology, Mobile technology, Obsolete technologies, Technology organizations, Philosophy of technology, Technological pollution, and Real-time technology”.

Some embodiments comprise chat rooms with one or more teenlife dedicated topics, including, but not limited to, “Teen films by series, Teen films by country, Teen films by decade, Teen films by genre, Coming-of-age films, Disney XD original films, Films about fraternities and sororities, Films about proms, Juvenile sexuality in films, Teen films based on works by William Shakespeare, Teenage pregnancy in film, Teenage characters in film, List of teen films, Alien Arsenal, All You've Got, Amar Bondhu Rashed (film), American Yearbook, Bang Bang You're Dead (film), Beautiful Loser (film), and Before the Storm (2000 film)”.

Some embodiments comprise chat rooms with one or more tea dedicated topics, including, but not limited to, “Tea by continent, Tea by country, Tea culture, History of tea, Tea houses, Tea dishes, Tea industry, Teaware, Tea varieties, Works about tea, Tea stubs, Camellia sinensis, Camellia taliensis, Candida theae, Canned tea, Cha Gordo, Compressed tea, Etymology of tea, GABA tea, and Gamma-Glutamylmethylamide”.

Some embodiments comprise chat rooms with one or more teen parenting dedicated topics, including, but not limited to, “fictional teenage parents, Preteen pregnancy, Works about teenage pregnancy, Teenage pregnancy in Australia, Demetress Bell, Candie's Foundation, Prevalence of teenage pregnancy, Pregnancy school, Teenage pregnancy in the United Kingdom, Teenage pregnancy in the United States, Psychological and Physical Dating Violence Perpetrated by Pregnant and Parenting Latina Adolescents, Report of an Equity-Focused Health Impact Assessment of a Proposed Universal Parenting Program in Manitoba, Ecological Factors Associated with Adolescent Pregnancy and Parenting, Intervention for Elimination of Inappropriate Parenting Skills through E-Booklet on Different Parenting Styles, School-Based Prenatal and Postpartum Care: Strategies for Meeting the Medical and Educational Needs of Pregnant and Parenting Students, Teenage Parenting: Challenges, Interventions and Programs, Maternal Role Satisfaction: A New Approach to Assessing Parenting, Building a Professional Development System: A Case Study of North Carolina's Parenting Education Experiences, A Primer for Teen Parent Services: Issues, Program Development, and Advocacy, and The Well-Being of Children Born to Teen Mothers”.

Some embodiments comprise chat rooms with one or more telecom dedicated topics, including, but not limited to, “Telecommunications by continent, Telecommunications by country, Aviation communications, Broadcasting, Businesspeople in telecommunications, Telecommunications companies, Computer networking, Data transmission, Telecommunications economics, Telecommunications engineering, Telecommunications engineers, Telecommunications equipment, History of telecommunications, Telecommunications images, Telecommunications infrastructure, Interference, International telecommunications, Interstellar communication, Telecommunications lists, Military communications, and Military communications”.

Some embodiments comprise chat rooms with one or more television dedicated topics, including, but not limited to, “Television History, Reality Television, Television Advertising, Television News, Tabloid Television, Television Sitcoms, Science Fiction Television, Television and Education, Television and Children, Directing Film and Television, Television and Presidential Politics Women and Television, Television Coverage of War Soap Operas Ethics in Entertainment, Talk Shows Televangelism, Entertainment and Education, Teenagers and the Media Public Broadcasting (PBS and NPR), Frank CapraMedia Fandom, Violence in the Media Courts and the Press, Broadcast JournalismV-ChipPolitics and Mass Media, Australian Popular Culture Media Images of African-Americans, and Michelangelo Antonion”.

Some embodiments comprise chat rooms with one or more tennis dedicated topics, including, but not limited to, “Tennis by city, Tennis by continent, Tennis by country, Tennis-related lists, Men's tennis, Mixed doubles tennis, Women's tennis, Tennis academies, Tennis awards, Tennis controversies, Tennis court surfaces, Tennis culture, Tennis equipment, Tennis in fiction, Forms of tennis, History of tennis, Junior tennis, Tennis logos, Tennis matches, and Tennis media”.

Some embodiments comprise chat rooms with one or more terrorism dedicated topics, including, but not limited to, “Terrorism by form, Terrorism by location, Terrorism by method, Terrorism by perpetrator, Terrorism by year, Terrorist incidents, Counter-terrorism, Terrorism stubs, Terrorism databases, Dirty wars, Far-right terrorism, Funding of terrorism, Terrorism laws, Terrorism-related lists, Organizations designated as terrorist, People charged with terrorism, Terrorism tactics, Terrorism victims, War on Terror, and Works about terrorism”.

Some embodiments comprise chat rooms with one or more toys dedicated topics, including, but not limited to, “Gaming devices, Toy industry, Lists of toys, Toy mascots, Playing cards, Spider-Man toys, Toy culture, Toy franchises, Toys by century, Toys by decade, Toys by material, Toys by type, Toy stubs, Baby jumper, Cat play and toys, Chew toy, Furskin Bears, Gel ball shooter, Hatchimals, and List of Spider-Man toys”.

Some embodiments comprise chat rooms with one or more track and/or field dedicated topics, including, but not limited to, “Track and field by city, Track and field by country, Track and field athletes, Track and field broadcasters, Indoor track and field, Masters athletics (track and field), Track and field organizations, Athletics (track and field) records, Athletics (track and field) venues, Track and field athletics stubs, Track and field, All-weather running track, Kick (running), Pacing strategies in track and field, Panhandle track, Race clock, Hershey's Track and Field Finishes Strong, Hershey's Track and Field Youth Program, and Arthur Ashe Jr. Sports Scholars Awards”.

Some embodiments comprise chat rooms with one or more trains and/or railroad dedicated topics, including, but not limited to, “Rail infrastructure by continent, Rail infrastructure by country, Proposed rail infrastructure, Cancelled rail infrastructure, Railway track layouts, Track gauges, Railway cuttings, Electric rail transport, Railway freight terminals, Rail junctions, Rail loading gauge, Level crossings, Rail mountain passes, Permanent way, Rail yards, Railway inclines, Railway lines, Railway signaling, Rail technologies, and Railway test tracks”.

Some embodiments comprise chat rooms with one or more trance dedicated topics, including, but not limited to, “Trance albums, Trance genres, Trance music groups, Trance musicians, Trance record labels, Trance songs, Trance festivals, Club Nation, Future Sound of Egypt, Progressive trance, Rave music, A State of Trance, SynSUN, Tisto's Club Life, Global Warning, The Lila of the Gnawa, The Edge of Darkness, Glossolalia Meets Glosso-Psychology: Why Speaking in Tongues Persists in Charismatic Christian and Pentecostal Gatherings, Brits, Glitz and Grit, and Boyle's Hypnotic Caper Leaves Mind Behind”.

Some embodiments comprise chat rooms with one or more transportation dedicated topics, including, but not limited to, “Transport by city, Transport by continent, Transport by country, Transport by mode, History of transport, Ice in transportation, People in transport, Accessible transportation, Transport companies, Commuting, Transport controversies, Transport culture, Transport economics, Energy in transport, Transportation engineering, Transport and the environment, Freight transport, Transportation geography, Transport of heads of state, and Hijacking”.

Some embodiments comprise chat rooms with one or more travel dedicated topics, including, but not limited to, “Types of tourism, Adventure travel, Business travel, Cruising (maritime), Diplomatic visits, Exploration, Interstellar travel, Long distance travel, Pilgrimages, Royal visits, Specialist travel, Student travel, Time travel, Travel classes, Walking, Bleisure travel, Business tourism, Business travel, Travel class, and Commuting”.

Some embodiments comprise chat rooms with one or more trip-hop and/or downtempo dedicated topics, including, but not limited to, “Epitonic.com Music to a Writer's Ears, Desert Style Brunch, Steve Hillage, Serbian Films Shine at Karlovy Vary Works in Progress, Labels to Watch, Broken Social Scene Forgiveness Rock Record (Arts & Crafts), Television & Music: The Grammys, Atlas of the Underground: What People Are Eating, Where They Are Sleeping, What They Are Spending Money on, and How Scenes Form in 24 Countries, Michna Is Game, Tuff Love: In Times of Trouble, Busy Signal Doctors Jamaica's Ills with Harsh Medicine, Losing Firepower, Desert-Style Brunch, American Utopia, Hello Darkness, My New Friend, Nws Prnt, Ryan Adams, DJ Catharsis Offers a New Take on Electronic Music, CD OF THE WEEK: Rock and Pop, An Element of Surprise on the Radio, and Ladi Weaves Intricate Sounds”.

Some embodiments comprise chat rooms with one or more UFO dedicated topics, including, but not limited to, “Studies, Early history, Investigations, Project Sign, Project Grudge, USAF Regulation 200-2, Project Blue Book, Scientific studies, United States, Post-1947 sightings, Project Sign, Condon Committee, Notable US cases, Brazil, Canada, France, Italy, Notable cases, United Kingdom, Notable cases, Uruguay, and Astronomer reports”.

Some embodiments comprise chat rooms with one or more UK dedicated topics, including, but not limited to, “United Kingdom by country, United Kingdom-related lists, Buildings and structures in the United Kingdom, British culture, Economy of the United Kingdom, Education in the United Kingdom, Environment of the United Kingdom, Geography of the United Kingdom, Government of the United Kingdom, Health in the United Kingdom, History of the United Kingdom, Images of the United Kingdom, Organizations based in the United Kingdom, British people, Politics of the United Kingdom, British society, Wikimedia UK, United Kingdom stubs, UK MPs Urge Government to Challenge Controversial EU Film and TV Plans, and Sony, Paramount Appoint UK MDs”.

Some embodiments comprise chat rooms with one or more USA dedicated topics, including, but not limited to, “States of the United States, United States-related lists, Buildings and structures in the United States, American culture, Economy of the United States, Education in the United States, Environment of the United States, Geography of the United States, Government in the United States, Health in the United States, History of the United States, Organizations based in the United States, American people, Politics of the United States, American society, United States stubs, USA Services-Your Front Door to the Federal Government, First USA Buys Two Processing Sales Agents, First USA in Deal with Priceline to Boost Use of Its Cards On-Line, and Brain Drain: Execs Head for Exits at First USA”.

Some embodiments comprise chat rooms with one or more University and/or College dedicated topics, including, but not limited to, “Universities and colleges by association, Universities and colleges by city, Universities and colleges by continent, Universities and colleges by country, Universities and colleges by religious affiliation, Universities and colleges by type, Lists of universities and colleges, Categories by university or college, Universities established in the 19th century, Universities established in the 20th century, Universities established in the 21st century, University and college admissions, Universities and colleges in art, Attacks on universities and colleges, University and college buildings, University and college bus systems, Campus sexual assault, Campuses, University constituencies, and University and college elections”.

Some embodiments comprise chat rooms with one or more vegetarian dedicated topics, including, but not limited to, “Vegetarianism by continent, Vegetarianism by country, Vegetarian communities, Vegetarian companies and establishments, Critics of vegetarianism, Vegetarian cuisine, Vegetarian diets, History of vegetarianism, Vegetarian-related media, Vegetarian organizations, Pythagoreanism, Vegetarianism and religion, Vegetarian restaurants, Semi-vegetarianism, Veganism, Vegetarian festivals, Vegetarians, Works about vegetarianism, Vegetarian Vanguard, and 20. Could Steak-Loving Warriors Withstand Vegetarian Assault?”

Some embodiments comprise chat rooms with one or more video equipment dedicated topics, including, but not limited to, “Audiovisual ephemera, Film and video fandom, Film, Video gaming, Video hardware, Home video, Music and video, Video production companies, Video software, Space photography and videography, Video storage, Film and video technology, Television, Film and video terminology, Video art, Video compression, Video equipment manufacturers, Video formats, Video on demand, Video surveillance, and Video surveillance”.

Some embodiments comprise chat rooms with one or more video games dedicated topics, including, but not limited to, “Video games by narrative form, Video games by physics engine, Video games by platform, Video games by setting, Video games by source, Video games by staff, Video games by theme, Video games by year, Video games with 6 drees of freedom, Video games by type of adaptation, Video games with alternate versions, Video games using barcodes, Video games that use figurines, Hackers in video games, Video game mods, Motion capture in video games, Video games using procedural generation V, Virtual reality games, Wikipedia categories named after games, and Video game stubs”.

Some embodiments comprise chat rooms with one or more vintage cars dedicated topics, including, but not limited to, “Australian Six, Austro-Daimler, Auto Red Bug, Autogear, Autotrix, AV (cyclecar), Avro, Babcock Electric Carriage Company, Baby Blake, Baker & Dale, Ballot (automobile), Bantam (car), Barnard (cyclecar), Beacon Motors, William Beardmore and Company, Bellanger (automobile), Berliet, Bianchi (company), Bignan (automobile), and Borderel-Cail”.

Some embodiments comprise chat rooms with one or more virtual reality dedicated topics, including, but not limited to, “Haptic technology, Virtual reality headsets, Holography, Mixed reality, Virtual reality organizations, Virtual reality pioneers, Psychoacoustics, Ray tracing (graphics), Virtual avatars, Virtual economy, Virtual reality communities, Virtual reality games, Virtual reality in fiction, Virtual reality works, Eric Howlett, Hyper Reality Experience, Hyperlinks in virtual worlds, Id Tech 3, IEEE Transactions on Visualization and Computer Graphics, and Imagination age”.

Some embodiments comprise chat rooms with one or more vocal music dedicated topics, including, but not limited to, “Musical settings of poems by author, A cappella, Barbershop music, Beatboxing, Choral music, Vocal musical compositions, Librettists, Musical theatre, Opera, Part songs, Rapping, Singing, Songwriting, Vocal and choral music organizations, Vocal coaches, Vocal gharanas, Voice registers, Voice teachers, Voice types, and Vocal Music by Faure”.

Some embodiments comprise chat rooms with one or more volleyball dedicated topics, including, but not limited to, “Volleyball by city, Volleyball by continent, Volleyball by country, Beach volleyball, Volleyball-related lists, Men's volleyball, Women's volleyball, Volleyball in the Arab world, Volleyball awards, Volleyball clubs, Volleyball coaches, Volleyball competitions, Volleyball logos, Volleyball maps, Volleyball media, Volleyball museums and halls of fame, Volleyball organizations, Volleyball players, Volleyball records and statistics, Seasons in volleyball, and Volleyball squads”.

Some embodiments comprise chat rooms with one or more water sports dedicated topics, including, but not limited to, “Water sports by country, Underwater sports, Water sports-related lists, Water sports competitions, Water sports equipment, Aquatics, Boat racing, Boating, Canoeing and kayaking, Competitive diving, Diving (acrobatics), Jet ski, Recreational diving, Recreational fishing, Sailing, Skim-boarding, Surfing, Swimming, Synchronized swimming, Towed water sports, and Water sports video games”.

Some embodiments comprise chat rooms with one or more web development dedicated topics, including, but not limited to, “Ajax (programming), CSS frameworks, E-commerce, HTML, Hypertext Transfer Protocol, Website management, Web services, Web development software, Web accessibility, Web analytics, Web design, Web developers, Web frameworks, Web programming, Web syndication, Agile web development, Ajax (programming), Blend4Web, Augmented web, and Awards”.

Some embodiments comprise chat rooms with one or more web hosting dedicated topics, including, but not limited to, “Blog hosting services, Endurance International Group, Free web hosting services, GIF hosting websites, Image hosting, Internet forum hosting, Photo sharing, Video hosting, The Access Group, Alternc., Amazon ElastiCache, Amazon Web Services, Angelfire, AOL Hometown, BOSH (software), Arq Group, Backblaze, Blog comment hosting service, BlueCentral, and Bluehost”.

Some embodiments comprise chat rooms with one or more weblogs dedicated topics, including, but not limited to, “Aangilam, All Things Vice, Autism's Gadfly, BettyConfidential, Blog fiction, Blogdex, BlogHer, Blogosphere, Boing Boing, Bossip, BROG, BuzzFeed, Calculated Risk, Character blogging, Classical music blog, Colalife, Communities @ State, Corporate blog, Davao Eagle, and DC Rainmaker”.

Some embodiments comprise chat rooms with one or more weddings dedicated topics, including, but not limited to, “weddings by culture, Weddings by nationality, Weddings by religion, Attacks on weddings, Wedding clothing, Wedding food, Wedding gifts, Wedding objects, Wedding ceremony participants, Wedding photography, Pre-wedding, Royal weddings, Wedding traditions, Wedding chapels, Wedding industry, Wedding music, Wedding of Elizabeth II, Works about wedding, and The Wedding Whisperers: Stone Fox Explains How to Avoid Bridezilla Weddings”.

Some embodiments comprise chat rooms with one or more weight-loss dedicated topics, including, but not limited to, “Anorexia nervosa, Weight loss companies, Diets, Fat substitutes, Angus Barbieri's fast, The Biggest Loser, Caloric deficit, Cigarette smoking for weight loss, Charles D'Angelo, Diet Rewards, Eat Smart, Move More, Weigh Less, Eat to Live, Fat: The Fight of My Life, Fitness boot camp, High-Intensity Focused Electromagnetic Field, Lubomyr Kuzmak, David Letele, One weird trick advertisements, Qardio, and Serving size”.

Some embodiments comprise chat rooms with one or more Wicca dedicated topics, including, but not limited to, “Wiccan books, Films about Wicca, Wiccan terminology, Texts used in Wicca, Wiccan traditions, Wicca by country, Wiccan feminism, Wiccans, Wiccan church, Craft name, Crone, Religious discrimination against Neopagans, Doreen Valiente Foundation, Drawing down the Moon (ritual), Etymology of Wicca, Fivefold kiss, Goddess movement, Great Rite, History of Wicca, and Homed God”.

Some embodiments comprise chat rooms with one or more Windows® dedicated topics, including, but not limited to, Windows® administration, Windows® architecture, Windows® components, Discontinued versions of Microsoft® Windows®, Windows files, Microsoft Windows® magazines, Windows® people, Windows® rootkit techniques, Screenshots of Microsoft® Windows®, Windows® software, Windows® technology, Windows® 95, Windows® 98, Windows® ME, Windows® Mobile, Windows® NT, Windows® Phone, Microsoft® Windows® stubs, Progress Illuminated: Two Stained Glass Windows from the 1893 Woman's Building, and Dynix for Windows-Cataloging”.

Some embodiments comprise chat rooms with one or more Windows® development dedicated topics, including, but not limited to, A86 (software), Actor (programming language), Android Studio, Bedrock (framework), BlueJ, Cheat Engine, CodeView, Earth3D, Eclipse (software), Eclipse Che, Edge Development Option, Eric (software), FASM, FC-HBA API, FpGUI, Free Pascal, FreeBASIC, Game Editor, GameMaker Studio, and Glk (software)”.

Some embodiments comprise chat rooms with one or more windsurfing dedicated topics, including, but not limited to, “Windsurfing competitions, Windsurfing equipment, Windsurfers, Windsurfing stubs, Aloha Classic, Body drag, Christian Bornemann, The Canal, Jim Drake (engineer), El Medano, Formula Windsurfing, Front loop, Ho'okipa, International Speed Windsurfing Class, Land windsurfing, Omaezaki, Prasonisi, Tilawa Viento Surf Center, Waterstart, and Windfoiling”.

Some embodiments comprise chat rooms with one or more wine dedicated topics, including, but not limited to, “Wine by location, Wine-related lists, People associated with wine, Wine accessories, Appellations, Wine awards, Wine brands, Wine classification, Cocktails with wine, Wine companies, Wine culture, Wine dishes, Wine grape varieties, History of wine, Winemaking, Oenology, Wine industry organizations, Wine packaging and storage, Wine styles, Wine terminology”.

Some embodiments comprise chat rooms with one or more women's issues dedicated topics, including, but not limited to, “Women's health by country, Breast diseases, Breastfeeding, Causes of death specific to women, Feminism and health, Gynaecology, Human female endocrine system, Human female reproductive system, Maternal health, Multiple births, Obstetrical nursing journals, Obstetrics and gynaecology journals, Syndromes in females, Violence against women, Women's health nursing journals, Women's health stubs, Husband stitch, Hydrocolpos, Hyperandrogenism, and Hyperemesis gravidarum”.

Some embodiments comprise chat rooms with one or more woodworking dedicated topics, including, but not limited to, “Wooden buildings and structures, Carpentry, Chair-making, Furniture-making, Green woodworking, Indian woodwork, Japanese woodwork, Joinery, Woodworking materials, Woodworking media, Surface decorative techniques in woodworking, Woodworking techniques, Timber preparation, Woodworking tools, Woodcarving, Wooden toys, Woodturning, Woodworkers, Woodworking stubs, and Crafting Hope: Love, Dedication and Second Chances Meet CNC and CAD CAM Technology”.

Some embodiments comprise chat rooms with one or more wrestling dedicated topics, including, but not limited to, “wrestling by city, Wrestling by continent, Wrestling by country, Sport wrestling, Catch wrestling, Wrestling clubs, Wrestling competitions, Wrestling films, Wrestling-related lists, Wrestling logos, Wrestling people, Submission wrestling, Wrestling venues, Wrestling weight classes, Years in wrestling, Intergender wrestling, Ippon seoi nage, Jacket wrestling, Nelson hold, and Over-under position”.

Some embodiments comprise chat rooms with one or more writing dedicated topics, including, but not limited to, “creative Writing, Paper Writing, Academic Writing, Technical Writing, Grant Writing, Business Writing, Teaching Writing, Feature Writing, Legal Writing, History of Writing, Writing across the Curriculum (WAC), Teaching Composition, Freewriting, Portfolio Assessment, Epistolary Literature, Essays, Travel in Literature, Personal Diaries, Technical Communication, and Mark Twain (Primary Works—Nonfiction)”.

Some embodiments comprise chat rooms with one or more yoga dedicated topics, including, but not limited to, “Hatha yoga, Mantras, Modern yoga, Yoga organizations, Pranayama, Ramdev, Tantra, Yoga texts and documentation, Yoga concepts, Yoga injuries, Yoga paths, Yoga scholars, Yogis, Yoga stubs, Template:Asanas, Kesin, Meditation, Modern yoga, Patanjali, and Sattvic diet”.

Some embodiments comprise chat rooms with one or more zoology dedicated topics, including, but not limited to, “Zoologists by field of research, Herpetology, Ichthyology, Mammalogy, Ornithology, Paleozoology, Planktology, Arachnology, Arthropodology, Batrachology, Bryozoology, Carcinology, Cheloniology, Cnidariology, Conchology, Cynology, Ethology, Helminthology, Herpetology, and Ichthyology”.

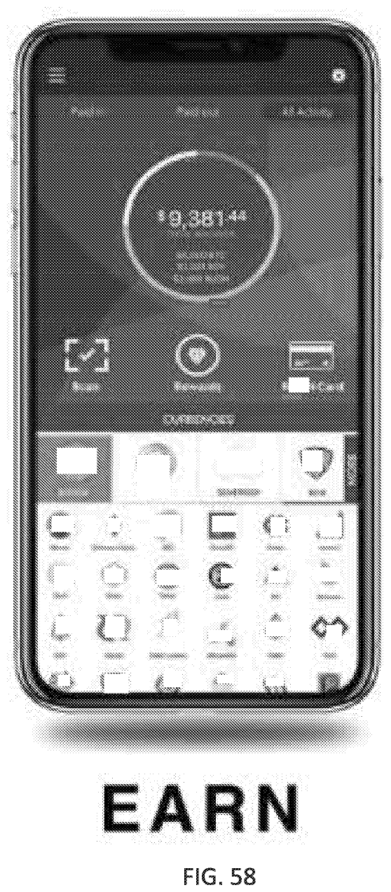

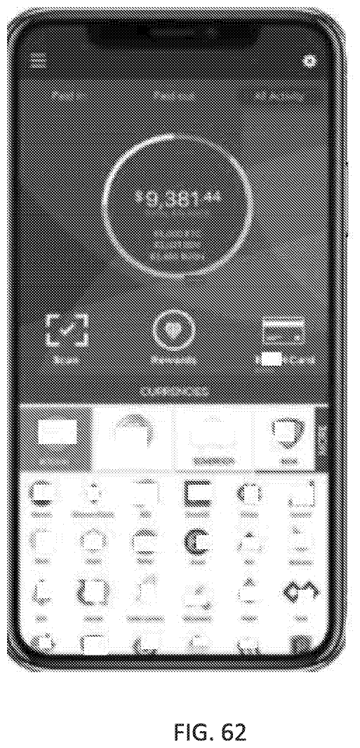

FIG. 58 shows an “earn” display page in accordance with some embodiments of the invention. In some embodiments, the “earn” display can include a total of earned currency or tokens. In some embodiments, the display can include one or more selectable currencies for conversion, receiving, and/or sending. FIG. 62 shows a similar display including a digital wallet where the lower portion can be scrolled through for one or more selectable currency systems. In some embodiments, the system can process an in-application token exchange including the ability to share and exchange any tokens (i.e., such as those purchased via the system exchange) within the system ecosystem and system application. For example, in some embodiments, any tokens in one cryptocurrency can be at least partially exchanged with at least one other cryptocurrency within the system. In some embodiments, this in-application exchange can occur substantially in real-time. This can occur within the confines of the system without the need for a user to perform a conversion with another application (e.g., such as a third-party cryptocurrency exchange).

Some embodiments of the system include one or more servers and security features, including, but not limited to, auto-scaled servers, PCI DSS compliance, pen-tested Servers and Software, real-time monitoring and alerts, custodian Integration, 2FA google authentication, biometric verification in mobile application, anti-phishing protection, anti-theft tokens, anti DDoS Solutions, four levels of encryption, and regular automated backups in different geographically data centers.

In some embodiments, system main features can include, but not be limited to, instant liquidity shared with twenty or more top exchanges, a large variety of trading pairs, real-time trade execution, support for KYC and AML providers, localization and translations management, emails and SMS templates management, REST-APIs, web socket and FIX APIs, rich statistics and reports, a referral module, roles management, a large variety of currency trading pairs, Fiat (money without intrinsic value) to crypto conversion, advanced API's for traders, margin trading, the ability to set a coin as a default trading pair, and the ability to determine pricing structure.

In some embodiments, system features can include, but is not limited to, extremely secure vault technology, derivatives capability, the ability for a user to determine design and branding, a passive income system, fully secured hosting, full maintenance and support, a customizable skin, transactional emails and SMS providers, marketing tools, a built-in affiliate system, account tiers, biometric verification in mobile application, tools, indicators, a trading view capability, and a depth chart capability.

In some embodiments, system features can include, but is not limited to, balances, deposits and withdraws management, announcements and news, exchange token, login and device management, and open orders capability (limit, market, stop-order, etc.).

Some embodiments include artificial intelligence exchange system components. Some embodiments include web based digital asset exchange, mobile (iOS, Android) digital asset exchange liquidity provider integrated with twenty of more top exchanges, private and public APIs, order management system (“OMS”), matching engine, compliance and risk management, and back office capabilities. For example, some embodiments include a system comprising one or more software engines running a digital asset exchange. In some embodiments, the digital asset exchange can comprise one or more of the following: web based digital asset exchanges, mobile (iOS, Android) digital asset exchanges, liquidity providers integrated with +20 top exchanges, private & public application programming interfaces (APIs), order management systems (OMS), matching engines, compliance and risk management software, and back office software.

In some embodiments, the digital asset exchange can comprise servers and security components that include, but are not limited to, one or more of the following: auto scaled servers, PCI DSS compliance, pen tested servers and software, real time monitoring & alerts, custodian integration, 2FA google authentication, biometric verification in mobile application, anti-phishing protection, anti-theft tokens, anti-DDoS solutions, four levels of encryption, regular automated backups in different geographically data centers, and combinations thereof.

In some embodiments, the digital asset exchange can comprise features and capabilities that include, but are not limited to, one or more of the following: instant liquidity shared with +20 top exchanges, large variety of trading pairs, real time trade execution, support for know your customer (KYC) & anti-money laundering (AML) providers, localization & translations management, emails & short message service (SMS) templates management, representational state transfer (REST) APIs, web socket and financial information exchange (FIX) APIs, rich statistics & reports, referral module, roles management, large variety of currency trading pairs, Fiat to crypto currency conversions, advanced API's for traders, margin trading, “set your coin as a default trading pair” functions, and “determine your pricing structure” functions.

In some embodiments, the digital asset exchange can further comprise features and capabilities to provide one or more of the following: extremely secure vault technology, derivatives, personalized design and branding, a passive income system, fully secured hosting, full maintenance & support, customizable skin, transactional emails & SMS providers, marketing tools, built in affiliate system, account tiers, biometric verification in mobile application, tools, indicators, trading view, depth chart, balances, deposits and withdraws management, announcements & news, exchange token, login & device management, open orders (limit, market, stop order, etc.).

In some embodiments, the digital asset exchange can comprise a setup process. The setup process can include, but are not limited to, one or more of the following steps: an account manager is assigned for each customer, an onboarding is carried out by account manager for each customer, an infrastructure is set up on a subdomain (one week), a customer gets access to all the features of the dashboard, a team provides one on one training and materials prelaunch to ensure the customers understand the system. The digital asset exchange setup process can comprise other steps, and/or the aforementioned steps can be provided in any order.

In some embodiments, the digital asset exchange can comprise systems that support multiple currency types. The currency types can include, but are not limited to, one or more of the following: Bitcoin, Bitcoin Gold, Bitcoin Cash, Bitcoin Cash SV, Litecoin, Ethereum, Dash, Dogecoin, Zcash, Tether, all Ethereum based tokens, Ripple, Stellar, EOS, Tron, Cardano, Monero, IOTA, Tezos, NEM, Ontology.

In some embodiments, the system can comprise a blockchain system with a communication node located on one or more of a water vehicle or floating object including, but not limited to, ships, boats, submarines, barges, buoys, and the like. In some embodiments, the blockchain system can execute contracts in international waters, while avoiding such transactions in countries that prohibit such transactions. In some embodiments, the blockchain system checks one or more jurisdictional boundaries defined by one or more global positioning systems (GPS) coordinates. In some embodiments, the blockchain system automatically signs one or more transactions when either inside or outside the jurisdictional boundaries defined by GPS. In some embodiments, one or more communication nodes can communicate with, either by a continuous or intermittent signal, a single satellite or a network of satellites in orbit around the earth. In some embodiments, the satellite or satellites can be in a low earth orbit. In some embodiments, the satellite or satellites can be in a polar orbit and/or a geosynchronous orbit.

In some embodiments, the system can comprise a space-based blockchain satellite network that host a blockchain system in space. In some embodiments, the system can comprise a SovereignSky space-based satellite blockchain network as previously described. In some embodiments, the space-based blockchain satellite network can be powered by one or more of solar panels, batteries, and/or nuclear power; other suitable power supplies can also be used. A space-based blockchain satellite network can comprise nodes comprising between 1 to 2,500 small micro cube satellites which are launched into space. The satellite shape is not limited to a cube, as any suitable shape can be used for the satellite design. In some embodiments, the space-based blockchain satellite network can serve as a giant free trade zone. In some embodiments, the free trade zone complies with one more rules of earth-bound governments. In some embodiments, the free trade zone operates independent of and is not required to comply with one or more rules for one or more earth-bound governments. In some embodiments, the space-based blockchain satellite network automatically signs transactions on nodes located in favorable jurisdictions. In some embodiments, the nodes may be ultra-low power nodes running EOS third generation graphene technology.

In some embodiments, users can get paid in digital currency for posting videos, photos and my stories. In some embodiments, one or more mosaic news feeds allows users to see hundreds of posts all at once. In some embodiments, users can add thousands of followers instantly by adding user interest groups or UIGs.

In some embodiments, the system comprises a social login and connect system. In some embodiments, the social login and connect system can include client based processes including, but not limited to, internal login, internal registration. In some embodiments, the social login and connect system can include external login and registration via outside social media including but not limited to Facebook®, Instagram®, Twitter®, LinkedIn®, and the like. In some embodiments, the social login and connect system can include the ability to import images, content, and contact information from outside social media accounts. In some embodiments, the social login and connect system can access and import computer, cell phone, tablet, and/or personal device contact lists, and the like. In some embodiments, the social login and connect system can create categories for contact information. In some embodiments, the social login and connect system can edit contact information and assign or edit contact groups to contact profiles. In some embodiments, editing contact info can include changing phone numbers, addresses, email addresses, and the like.

In some embodiments, the system displays video filters and tags, animated selfies, and picture filters, tags, and the like. In some embodiments, the system displays and allows access and editing of information feeds from outside social media accounts. In some embodiments, information feeds can be manipulated by swiping left or right on a touch screen or display interface. In some embodiments, swiping left or right allows users to switch between applications or tabs within applications.

In some embodiments, the system allows the user trend content to specific audiences or integrated outside social media platforms. In some embodiments, the system allows the user to promote videos, chats, posts, and the like across the user media platform server system.

In some embodiments, the user can create user profile settings and edit user profile settings. In some embodiments, profile settings include posting on information feeds, following and unfollowing users, commenting and liking other user's post, editing and deleting post, editing and deleting comments, blocking users, reporting posts, editing push notifications, and searching or discovering other users.

In some embodiments, a user can collect tokens for joining the user media platform server system. In some embodiments, a user can view their tokens via their profile page. In some embodiments, a user can receive tokens for every successful invite. In some embodiments, a user can add tokens to other post and video streams. In some embodiments, a user can offer tokens from the user's personal profile to information or video feeds to offer as incentive for other users to interact with feed content.

In some embodiments, the system comprises content posting. In some embodiments, content posting comprises one or more of: users paying for longer videos length, users paying for advanced features on sending videos (i.e., setting time for disappearing), users paying to store and save daily myVideos stories (min. monthly fee), users paying to send pictures as postcards (partnership) (create app page), users paying to access library of premium animated emoji features, users paying for library of premium filters and advanced/animated filters, users paying for library video effects and SFX, special titles, users paying to trend video to bigger audience on the system application, users paying to activate user interest groups or “UIGs” for individual content image posts & videos, users paying to promote their video content, image posts and status updates (update app page with status update), users paying for library of additional effects, titles, animations on daily status updates.

In some embodiments, the system comprises a dedicated store. In some embodiments, the dedicated store comprises one or more of: the user pays to active each dedicated store, cost is taken from their first sales (monthly fee), users pay to upgrade their stores, users paying to for add-on features or individual items, users paying to “feature” their new items on news feeds, allowing developers (using open source) list add-on products and features for enhanced shopping, users paying to activate “UIG” to promote store to (monthly fees for as long as they are connected to “UIG” group), to turn on their customer chat room connected to their store (min. monthly fee), users pay to advertise their stores within Amazon-style search directory (PPC & PPM).

Some embodiments of the system can generate, utilize, and/or user-interest feeds (UIFs) where the artificial intelligence engine of the system create one or more user-interest feeds for the use. Some non-limiting example feeds can include, but not be limited to, a standard news feed from your friends and family like Instagram®. In some embodiments, because a user has categorized friends, the user can select a feed that includes, but is not limited to, close friends, distant or casual friends, business contacts, and family. In some embodiments, the system can enable the user to choose a feed from one or more interest groups, and display the one or more feeds from one or more users within one or more groups. In some embodiments, the user can be enabled to choose a feed from the topic of the interest group so that the feed displays #hashtag content associated with the interest group. In some embodiments, once a user selects an interest group, the group chat from that interest group will be accessible from within a user's message center. In some embodiments there are three group chats for each of the user's selected interests. In other embodiments, there can be more or fewer group chats for each user. In some embodiments, the followers from within each interest group can follow a user's profile automatically or manually.

FIG. 59 shows a “choose AI” display page in accordance with some embodiments of the invention. For example, in some embodiments, the display page can include one or more selectable artificial intelligent personal assistants. In some embodiments, the display page can include one or more selectable artificial shoppers. In some further embodiments, the display page can include one or more selectable artificial birthdays reminders. In some other embodiments, the display page can include one or more selectable artificial matchmakers. In some embodiments, the display page can include one or more selectable artificial entertainment and events. In some embodiments, the display page can include one or more selectable artificial money makers.

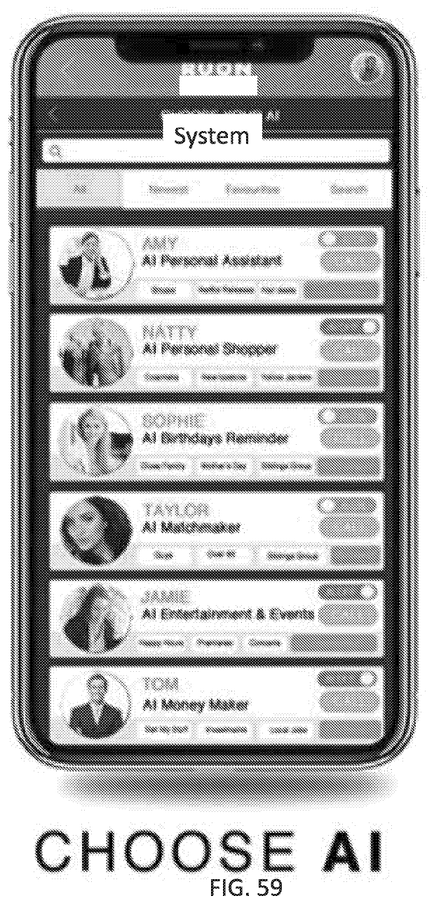

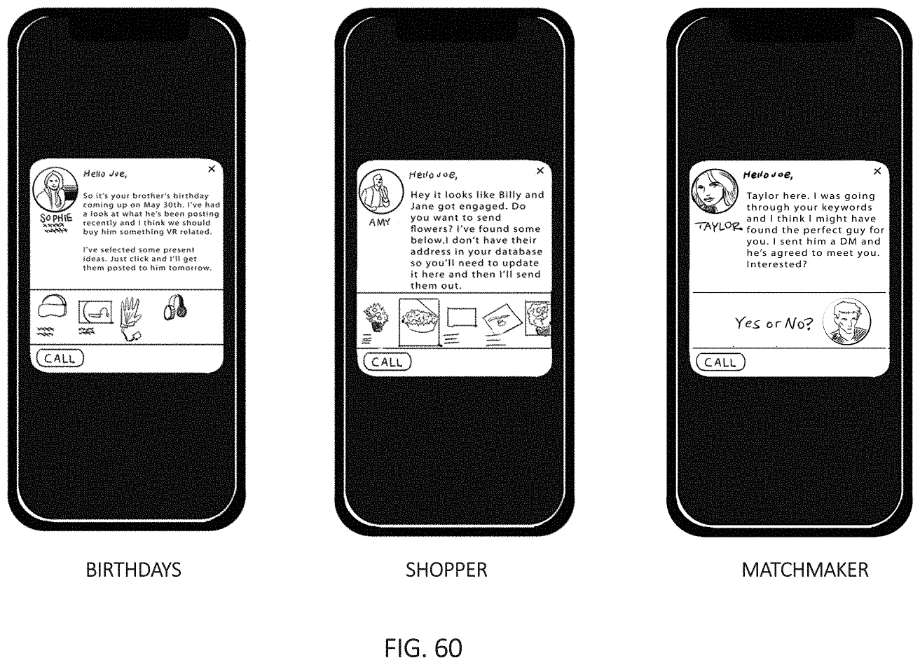

FIG. 60 shows “birthday”, “shopper”, and “matchmaker” display pages in accordance with some embodiments of the invention. In some embodiments, the display pages include personal assistant services to the user. In some embodiments, the system artificial intelligence engine can generate at least one personal assistant offering services to the user as shown. In some embodiments, the artificial intelligent personal assistants can interact with the user and suggest one or more outcomes, products, or services. In some embodiments, the display can include an image or video of a product or service suggested by the artificial intelligent personal assistant. In some embodiments, this might include live call staff once the company has a decent turnover to afford physical staff to support the system's artificial intelligence engines.

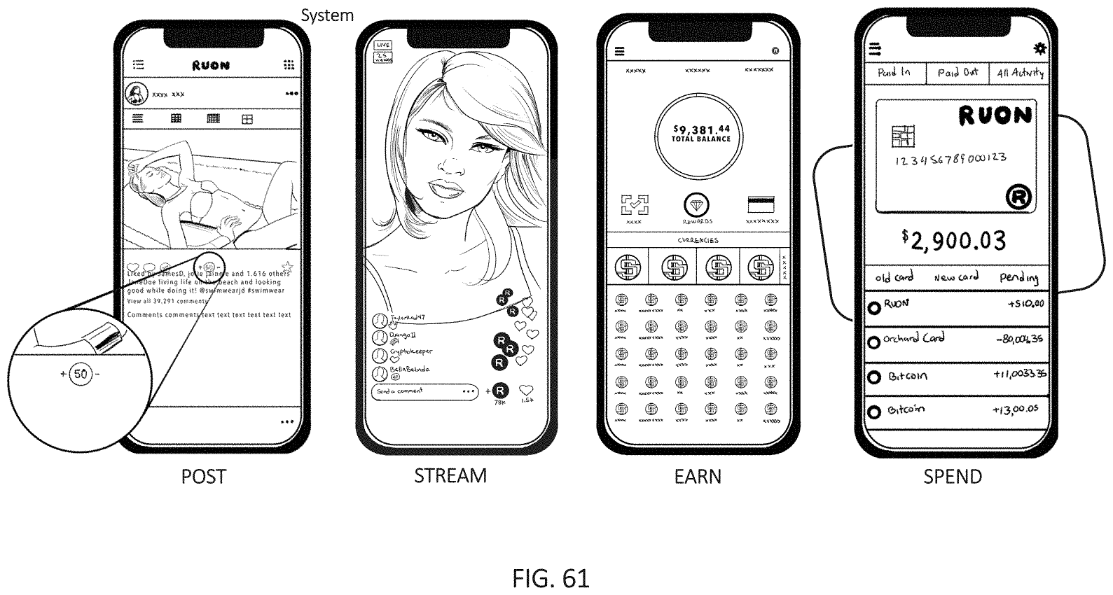

FIG. 61 shows “post”, “stream, “earn”, and “spend” display pages in accordance with some embodiments of the invention. In some embodiments, the system provides a platform enabling a method of spending by posting content. For example, in some embodiments, a user can post one or more content items, stream content, receive rewards for content, and spend reward for content.

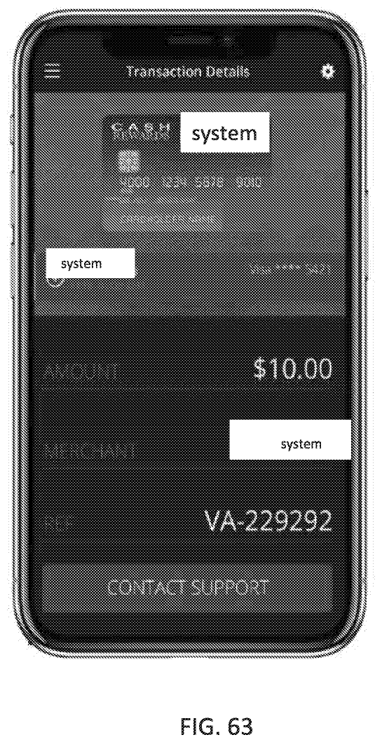

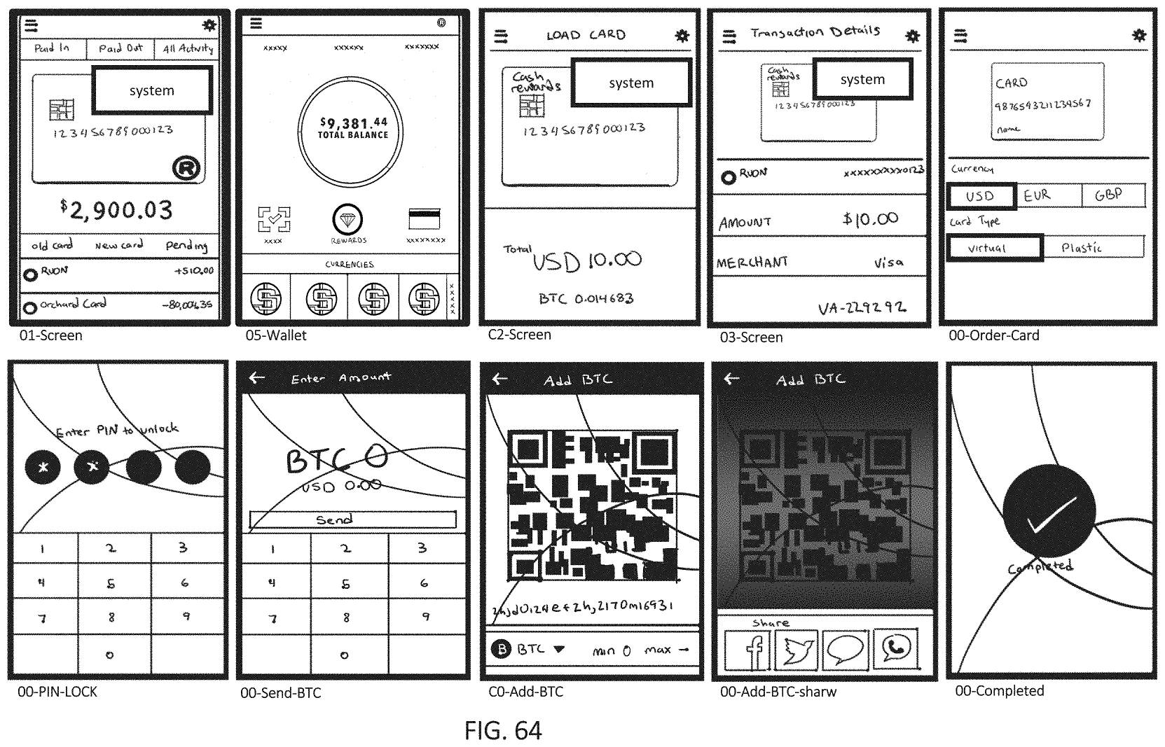

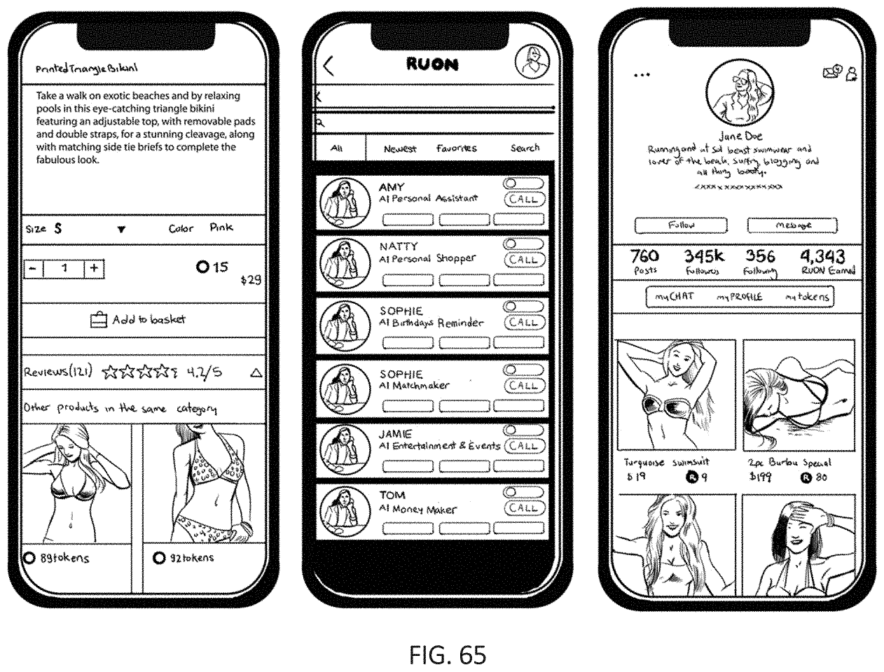

FIG. 63 shows a user transaction display in accordance with some embodiments of the invention, and includes details of transactions, including, but not limited to, amount, merchant, and reference number. Further, FIGS. 64-65 shows miscellaneous system-generated display pages in accordance with some embodiments of the invention. As shown in the display images of FIG. 64, some embodiments include detailed display screens related to a user's payment account and transactions. In some embodiments, one or more of these display screens can be shown following a review and selection of a product or service of a dedicated store as illustrated in FIG. 65.

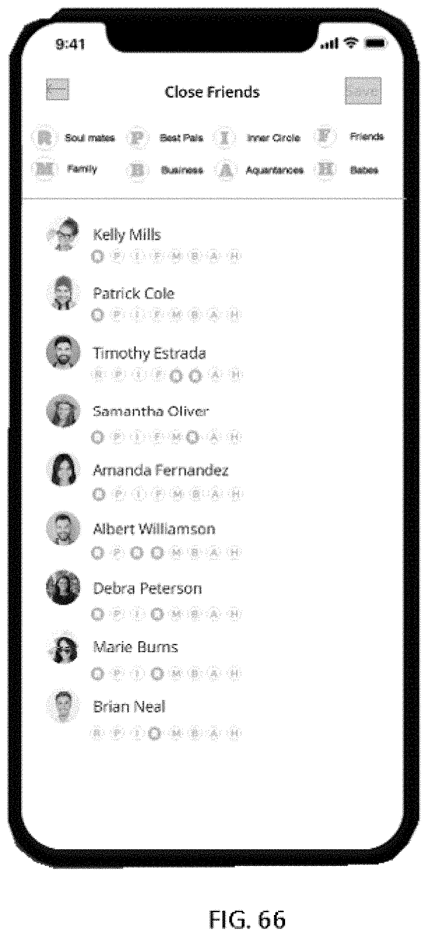

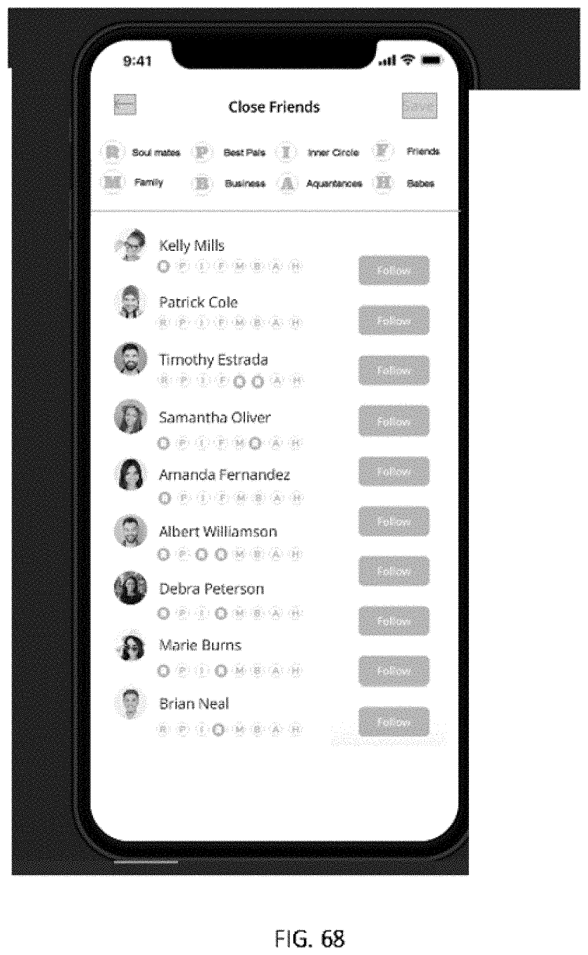

As discussed earlier, in some embodiments, the system can enable contact categorizing, including system processed categorizing using an artificial intelligence algorithm that analyzes the communication habits of a user. Referring to FIGS. 66 and 68, showing friend categorization display pages, in some further embodiments, the system can enable user categorization of friends and/or other contacts. In this non-limiting embodiment, the display page can be used to categorize close friends using one or more selectable categories, including, but not limited to, “soul-mates”, “family”, “best pals”, “business”, “inner-circle”, “acquaintances”, “friends”, and “babes”. In some embodiments, each category can include an associated icon. In some embodiments, the display can include a list of one or more friends including an associated icon based on a user selection and/or an artificial intelligence selection. In other embodiments, the same features can be used to categorize other users, including, but not limited to friends, family, relationships, other users, non-users, system contacts, personal contacts, business contacts, users associated with the user's posted content (e.g., such as user's who have accessed, viewed, and/or rewarded the user's posted content).

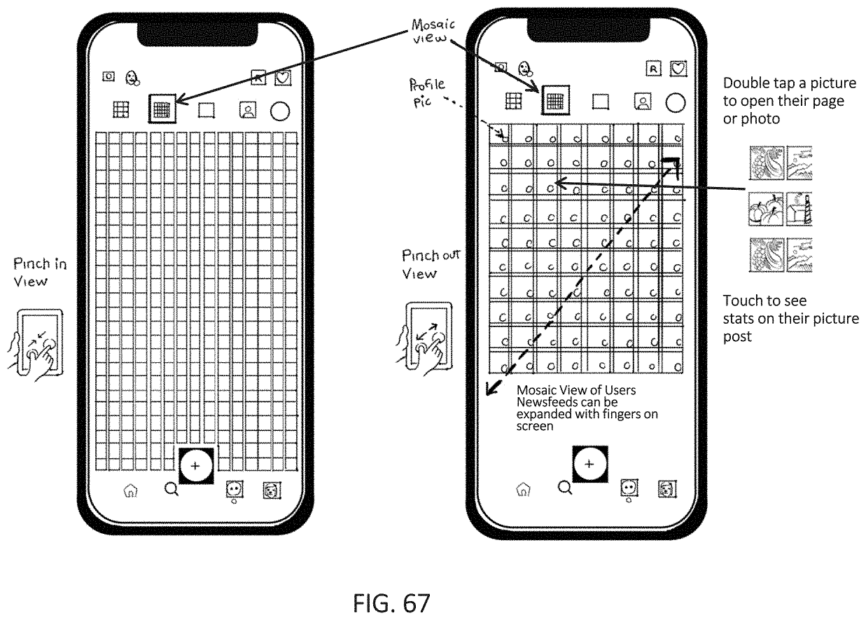

Referring to FIG. 67, illustrating a display method according to some embodiments. In some embodiments, the system can enable a user to expand or contract the displayed content of the display page to enable more or less content to be displayed. For example, in some embodiments, a pinch-in action of a user with the display screen of the user's device can maximize the viewing content for the purposes of selection of a potential date, whereas a pinch-out action can minimize the displayed content. The non-limiting embodiment of FIG. 67 shows the display screen in a mosaic view function with a plurality of content displayed in mosaic format, and comprising mosaic newsfeed. In some embodiments, the content can comprise a mosaic newsfeed including profile images and/or videos. In some embodiments, a user can double-tap or select one or more of the content images or video to open the page, image or video, or can touch the content to show statistics on the content.

In some embodiments, the mosaic view can enable users to search and display other dates, potential dates, other users, contacts, friends, partners, business or personal contacts, or users associated with the user's posted content as described above, where the user can manipulate the display to reduce or enlarge the individual images to show more or less images on the display. In some embodiments, the mosaic display can include other users or potential users within a dating application engine of the system. In some embodiments, the system can enable the initiation of a dating process by selecting one or more of the displayed images of users, contact, friends, acquaintances or strangers. As with other user interactions with the system, any selection or interaction with the display by a user can comprise or initiate a blockchain tracking of the interaction using any of the blockchain processes described herein.

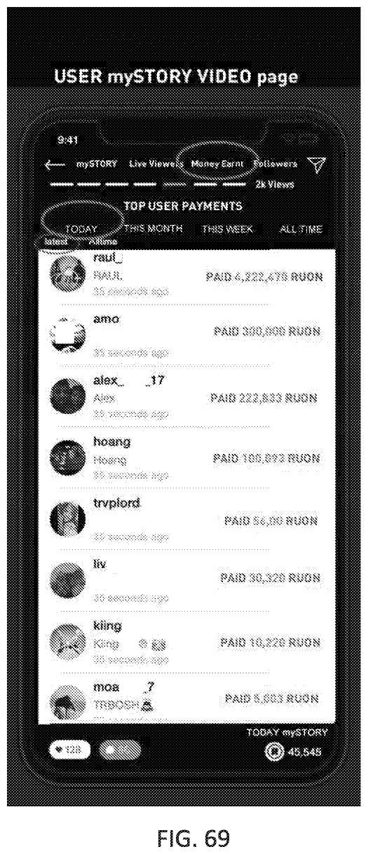

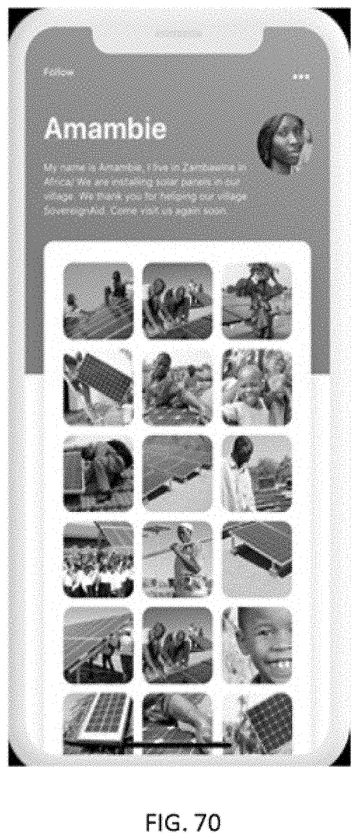

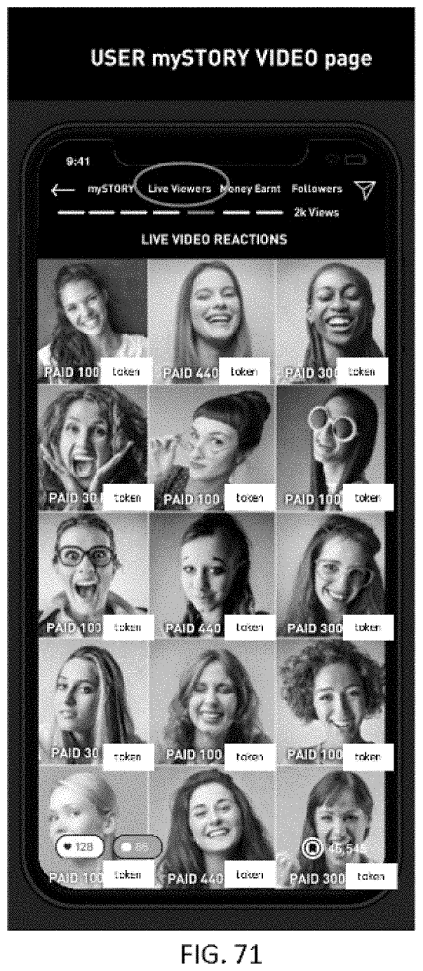

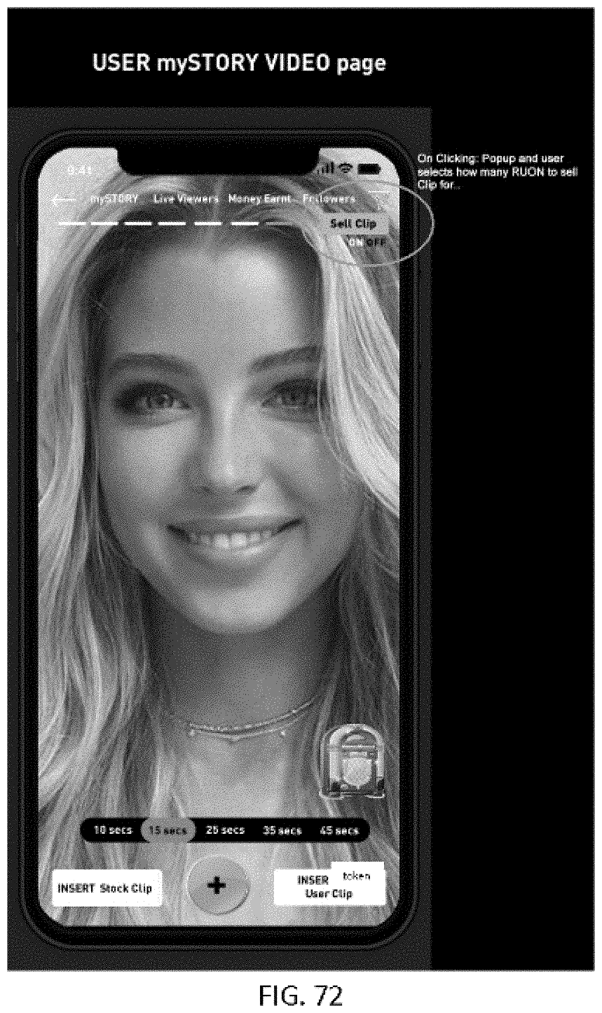

FIGS. 68-99 illustrate display images generated by the system and one or more processes described herein in accordance with one or more embodiments of the invention. For example, FIG. 69 shows a system-generated display page including a “myStory” video page where a user can view one or more other users and the amount other users may have paid for access to one or more posted content items of the user's “myStory” video page. As shown in FIG. 71, in some embodiments, the system can display one or more live or recorded videos and/or image of viewers of content. FIG. 72 shows a “myStory” video page where a user can video and/or image clip capture and posting page. The display can include a “sell clip” icon enabling the user to configure selling parameters such as minimum or maximum sale price for a captured video or image, and/or currency parameters, and/or posting location(s), and/or posting time.

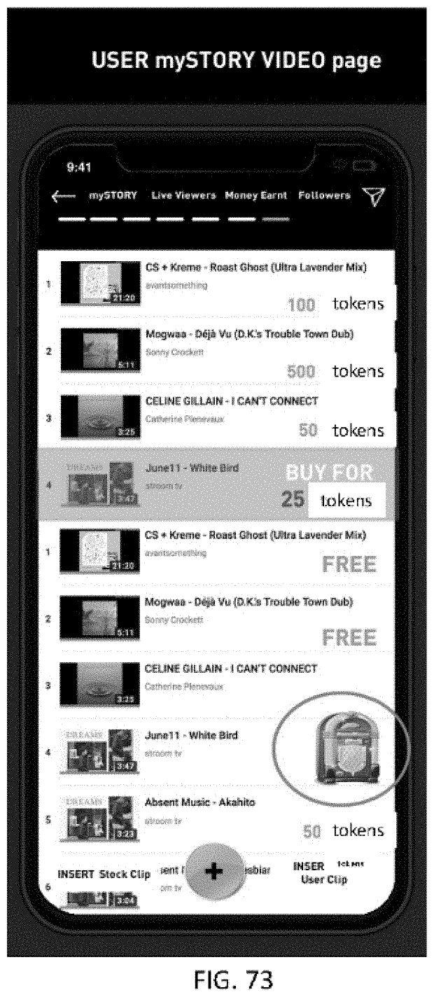

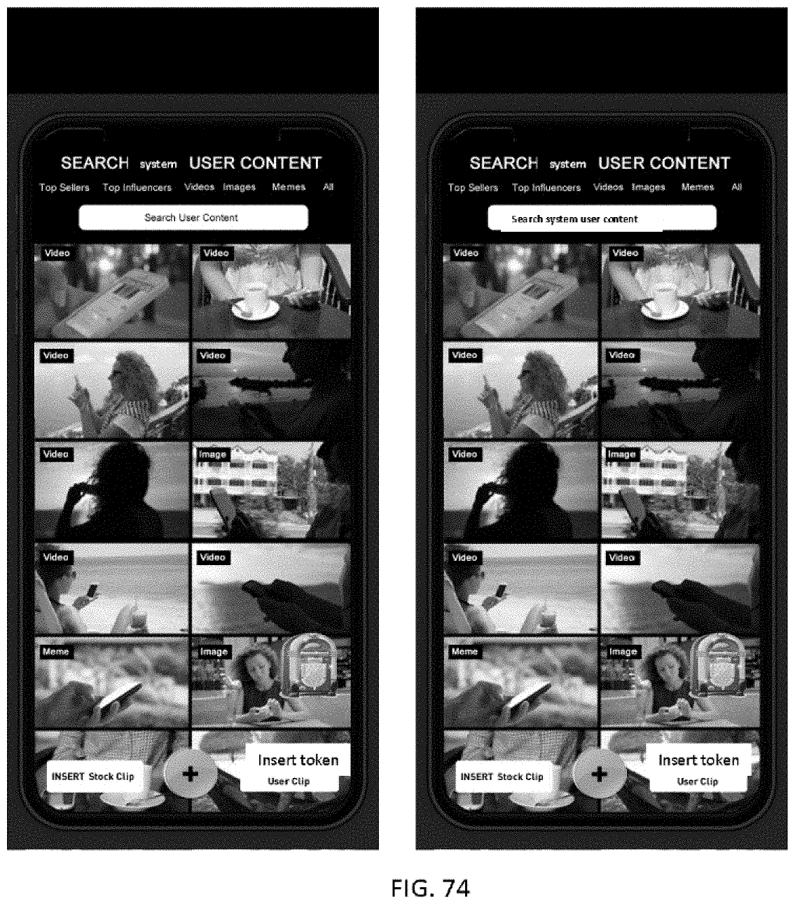

Referring to FIG. 73, some embodiments include a display enabling selection of one or more stories or other content. Referring to FIG. 74, some embodiments include display enabling a user to search for and/or sell content such as videos and/or images, or other posted information.

FIG. 75 illustrates a “comments on content” display page in accordance with some embodiments of the invention. In some embodiments, any display content can include a comments section enabling users to post comments and/or feedback.

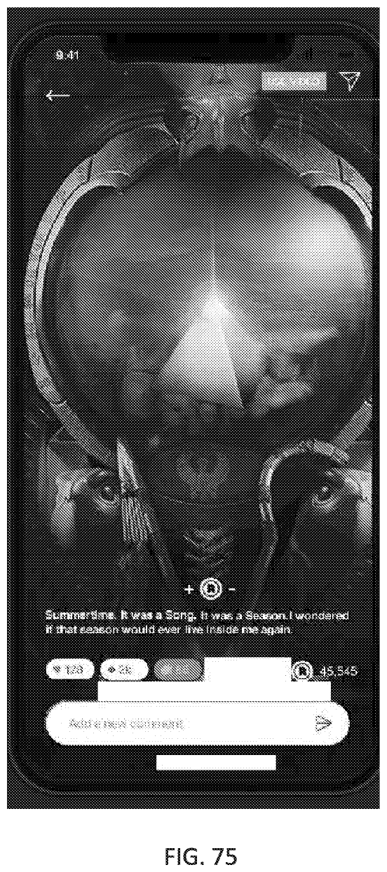

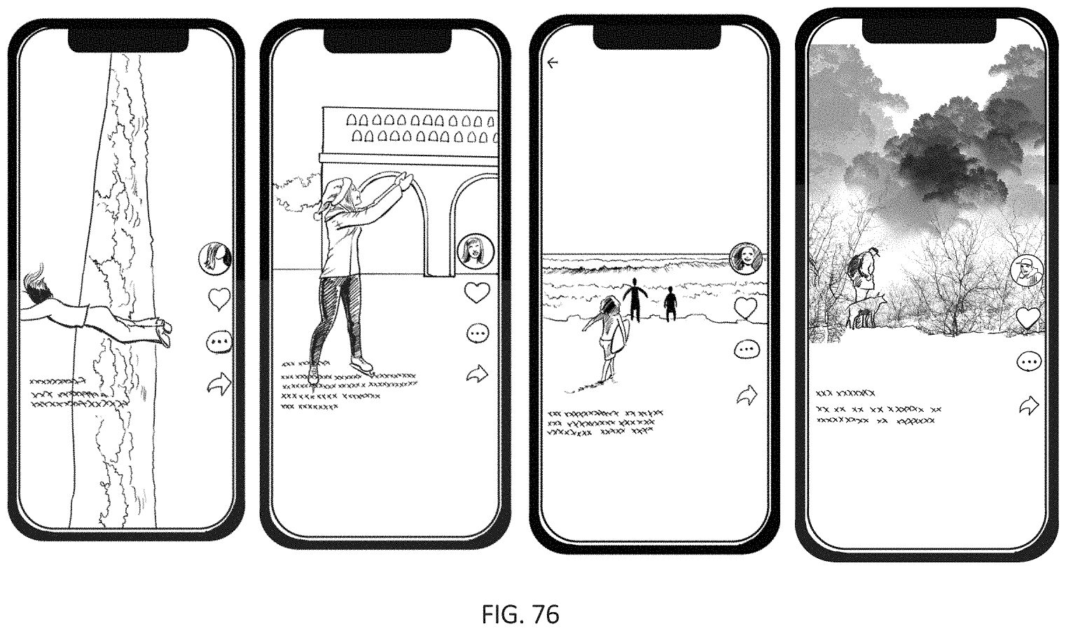

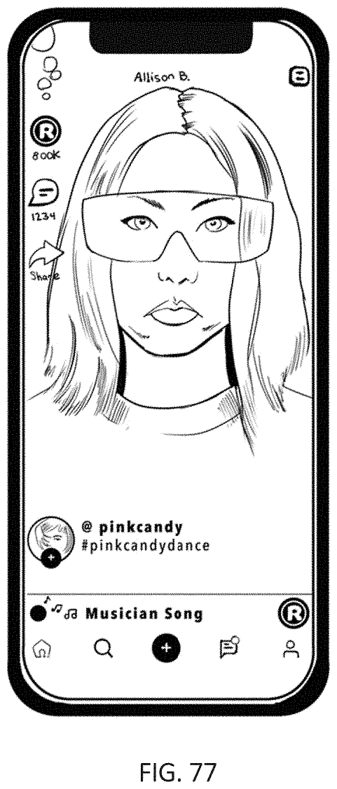

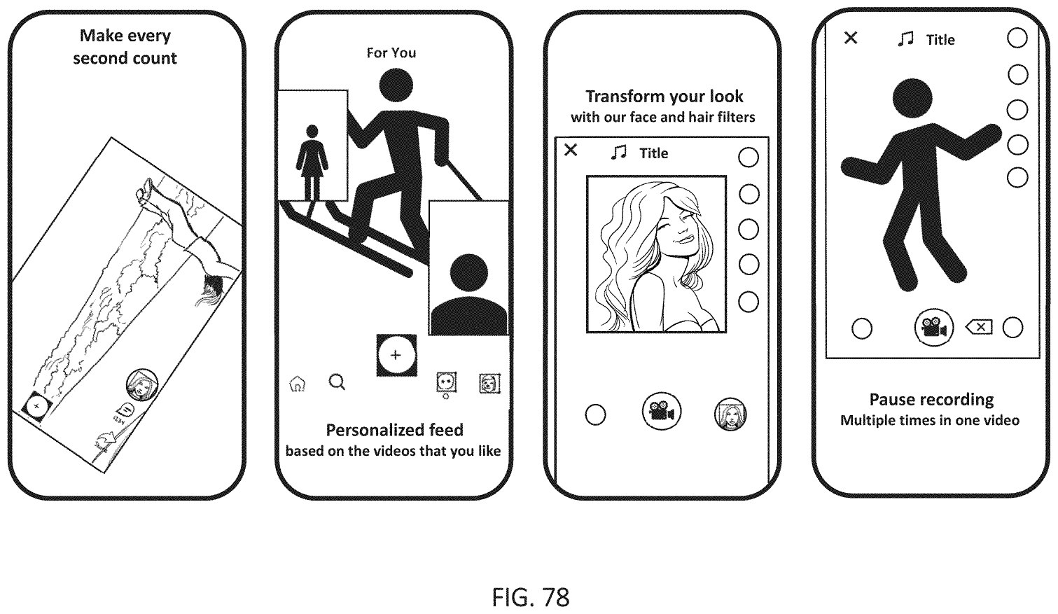

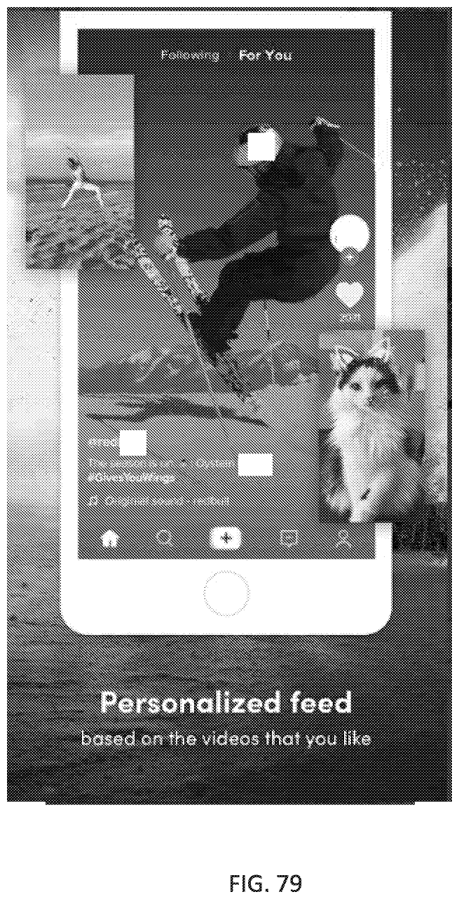

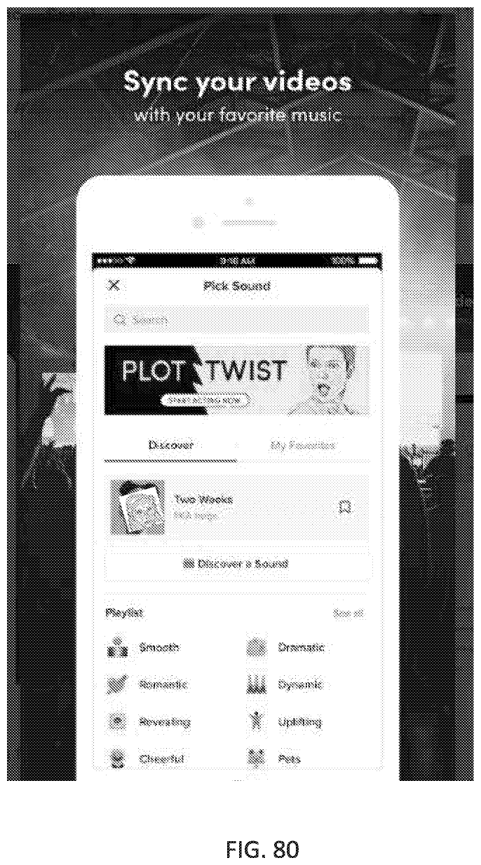

Some embodiments can integrate with, include, or duplicate one or more functions of a “Tik Tok”-style music video-sharing application, and employ blockchain technology to enable users awarding other users with their cryptocurrencies in addition to or in place of posted “likes”. For example, in some embodiments, the system can enable users to shoot and edit short clips, add music, and special effects into those videos. Some embodiments enable a user to access a “Use a Video” function or icon from another user's “mySTORY” or video or post in a user's own “Tik Tok” style “Create a Video” function. FIG. 76 illustrates content and/or stories display pages in accordance with some embodiments of the invention. FIG. 77 illustrates content view display page in accordance with some embodiments of the invention. FIG. 78 illustrates “tik-tok”-style display pages in accordance with some embodiments of the invention. FIG. 79 illustrates a personalized feed display page in accordance with some embodiments of the invention. FIG. 80 illustrates a synchronize video display page in accordance with some embodiments of the invention.

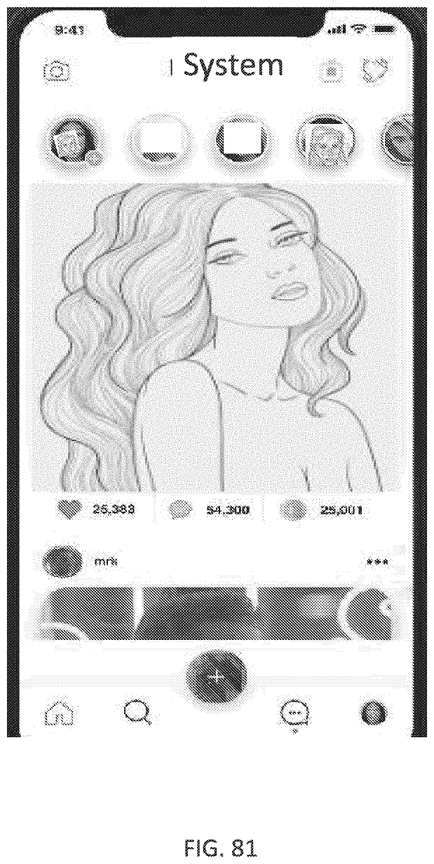

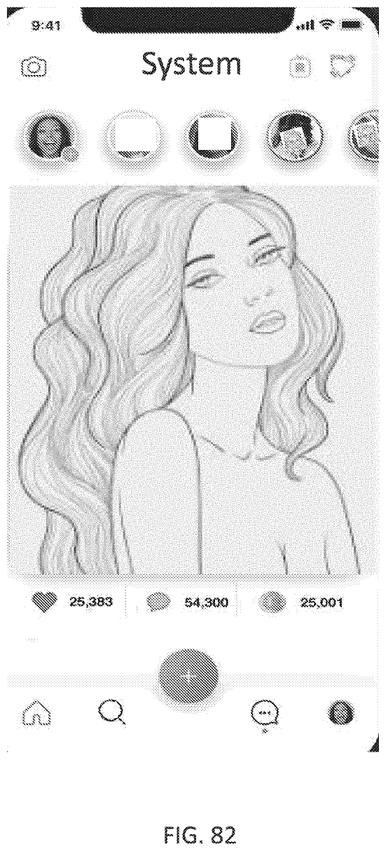

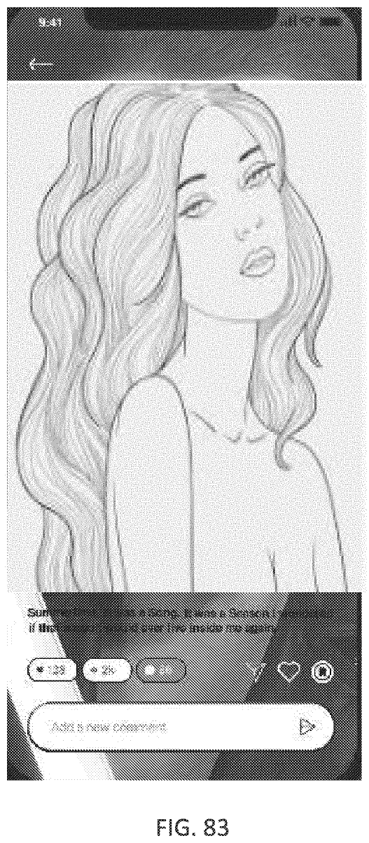

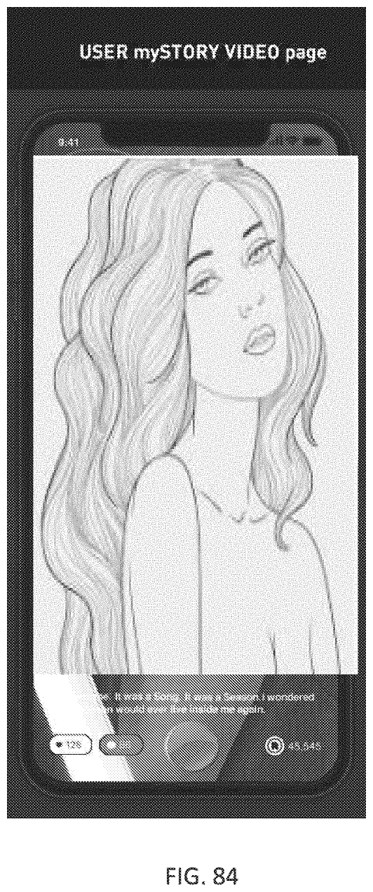

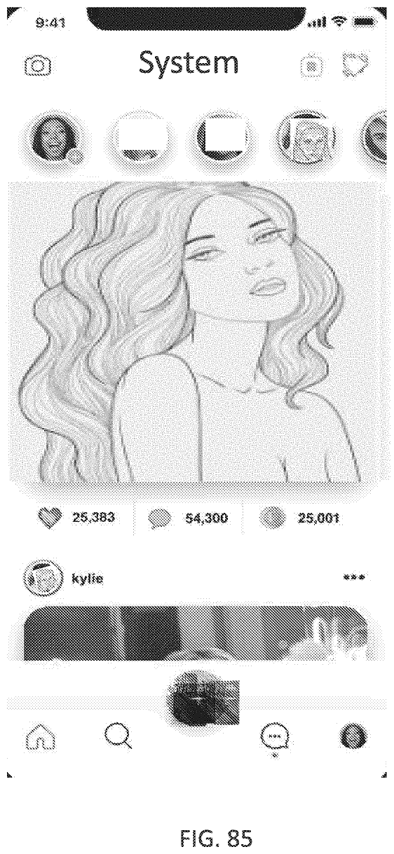

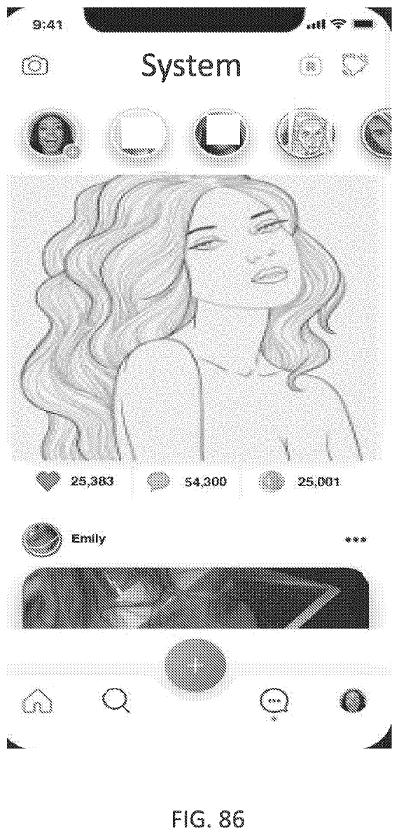

The system can provide a variety of methods for a user to manipulate a content and/or posting display page. For example, FIG. 81 illustrates shows a user and/or content scrolling display page in accordance with some embodiments of the invention. FIG. 82 illustrates a currently viewed display page in accordance with some embodiments of the invention. FIG. 83 illustrates an add comment display page in accordance with some embodiments of the invention. Further, FIG. 84 illustrates a myStory display page in accordance with some embodiments of the invention. FIGS. 85-86 illustrate scrolling profile display pages in accordance with some embodiments of the invention.

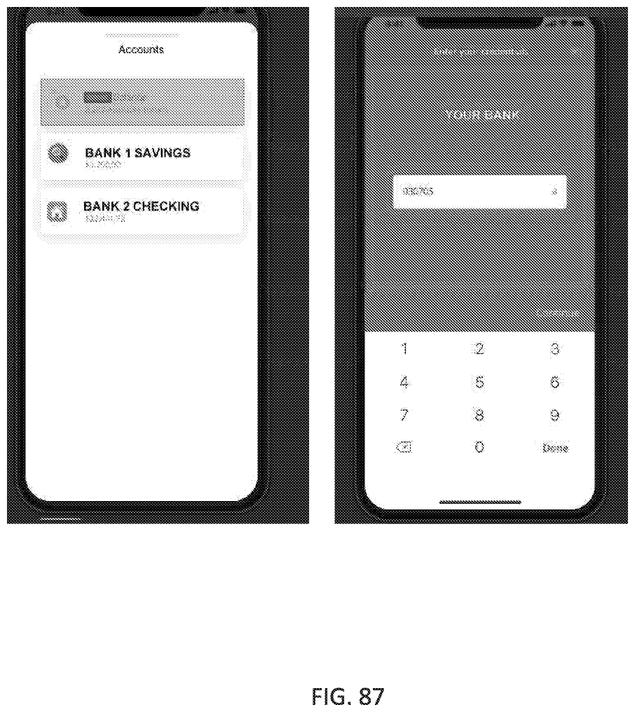

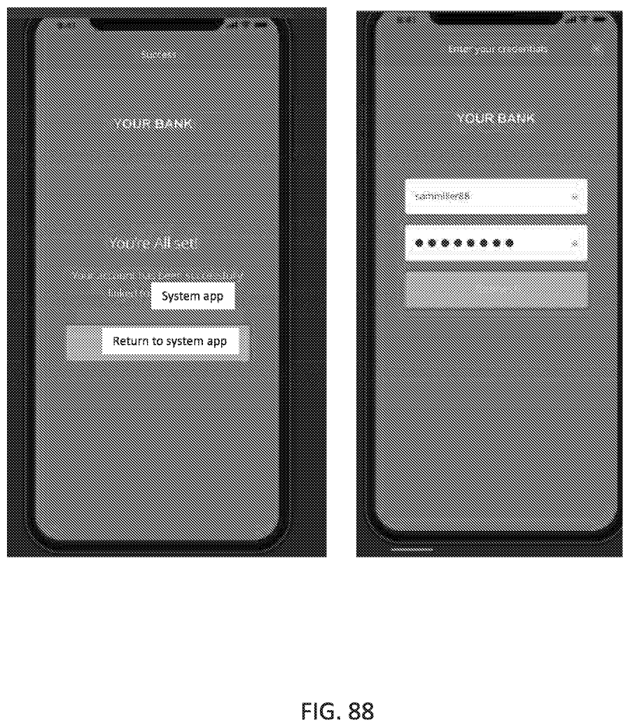

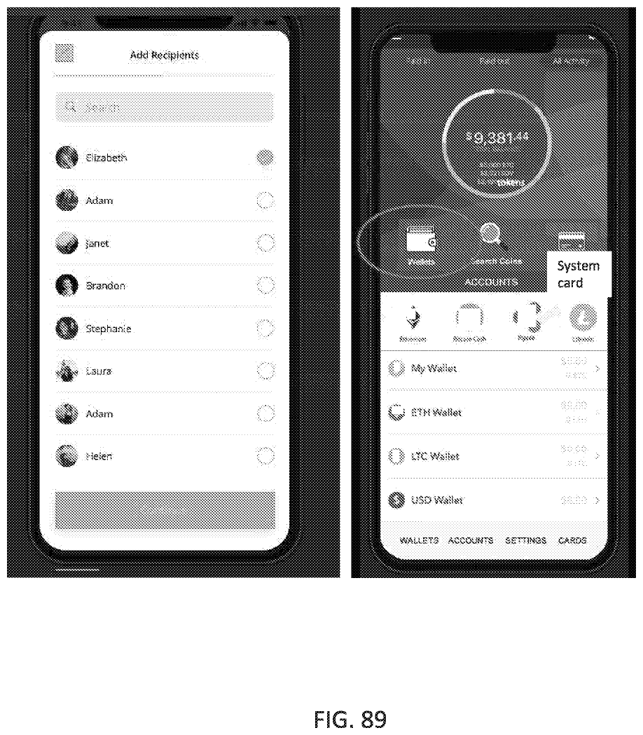

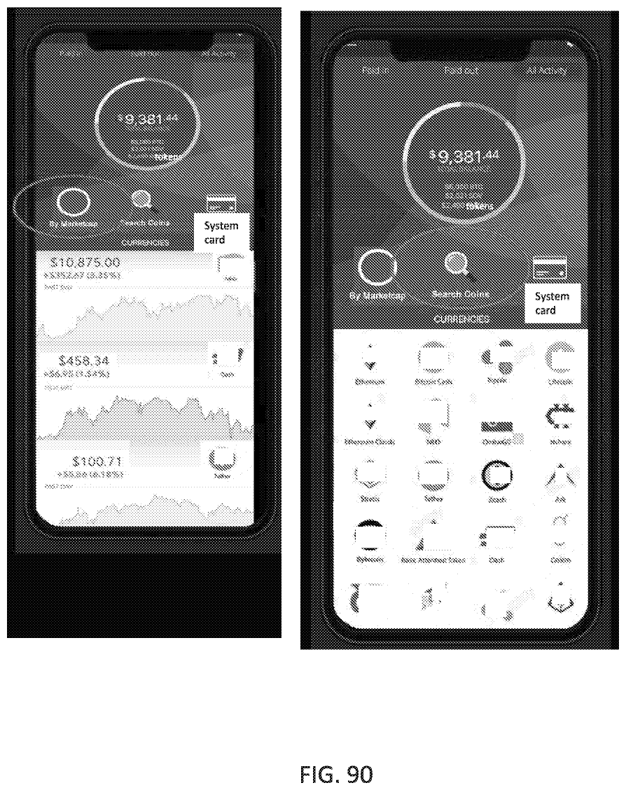

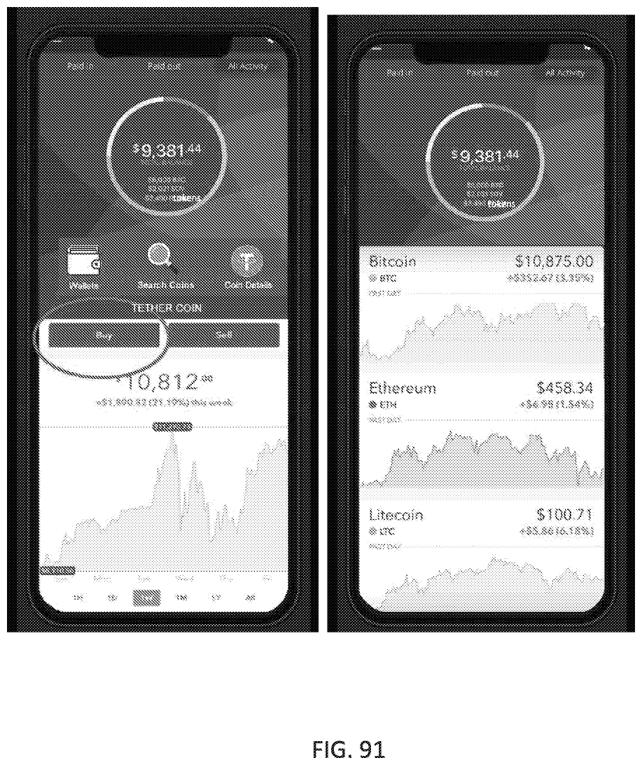

As described earlier, some embodiments include a system with functions built on sovereign blockchain and/or a scalable blockchain, and/or systems utilizing a hybrid blockchain that enables the system to process an in-application token exchange. Some system-generated display screens related to in-application cryptocurrency are shown in FIGS. 87-91. For example, FIG. 87-88 illustrates in-application cryptocurrency banking and exchange display pages in accordance with some embodiments of the invention. FIG. 89 illustrates wallet and currency recipients display pages in accordance with some embodiments of the invention. FIG. 90 illustrates marketplace and Coins search cryptocurrency display pages in accordance with some embodiments of the invention, and FIG. 91 illustrates crypto wallet and buy/sell tether display pages in accordance with some embodiments of the invention.

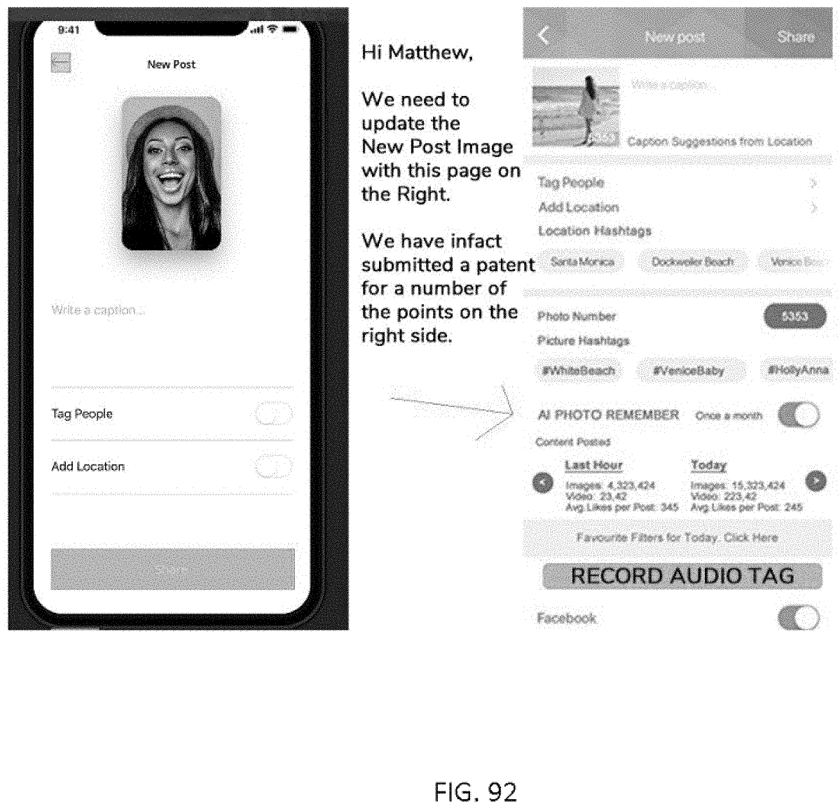

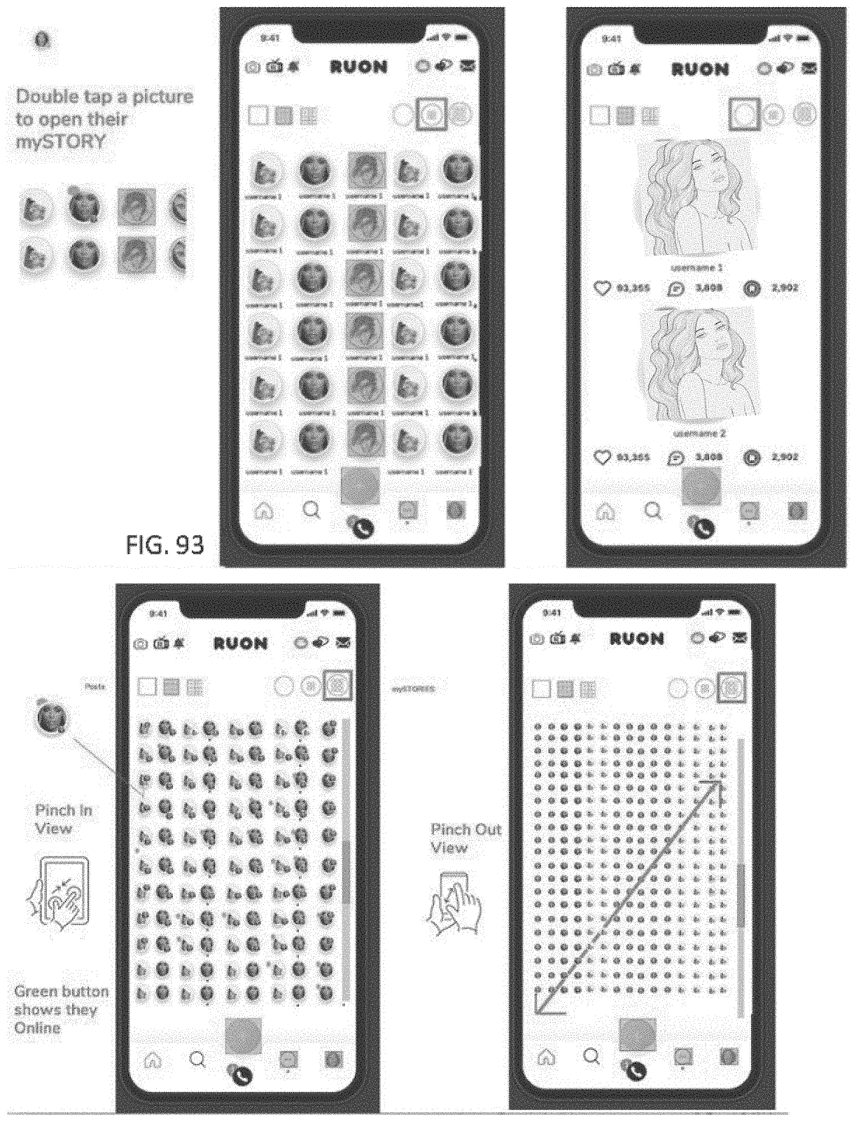

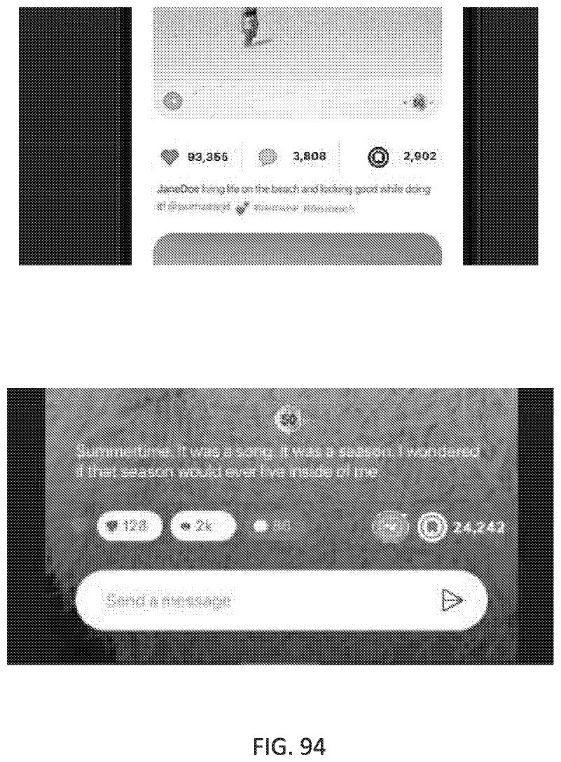

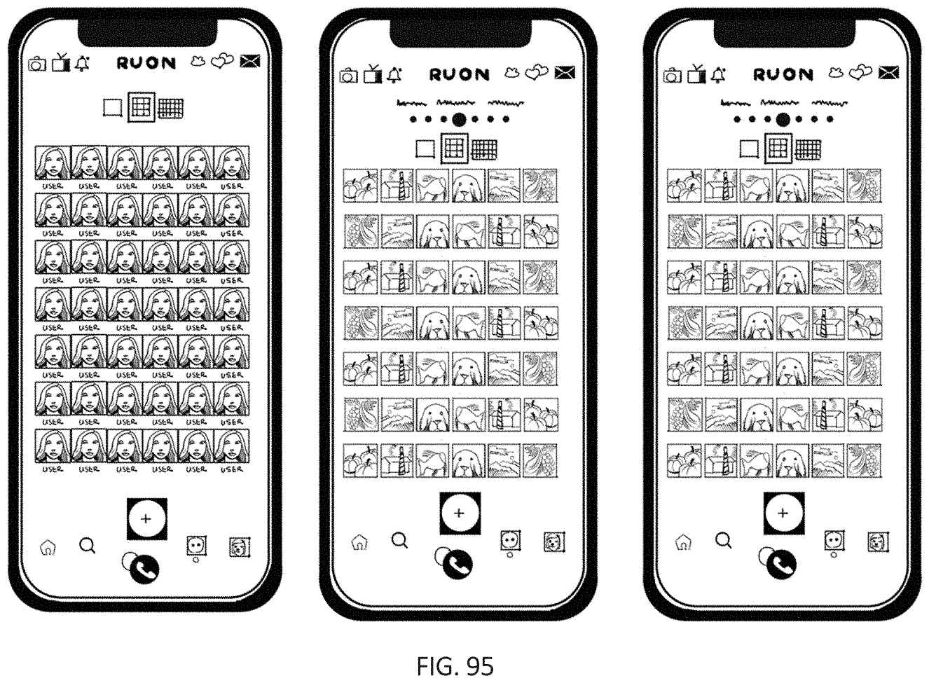

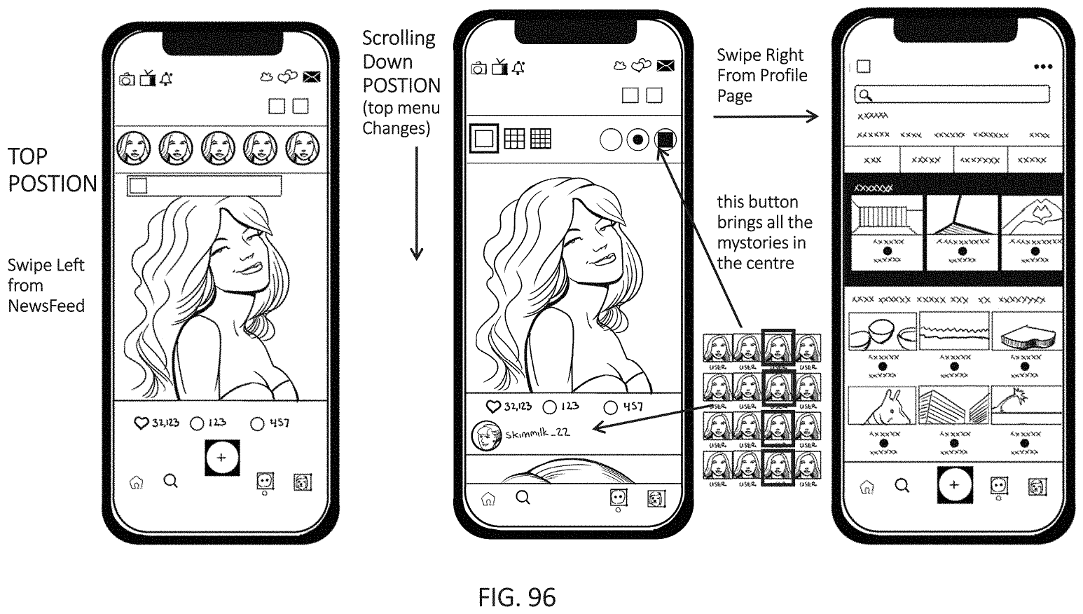

Related to the earlier discussion of “tik-tok”-style functions, FIGS. 92 and 93 illustrate new post display pages in accordance with some embodiments of the invention. Further, in some embodiments, the system allows users to expand or contract the displayed content using a pinch-in action of a user and/or a pinch-out action as discussed above. The mosaic view can enable users to search and display other dates, potential dates, such as illustrated in FIG. 93 showing dating users and myStory access display pages in accordance with some embodiments of the invention. Further actions following a selection enable communications or actions related to viewed content, such as that shown in FIG. 94 illustrating portions of display pages including attach currency and myStory features in accordance with some embodiments of the invention. Further, FIG. 95 illustrates friends, followers and matches display pages in accordance with some embodiments of the invention, and FIG. 96 illustrates swiping display page in accordance with some embodiments of the invention.

In some embodiments, the system artificial intelligence engine can facilitate any dating function disclosed herein. For example, in some embodiments, the system artificial intelligence engine can be used to search for one or more dates for a user. In some embodiments, the system artificial intelligence engine can search for information related to the user and at least one other user and apply artificial intelligence to find at least one match between two or more users. For example, in some embodiments, the system artificial intelligence engine can search at least a portion of a user's profile and/or information related to the user, including any information posted or stored within the system. For example, in some embodiments, the system artificial intelligence engine can search a user's “data points”, keywords, hastags, profile pictures and/or posts. In some embodiments, the system artificial intelligence engine can determine at least one characteristic of one or more users for the purposes of matching one user with at least one other user. For example, in some embodiments, the system artificial intelligence engine can determine if a user has blonde hair and how tall they are, and provide a page with a plurality of profiles that “match” the romance criteria the user is seeking.

In some embodiments, a user can be enabled to ask the system artificial intelligence engine to search for lovers or “matches”, searching at least a portion of all the profiles stored in the system to bring up the most relevant. Further, in some embodiments, the system can guide a user through every step of a dating search, and if a user selects a “message all”, the system can send a ‘welcome’ message to all potential matches as determined by the system artificial intelligence and/or the user. Furthermore, the system artificial intelligence can then help with each reply. Some further details can be found at https://medium.com/mit-technology-review/ai-could-be-your-wingman-er-wingbot-on-your-next-first-date-86d2995494c8.

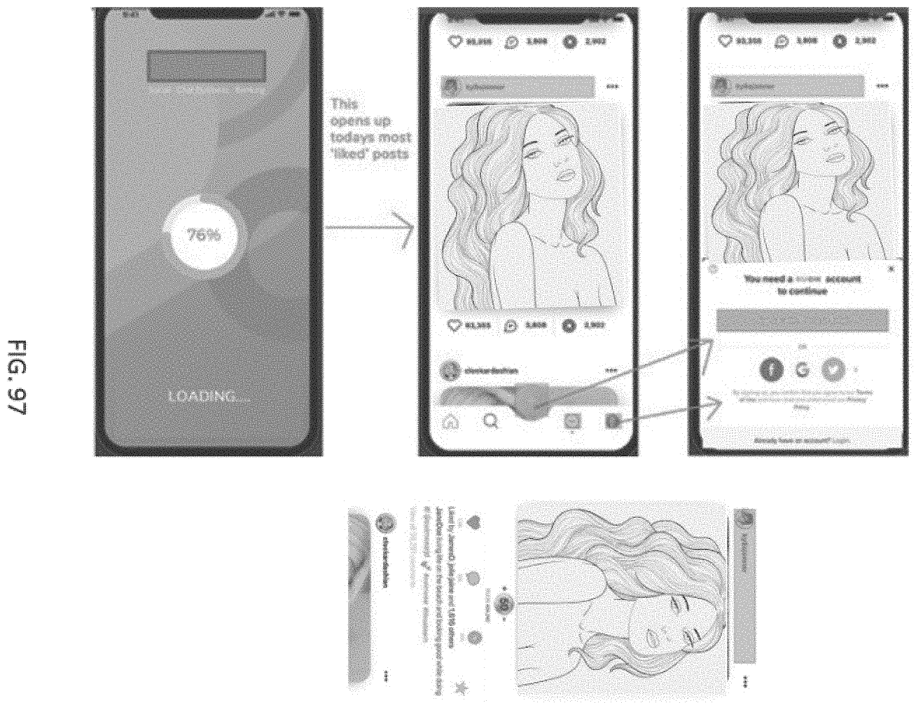

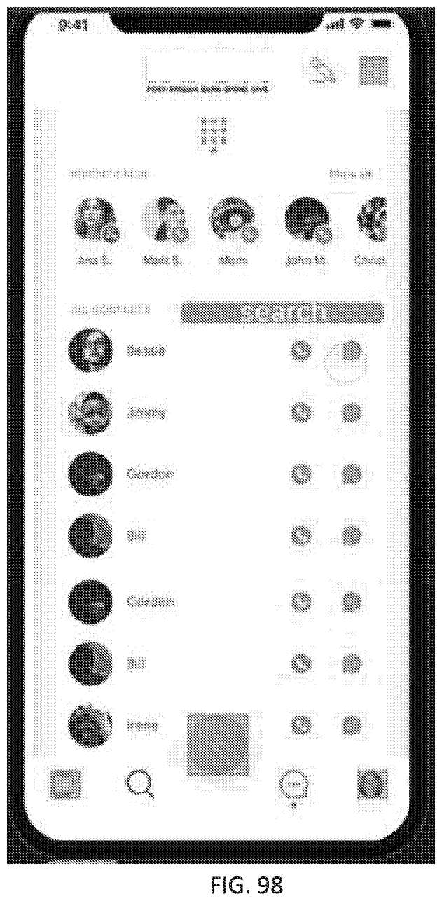

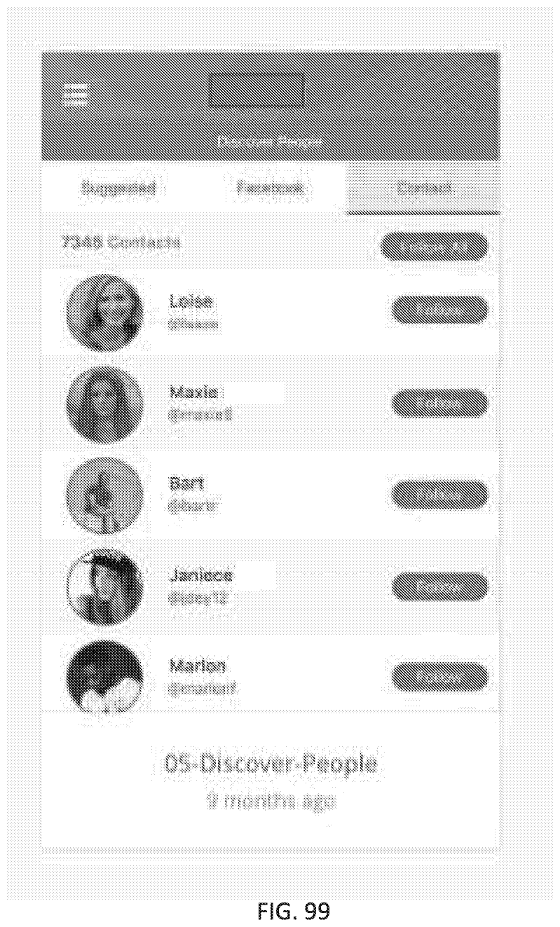

FIG. 97 demonstrates a process for displaying today's most-liked posts in a display page in accordance with some embodiments of the invention. FIG. 98 illustrates a calling display page in accordance with some embodiments of the invention. FIG. 99 illustrates discover users display page in accordance with some embodiments of the invention.

Some embodiments include system augmented reality, cryptocurrency utility, and map-dropping. Some embodiments enable users to drop cryptocurrency on a map. In some embodiments, if an employer wants an employee to report to work, to confirm the employee has arrived, the system can include a clock-in API to incentivize the employee to show up to work. For example, in some embodiments, users or employees can drop money in the form of (“Eggs”) with cryptocurrency inside. The employee can travel to their place of work, and walk over the cryptocurrency on the map for that cryptocurrency to be picked up inside their digital wallet. This method enables employers to have a safe way to pay others knowing they have actually traveled to that location to pick up a parcel, and done a day's work. In some embodiments, cryptocurrency can be picked-up at the start of the day, and the employee's manager can activate it at the end of the day after the employee has finished their work at the place of business. In a further example, someone abroad can leave an egg of system cryptocurrency on the map of their house to check on the occupant's and/or user's dogs. Using the described system, the user can be alerted when another user has to go to their house to check on the dogs and collect the cryptocurrency. In this instance, the house owner can view on their wallet that the egg has been picked-up by the other user, knowing they are at the house looking after the dogs. This method can be a way to safely pay people and prove work or a location/business has been visited.

In some embodiments, other users can drop all types of system cryptocurrency all over town assigning a different user to pick it up or allowing a group of friends (e.g., from within the system's “Categorized Friends” section). In some embodiments, a “close group of friends” can be selected and can be enabled to pick up the “eggs”, or a user can select individual users or only “family” or only “followers”. These eggs can also be used to pay workers in a company. Further, the boss will know which workers have come into work.

In some embodiments, the cryptocurrency-enabled system can be used in a situation related to a party. For example, in the case of a user throwing a party, a host can leave an egg at the location and all their “Followers' who come to the party can earn the “egg” and the system cryptocurrency inside the egg. Further, within the system, the user can go to “create Group” and put all a user's followers inside, and then “drop egg”, and choose a party house location.

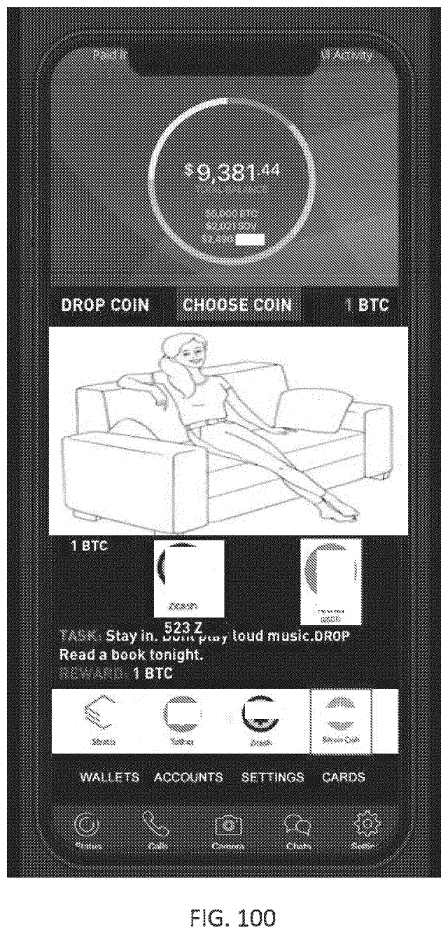

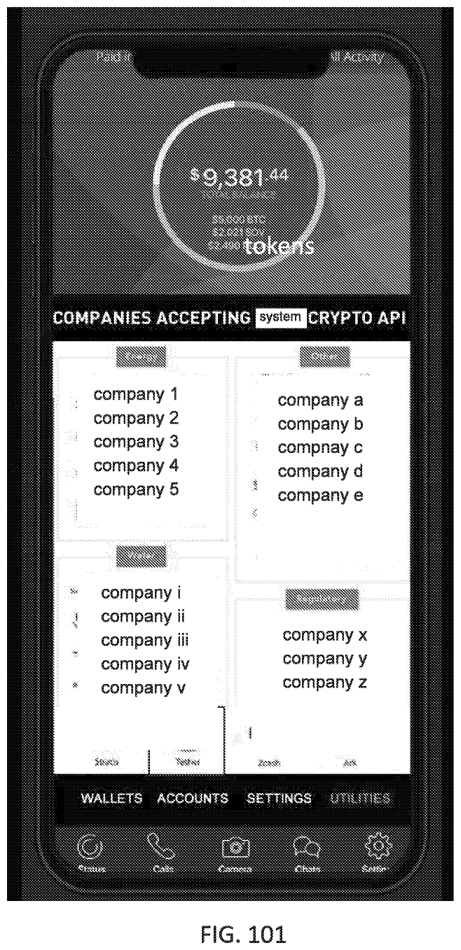

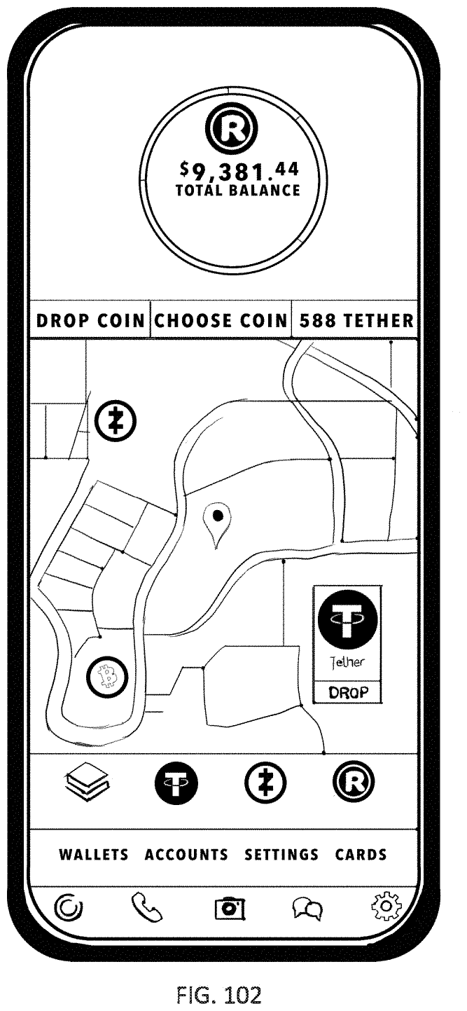

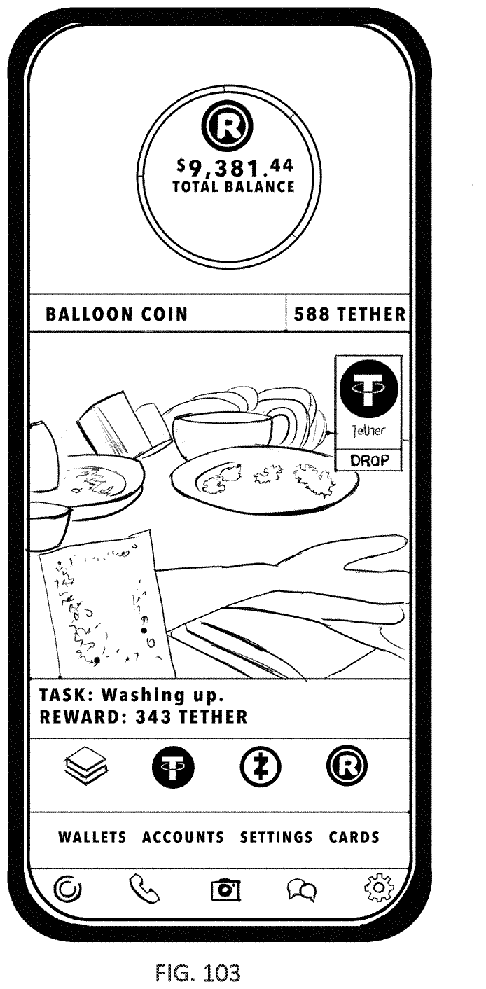

In some embodiments, the system can process and display augmented reality scenes. FIG. 100 illustrates an augmented reality dropping display page in accordance with some embodiments of the invention. FIG. 101 illustrates a utilities cryptocurrency display page in accordance with some embodiments of the invention. FIG. 102 illustrates a drop cryptocurrency display page in accordance with some embodiments of the invention. FIG. 103 illustrates an augmented reality display page in accordance with some embodiments of the invention. In some embodiments, users can attach coins or leave coins in a room. In some embodiments, the users can turn-on their camera and drop coins anywhere in a room, and other system users can turn their camera on and see these coins and can collect them. For example, in the in-application example shown in FIG. 100, a flat mate is quietly reading a book and the other flat mate has placed 1 BTC cryptocurrency in that space. The flat mate communicates that if she doesn't play loud music and reads tonight, she will pay her 1 BTC cryptocurrency. The 1 BTC cryptocurrency was placed on the sofa and was collected when the flat mate quietly sat on the sofa reading the book.

In some embodiments, system users can drop system tokens or other currency in a “Balloon” inside an augmented reality for other users to pick up for doing tasks set by the other user as per the mobile application display. All types of tasks can be set, such as a user “Balloon” 341 Tether Coins above a task such as dish washing and/or kitchen cleaning (FIG. 103). In this non-limiting example embodiment, when the other user goes to that area in the room, the Tether, system tokens or other currency can be pulled into the own digital wallet as soon as the task is done and they are still in that area. Subsequently they can send the picture of a clean kitchen, and then the cryptocurrency tokens or coins can be released to the person/user that completed the task. In this instance, the person/user needs to be in the area where the “balloon” coins have been left in augmented reality to earn the amount of system tokens or other currency in that balloon, which can appear in their digital wallet.

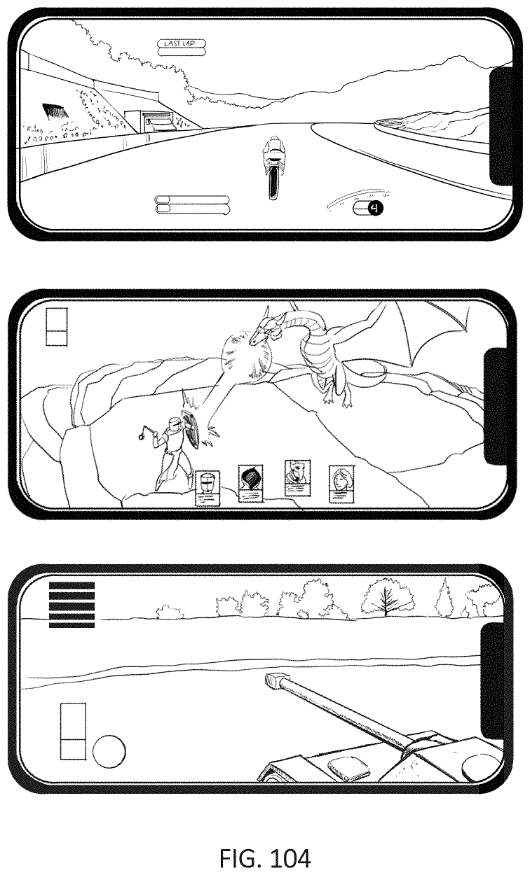

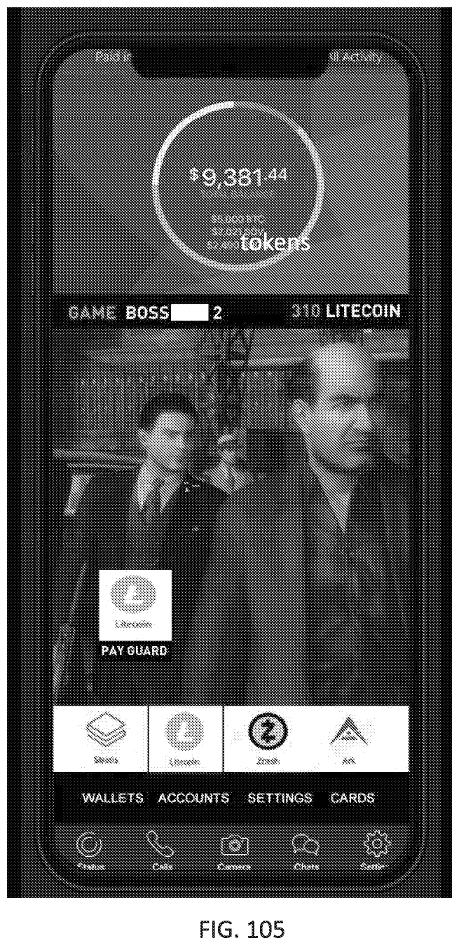

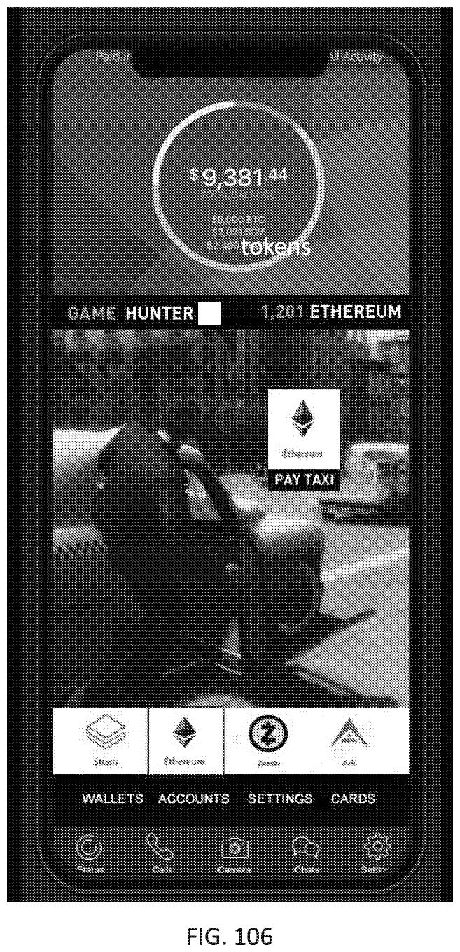

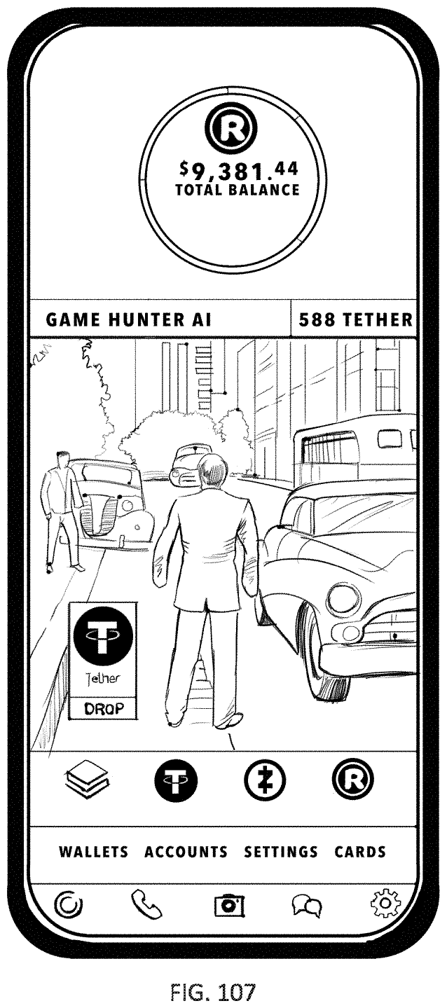

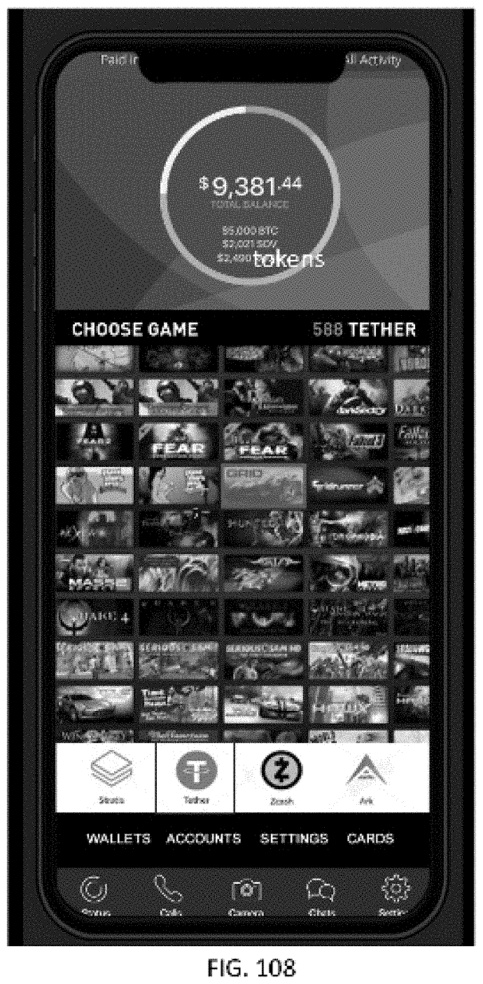

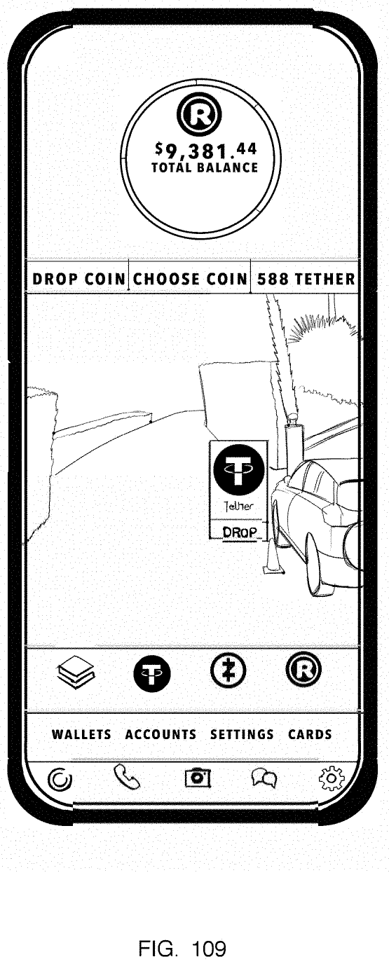

Some embodiments include in-application gaming and cryptocurrency processing. For example, FIG. 104 illustrates a game using cryptocurrency in accordance with some embodiments of the invention. FIG. 105 illustrates an in-game bodyguard who has been paid with system cryptocurrency in accordance with some embodiments of the invention. FIG. 106 illustrates an in-game taxi paid with system cryptocurrency in accordance with some embodiments of the invention. FIG. 107 illustrates an in-game person who has been paid with system cryptocurrency in accordance with some embodiments of the invention. FIG. 108 illustrates a cryptocurrency gaming selection display page with games that use the system currency or other cryptocurrencies from the system's exchanges or digital wallets in accordance with some embodiments of the invention. FIG. 109 illustrates a drop cryptocurrency display page in accordance with some embodiments of the invention.

In some embodiments, the system includes an in-application link are access to personal computer, mobile and online games include a “Connect to the system crypto API”, and enabling users as gamers to use system cryptocurrency inside each game or inside games in the system application using a system cryptocurrency API enabling games to use system crypto currency, including, but not limited to payment for game play, payment for gameplay viewing, payment as exchange within the game, payment as reward within the game, payment as virtual currency within the game, and payment exchange with other players of the game. In some embodiments, gamers have to be signed or have an account with game and the system to work. As shown in the above described figures, a user can see cryptocurrency that can be given (in game) to other gamers inside the game and/or to pay for services inside the game (e.g., to pay a taxi driver or pay for the services of a bodyguard). In some embodiments, any convention game can be opened up inside the system and/or system popup button, and can show up inside the standalone game once connected or signed-in. Further, gamers can remain connected on the phone in the background as the game is played in the foreground.

In some embodiments, the artificial intelligence engine of the system can gain “real” followers. In some embodiments, if a user wants extra users (real users), system cryptocurrency can be paid on a subscription or one-off “boost”. In some embodiments, once a user does this, they can pay the system in cryptocurrency (e.g., pay $200, 0.00034 BTC or 242 Tether ect). Subsequently, the user can be “seen” or “viewed” on over 1-10 million other users mySTORY videos per day. All the other users will, after time be viewing” their mySTORY videos every day and other profile image posts, and viewers can click on the profile of this user and click “Follow”. This way the user gets more real followers and interaction.

In some embodiments, the user will automatically post a comment on 1-10 million other users posts per day. The user can select which message this will be when signing up to the artificial intelligence gain follower service. In some embodiments, the user can automatically “Direct Message” 1-10 million other users posts per day. The user can select which “direct message” this will be when signing up to the artificial intelligence engine's gain follower service. In some embodiments, other users can choose to follow a user back and increase their overall followers.

Some embodiments include news feed options display pages where users and/or influencers can filter and label their followers into follower niches such as, but not limited to, ‘inner circle’ or ‘friends' or ‘family’ groups or ‘business' groups. In some embodiments, when posting, users or influencers will be able to select a niche follower group that receives that post. In this way, posting can be precisely targeted to the optimal audience for that post. Moreover, users will be able to select which feed they would like to see content from, increasing how much content is previewed each day. Furthermore, a user will be able to see content only from their family, close friends, girls or guys they like, and/or business contacts.

In some embodiments, the system artificial intelligence engine can offer users the ability to post videos, save videos and create “mySTORIES” streaming TV channels. In some embodiments, up to 70% of user-generated content on social media isn't seen, and thus the system can allow users to see hundreds of posts at the same time (via system pinch-screen displaying content technology).

In some embodiments, users will be able to “opt” to make their videos available to other users. In some embodiments, users will be able to use these videos in their short music clips, and the content users will be rewarded cryptocurrency for their content. In some embodiments, video channels and blogs can be categorized by the system artificial intelligence engine into themes. In some embodiments, these videos can be a powerful influencer marketing tool when linked to user stores that are just a swipe away from the user profiles. In some embodiments, the system differs from “Tick-tok”-style technology in that the system can enable a user to earn money, sell their own content, and all use is recorded and earnt with blockchain technology and on a jurisdictional-free blockchain in space. Further, in some embodiments, music owners can also get paid instantly via blockchain reporting tools.

In some embodiments, the system artificial intelligence engine can allow “mySTORIES” video owners to sell their “MyStories” and video content to other users, influencers, brands and advertisers.

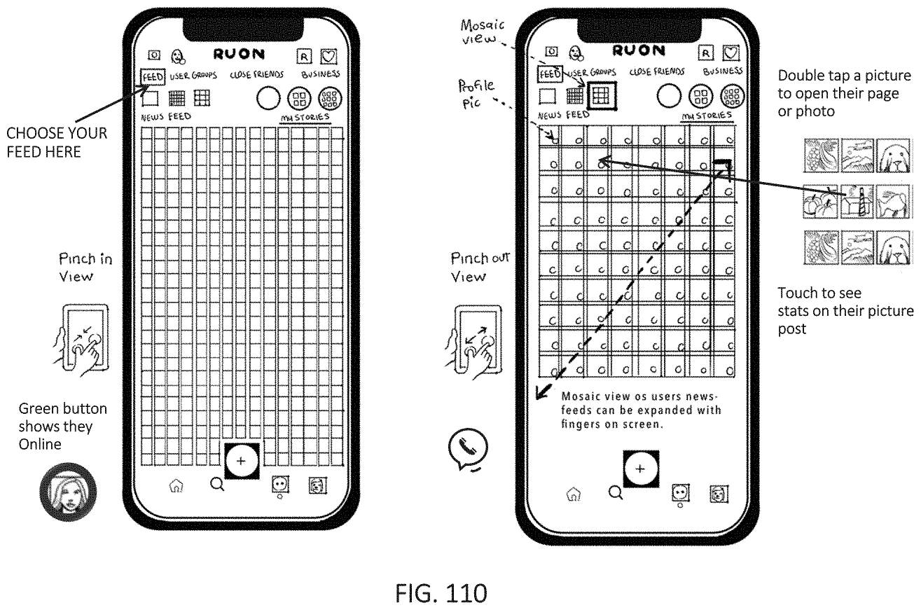

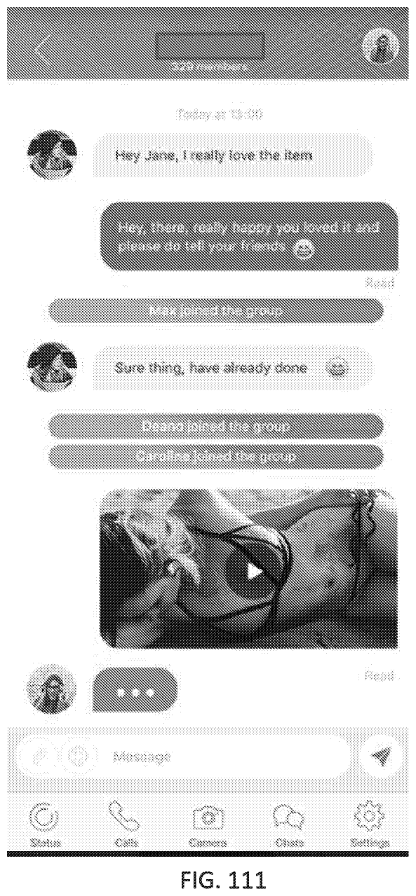

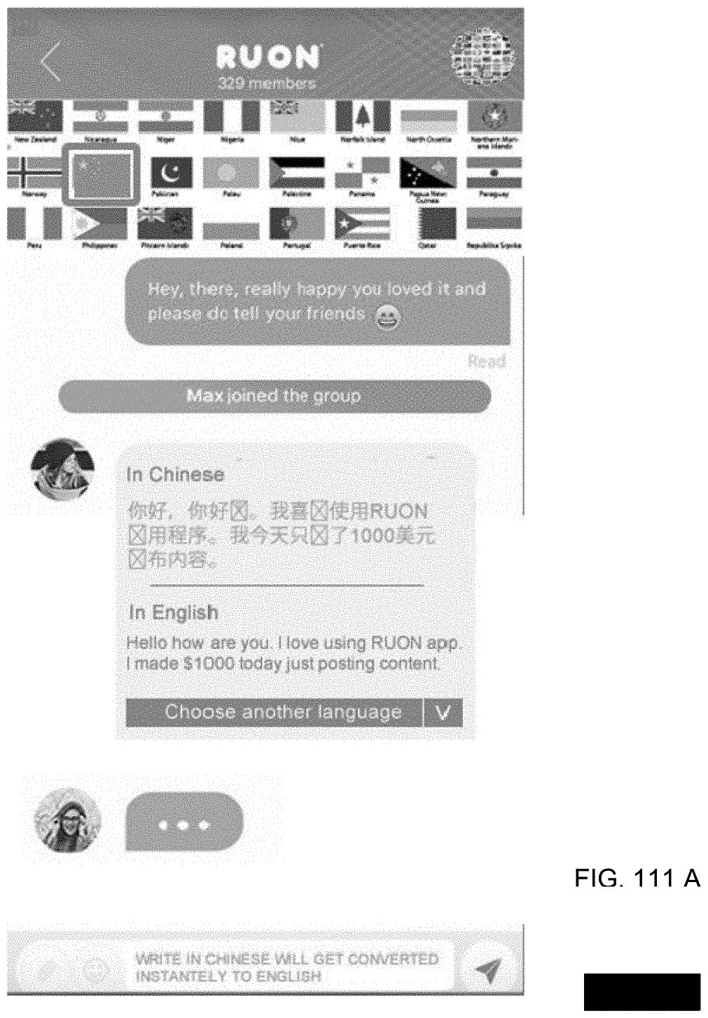

FIG. 110 illustrates a scrolling and touch pinch/zoom-in and zoom-out with thumb user communication display in accordance with some embodiments of the invention. In some embodiments, prior, delayed, and/or substantially real-time user communications can appear in a scrolling display page. In some embodiments, the display page can include communications between one or more users, posts of one of more users, and/or user or group status updates. FIG. 111 illustrates a scrolling user communication display in accordance with some embodiments of the invention.

FIG. 111B is a Chinese translator page in accordance with some embodiments of the invention. This display includes a group chat which allows the user to type in Chinese or select any other language to enter, and where that sentence will automatically be translated to English and displayed in the group in the native text language and also in English.

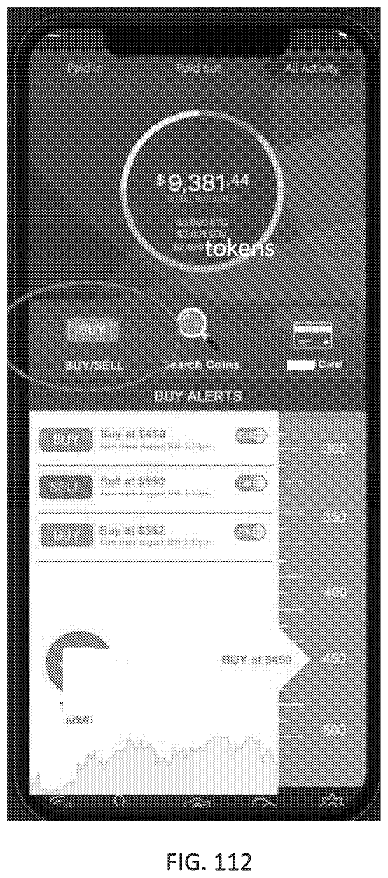

As discussed previously, the system can enable in-application cryptocurrency exchange. Further, in some embodiments, any system cryptocurrency and/or any exchanged cryptocurrency can be traded within the system. For example, FIG. 112 illustrates a cryptocurrency trading display page in accordance with some embodiments of the invention. As illustrated, in some embodiments, the display can include buy and/or sell prices that can be set and/or adjusted by a user. In some embodiments, any buy or sell prices can be adjusted using a movable slide-bar price scale.

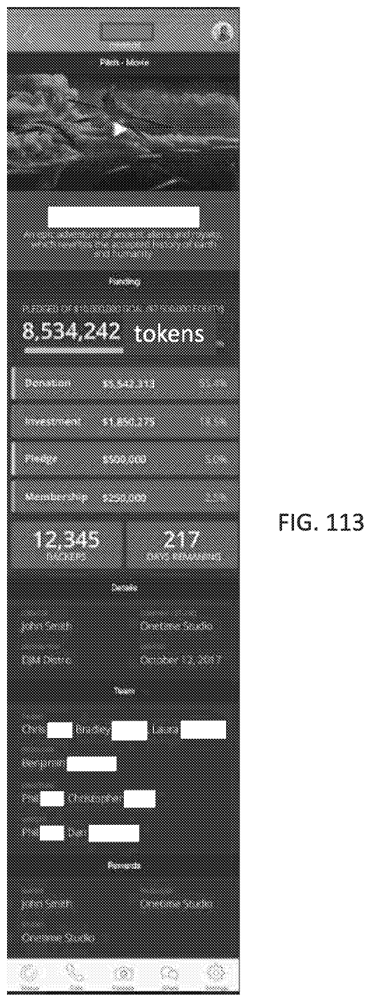

FIG. 113 illustrates a system-managed cryptocurrency funding display page in accordance with some embodiments of the invention. As described previously, in some embodiments, the system can facilitate funding for emergency and/or charity events. In other embodiments, the system can enable a user to apply (either as a donation, investment, pledge, and/or through a membership) one or more cryptocurrency, system tokens, or other currency to fund a campaign or commercial project (e.g., such as a film production, computer game, technology service, or one or more new products).

In some embodiments, user content can be correlated to, tagged to, coupled with, and/or combined with one or more audio sounds or clips (hereinafter, “audio tags”). In some embodiments, an audio tag can comprise a recorded sound or clip, including, but not limited to single or multifrequency sounds, music, and/or voice sound. For example, FIG. 92 illustrates an audio tag display page in accordance with some embodiments of the invention. As illustrated, in some embodiments, the display can include a function to enable a user to record audio content from the user's device into the system. In some embodiments, the record option can be used to record keywords or tags associated with one or more content posts. In some embodiments, the audio tag can be assigned to one or more content items to assist in searching for and finding specific content. In some embodiments, an audio button displayed by the system in the user display can be pressed when a user would like to search for an image, video, text, or content post. In some embodiments, an audio artificial intelligence engine can be used to search audio files assigned to each piece of content. In some embodiments, this engine can be used to match audio tags with voice or sound input to retrieve and display any content associated with the audio request being submitted as part of a “find content” request or function.

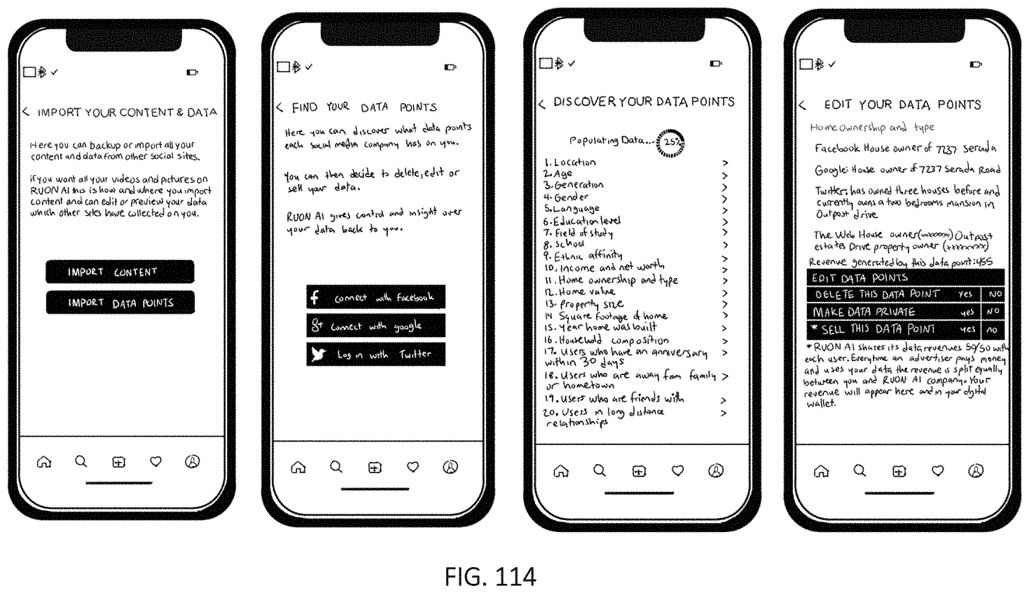

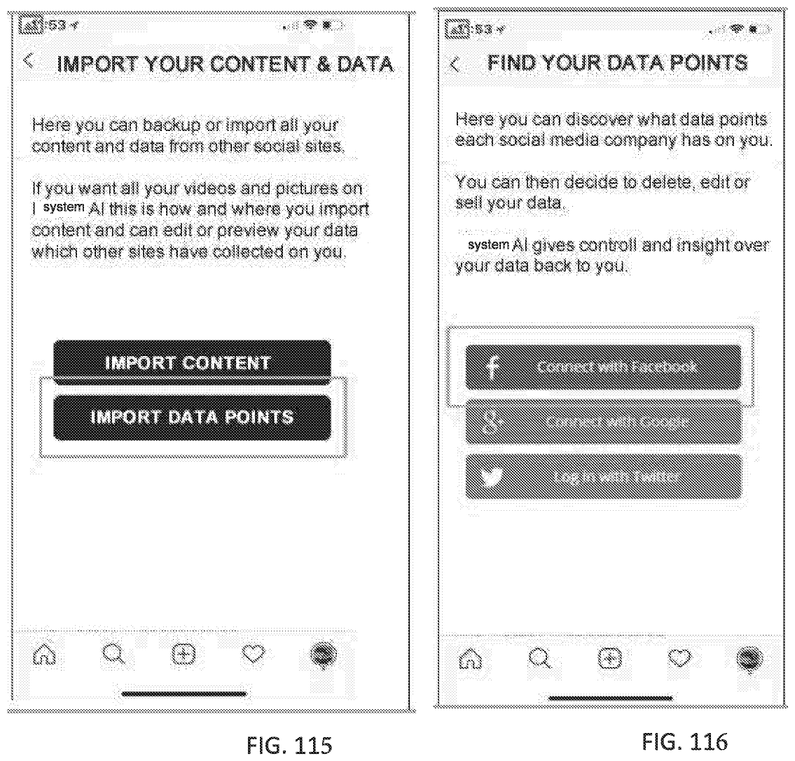

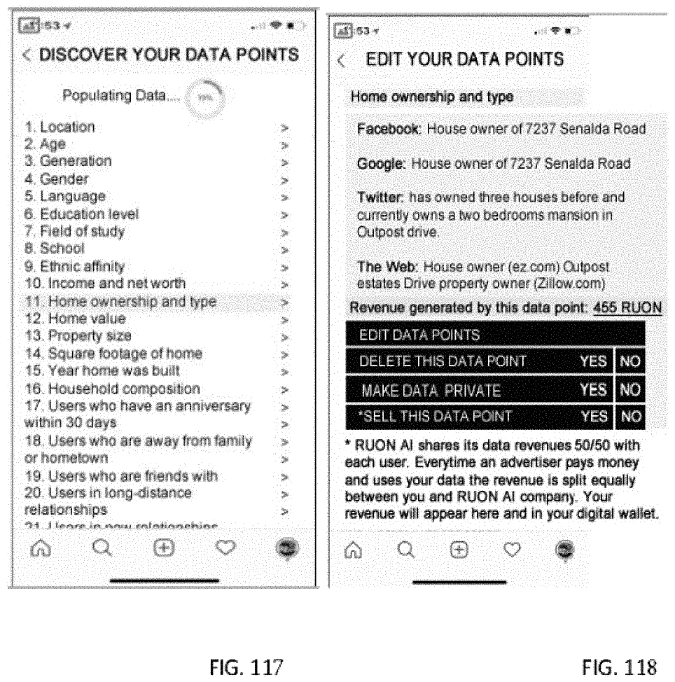

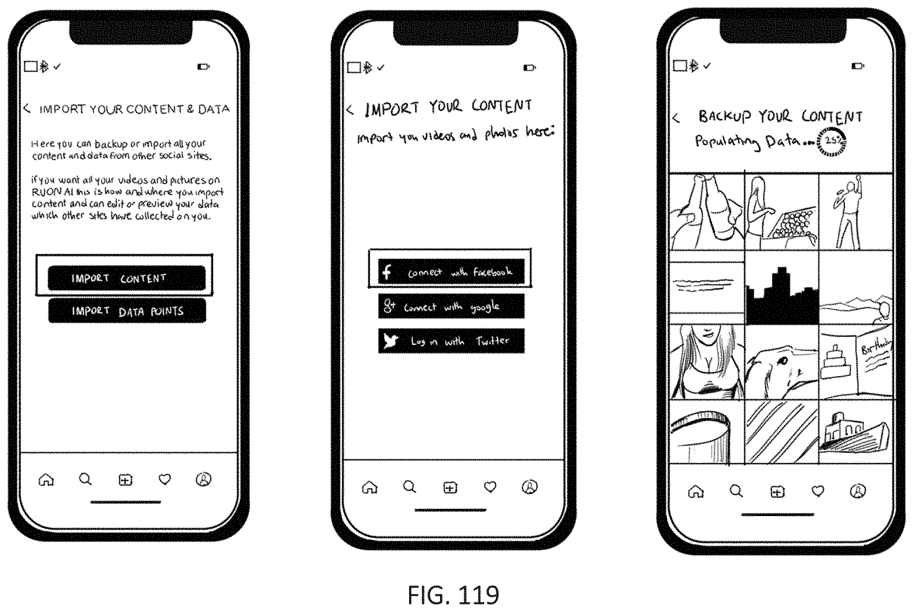

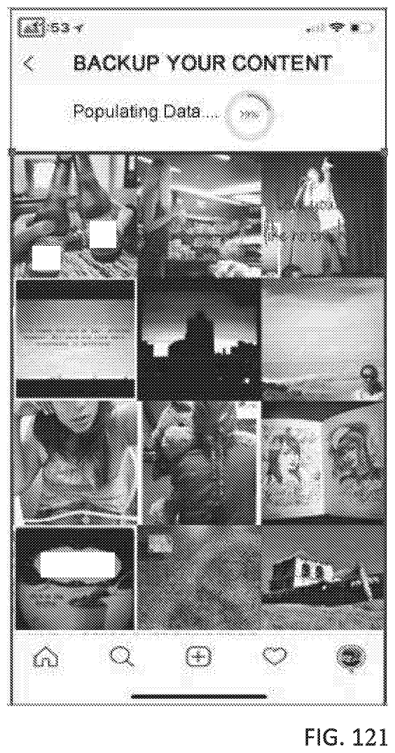

Referring to FIGS. 114 to 121, in some embodiments, the system can enable data point collection, edit and selling. In some embodiments, the data points can be included where a user can edit, and where the system will import from other social sites. In some embodiments, the system will split any revenue of data points that makes a user 50/50 from any advertisers using their data. In some embodiments, their revenue can appear on that page and also directly in their wallet in system currency and/or USD. In some embodiments, the user can be enabled by the system to turn off tracking ads. Further, the user can be provided with full transparency over what user data the system artificial intelligence engine has stored, and what other sites have stored on each user. In some embodiments, with data points added for the user, family, and friend's birthdays, the system can determine the upcoming dates, and can send predictive shipping for them if their “Data Points are turned On”.

In some embodiments, within data points, a user can also decide who sees a user's data and if the system artificial intelligence engine can read a user's data to help sell it to make money for the user, and to allow people to advertise to the user. In this instance, the user can choose which data points to use for advertising, and to generate a revenue with 50/50 shares with the system while maintaining full control over the data. In some embodiments, the system can assist a user to delete or notify other social sites that include it, and a user can download a data report from the system artificial intelligence engine with projected revenues if the user sells or updates the data for advertisers. In some embodiments, the system artificial intelligence engine can provide revenue estimates, and information on how best to monetize the user's data to other data brokers, advertisers and e-commerce platforms.

In some embodiments, targeting options for Facebook® advertisers can include 1. Location 2. Age 3. Generation 4. Gender 5. Language 6. Education level 7. Field of study 8. School 9. Ethnic affinity 10. Income and net worth 11. Home ownership and type 12. Home value 13. Property size 14. Square footage of home 15. Year home was built 16. Household composition. In some further embodiments, users who have an anniversary within 30 days 18. Users who are away from family or hometown 19. Users who are friends with someone who has an anniversary, and/are newly married or engaged, recently moved, or have an upcoming birthday 20. Users in long-distance relationships 21. Users in new relationships 22. Users who have new jobs 23. Users who are newly engaged 24. Users who are newly married 25. Users who have recently moved 26. Users who have birthdays soon 27. Parents 28. Expectant parents 29. Mothers, divided by “type” (soccer, trendy, etc.) 30. Users who are likely to engage in politics 31. Conservatives and liberals 32. Relationship status 33. Employer 34. Industry 35. Job title 36. Office type 37. Interests 38. Users who own motorcycles 39. Users who plan to buy a car (and what kind/brand of car, and how soon) 40. Users who bought auto parts or accessories recently 41. Users who are likely to need auto parts or services 42. Style and brand of car you drive 43. Year car was bought 44. Age of car 45. How much money user is likely to spend on next car 46. Where user is likely to buy next car 47. How many employees your company has 48. Users who own small businesses 49. Users who work in management or are executives. Some further embodiments include, 50. Users who have donated to charity (divided by type) 51. Operating system 52. Users who play canvas games 53. Users who own a gaming console 54. Users who have created a Facebook® event 55. Users who have used Facebook®. Payments 56. Users who have spent more than average on Facebook® Payments 57. Users who administer a Facebook® page. 58. Users who have recently uploaded photos to Facebook® 59. Internet browser 60. Email service 61. Early/late adopters of technology 62. Expats (divided by what country they are from originally) 63. Users who belong to a credit union, national bank or regional bank 64. Users who investor (divided by investment type) 65. Number of credit lines. Further some embodiments include 66. Users who are active credit card users 67. Credit card type 68. Users who have a debit card 69. Users who carry a balance on their credit card 70. Users who listen to the radio 71. Preference in TV shows 72. Users who use a mobile device (divided by what brand they use) 73. Internet connection type 74. Users who recently acquired a smartphone or tablet 75. Users who access the Internet through a smartphone or tablet 76. Users who use coupons 77. Types of clothing user's household buys 78. Time of year user's household shops most 79. Users who are “heavy” buyers of beer, wine or spirits 80. Users who buy groceries (and what kinds) 81. Users who buy beauty products 82. Users who buy allergy medications, cough/cold medications, pain relief products, and over-the-counter medications. Other embodiments include, 83. Users who spend money on household products 84. Users who spend money on products for kids or pets, and what kinds of pets 85. Users whose household makes more purchases than is average 86. Users who tend to shop online (or off) 87. Types of restaurants user eats at 88. Kinds of stores user shops at 89. Users who are “receptive” to offers from companies offering online auto insurance, higher education or mortgages, and prepaid debit cards/satellite TV 90. Length of time a user has lived in house 91. Users who are likely to move soon 92. Users who are interested in the Olympics, fall football, cricket or Ramadan 93. Users who travel frequently, for work or pleasure 94. Users who commute to work 95. Types of vacations user tends to go on 96. Users who recently returned from a trip 97. Users who recently used a travel app 98. Users who participate in a timeshare.

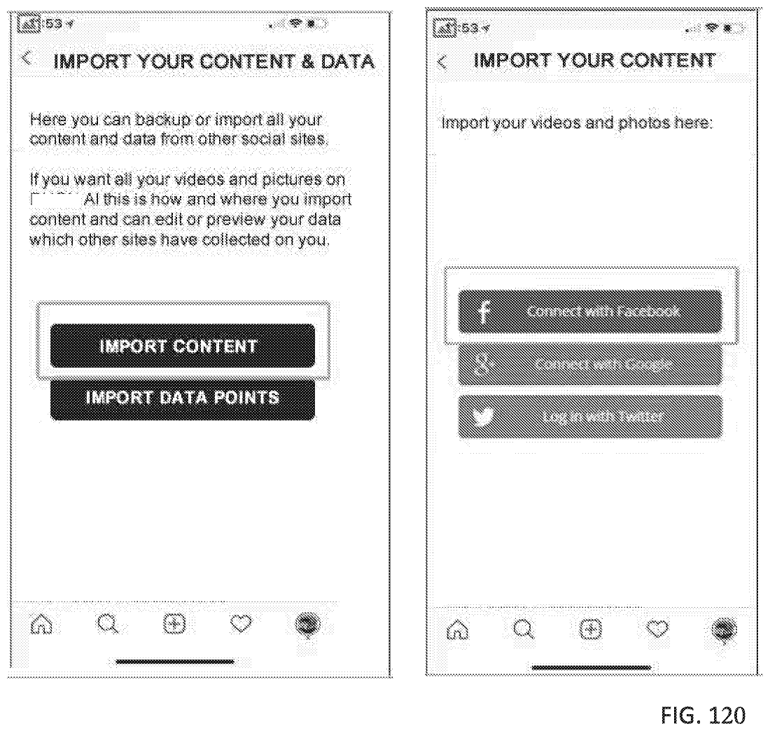

Referring to FIG. 120, in some embodiments, the system can enable import or backup of all a user's video and picture content from other social media sites. This content can then be monetized or sold or made available to other users for their own videos on the system platform, with money going back to user's digital wallet.

Some embodiments enable predictive shipping with data points (FIGS. 114 to 121). In some embodiments, with a user's “opt-in” permission, a system artificial intelligence engine's predictive shipping technology, in conjunction with drop-shipping platforms, can include giveaways, freebies and advertisers, where the system can send out products before they are ordered based on these enhanced data caption points. In some embodiments, with the system artificial intelligence engine, based on the user's own inserted data point answers, the system can predict what a user would like to receive and send it out before it is requested by the user. This works in conjunction with system features and displays shown in FIGS. 114 to 121. In some embodiments, once a user has filled in their data points, the user can ‘opt-in’ to receive goods in the post based on their data points. This will be great for advertisers. User can then take a photo of the product and upload it to their data point page or profile. or “RTag” it, allowing the shop, platform or advertiser to see they have it and charge them for the product if they want to keep it. If not, a user can return it. An advertiser can communicate with user directly through the application and the data point section.

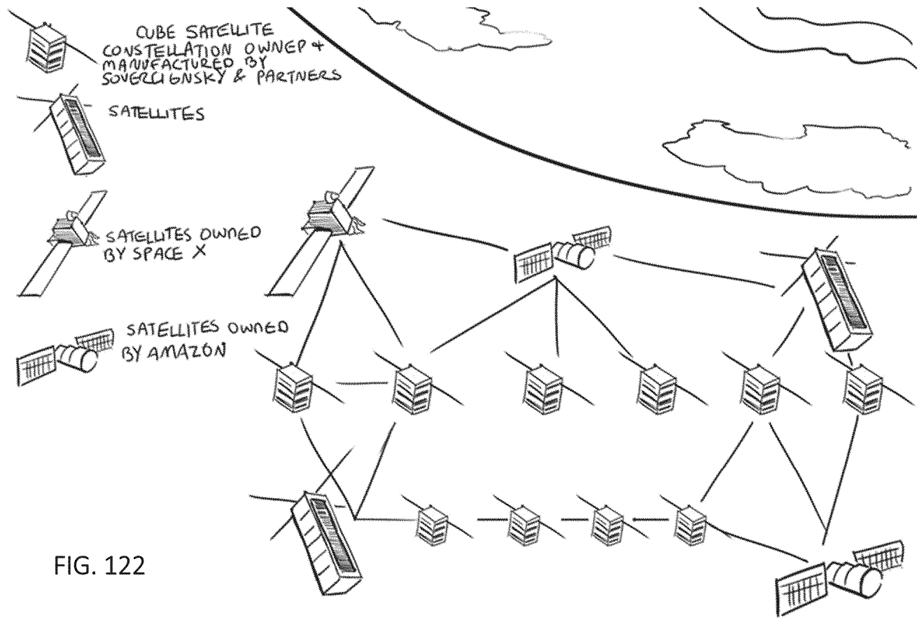

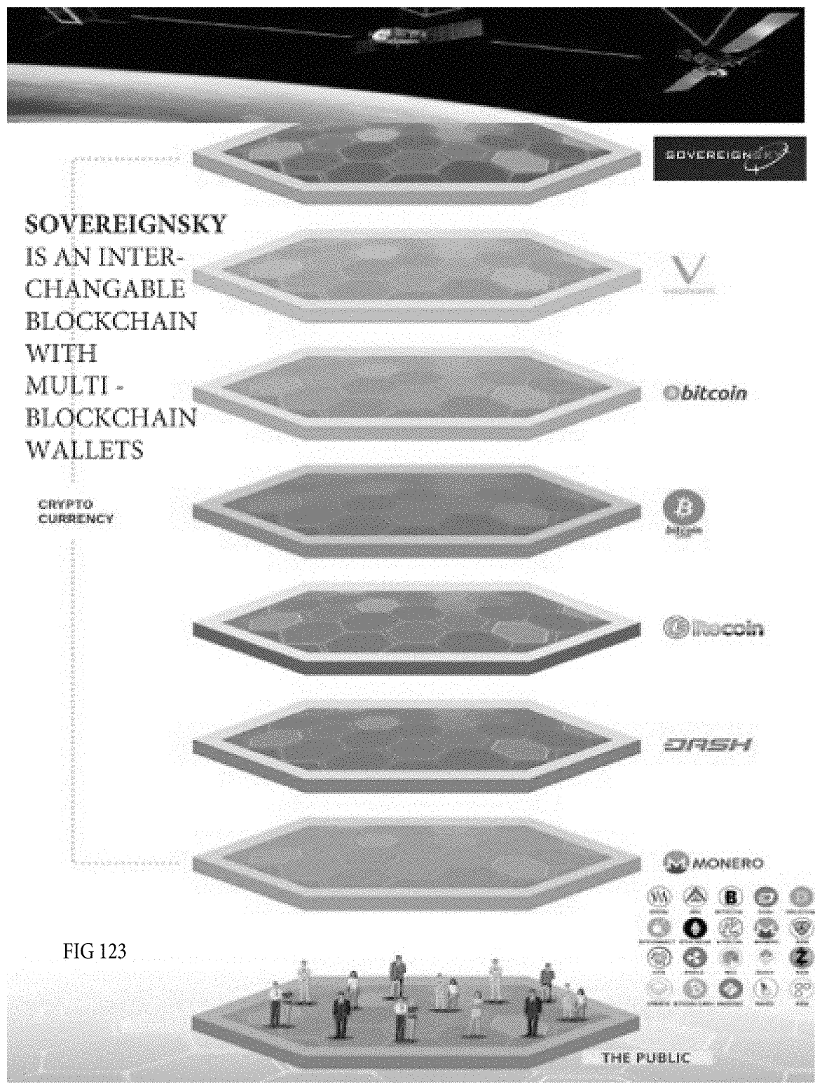

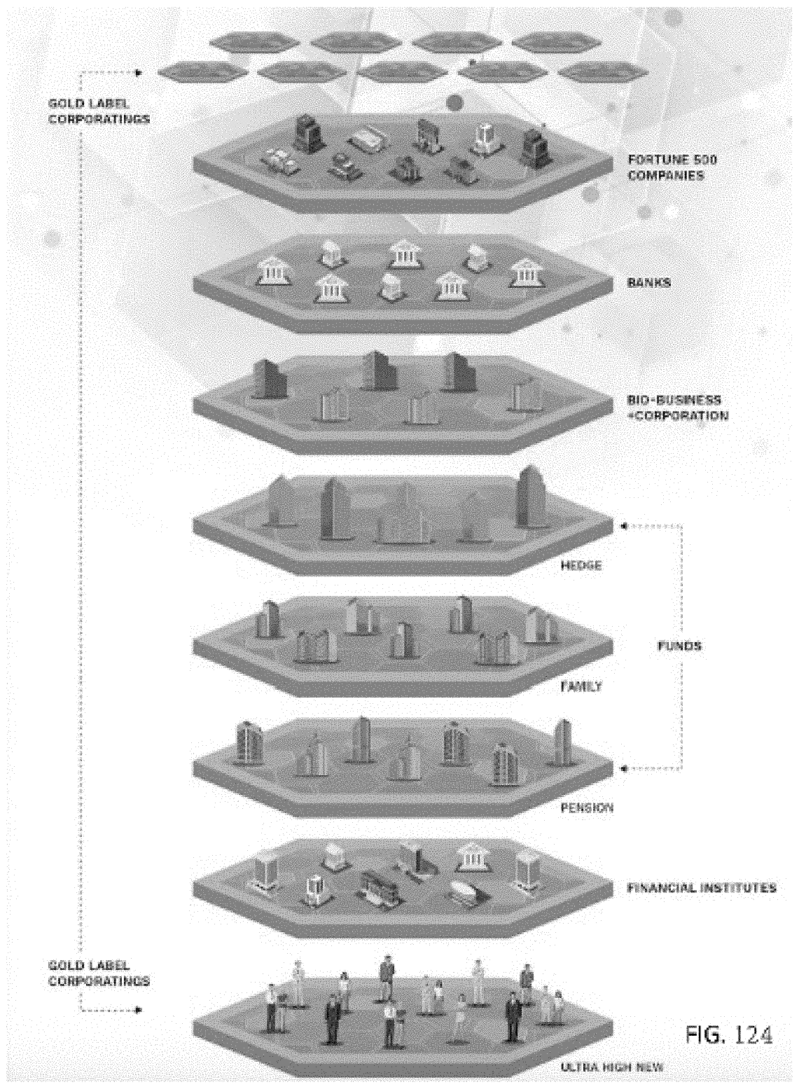

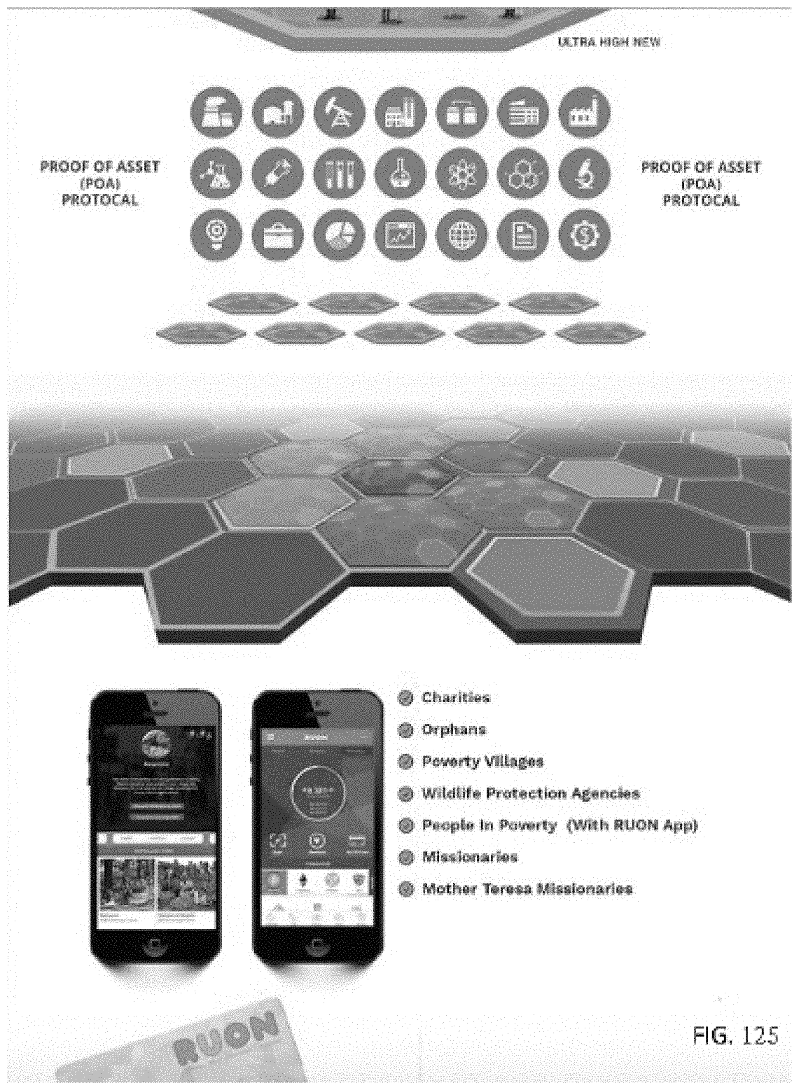

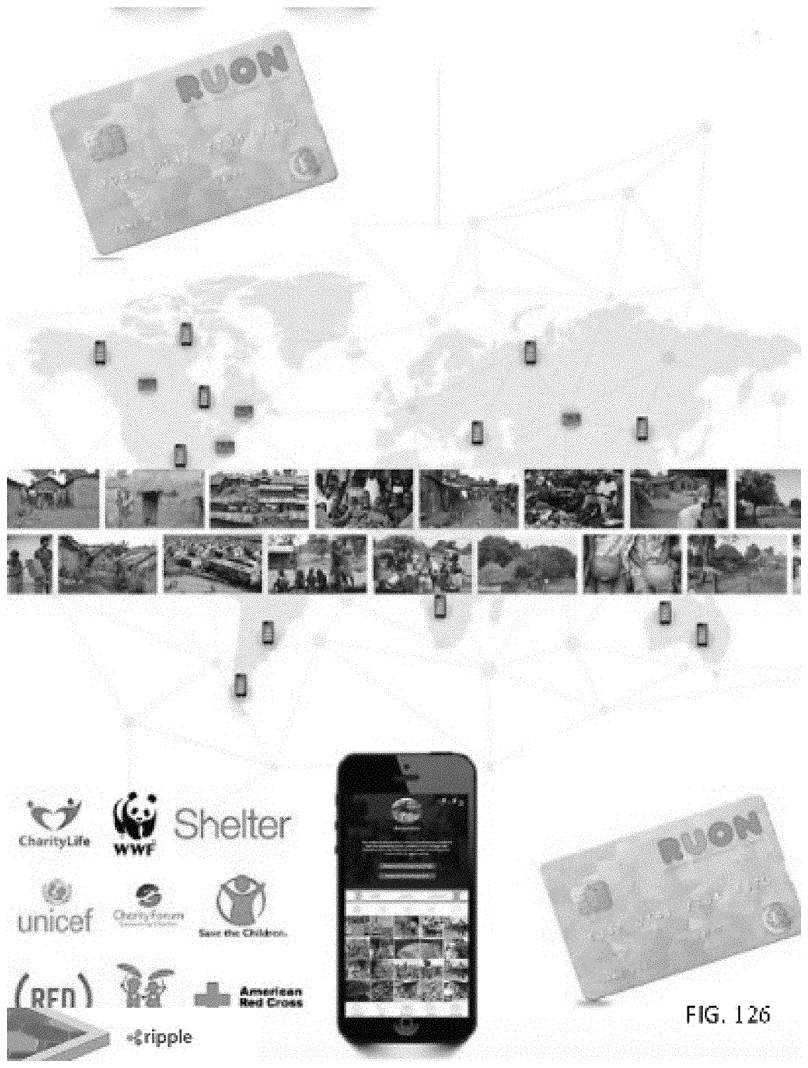

FIG. 122 illustrates a space-based satellite blockhain network in accordance with some embodiments of the invention. In some embodiments, the space-based satellite blockhain network can facilitate a global charity functionality of the system with SovereignSky. The SovereignSky space-based satellite blockhain network is an indestructible, “imesh” banking and financial system set in space and self-powered by solar panels”. The system is essentially a blockchain system that is hosted in space comprising a space-based blockchain with nodes, housed and built on between 1,000 to 2,500 small micro cubes satellites which are launched into space. Once these satellites cubes are orbiting, they can connect together via our imesh technology forming a military-grade encryption and near indestructible global WiFi connectivity to help eradicate extreme poverty everywhere. Further, the system can also comprise a future proof global digital currency built on SovereignSky that is one of the fastest, most secure and scalable blockchains on and off planet. The cube satellites are self-powered by solar panels.

In some embodiments, the system can include a social media network built on a satellite constellation and on cruise ships in international waters called SovereignSky to provide its customers the knowledge that we own the network for full encryption and privacy, full control to its trusted company owner, jurisdictional-free transactions, and a hack and future-proof, “quantum safe” network and banking system. This “One World, One Network” system can keep data safe, improve communication, and help the 3rd world with their own network and communication. In some embodiments, one or more business transactions happening on the system can wait until the satellite passes over of a node that is in international waters to transact, meaning all business transactions on the system can happen in a jurisdiction-free area.

In some embodiments, the system can comprise a jurisdiction-free blockchain built on an imesh network of cube micro-satellites, between 1,000-2,000 in number. In some embodiments, the nodes can be set on these and other satellites via USD connectivity allowing transactions to happen in the free jurisdiction of space. International Space, the final frontier, looms as a giant free trade zone that, if you can guarantee your transactions take place only there, may free you of the current nightmare of complying with the rules of over 250 earth-bound governments (and instead govern yourselves, as persons have opened new frontiers seeking to do since the beginning of time.)

In some embodiments, the system and SovereignSky project can be a privately funded blockchain, a straight clone of EOS intended to serve as a middle chain between BitShares and the EOS main chain. Its goals are token portability and jurisdictional agility. It does these functions without requiring any modifications to or cooperation from either BitShares or EOS, neither of which are involved in its development. Token portability means that all BTS and EOS tokens can move between these systems transparently, increasing the utility of the BitShares smart coin factory and access to EOS smart contract technology. In some embodiments, jurisdictional agility means that the new chain can explicitly control which jurisdiction(s) a transaction is allowed to be executed in.

Bitcoin, Ethereum, BitShares, Steem, EOS, and most blockchains are designed to be inter-jurisdictional, spread out over many jurisdictions, under the theory that if some rogue government shuts down nodes in one jurisdiction, the network will simply heal itself with nodes in the remaining jurisdictions. But there might be advantages to engineering “intra-jurisdictional” blockchains that can guarantee that all actions and transactions take place completely inside a single jurisdiction, thereby removing all doubt about which laws may apply. This could be very comforting to organizations of all types who find the current regulatory patchwork too befuddling to contemplate. The legal viability of such a strategy is certainly untested and your actual mileage may vary depending upon where your physically incarcerable body may reside. However, precedents abound. Consider your typical cruise ship that shuts down its casinos when in port and opens them in the regulatory freedom of international waters.

BEOS makes the location and applicable jurisdictions of each of its blockchain signing nodes explicitly known, where smart contracts only execute on nodes in favorable jurisdictions. Most will execute on nodes anywhere, but some will want to wait until a special jurisdiction node gets its next signing turn. This could be a node on a server in Utah, the Amazon, New York City, or a cruise ship in international waters or space, where BEOSnick 1 will offer its services. BEOS will offer representative nodes for users to choose from in many of these locations. BEOS will blaze the trail on this area by guaranteeing to organizations that their transactions are taking place in a jurisdiction where they know themselves to be compliant. All of this is made possible by ultra-low power nodes running EOS third generation graphene technology. Mining based block chains requiring a coal power plant to operate need not apply. Any business logic that can be implemented as a smart contract can now run in space.

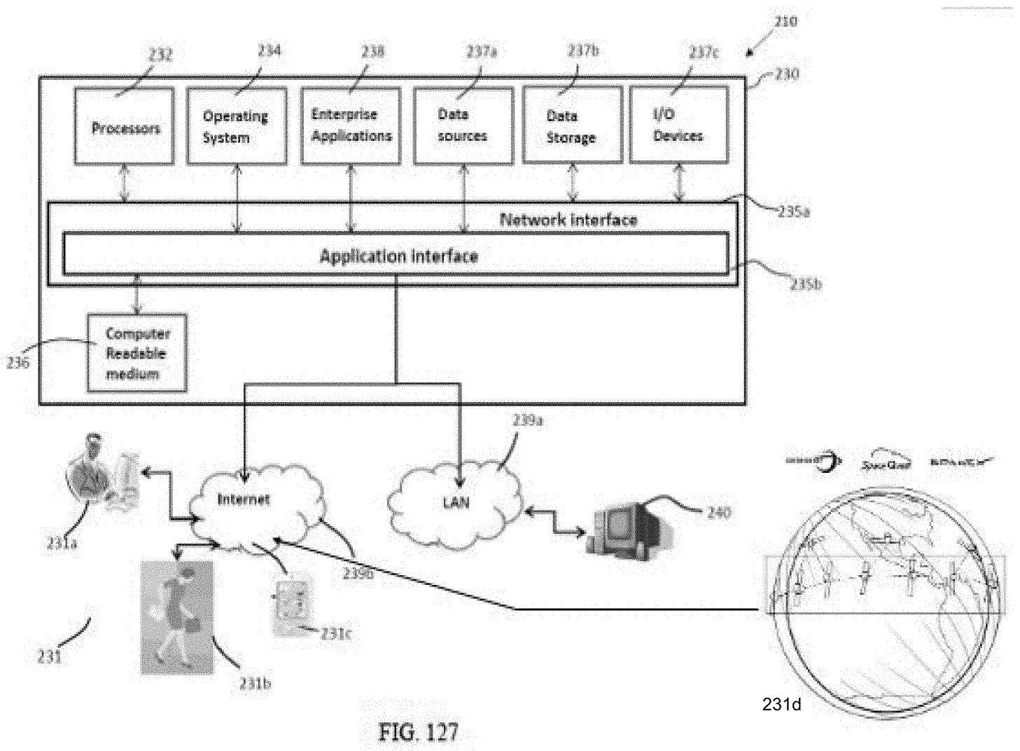

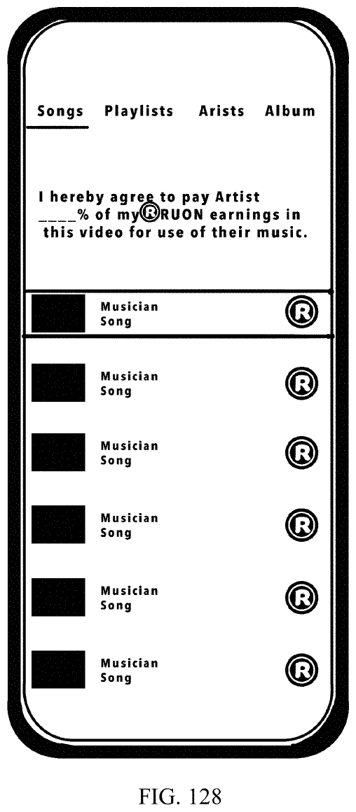

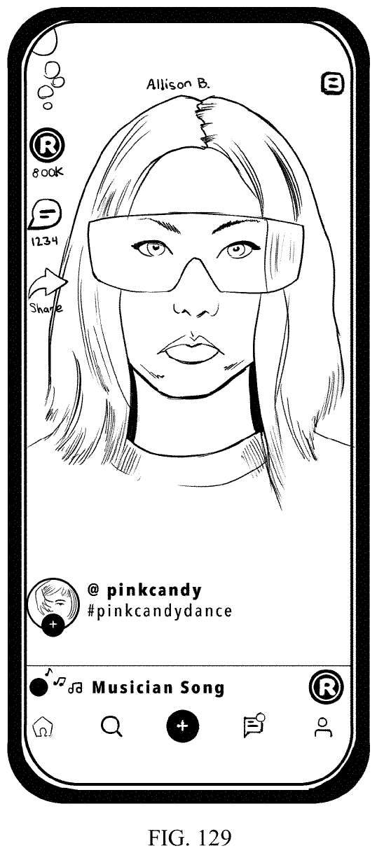

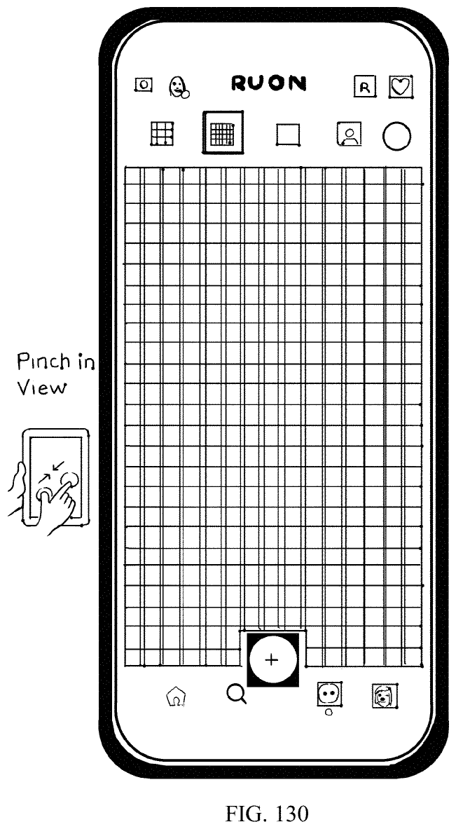

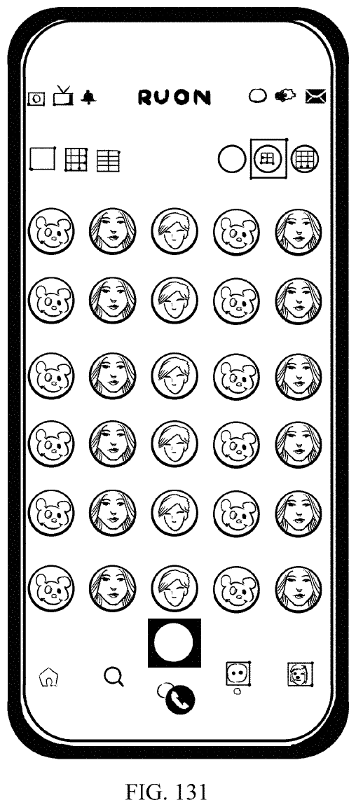

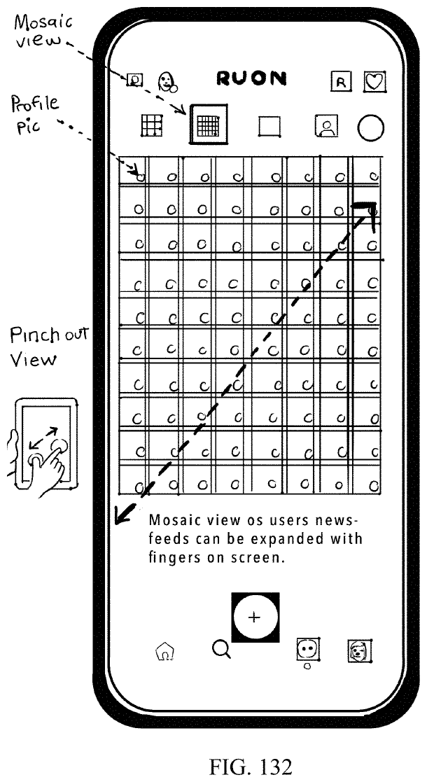

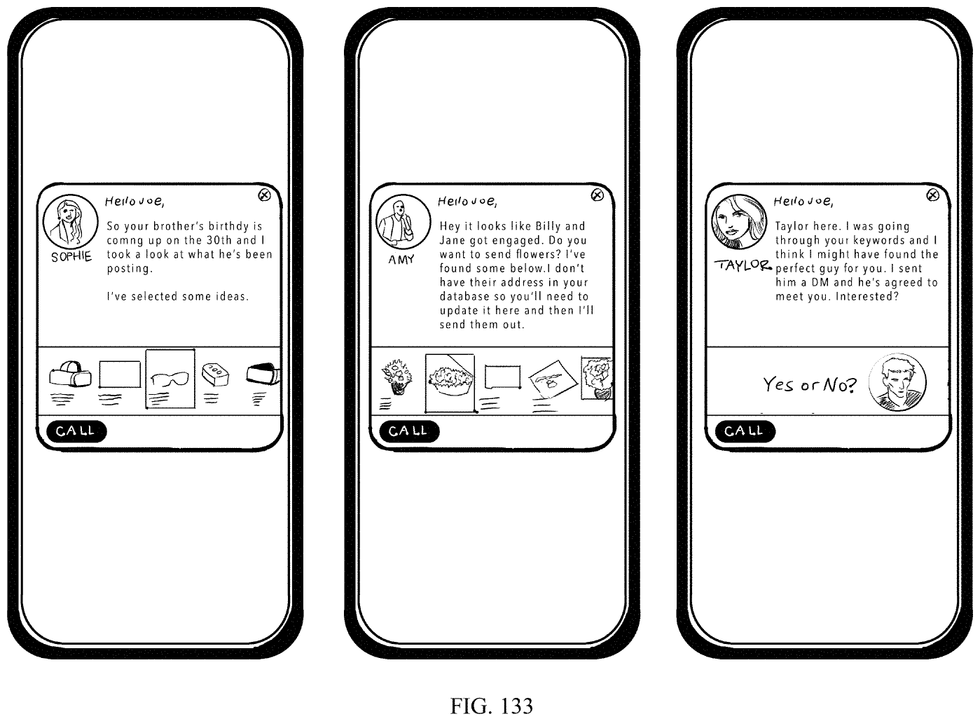

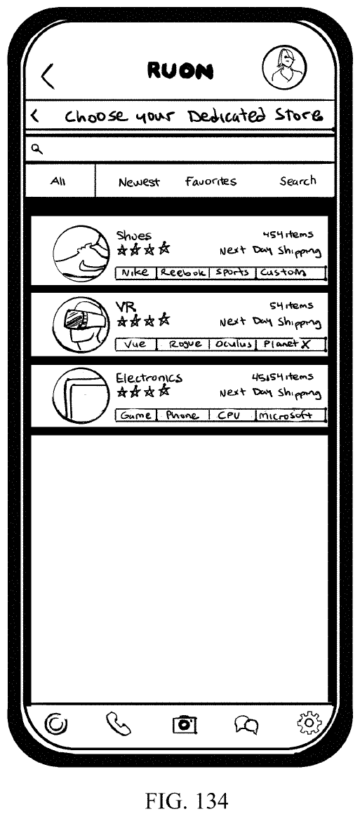

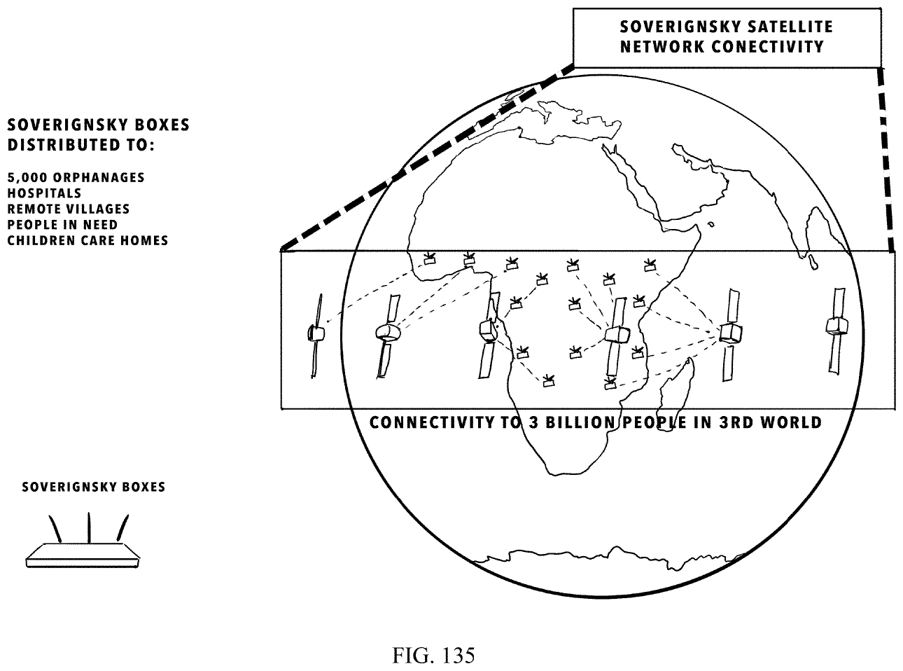

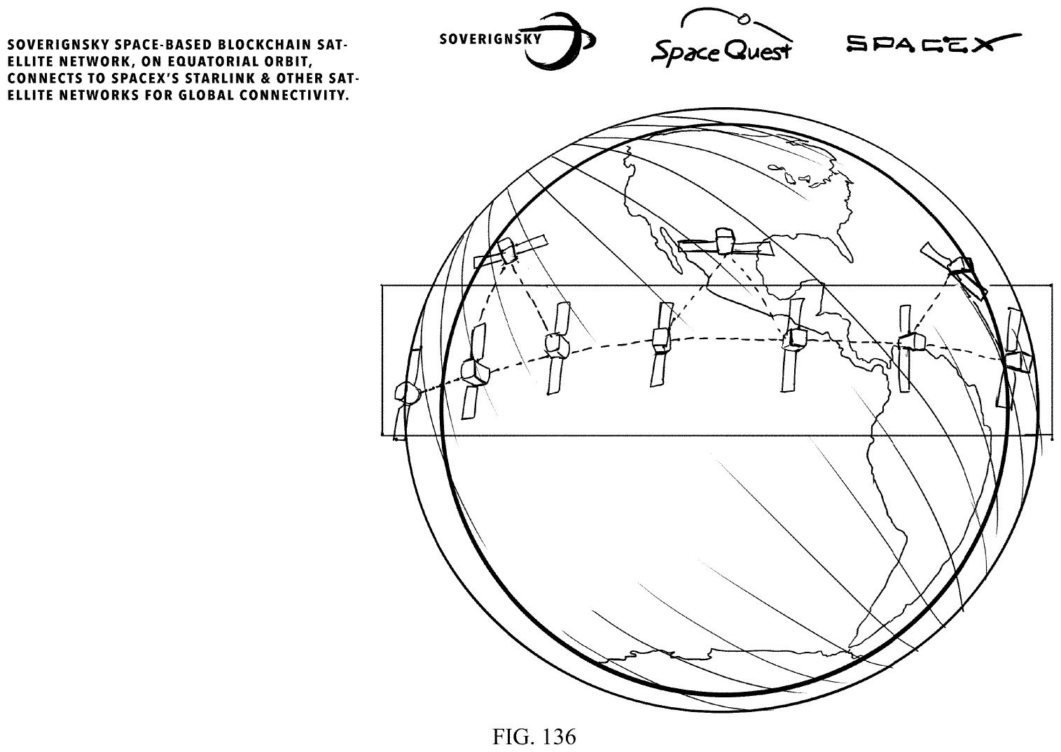

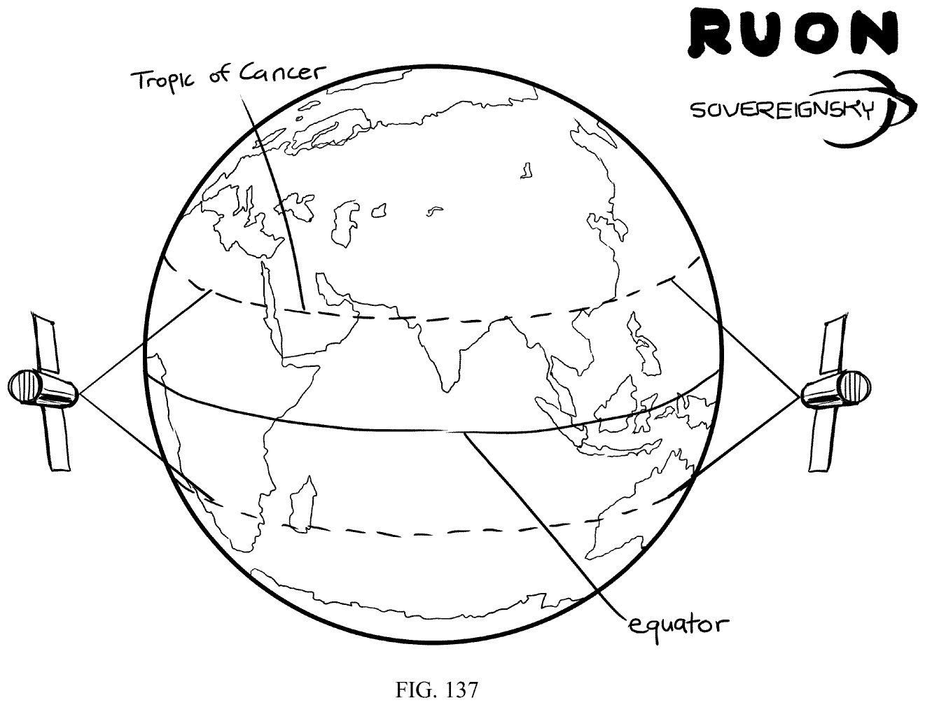

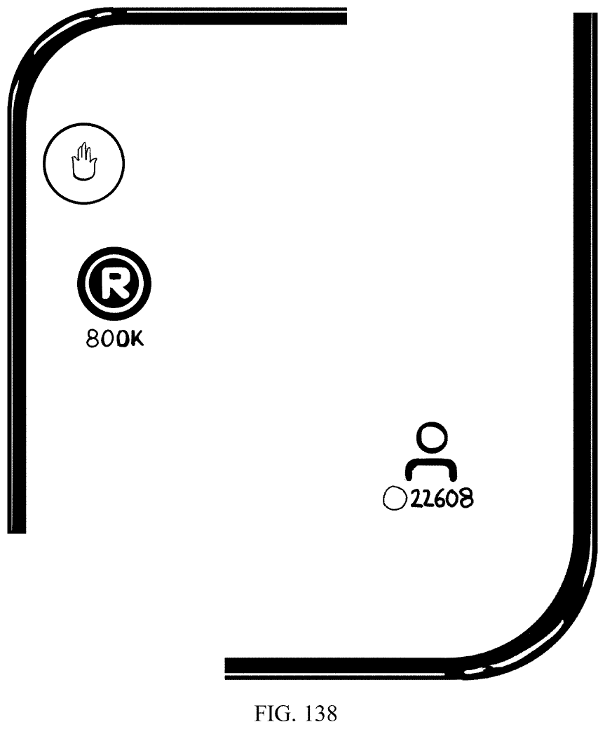

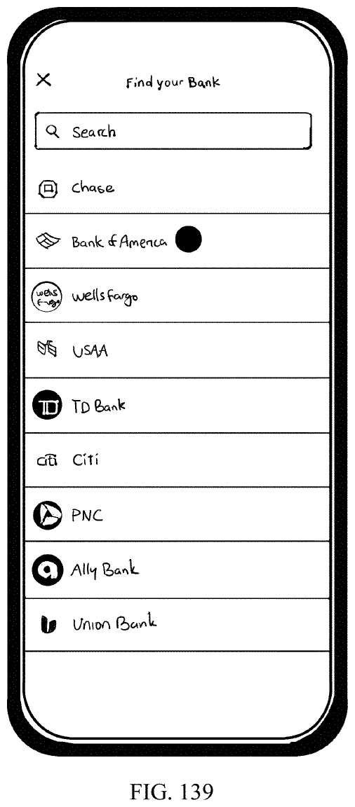

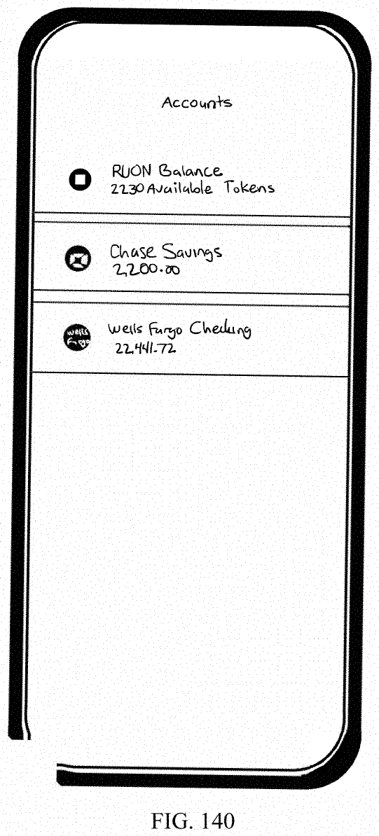

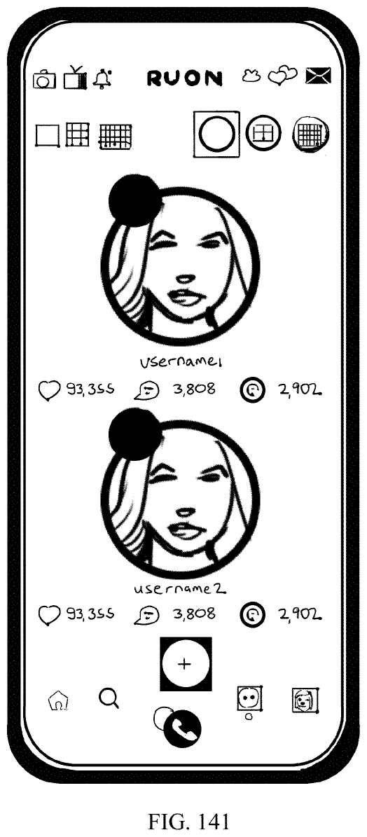

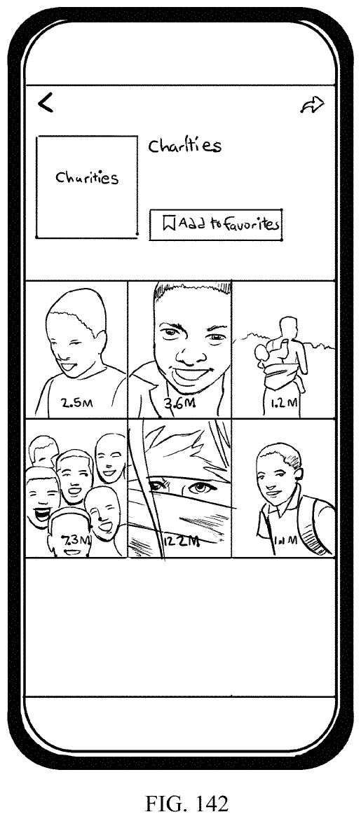

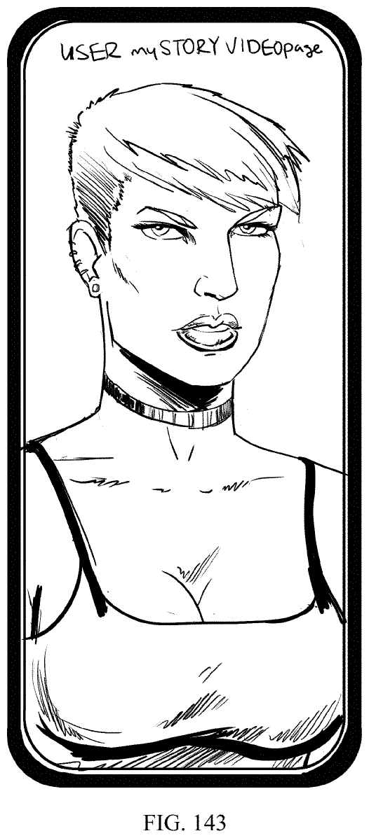

FIG. 127 illustrates a computer system 210 enabling or comprising the systems and methods in accordance with some embodiments of the system. In some embodiments, the computer system 210 can operate and/or process computer-executable code of one or more software modules of the aforementioned system and method. Further, in some embodiments, the computer system 210 can operate and/or display information within one or more graphical user interfaces (e.g., HMIs) integrated with or coupled to the system.

In some embodiments, the computer system 210 can comprise at least one processor 232. In some embodiments, the at least one processor 232 can reside in, or coupled to, one or more conventional server platforms (not shown). In some embodiments, the computer system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules (e.g., such as enterprise applications 238). In some embodiments, the software application modules 238 can include server-based software, and can operate to host at least one user account and/or at least one client account, and operate to transfer data between one or more of these accounts using the at least one processor 232.

With the above embodiments in mind, it is understood that the system can employ various computer-implemented operations involving data stored in computer systems. Moreover, the above-described databases and models described throughout this disclosure can store analytical models and other data on computer-readable storage media within the computer system 210 and on computer-readable storage media coupled to the computer system 210 according to various embodiments. In addition, in some embodiments, the above-described applications of the system 210 can be stored on computer-readable storage media within the computer system 210 and on computer-readable storage media coupled to the computer system 210. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 210 can comprise at least one computer readable medium 236 coupled to at least one of at least one data source 237a, at least one data storage 237b, and/or at least one input/output 237c. In some embodiments, the computer system 210 can be embodied as computer readable code on a computer readable medium 236. In some embodiments, the computer readable medium 236 can be any data storage that can store data, which can thereafter be read by a computer (such as computer 240). In some embodiments, the computer readable medium 236 can be any physical or material medium that can be used to tangibly store the desired information or data or instructions and which can be accessed by a computer 240 or processor 232. In some embodiments, the computer readable medium 236 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 236 can transmit or carry instructions to a remote computer 240 and/or at least one user 231, including a router, private or public network, or other transmission or channel, both wired and wireless. In some embodiments, the software application modules 238 can be configured to send and receive data from a database (e.g., from a computer readable medium 236 including data sources 237a and data storage 237b that can comprise a database), and data can be received by the software application modules 238 from at least one other source. In some embodiments, at least one of the software application modules 238 can be configured within the computer system 210 to output data to at least one user 231 via at least one graphical user interface rendered on at least one digital display.

In some embodiments, the computer readable medium 236 can be distributed over a conventional computer network via the network interface 235a where the system embodied by the computer readable code can be stored and executed in a distributed fashion. For example, in some embodiments, one or more components of the computer system 210 can be coupled to send and/or receive data through a local area network (“LAN”) 239a and/or an internet coupled network 239b (e.g., such as a wireless internet). In some embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of personal computers 240 which include for example desktop computers, and/or laptop computers, or any fixed, generally non-mobile internet appliances coupled through the LAN 239a. For example, some embodiments include one or more of personal computers 240, databases 241, and/or servers 242 coupled through the LAN 239a that can be configured for any type of user including an administrator. Some embodiments can include one or more personal computers 240 coupled through network 239b. In some embodiments, one or more components of the computer system 210 can be coupled to send or receive data through an internet network (e.g., such as network 239b). For example, some embodiments include at least one user 231a, 231b, is coupled wirelessly and accessing one or more software modules of the system including at least one enterprise application 238 via an input and output (“I/O”) 237c. In some embodiments, the computer system 210 can enable at least one user 231a, 231b, to be coupled to access enterprise applications 238 via an IO 237c through LAN 239a. In some embodiments, the user 231 can comprise a user 231a coupled to the computer system 210 using a desktop computer, and/or laptop computers, or any fixed, generally non-mobile internet appliances coupled through the internet 239b. In some embodiments, the user can comprise a mobile user 231b coupled to the computer system 210. In some embodiments, the user 231b can connect using any mobile computing 231c to wireless coupled to the computer system 210, including, but not limited to, one or more of at least one personal digital assistant, at least one cellular phone, at least one mobile phone, at least one smart phone, at least one pager, at least one digital tablets, and/or at least one fixed or mobile internet appliances. In some embodiments, the computer system 210 is coupled to a network of space nodes 231d (e.g., satellites, space stations, spacecraft).

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Modifications to the illustrated embodiments and the generic principles herein can be applied to all embodiments and applications without departing from embodiments of the system. Also, it is understood that features from some embodiments presented herein are combinable with other features according to some embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the additional meaning to the following terms:

“Substantially” and “approximately” when used in conjunction with a value encompass a difference of 10% or less of the same unit and scale of that being measured. In some embodiments, “substantially” and “approximately” are defined as presented in the specification in accordance with some embodiments.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

The use of and/or, in terms of “A and/or B,” means one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

As used herein, some embodiments recited with term “can” or “may” or derivations there of (e.g., the system display can show X) is for descriptive purposes only and is understood to be synonymous with “configured to” (e.g., the system display is configured to show X) for defining the metes and bounds of the system

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless a explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A digital media system comprising:
a decentralized communication system comprising a plurality of nodes;
wherein each of the plurality of nodes comprises one or more node computers comprising one or more node processors and one or more node non-transitory computer readable media located in one or more of:
a plurality of space nodes,
a plurality of vehicle nodes, and
a plurality of fixed nodes;
wherein at least one of the plurality of nodes is located within one or more jurisdictions;
wherein at least one of the plurality of nodes is configured to process, transmit, receive, and/or store digital data;
wherein at least one of the plurality of nodes is configured to execute a digital transaction comprising the digital data;
wherein the digital transaction includes one or more of receiving, storing, transmitting, exchanging, and/or processing a currency and/or a digital asset; and
wherein the system is configured to specify one or more node paths through which the digital data is passed, stored, and/or processed; and
wherein the system is configured to specify one or more jurisdictions in which the digital data is passed, stored, and/or processed.

2. The system of claim 1,
wherein the system is configured to enable a single reusable address;
wherein the reusable address is configured to provide user credentials for handling regulatory requirements for the digital transaction;
wherein the reusable address is configured to enable the user to maintain control over their identity data.

3. The system of claim 1,
wherein the system is configured to prevent the digital data from passing through the one or more jurisdictions.

4. The system of claim 1,
wherein the digital transaction comprises an exchange of fiat currency and digital currency.

5. The system of claim 1,
wherein the digital transaction comprises instructions executed in a blockchain technology.

6. The system of claim 3,
further comprising a social media system,
wherein the social media system comprises one or more social media computers comprising one or more social media processors and one or more social media non-transitory computer readable media, the one or more social media non-transitory computer readable media having instructions stored thereon that when executed by the one or more social media processors implement:
a social media network configured to transmit at least a portion of the digital data that comprises social media data including digital assets using one or more of the plurality of nodes;
wherein the system is configured to allow a user to choose through which of the one or more government jurisdictions the social media data passes.

7. The system of claim 6,
wherein the social media data comprises the digital transaction.

8. The system of claim 7,
the decentralized communication system further comprising a connectivity system comprising a plurality of one or more connectivity nodes;
wherein each of the plurality of connectivity nodes comprise one or more connectivity computers comprising one or more connectivity processors and one or more connectivity non-transitory computer readable media, the one or more connectivity non-transitory computer readable media having instructions stored thereon that when executed by the one or more connectivity processors implement:
a connectivity network configured to receive, store, transmit, and/or process the digital data to and/or from a plurality of connectivity network components.

9. The system of claim 8,
wherein the plurality of connectivity network components comprises a first computer, a second computer, and third computer each configured to receive, store, process, and/or transmit digital signals comprising at least a portion of the digital data;
wherein the second computer is configured to communicate directly with the first computer and the third computer;
wherein the third computer is configured to communicate directly with the second computer but not directly with the first computer; and
wherein the third computer is configured to receive the at least a portion of the digital data from the first computer via the second computer.

10. The system of claim 9,
wherein the connectivity system comprises one or more of a cellular phone, a smart card, and portable modem.

11. The system of claim 9,
further comprising a payment device;
wherein the payment device comprises one or more non-transitory computer media with at least a portion of the digital data that includes at least a portion of a user's identification information stored thereon;
wherein the system is configured to enable a user and/or merchant to request a currency transfer using the payment device; and
wherein the system is configured to specify one or more jurisdictions in which the currency transfer occurs.

12. The system of claim 11,
wherein the system is configured to execute the currency transfer upon receiving the request that comprises at least a portion of the digital data stored on the physical card.

13. The system of claim 12,
wherein the system is configured to prevent data the request for the currency transfer from passing through one or more of the one or more government jurisdictions.

14. The system of claim 13,
wherein the system is configured to convert the requested currency to at least one fiat currency accepted in the jurisdiction where the request for the currency transfer was sent.

15. The system of claim 12,
wherein the system is configured to transmit, store, and/or receive the digital data using any conventional communications system;
wherein the system is configured to transmit, store, and/or receive the digital data using any conventional social media system;
wherein the system is configured to transmit, store, and/or receive the digital data using any conventional space constellation system; and
wherein the system is configured to use any conventional blockchain technology to execute the transfer of the digital data.
